(19) United States
(12) Patent Application Publication
(10) Pub. No.: US 2011/0166904 A1
(43) Pub. Date: Jul. 7, 2011

(54) SYSTEM AND METHOD FOR TOTAL RESOURCE MANAGEMENT

(76) Inventors: Bryce ARROWOOD, Potomac, MD (US); Joshua Capy, Prescott, AZ (US); Eyal Iffergan, Sugar Land, TX (US); Jeffrey Brandt, Ashburn, VA (US)

(21) Appl. No.: 12/978,112

(22) Filed: Dec. 23, 2010

Related U.S. Application Data
(60) Provisional application No. 61/290,126, filed on Dec. 24, 2009.

(51) Int. Cl. G06Q 10/00

(52) U.S. Cl. 705/7.23

(57) ABSTRACT

A method for total resource management of at least one project for at least one knowledge-based practice, comprising: receiving, in at least two practice management applications, employee data for at least one employee and/or client data for at least one client; integrating data from the at least two practice management applications utilizing at least one enterprise application; and creating, at least one project management model utilizing the integrated data, the at least one project management model enabling clients and employees to interact and/or manage metrics of the knowledge-based practice.

This application is based on and derives the benefit of the filing date of U.S. Provisional Patent Application No. 61/290,126, filed Dec. 24, 2009. The entire content of this application is herein incorporated by reference in its entirety.

### BRIEF DESCRIPTION OF THE FIGURES

FIGS. 1 and 4 illustrate some primary components utilized in a total resource management system, according to several embodiments of the invention.

FIGS. 2-3 and 5-7 illustrate methods of performing total resource management, according to several embodiments of the invention.

FIGS. 8-174 illustrate various screen shots and tables that can be utilized in various embodiments of the invention.

### DESCRIPTION OF EMBODIMENTS OF THE INVENTION

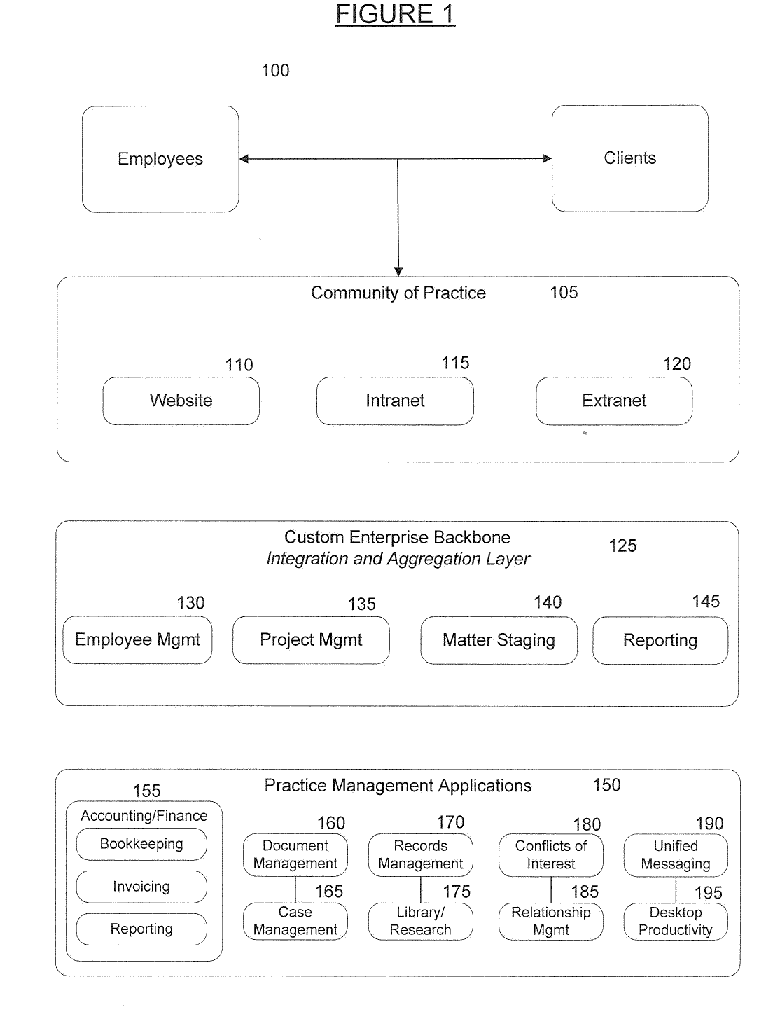

FIG. 1 illustrates some primary components utilized in a total resource management system, according to an embodiment of the present invention. A method can be provided for total resource management of at least one project for at least one knowledge-based practice, comprising: receiving, in at least two practice management applications, employee data for at least one employee and/or client data for at least one client; integrating data from the at least two practice management applications utilizing at least one enterprise application; and creating, at least one project management model utilizing the integrated data, the at least one project management model enabling clients and employees to interact and/or manage metrics of the knowledge-based practice. The knowledge-based practice can include any knowledge-based practice (e.g., business, government, non-profit), such as, but not limited to: at least one law practice; at least one consulting practice; at least one technology practice; at least one financial practice; at least one document management practice; at least one case management practice; at least one records management practice; at least one library application; at least one research application; at least one conflict of interest application; at least one relationship management application; at least one unified messaging application; at least one desktop productivity application; or at least one accounting practice; or any combination thereof. It should be noted that applications related to each or any combination of these practices can be utilized. In addition, a professional development social network can be provided. Furthermore, reports and documents can be managed. Thus, a total resource management system can be provided that brings awareness to every phase of a project: job staging, execution, final deliverables, and all internal and external business intelligence gathering and marketing. FIG. 1 includes a system 100 that can connect employees and clients through a community of practice 105 (e.g., website 110, Intranet 115, or Extranet 120, or any combination thereof) with a custom enterprise backbone 125 and various practice management applications 150. The custom enterprise backbone 125 will be discussed in more detail below. The practice management applications 150 can include accounting/finance application(s) 155 (e.g., bookkeeping, invoicing, reporting), document management application(s) 160, case management application(s) 165, records management application(s) 170, library/research application(s) 175, conflict of interest application(s), relationship management application(s) 185, unified messaging application(s), or desktop productivity application(s), or any combination thereof. Those of ordinary skill in the art will see that many other types of applications can be utilized. In addition, customized and/or off-the-shelf applications can be utilized.

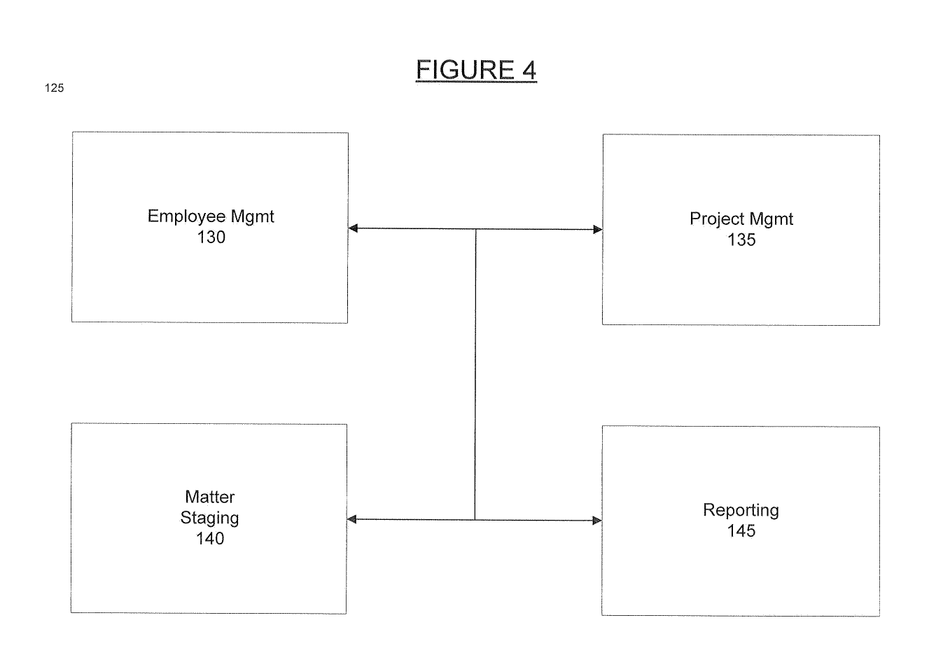

FIG. 4 is a diagram illustrating an additional view of the custom enterprise backbone 125, according to one embodiment. The custom enterprise backbone 125 can manage and integrate the practice management applications 150. For example: Active matters can be viewed (e.g., in read-only) so that sales staff can be aware of a matter's history. Internal and external business processes can be managed that concern the contractual relationship with clients, vendors, support practice, and internal team management. Matter specific task management can be done between professionals, clients, practice support, vendors, document creation, and time tracking. Billing processes can be performed. Matter specific and contractual agreements can be managed for clients with specific matters. Conflict and client party relationship information can be stored. These are merely examples, and the figures below will highlight many other examples of how the custom enterprise backbone 125 can manage and integrate the practice management applications.

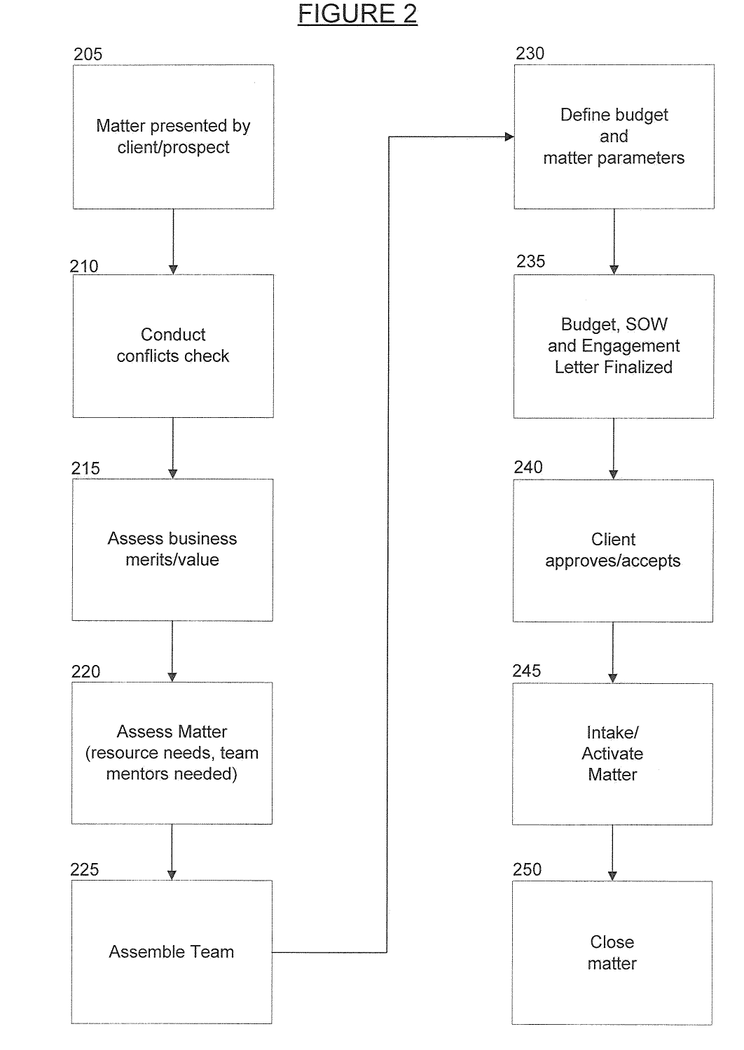

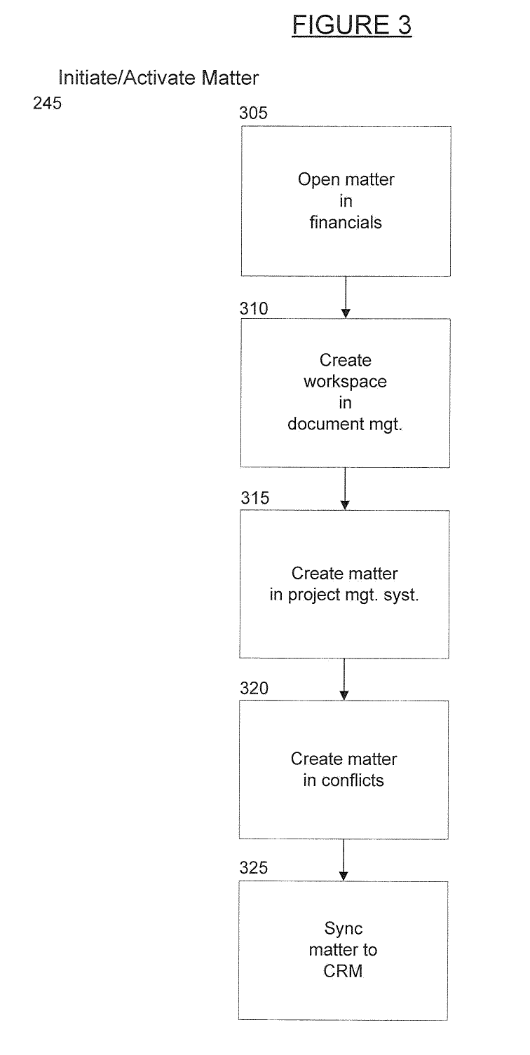

FIG. 2 illustrates a method for providing and maintaining a fixed priced budget, according to one embodiment. FIG. 2 can have four phases in some embodiments. Phase 1 can include pre-matter staging, which can produce a total pictures of the resources needed, when and where they are needed, and the costs associated with each of them. (See 205-240 of FIG. 2.) Pre-matter staging can use the custom enterprise backbone 125 to figure out who is ideally suited to help on a particular matter. Phase 2 can include matter staging, which can put the matter into action. (See 245 of FIG. 2.) Phase 3 can include matter execution and/or analysis, which can provide real time business awareness of an executing matter, and final analysis of a closed matter (e.g., which can assist in future job estimation and resources). Phase 4 can include matter closure, which can mark the end of a matter when costs stop accruing against it. (See 250 of FIG. 2.)

Referring now to FIG. 2, in 205, a matter can be presented by a client/prospect. In 210, a conflicts check can be conducted. In 215, the business merits/value can be assessed. In 220, the matter can be assessed. For example, the resource needs and team members needed can be determined. For example, the matter work that needs to be done can be broken down into multiple (e.g., hundreds of categories) and a search can be done for any employee who has done work in the categories of interest. (It should be noted that when employees start, they list this information. Going forward, all the work they do is captured and categorized). In 225, the team needed to complete the matter can be assembled. In 230, the budget and matter parameters can be defined. In 235, the budget, statement of work (SOW) and engagement letter can be finalized. In 240, the client can approve the budget, SOW, and engagement letter. In 245, the matter can be initiated. In 250, the matter can be closed.

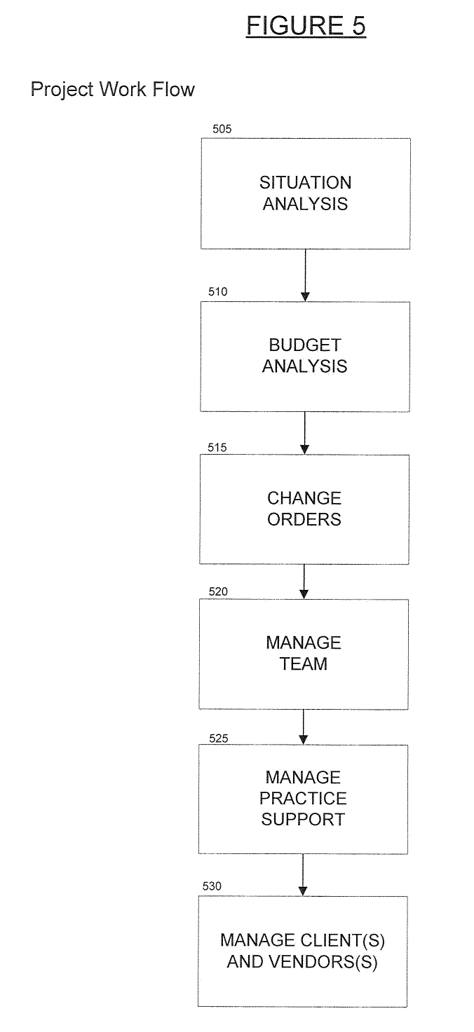

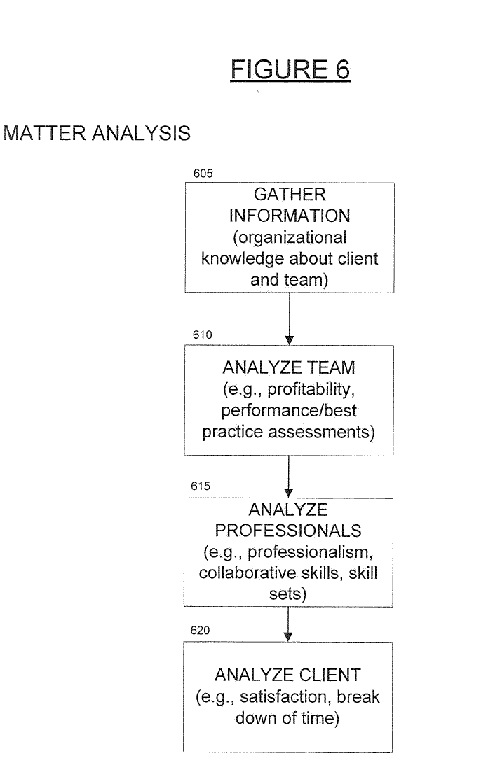

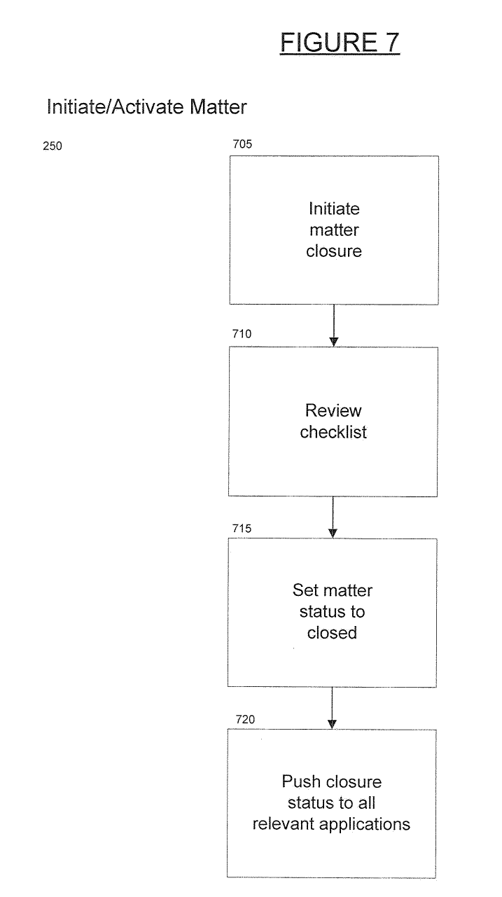

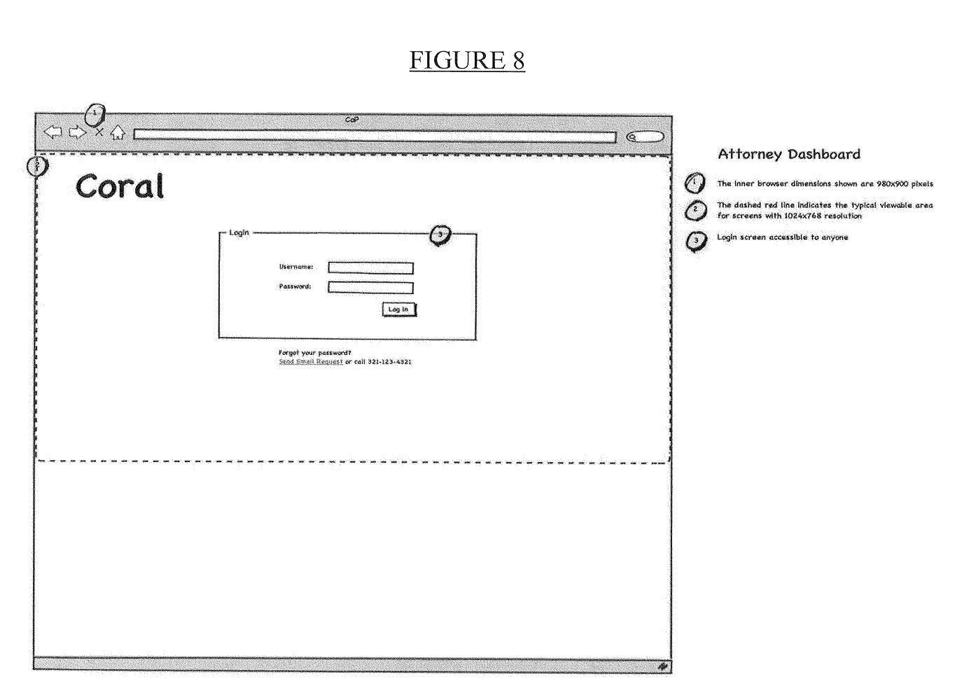

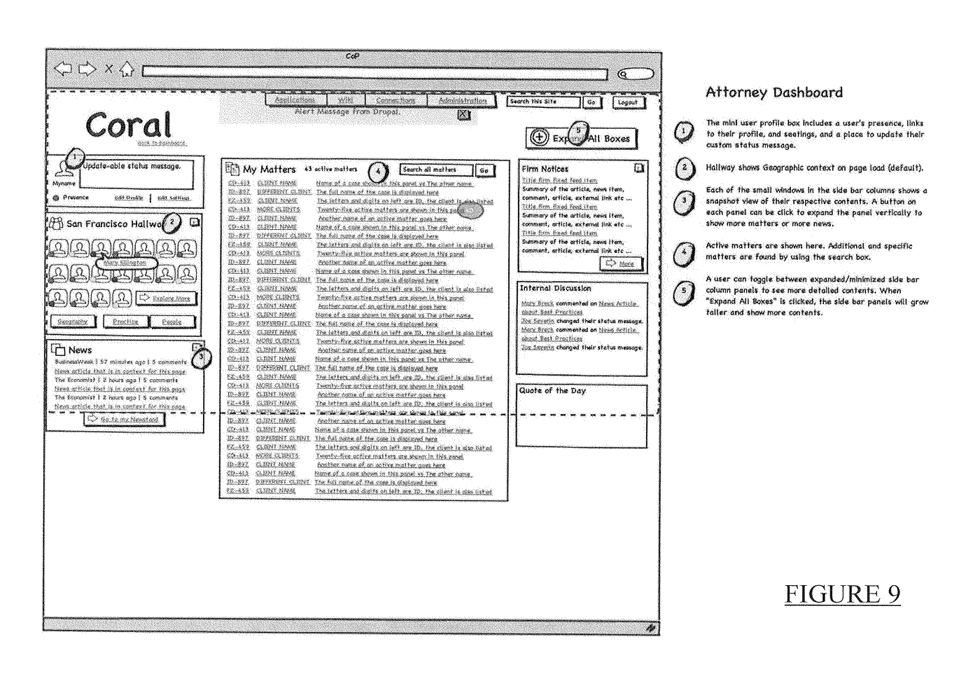

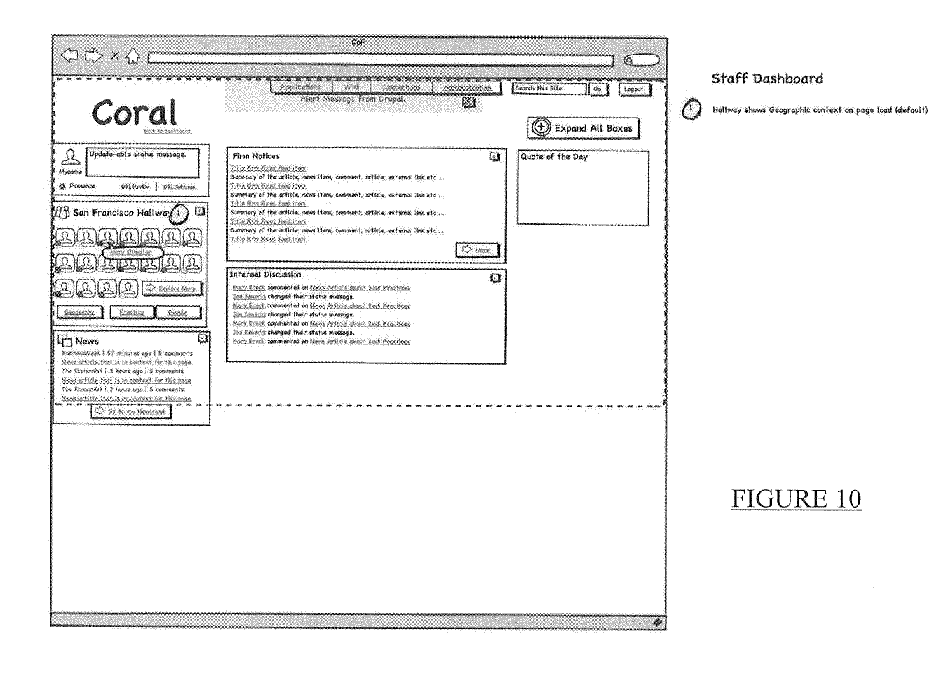

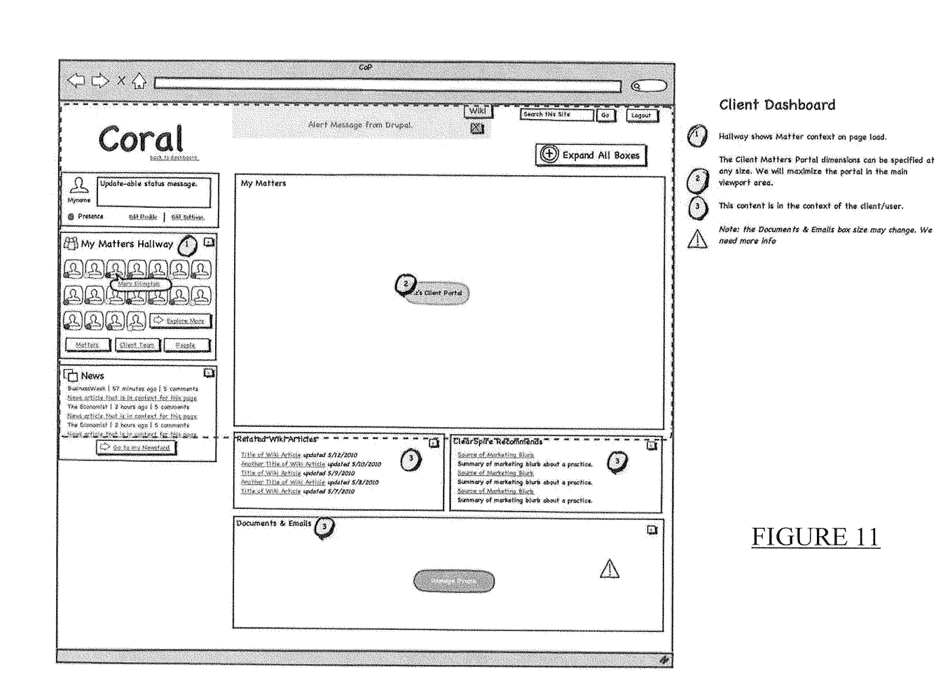

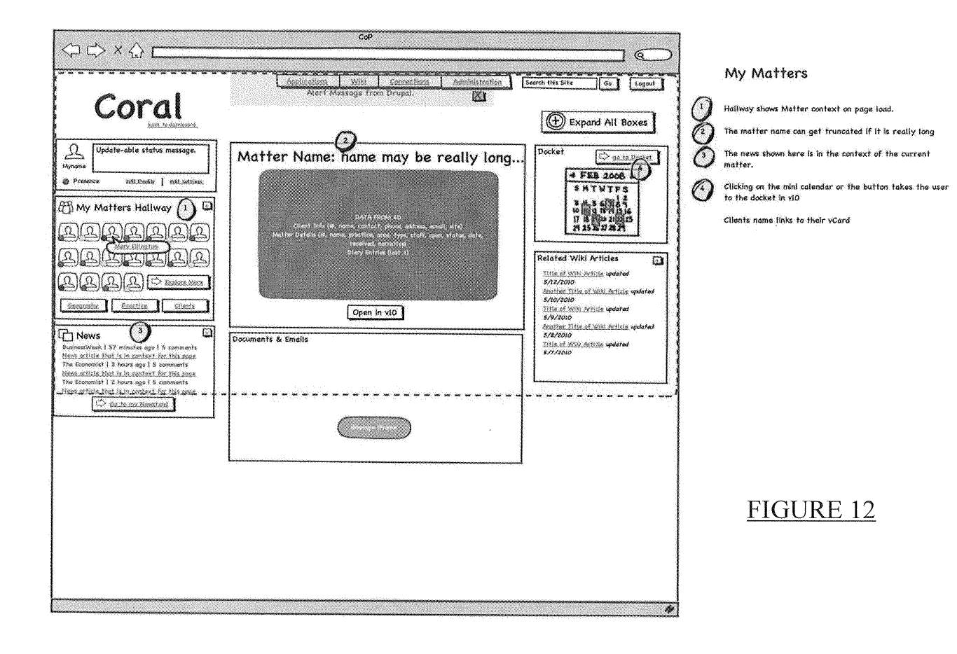

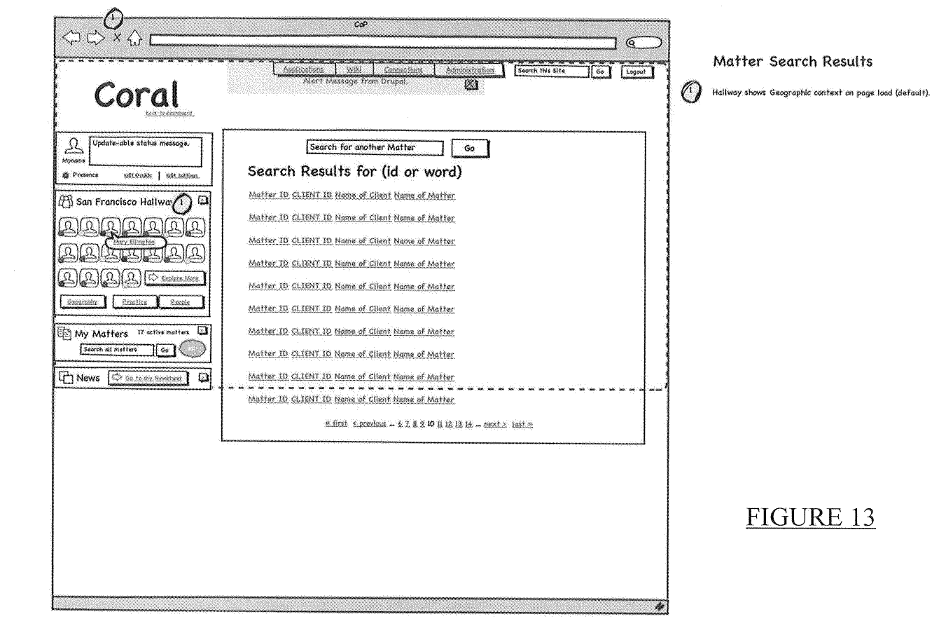

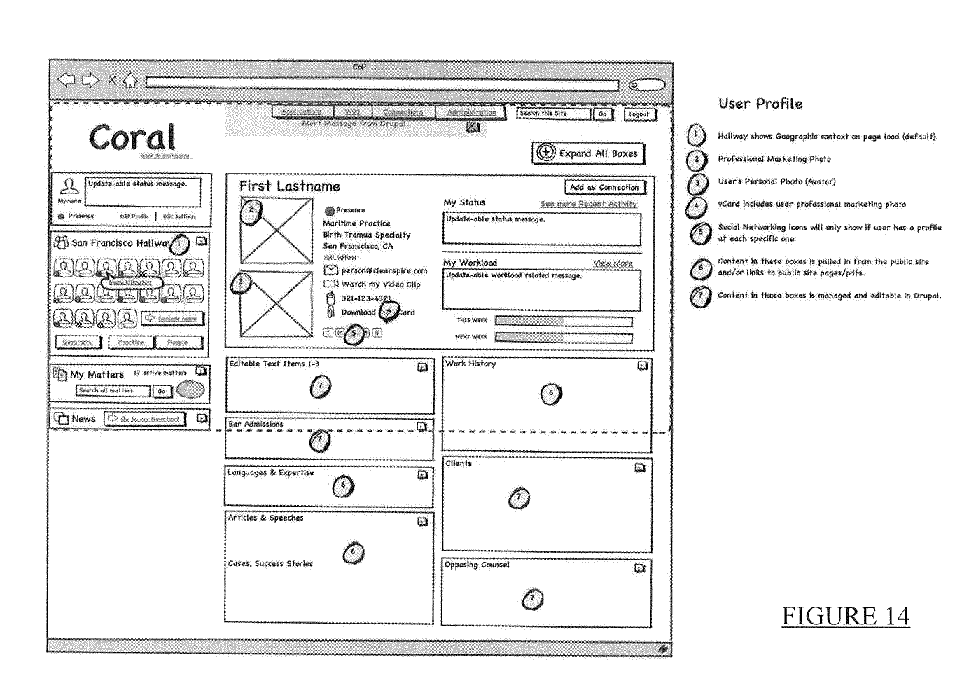

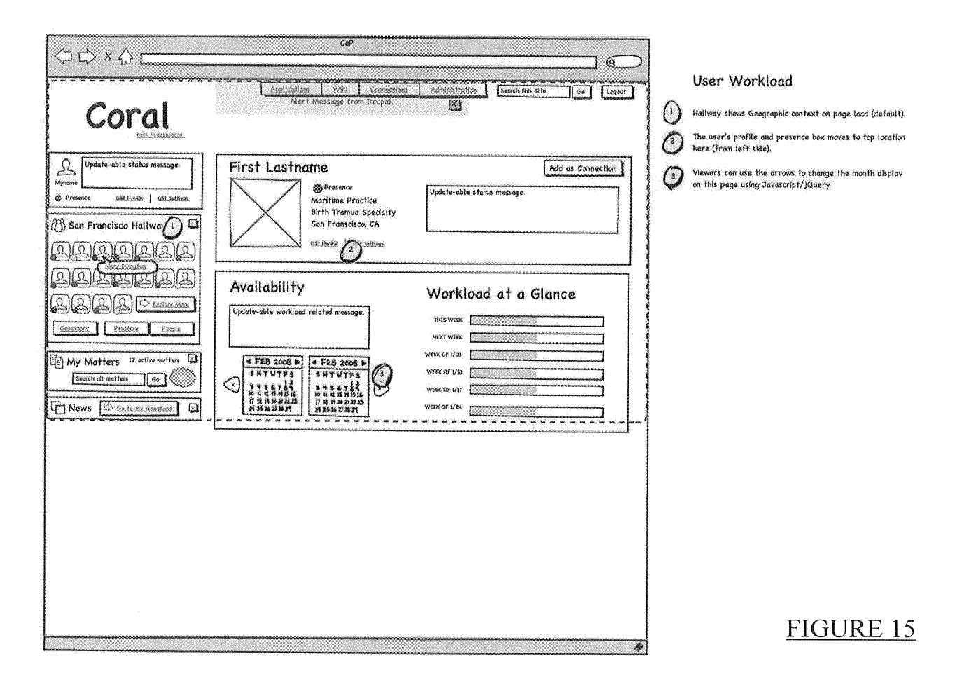

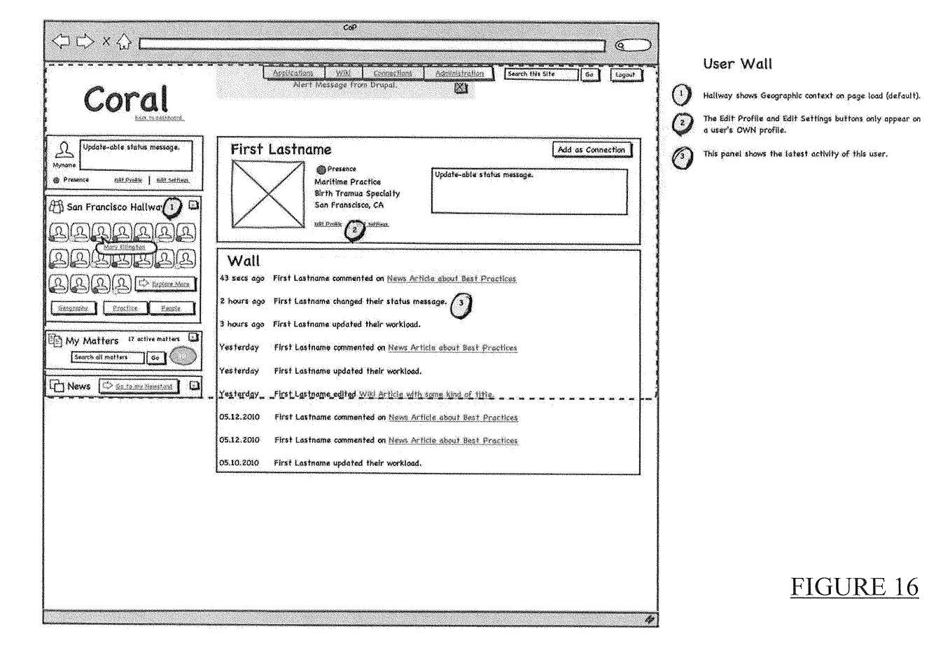

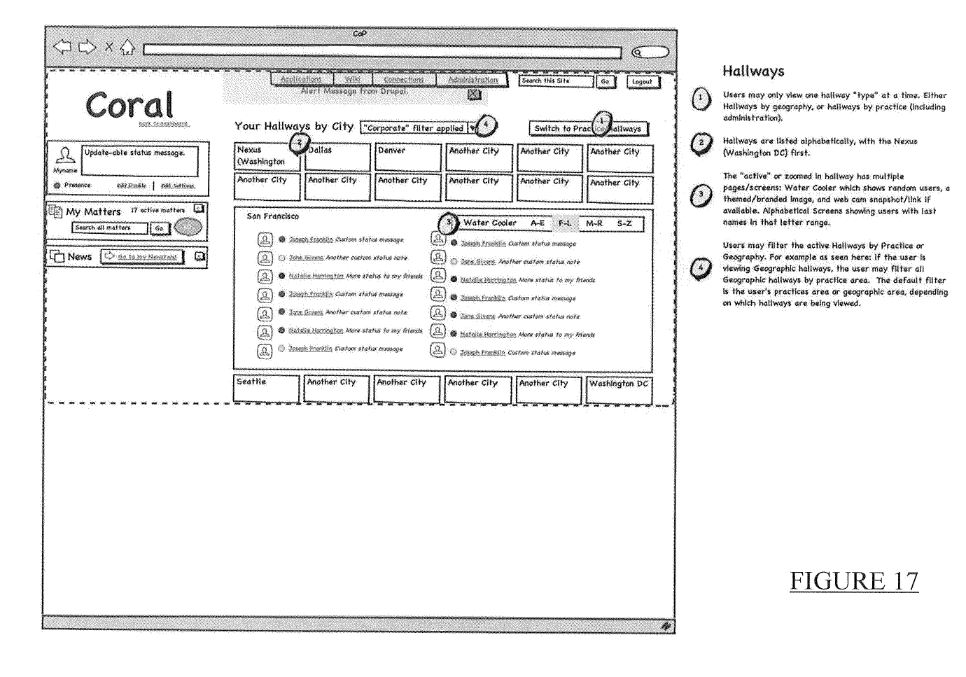

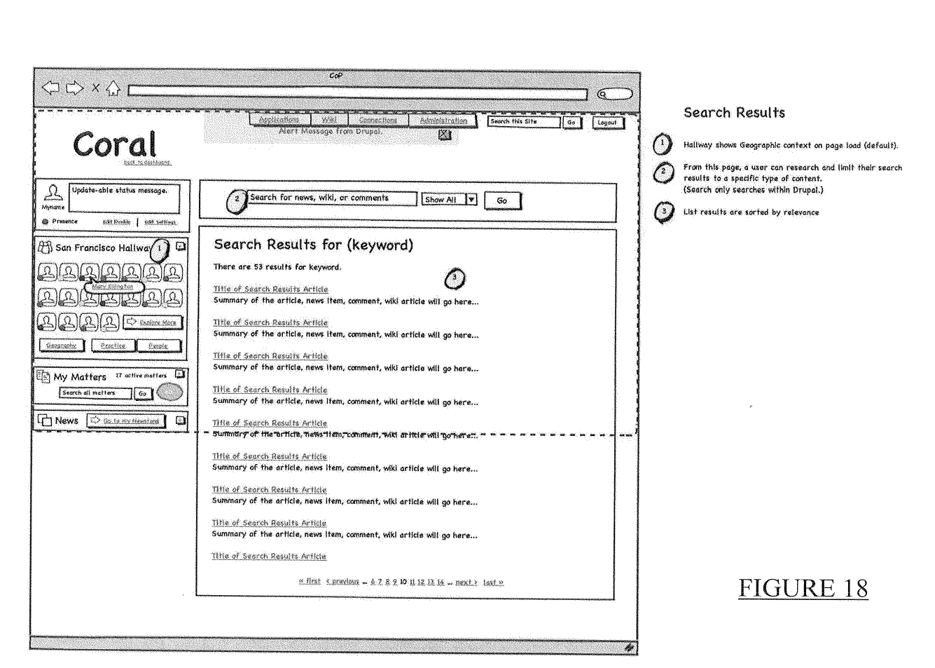

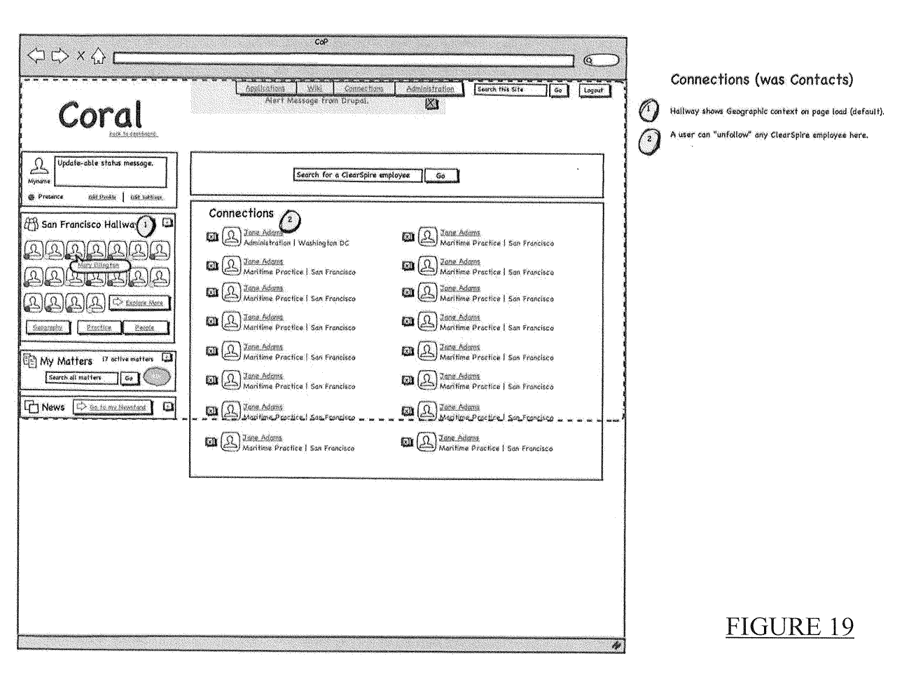

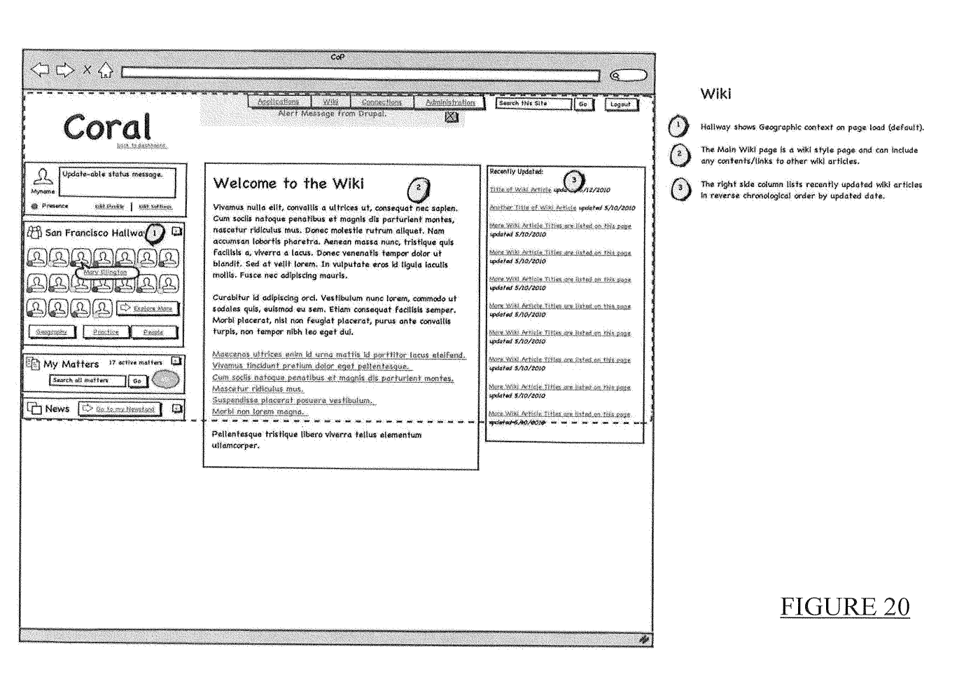

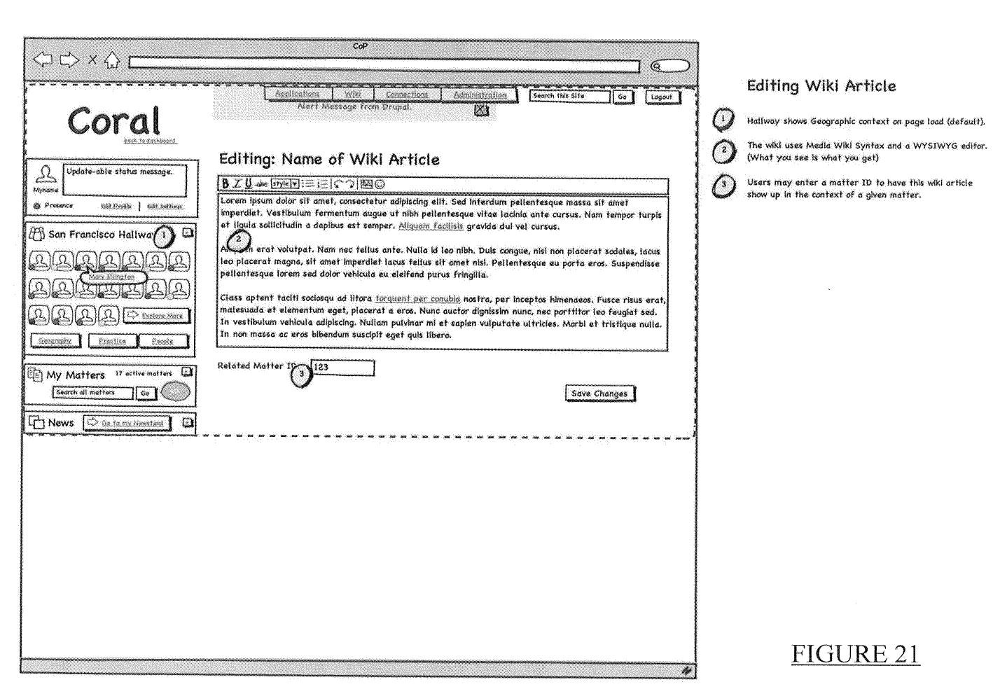

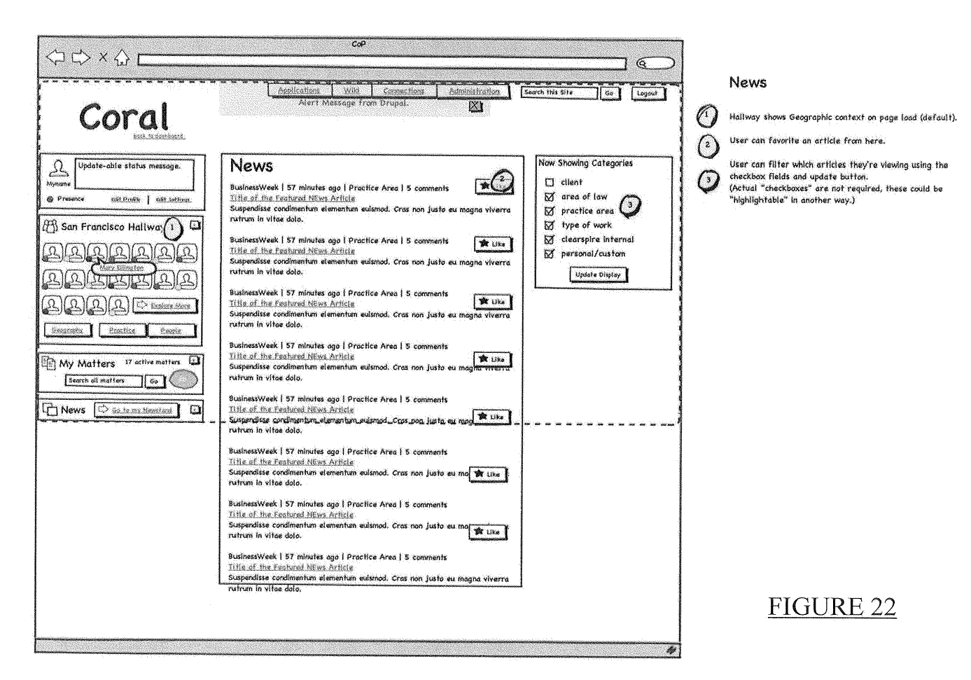

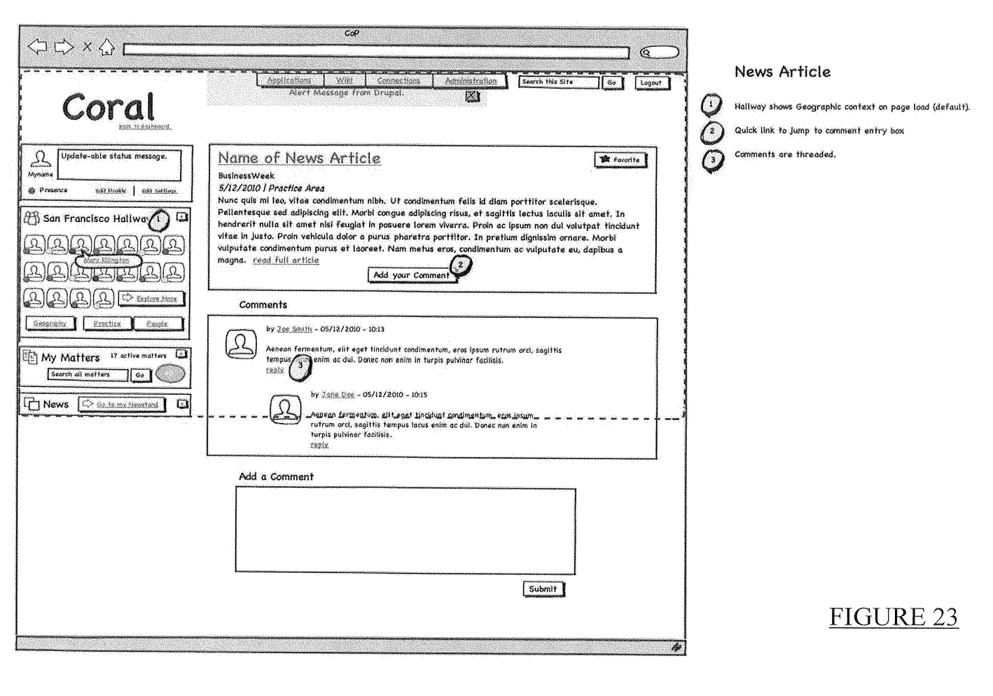

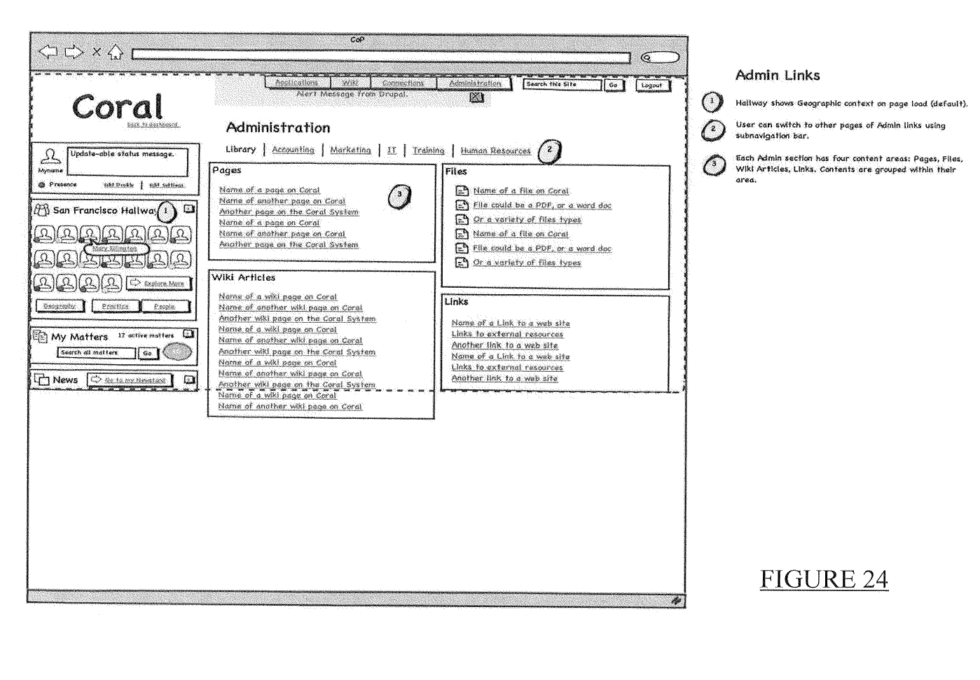

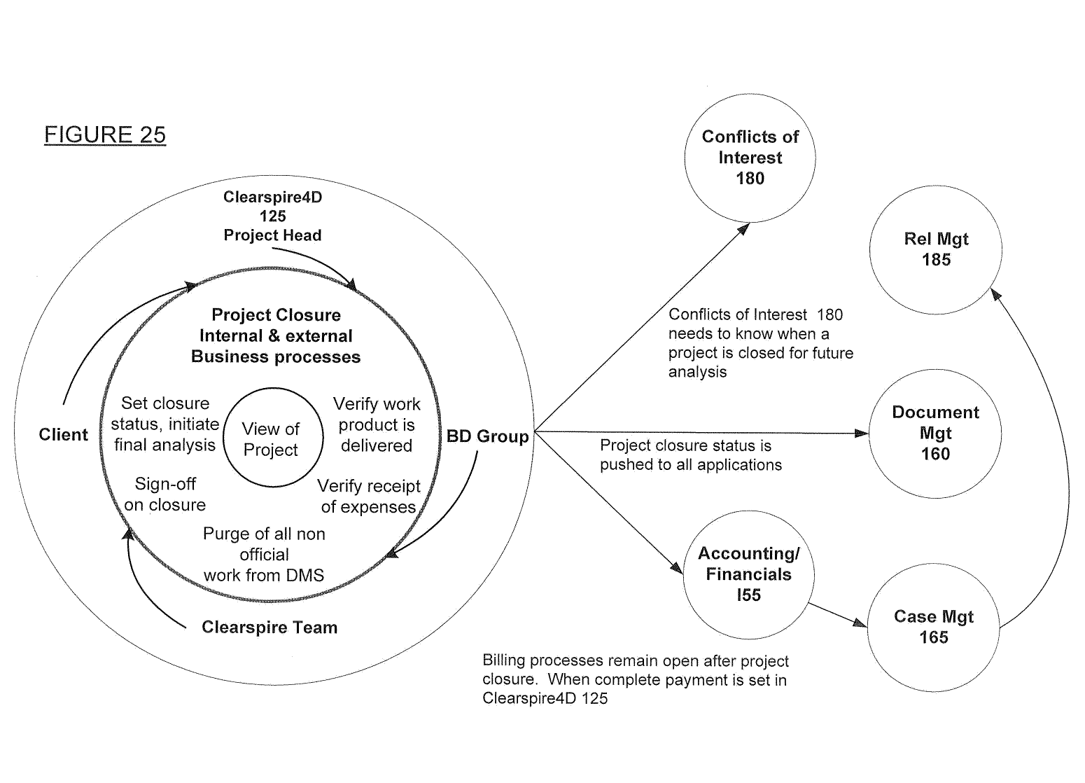

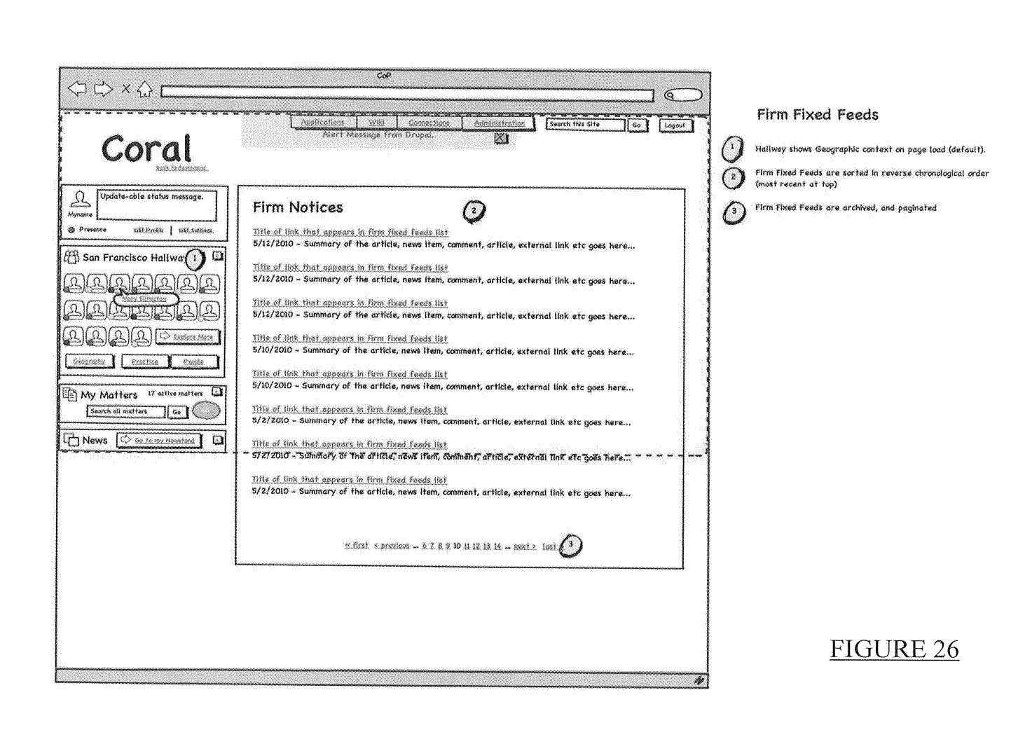

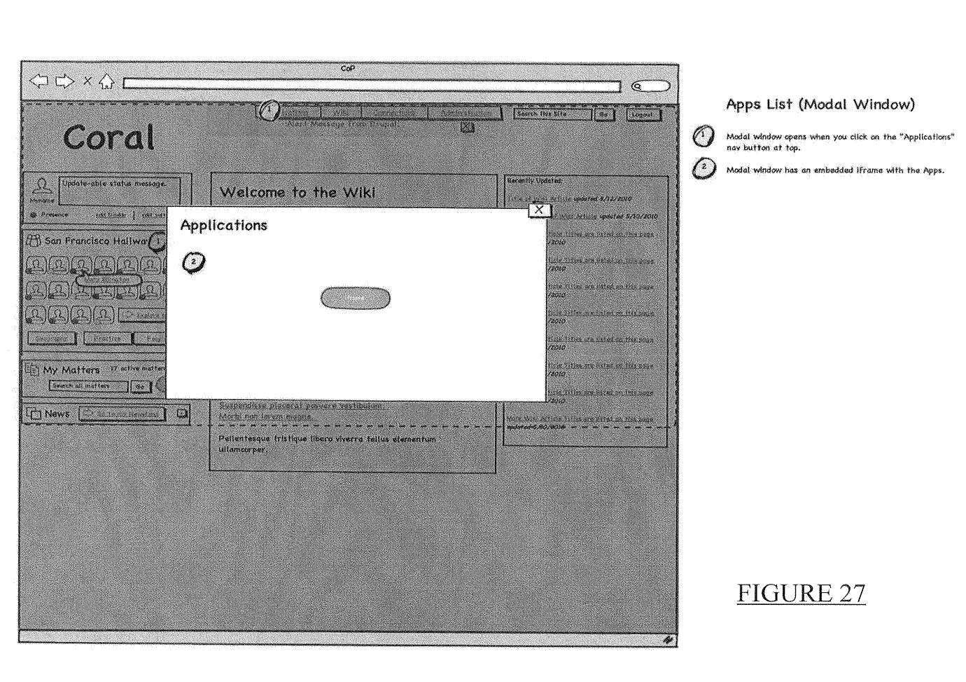

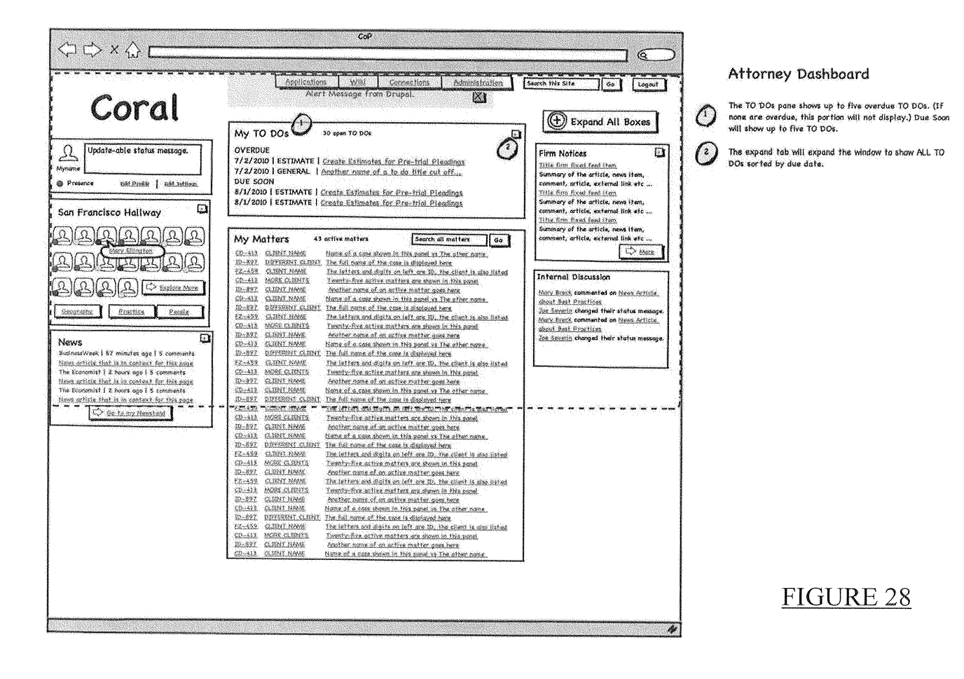

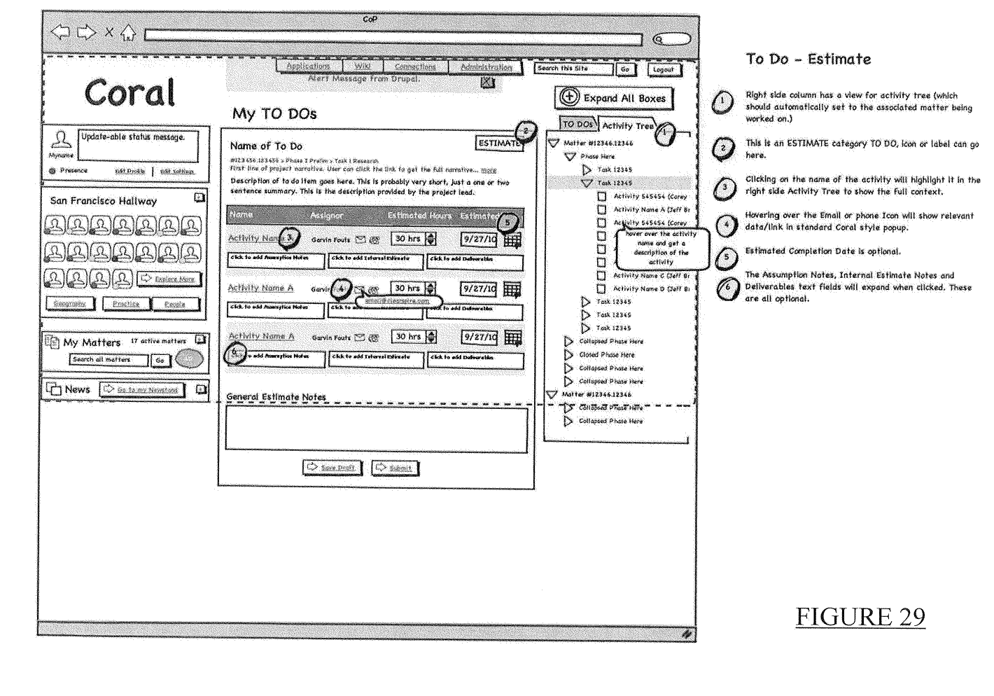

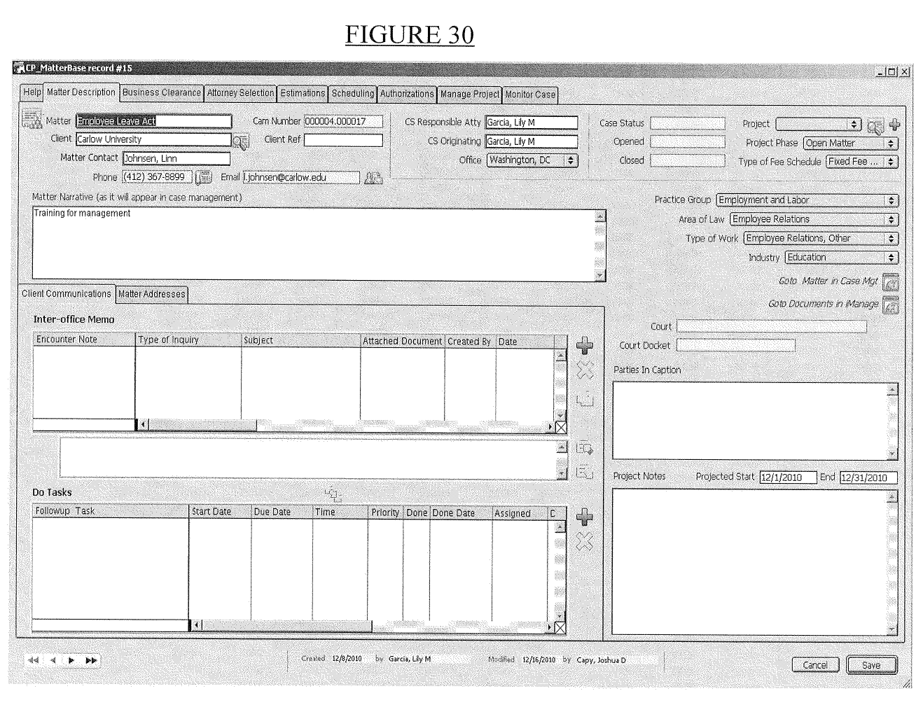

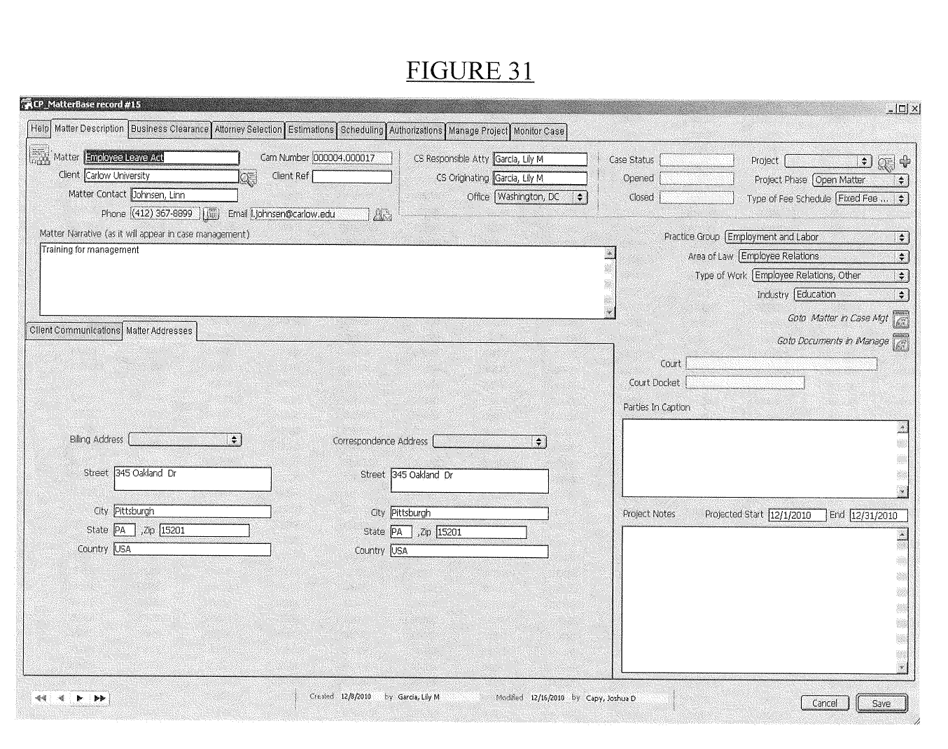

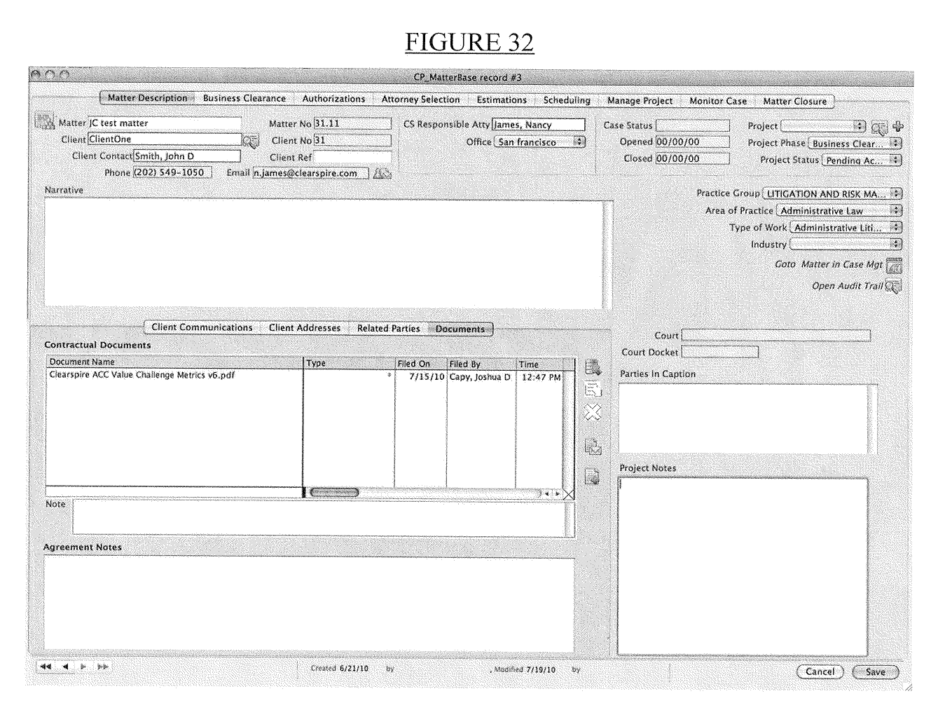

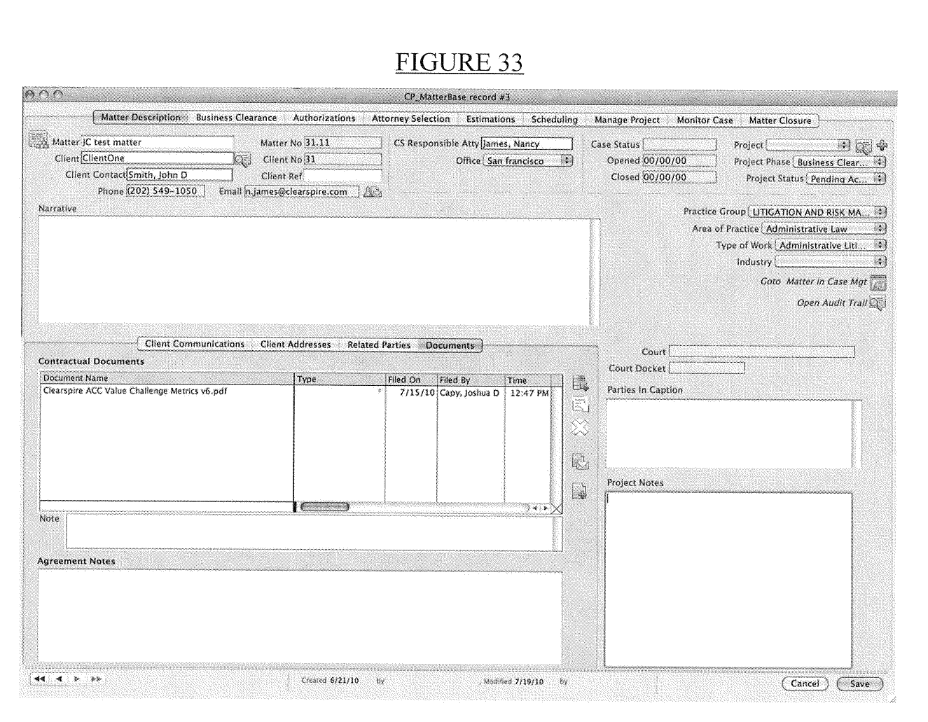

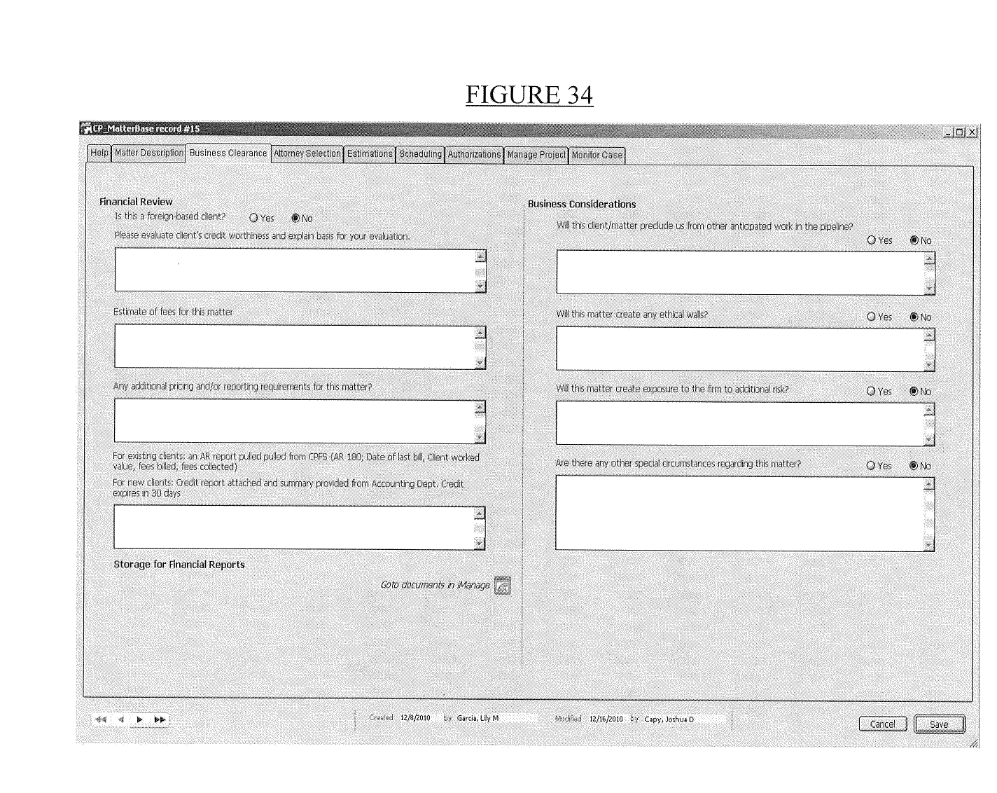

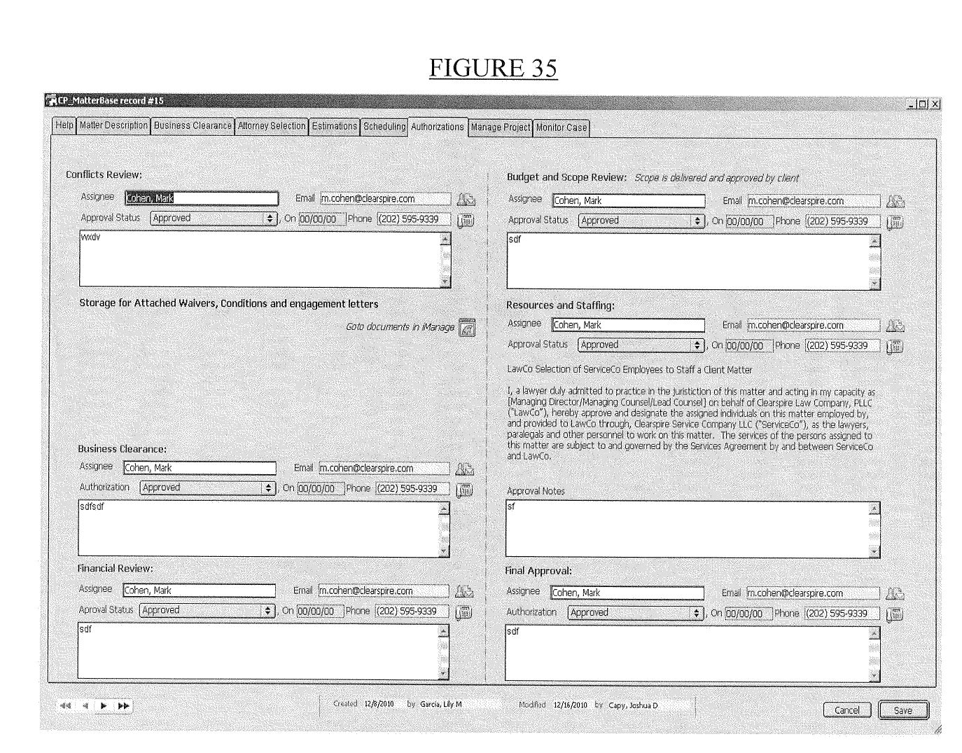

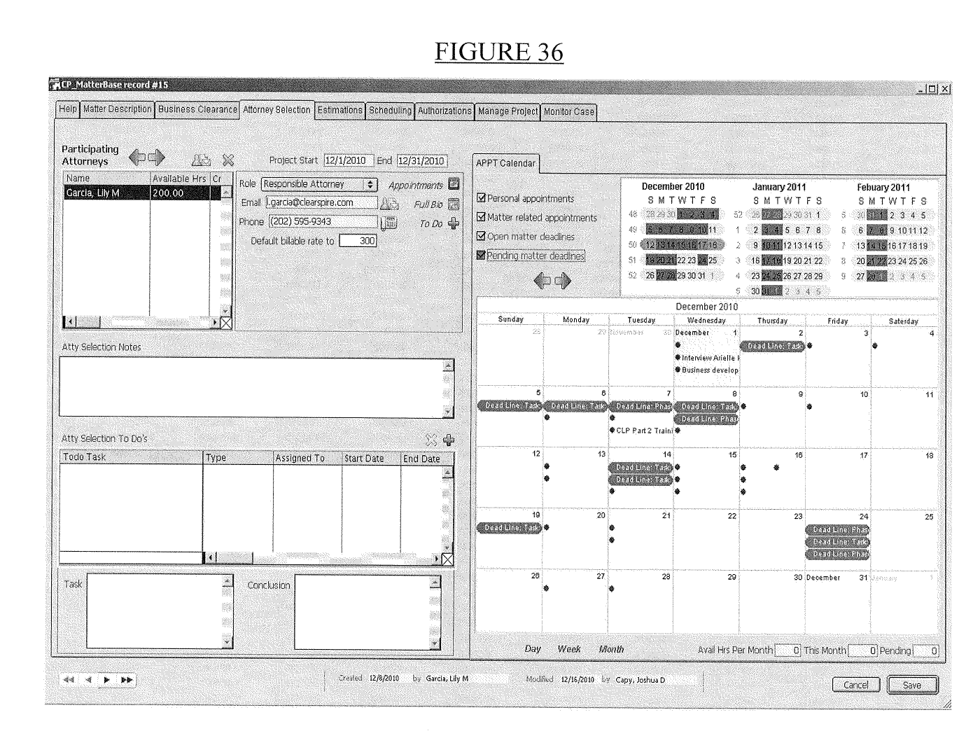

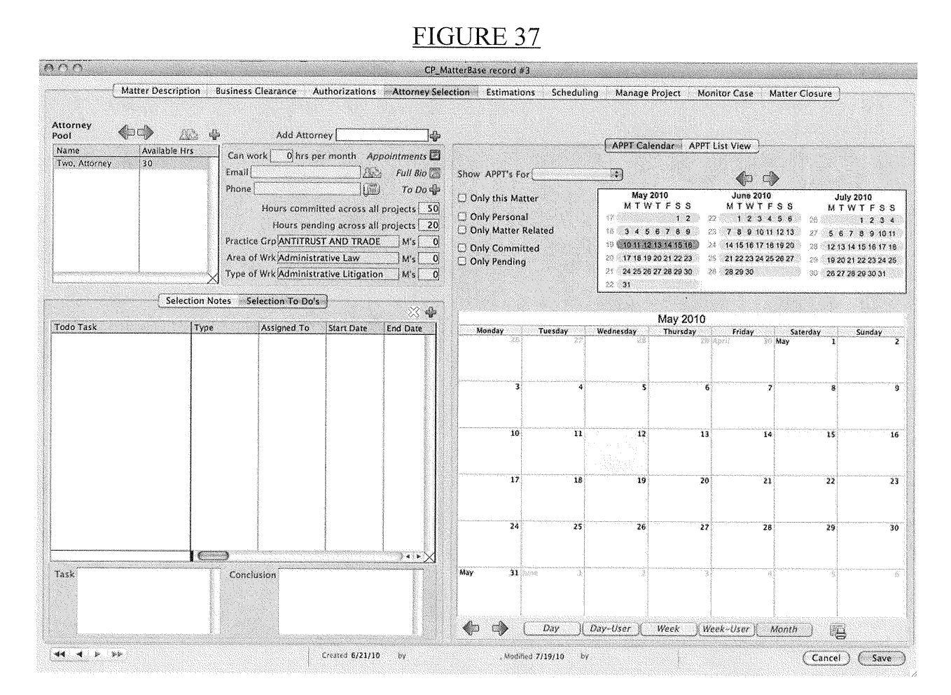

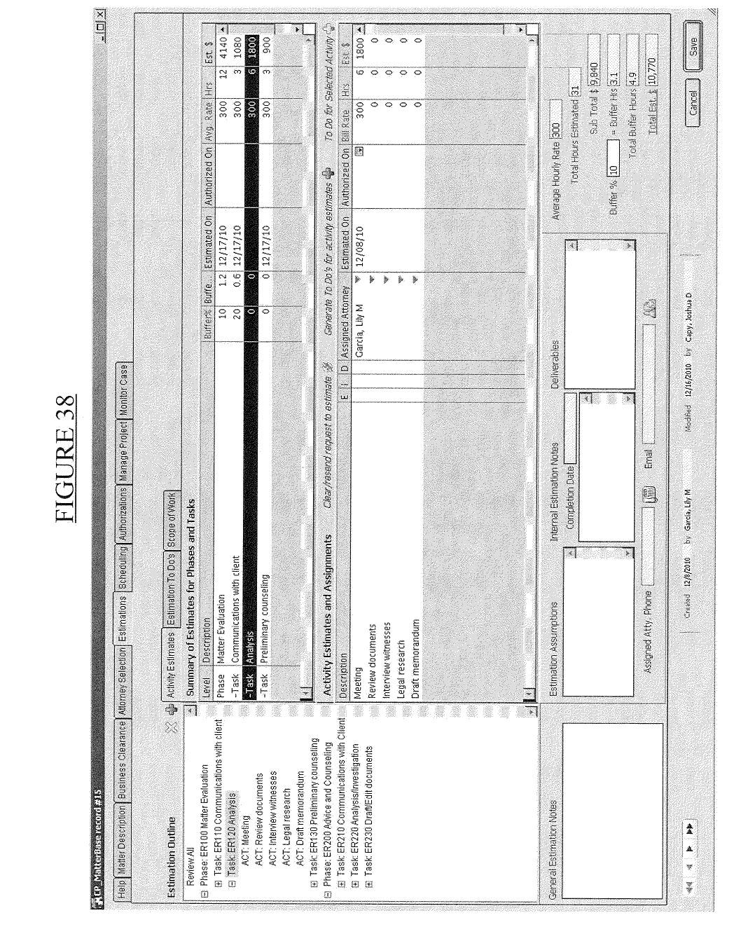

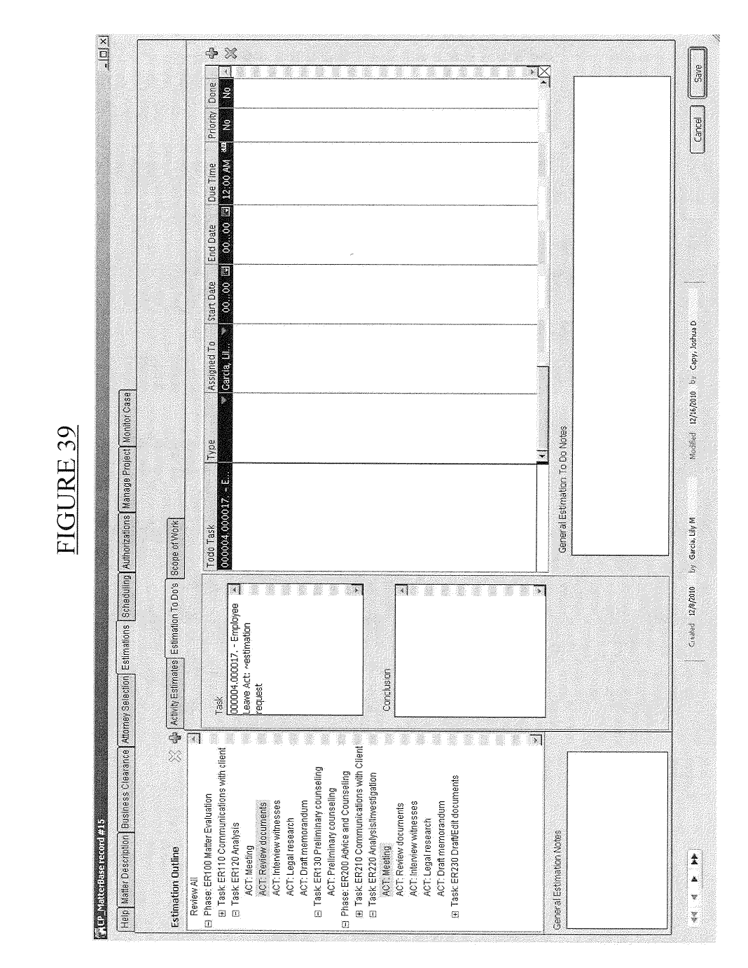

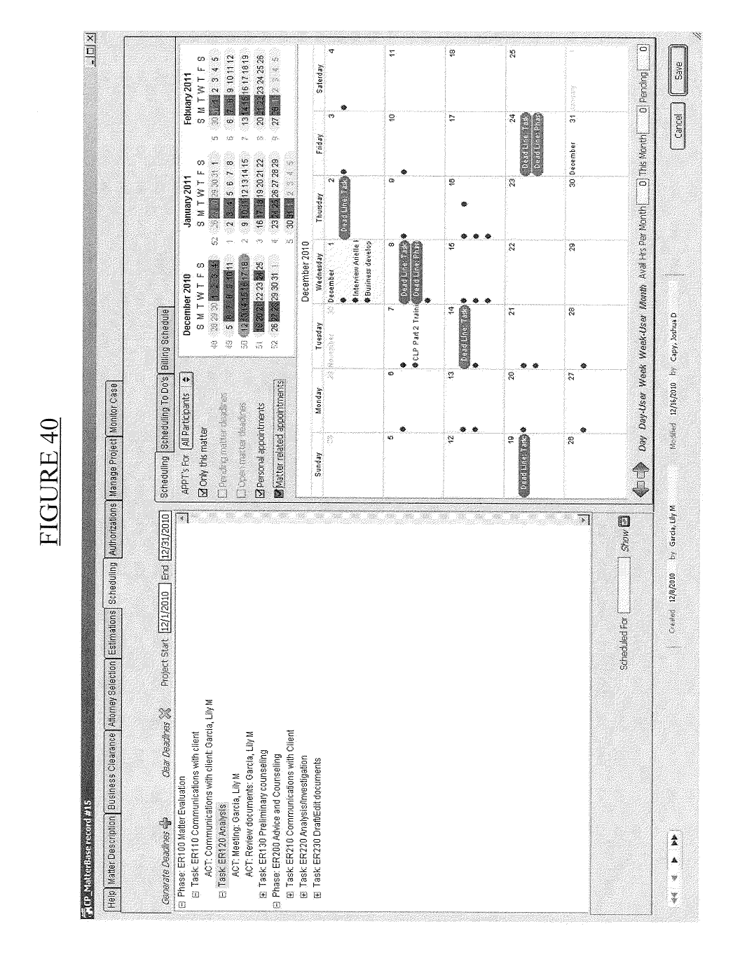

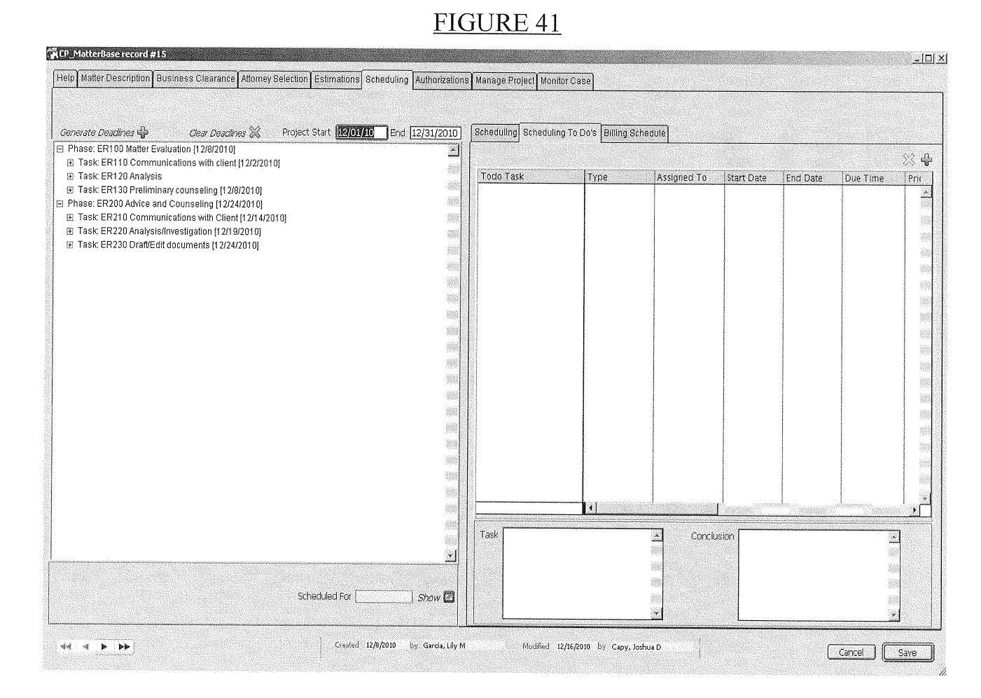

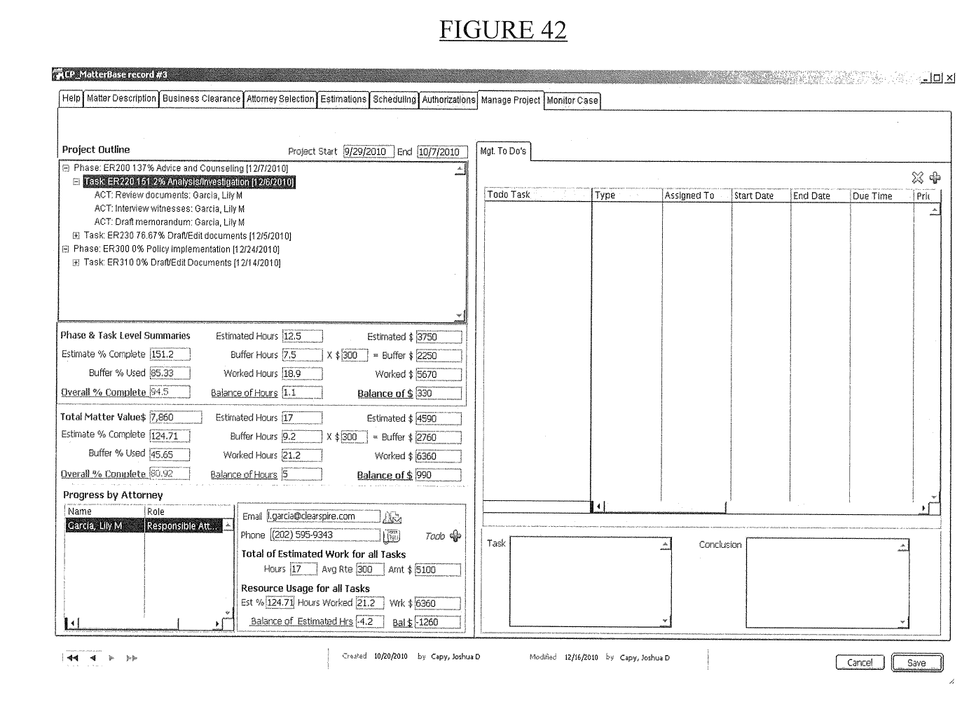

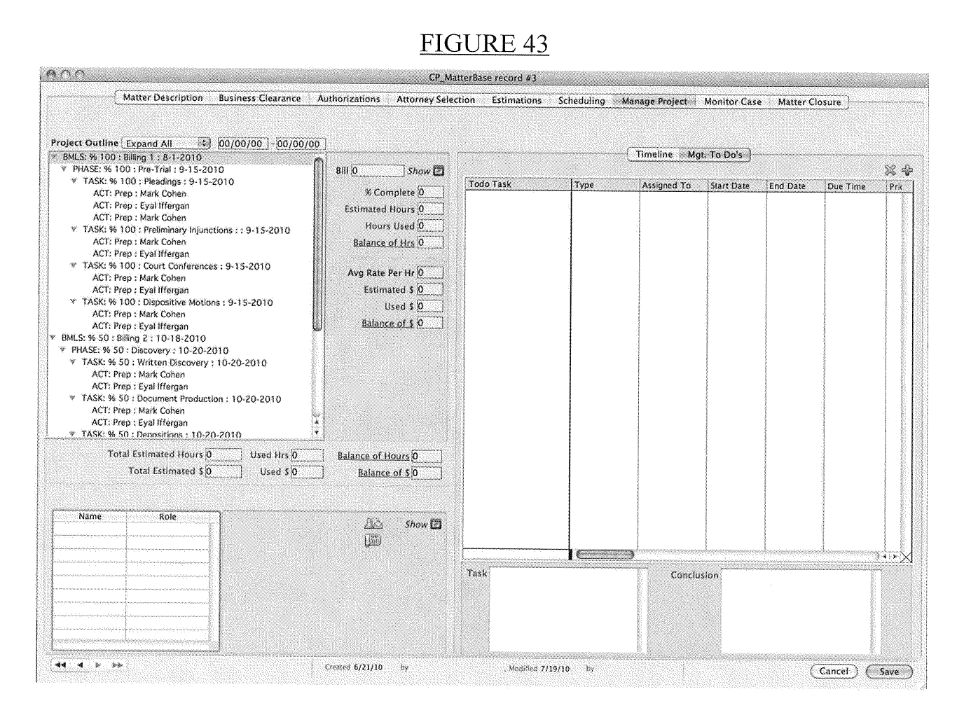

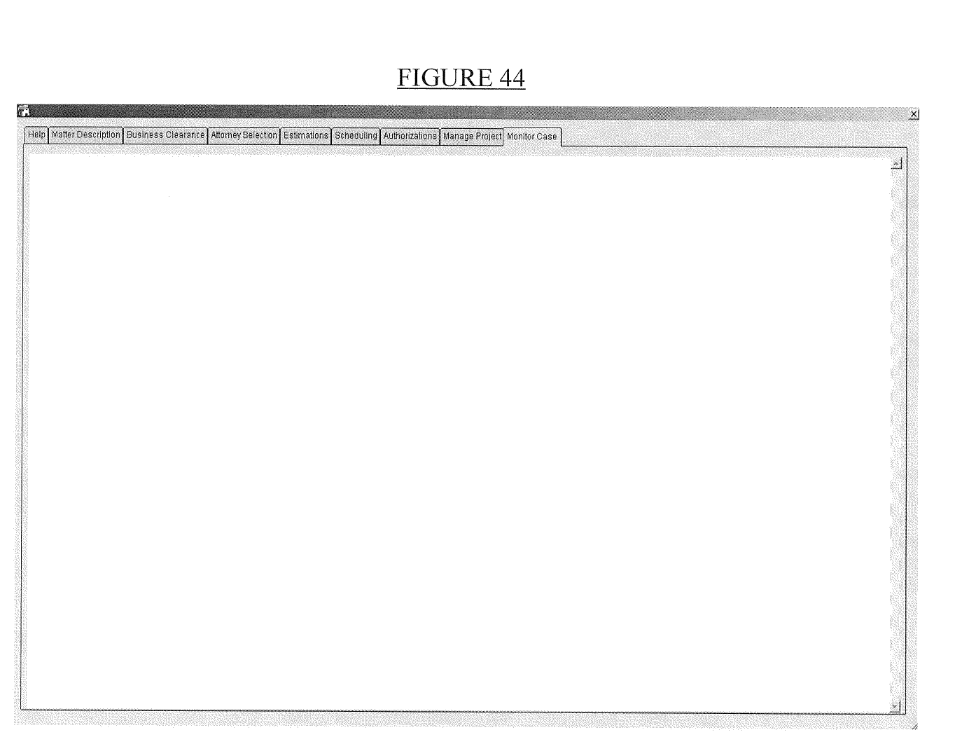

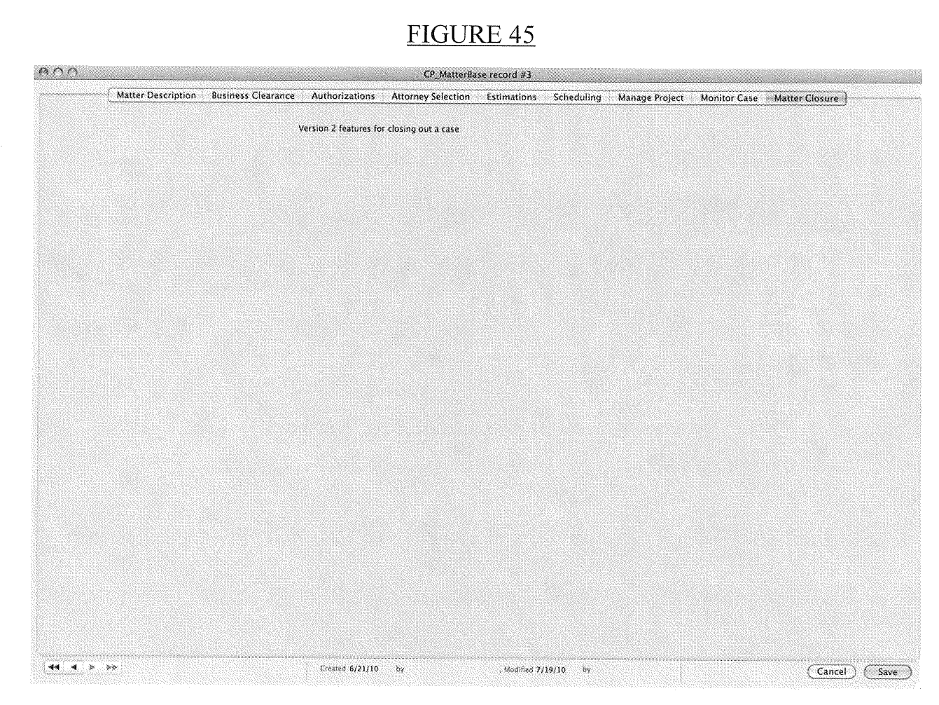

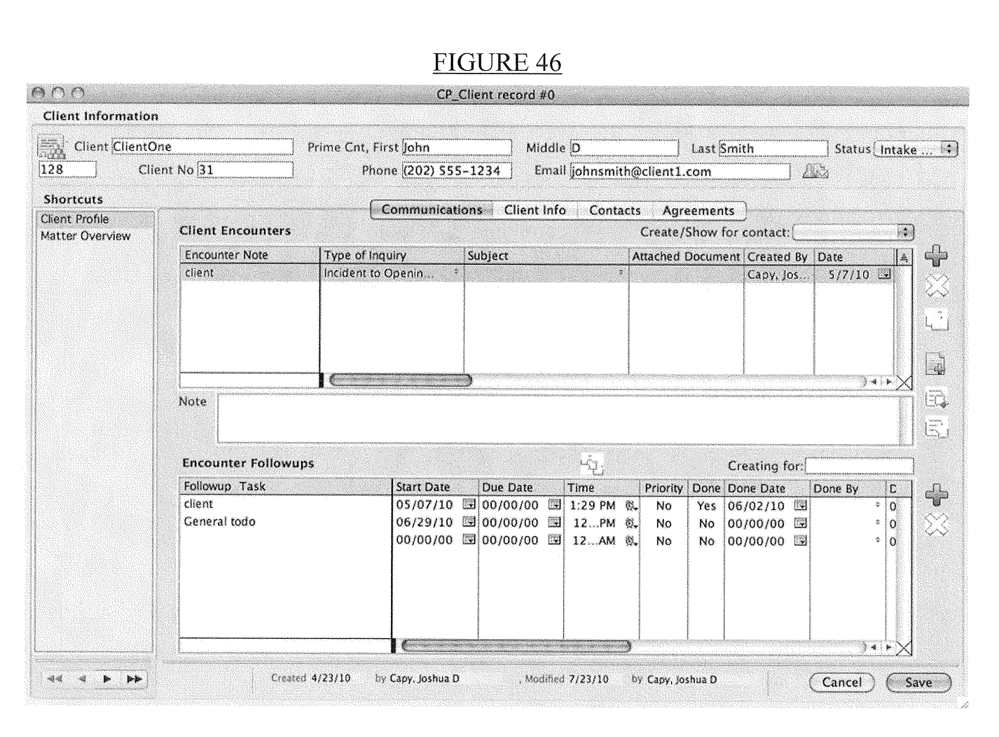

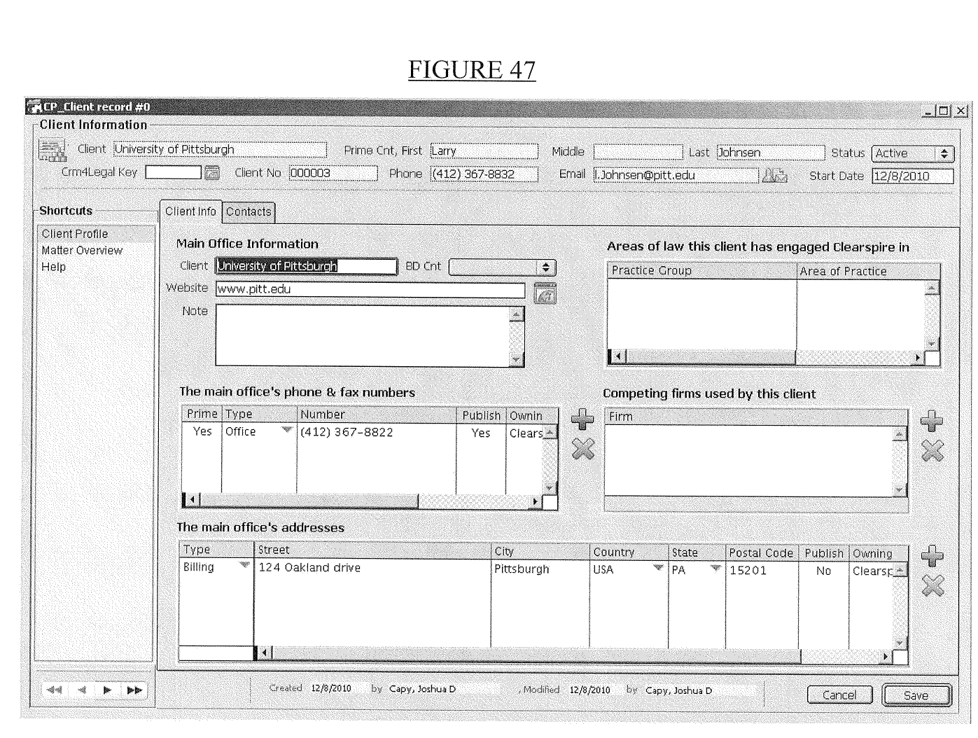

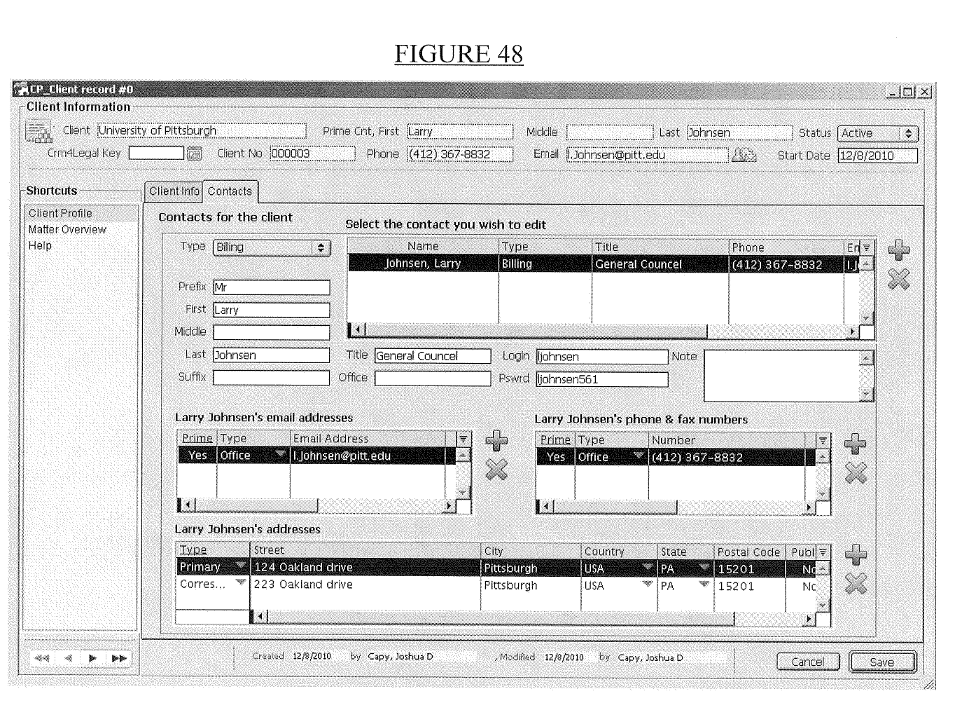

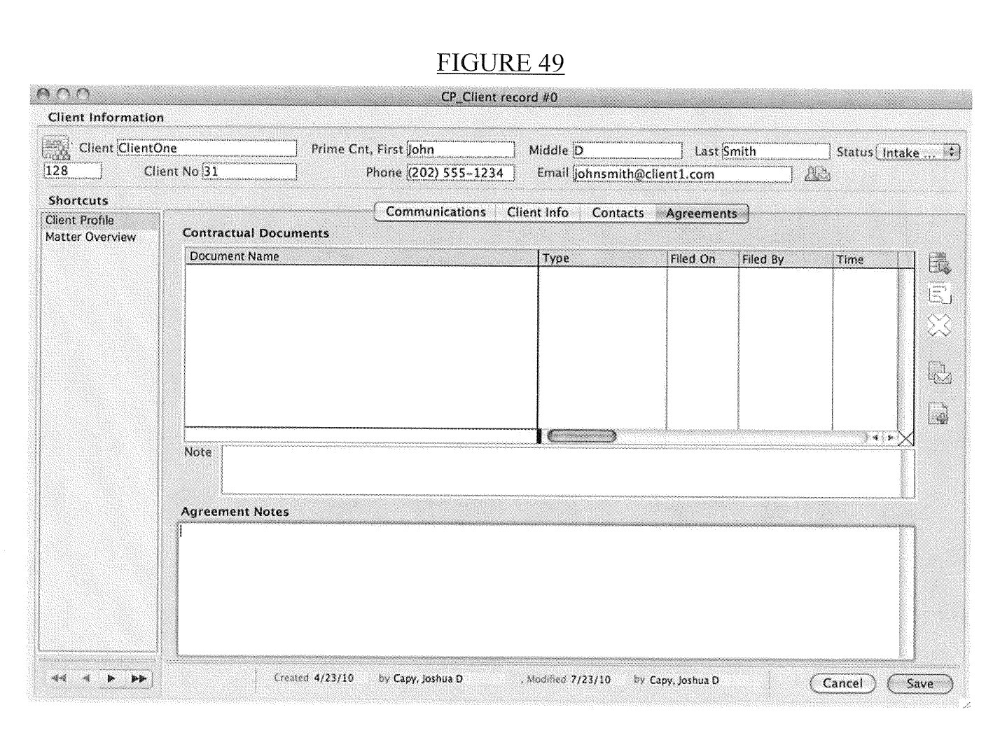

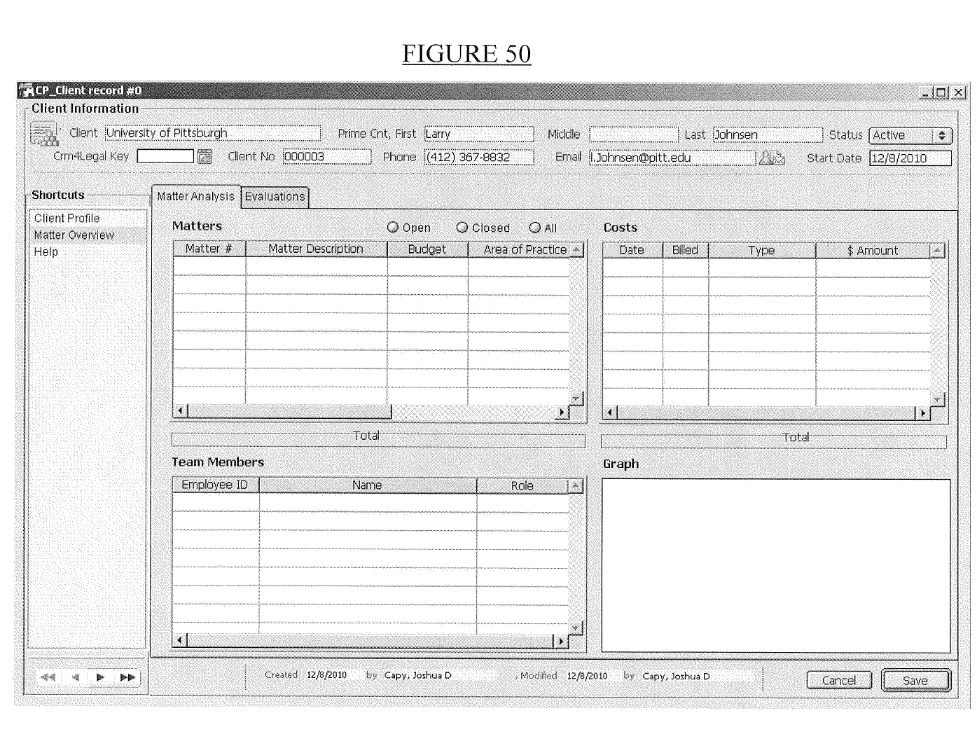

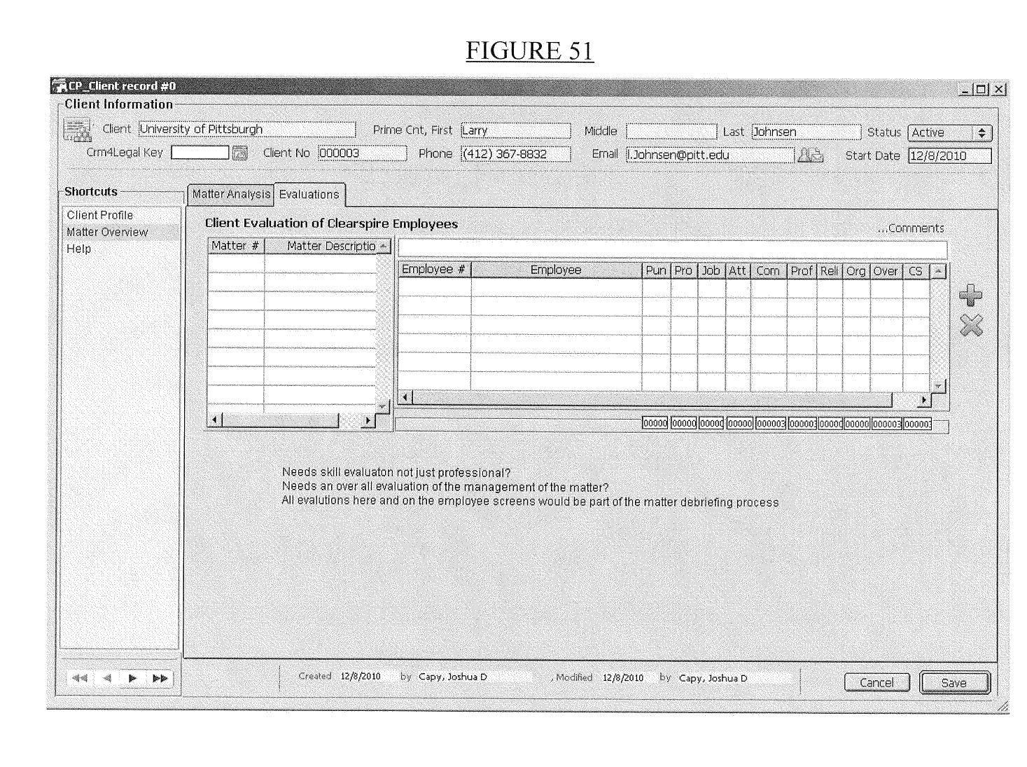

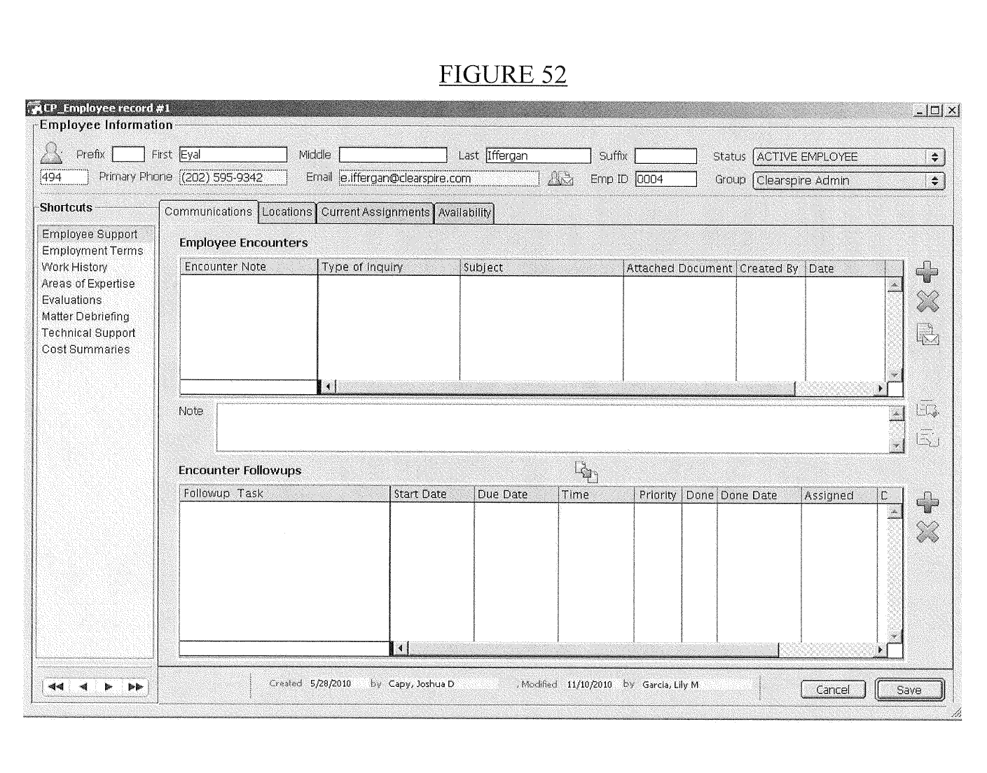

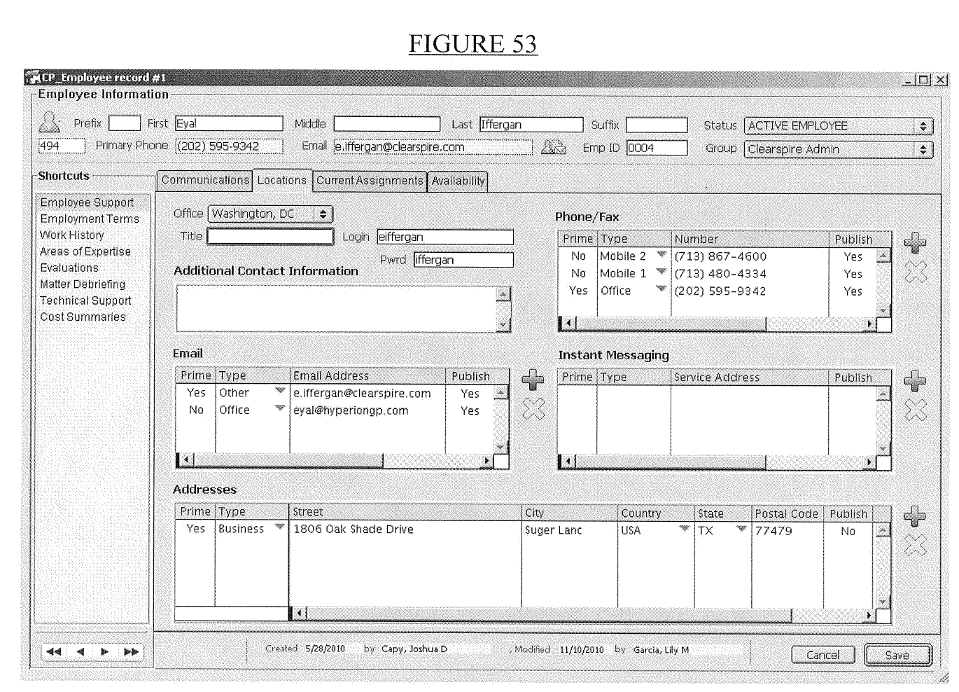

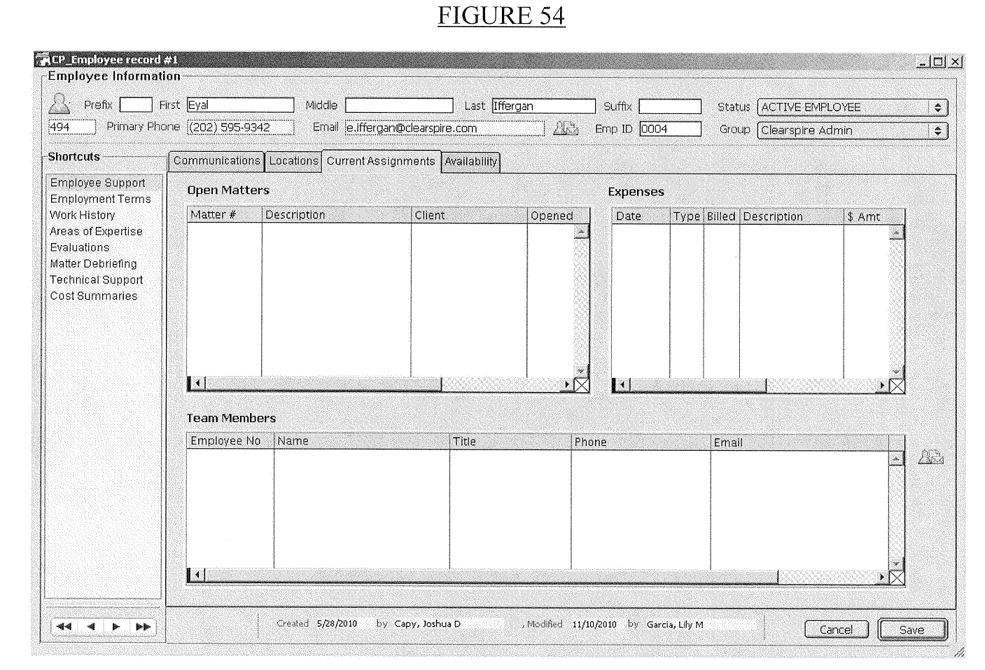

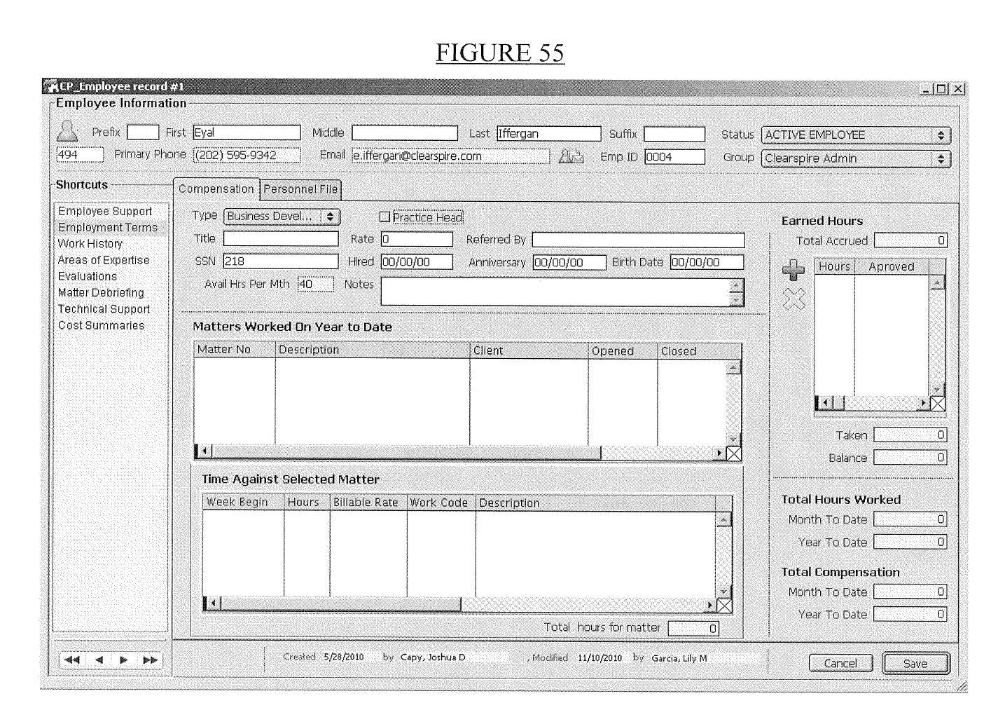

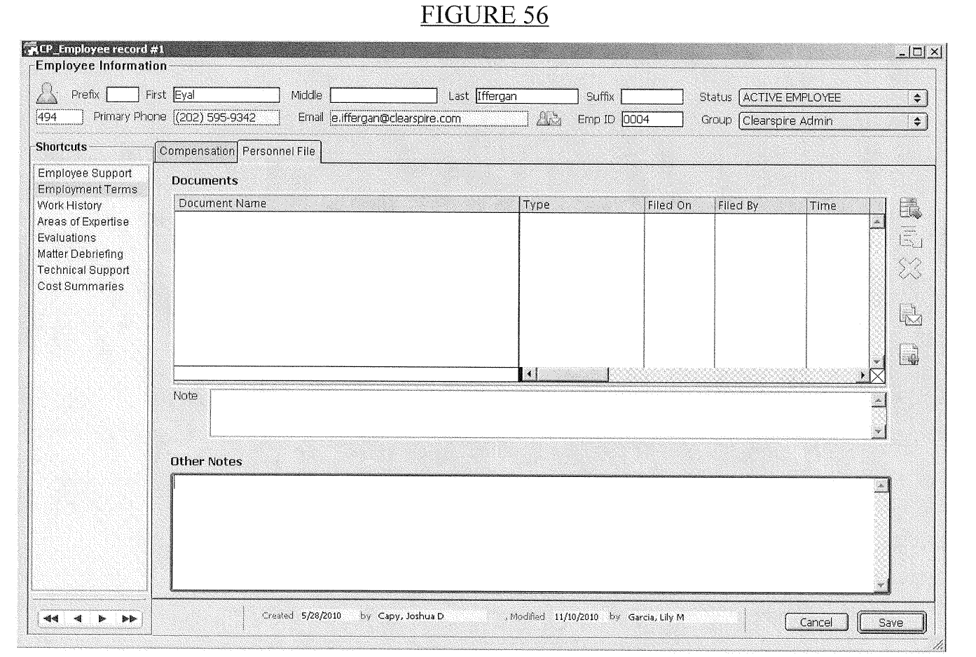

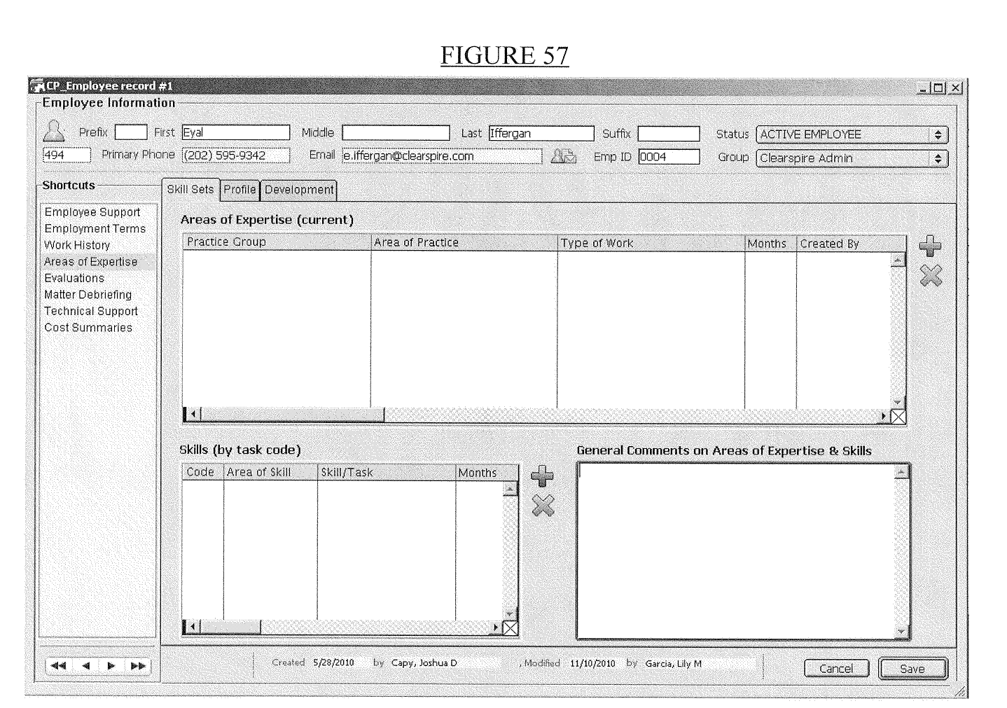

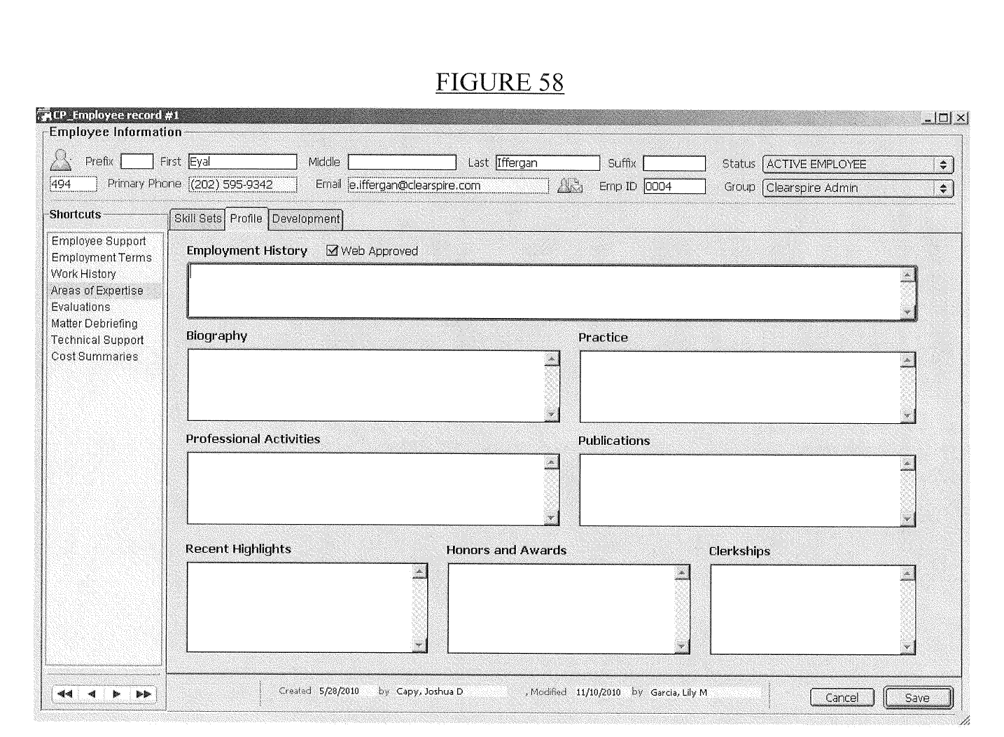

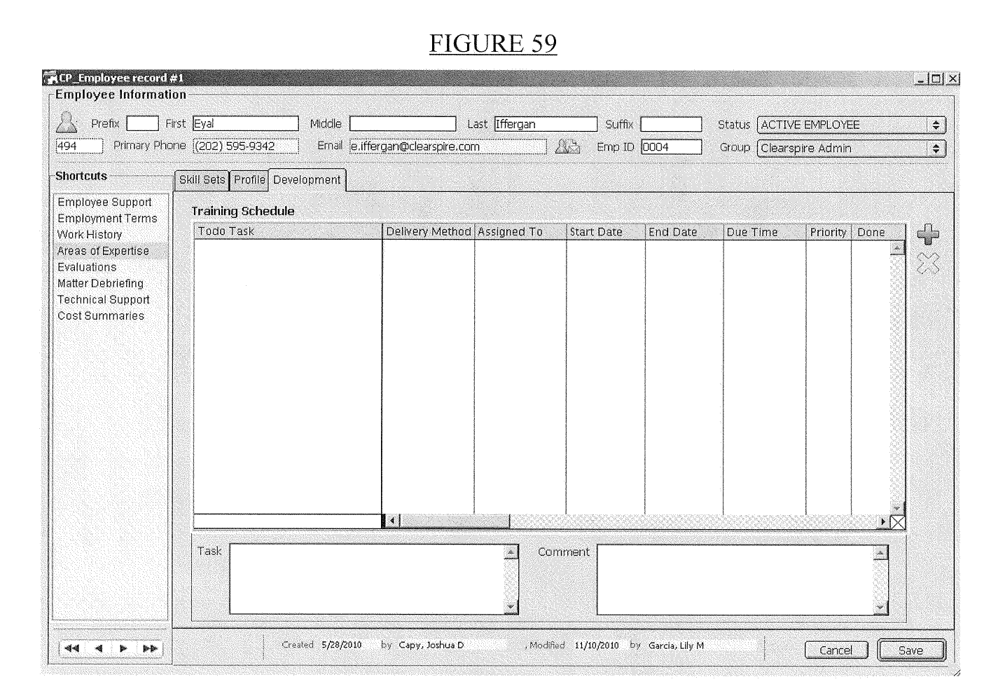

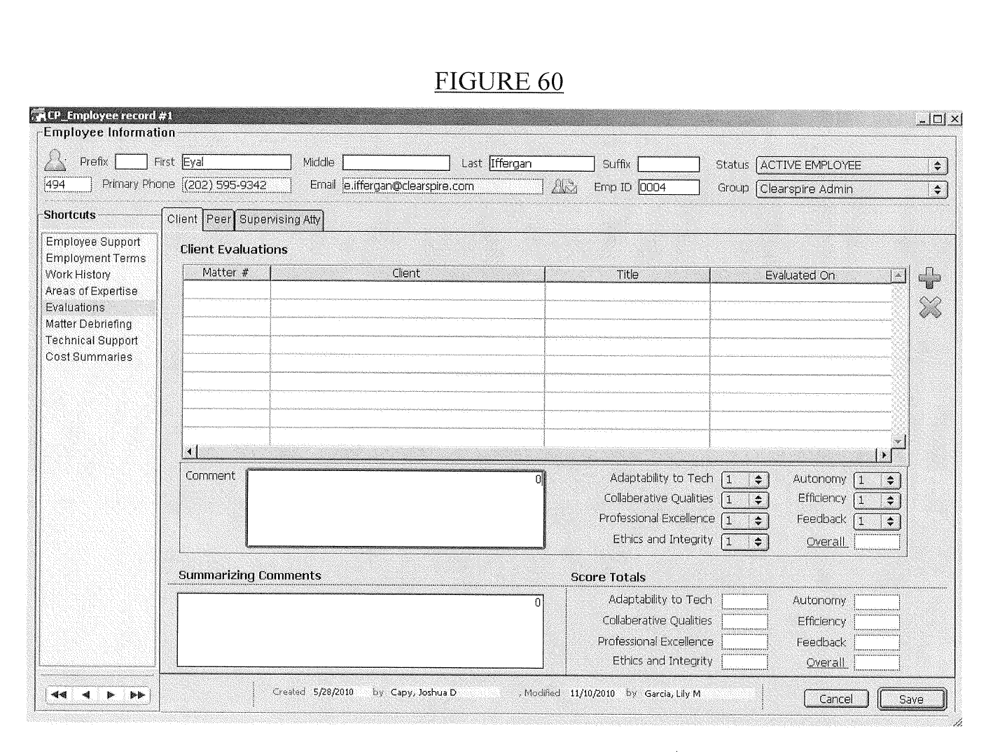

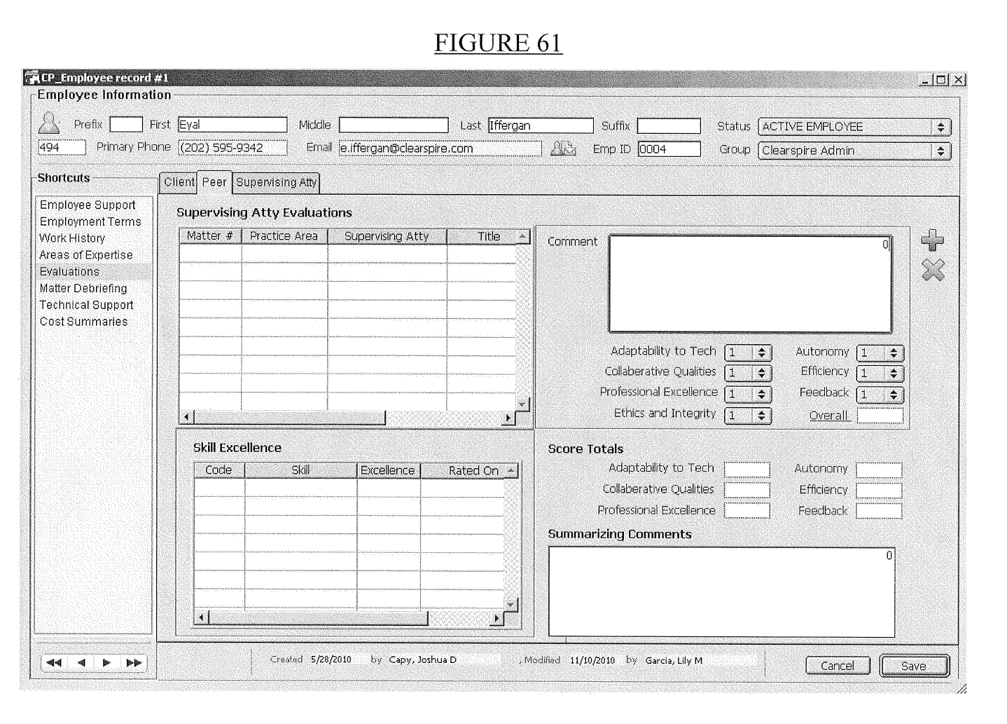

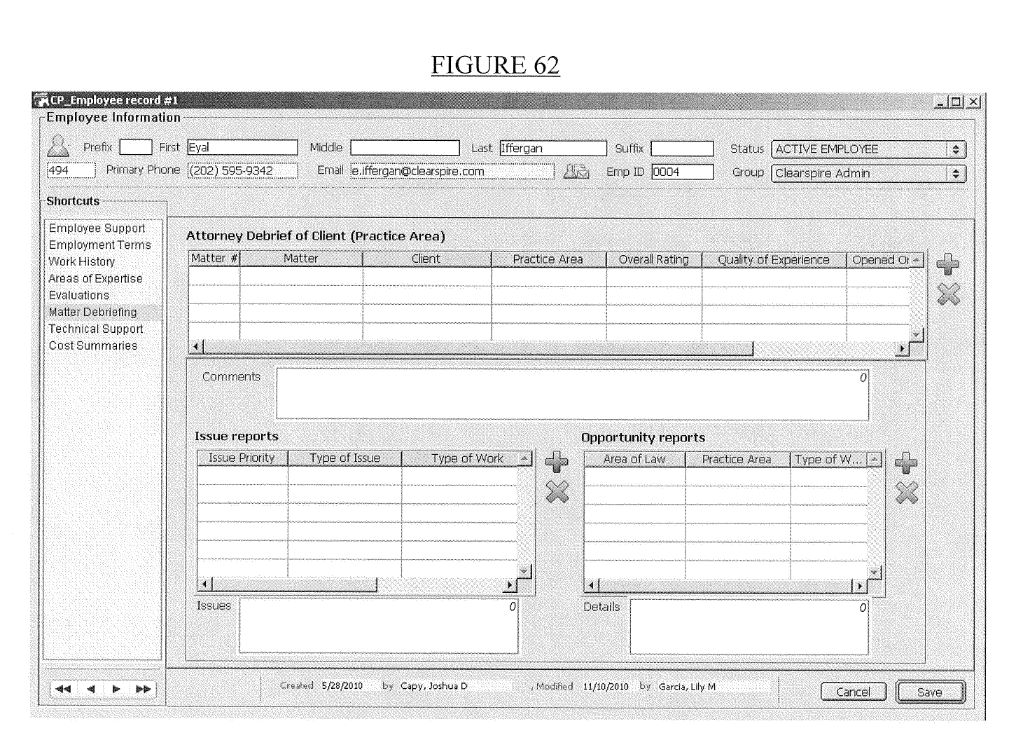

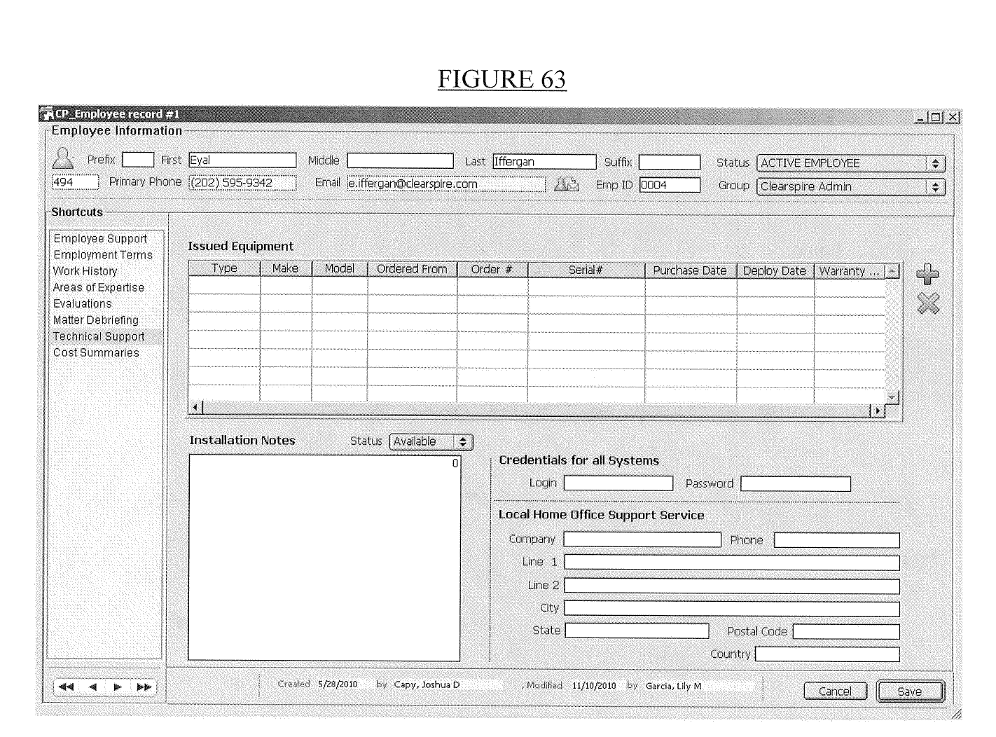

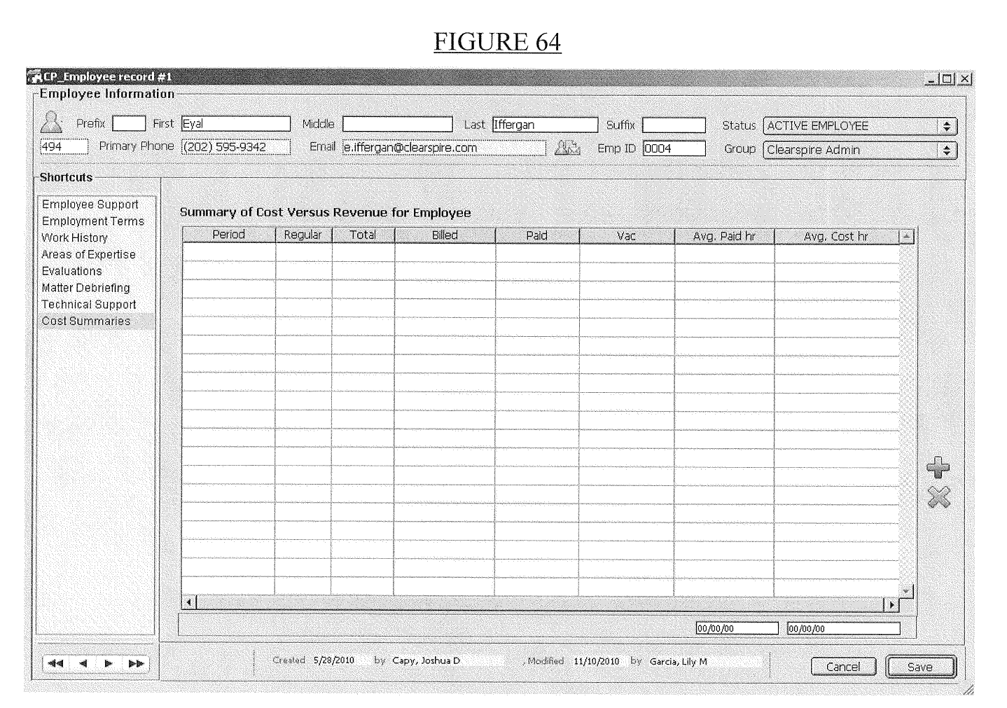

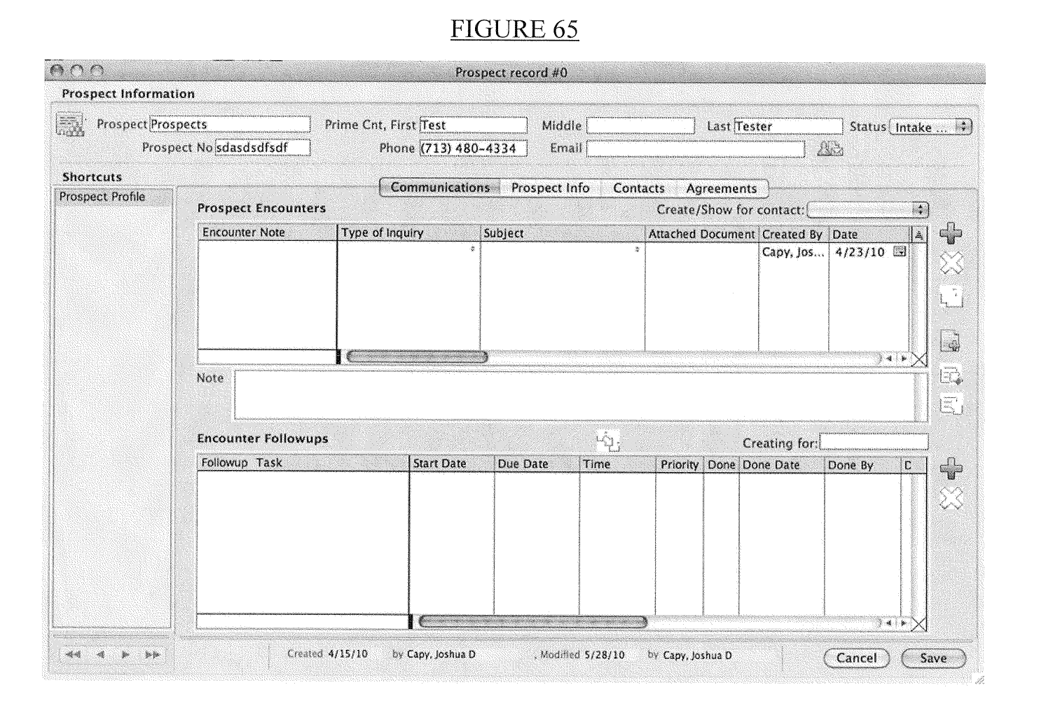

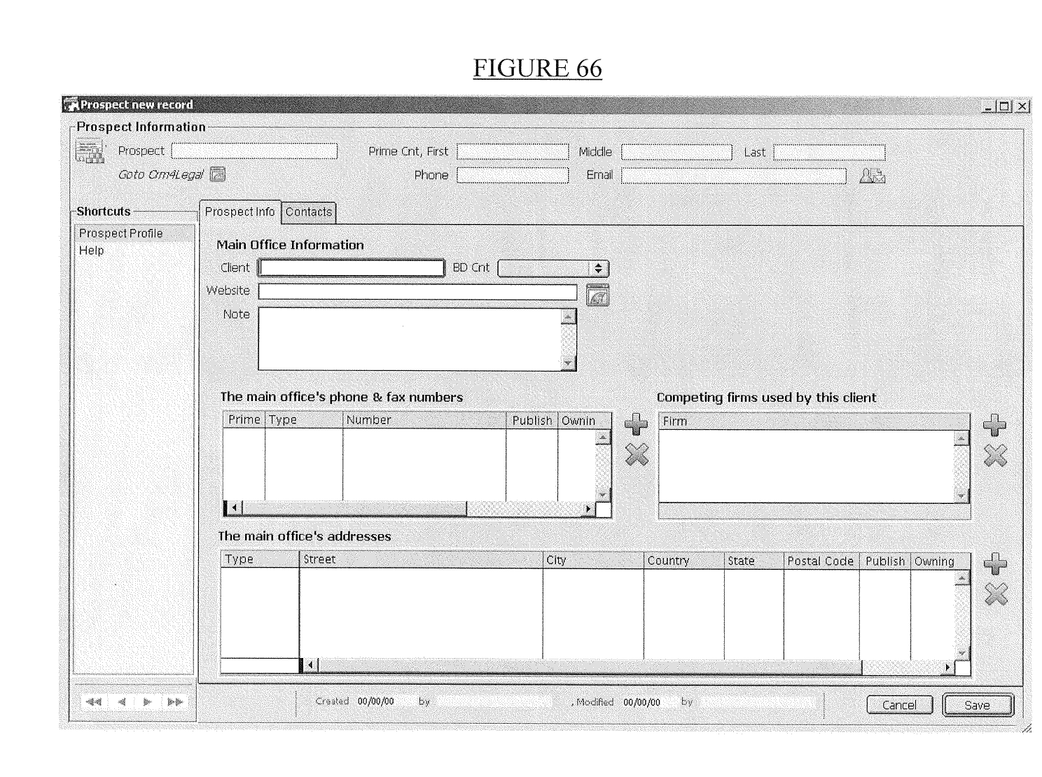

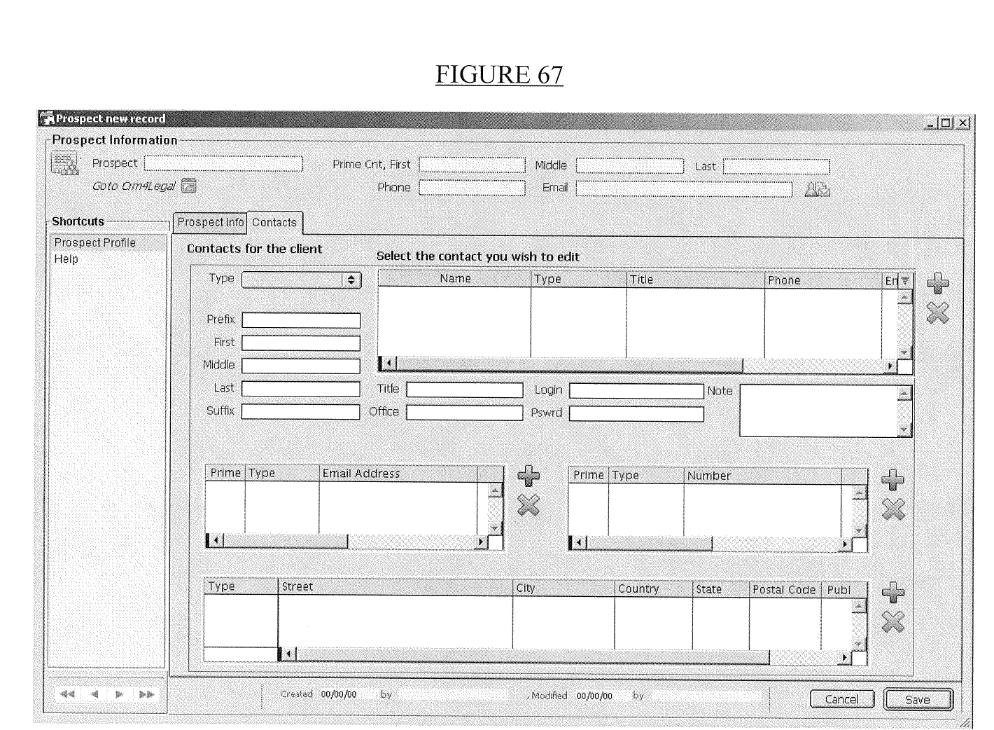

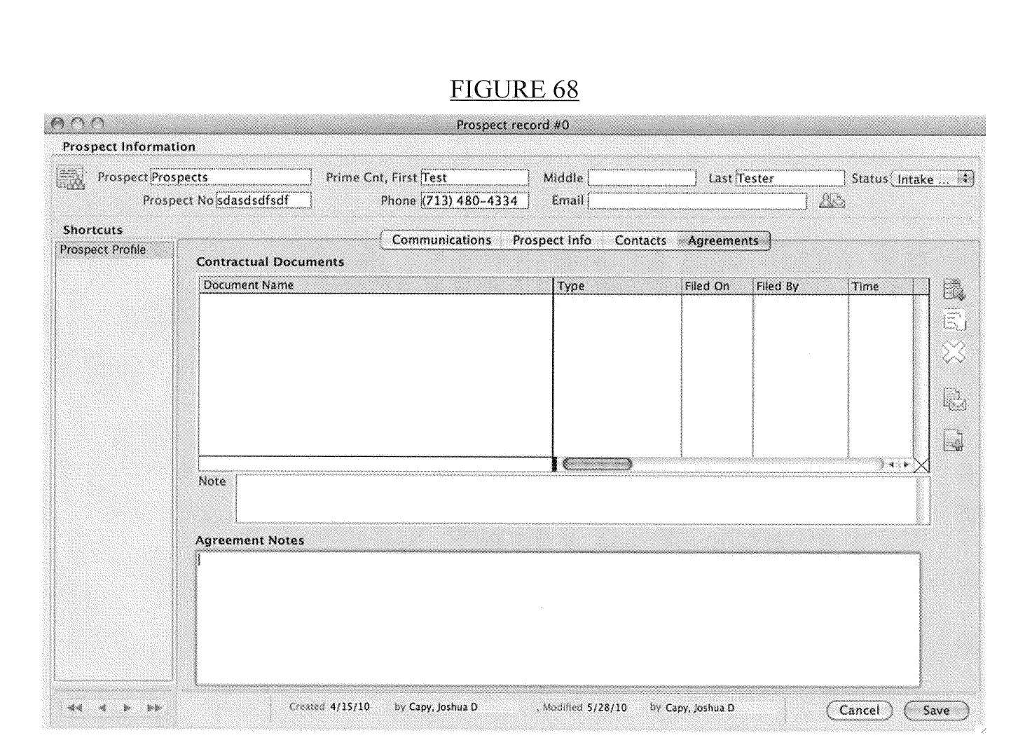

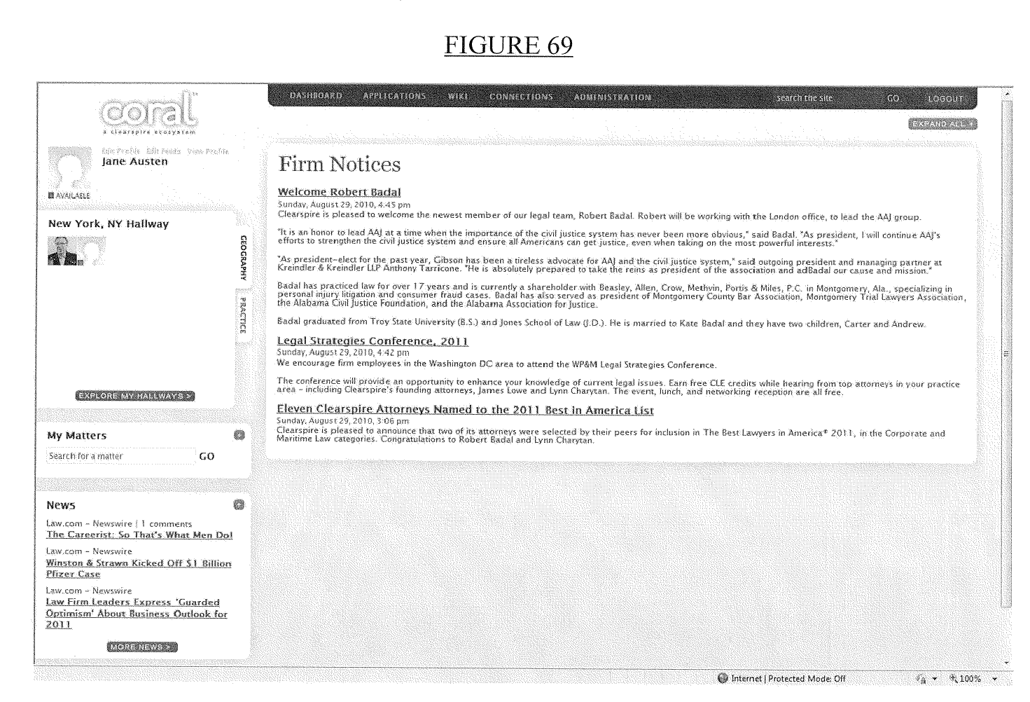

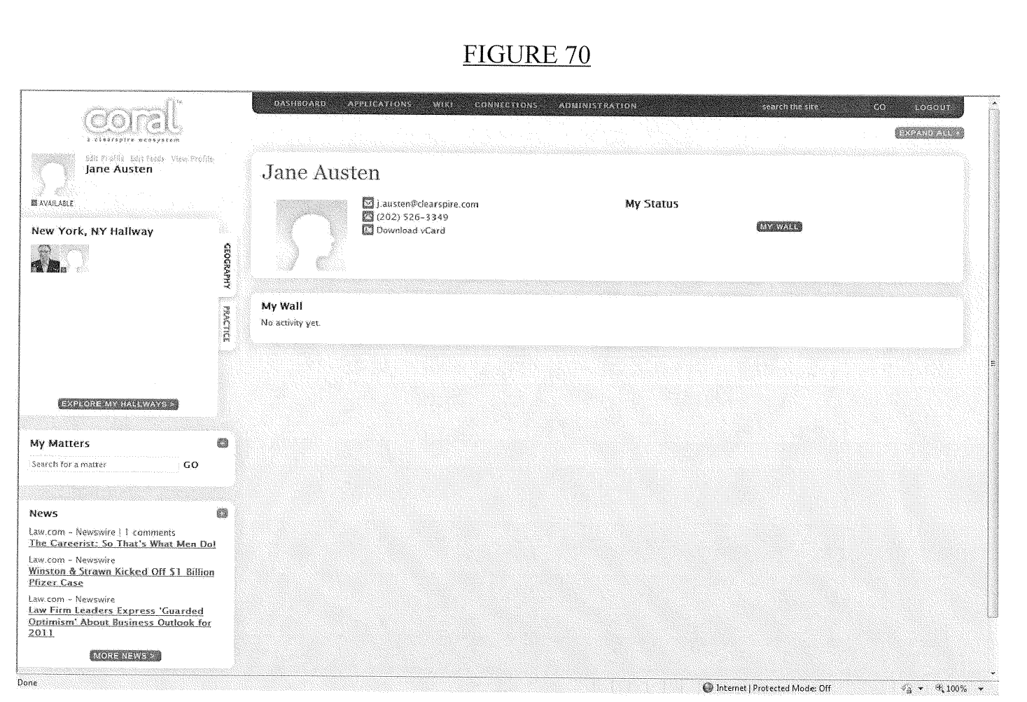

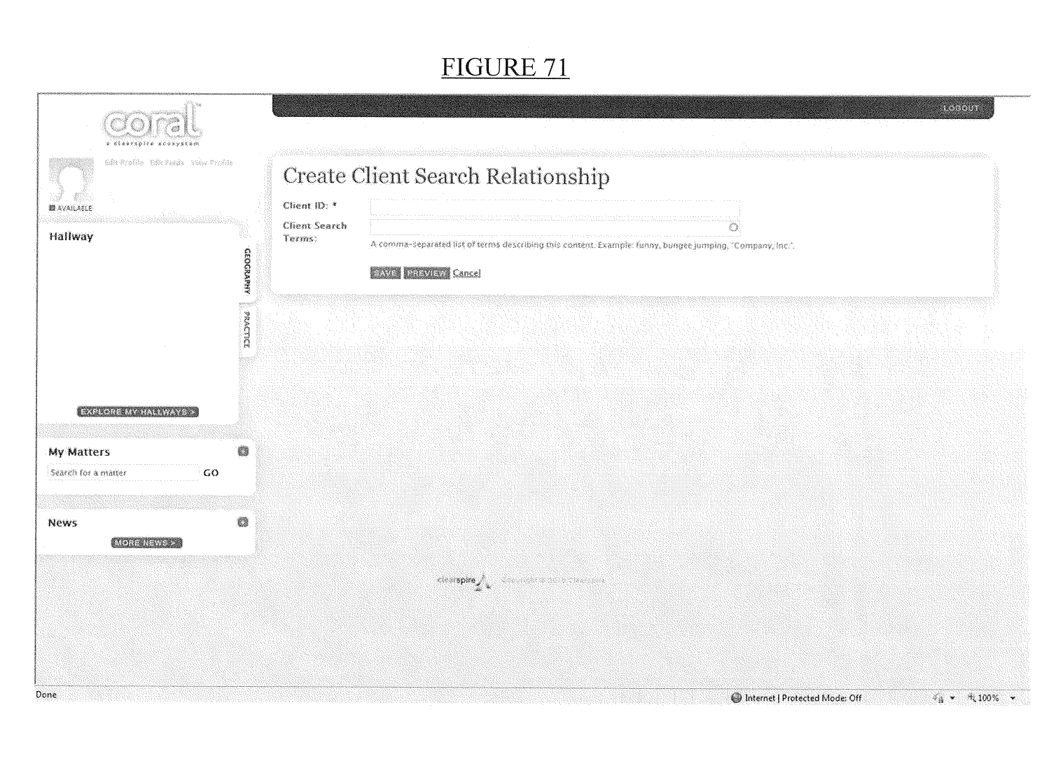

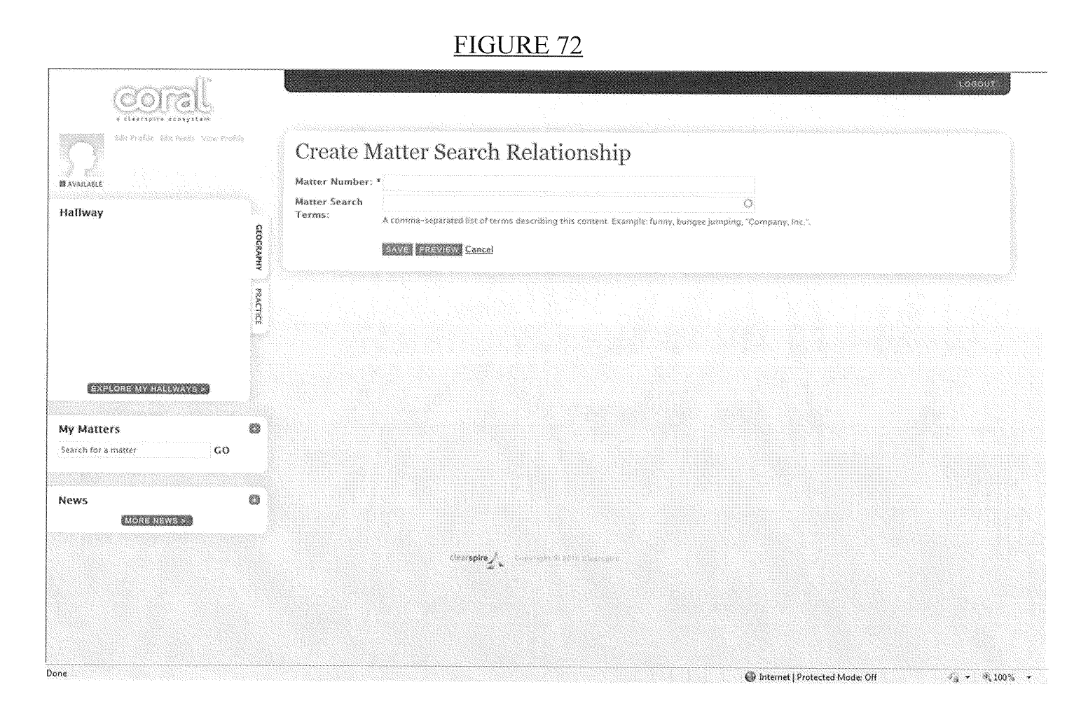

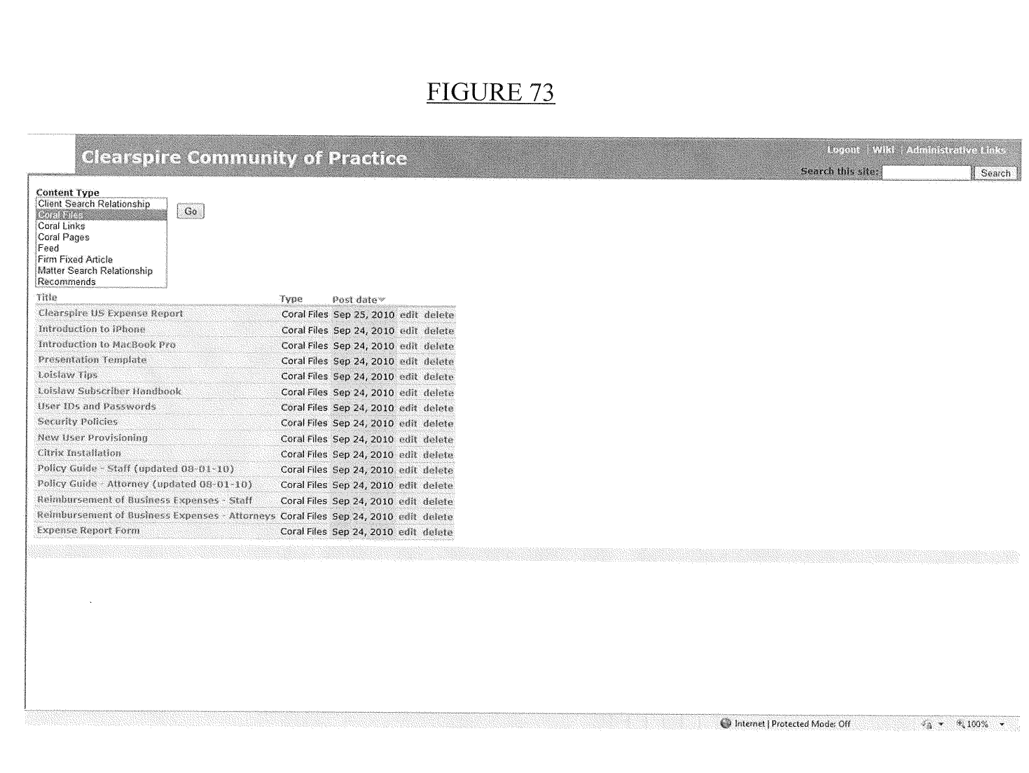

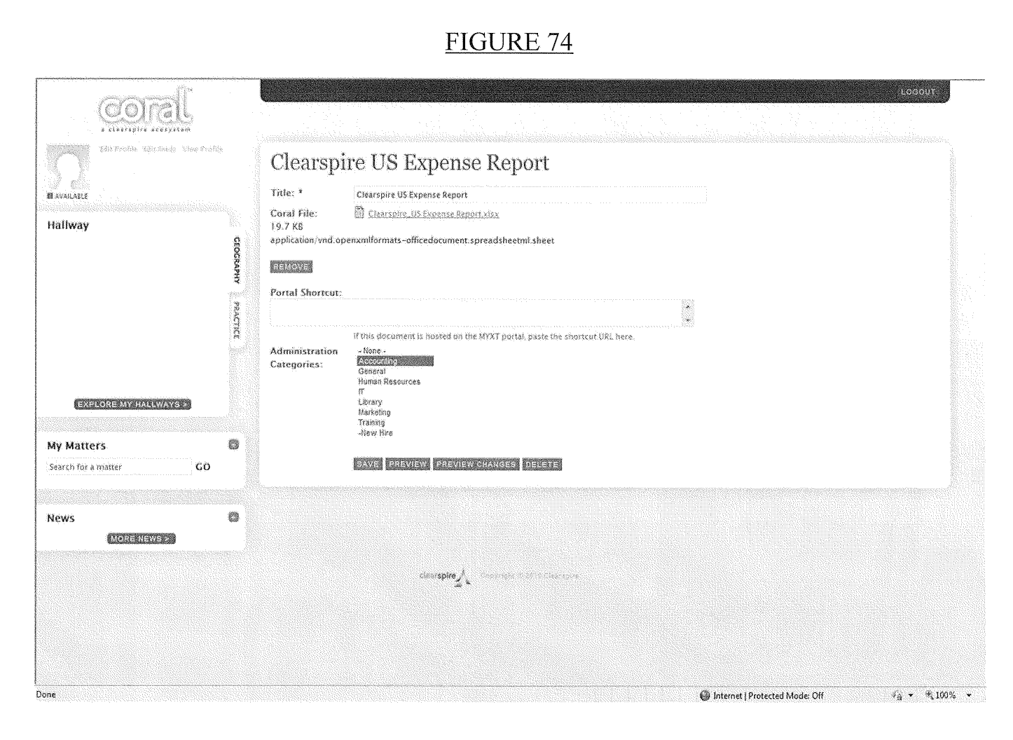

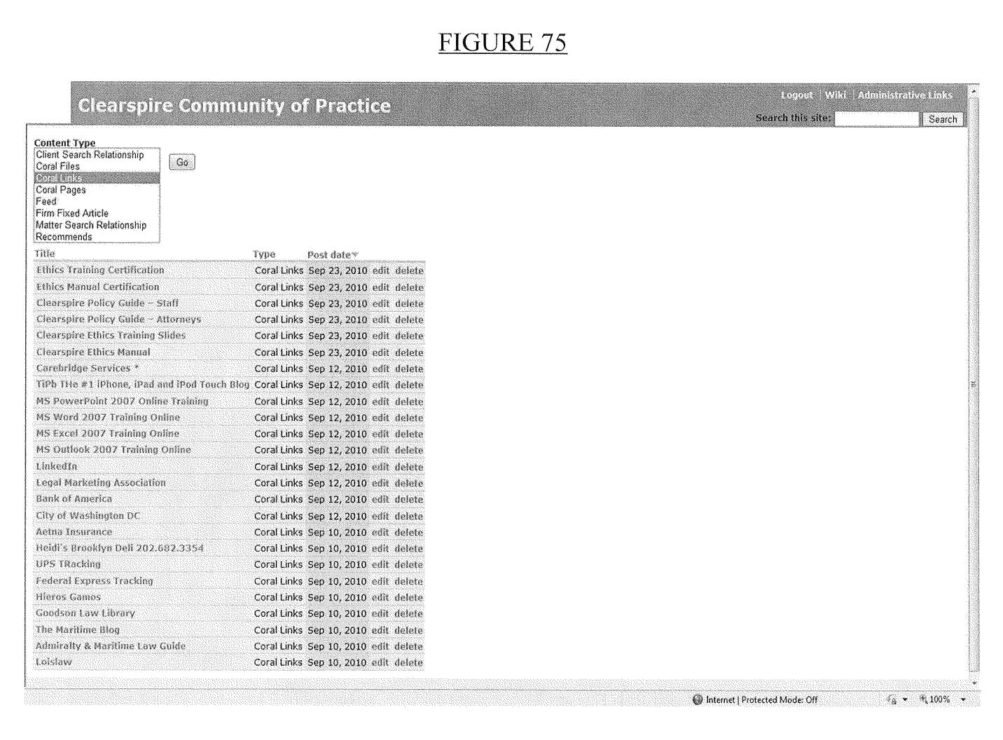

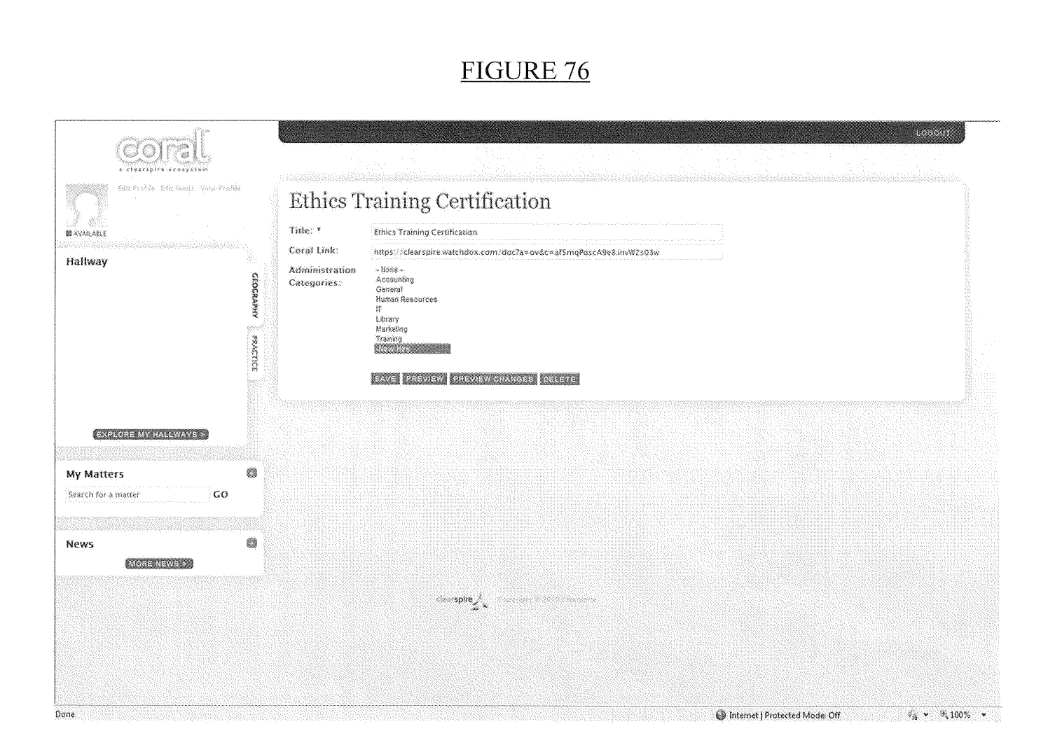

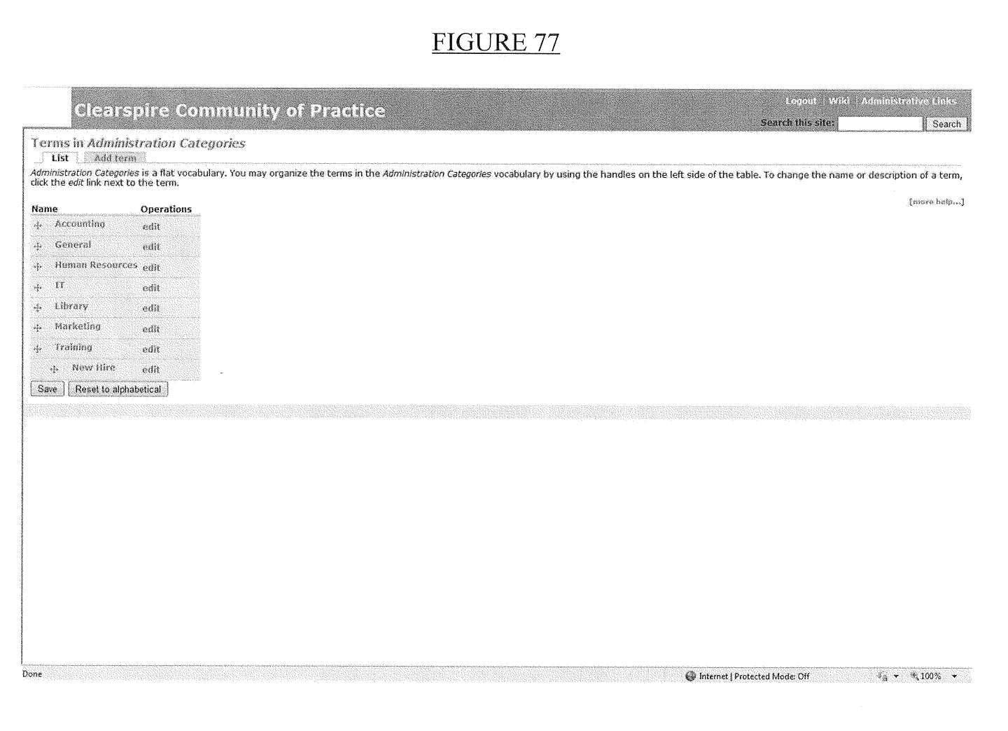

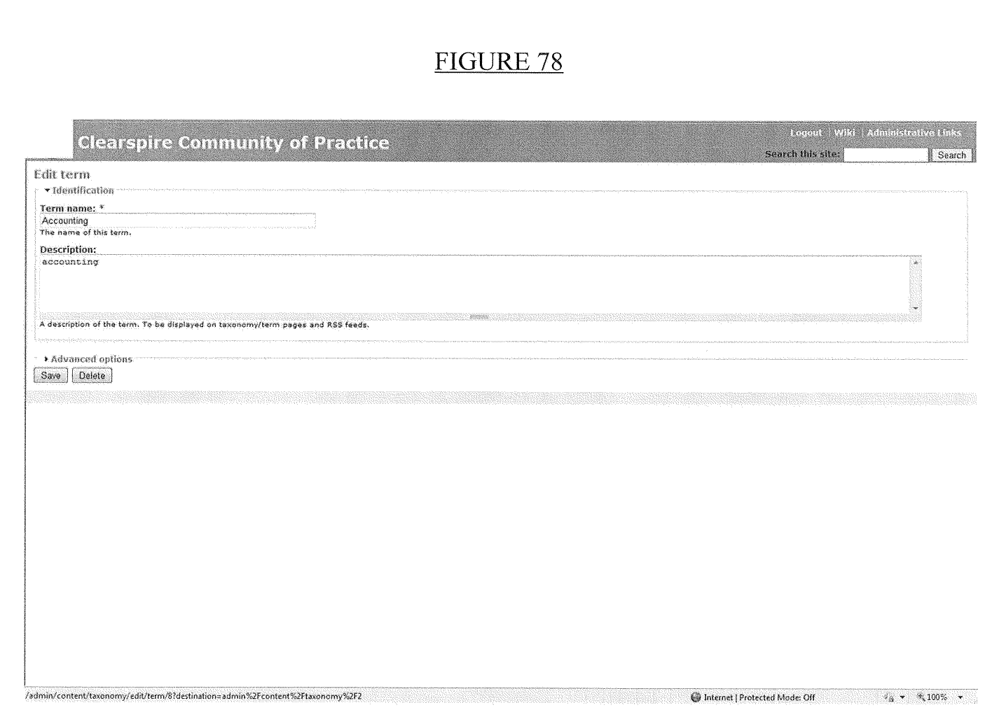

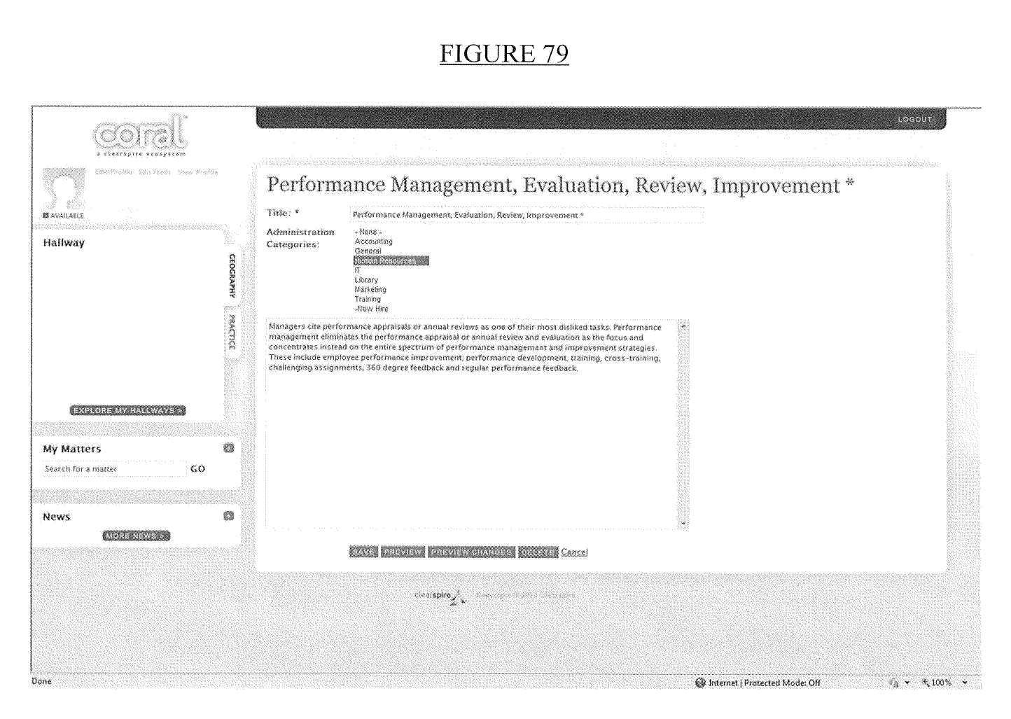

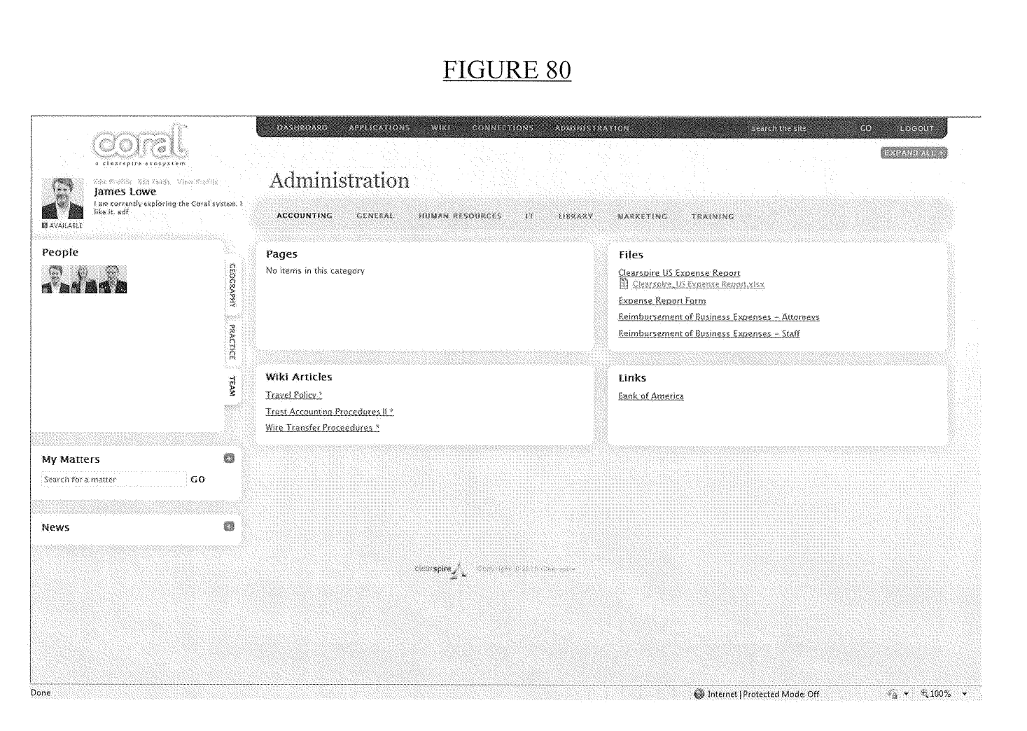

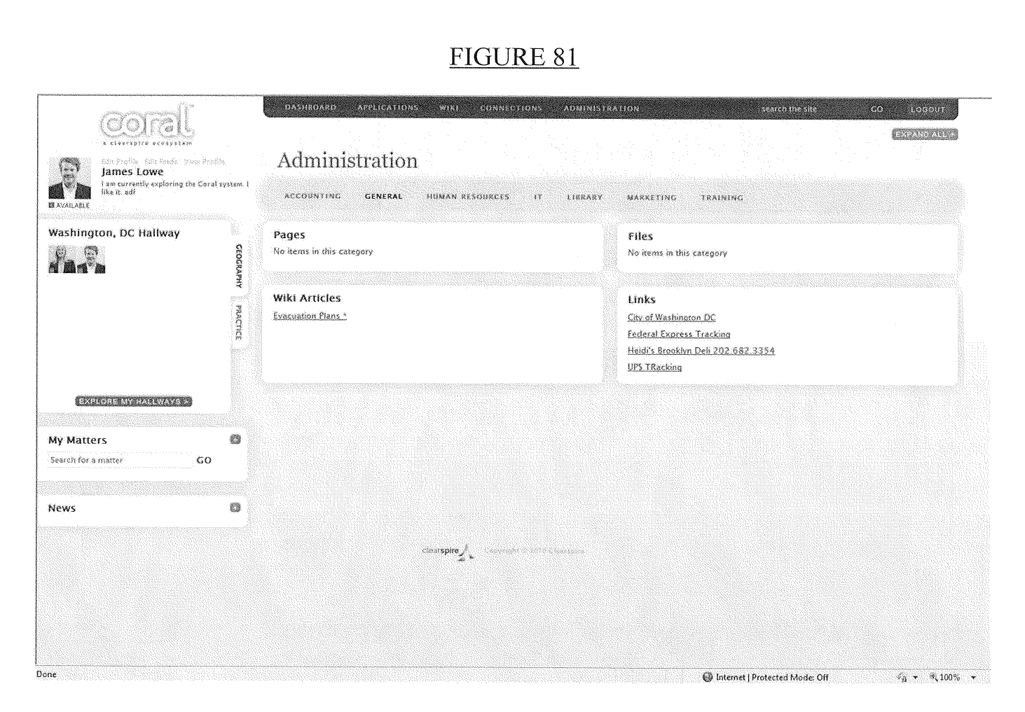

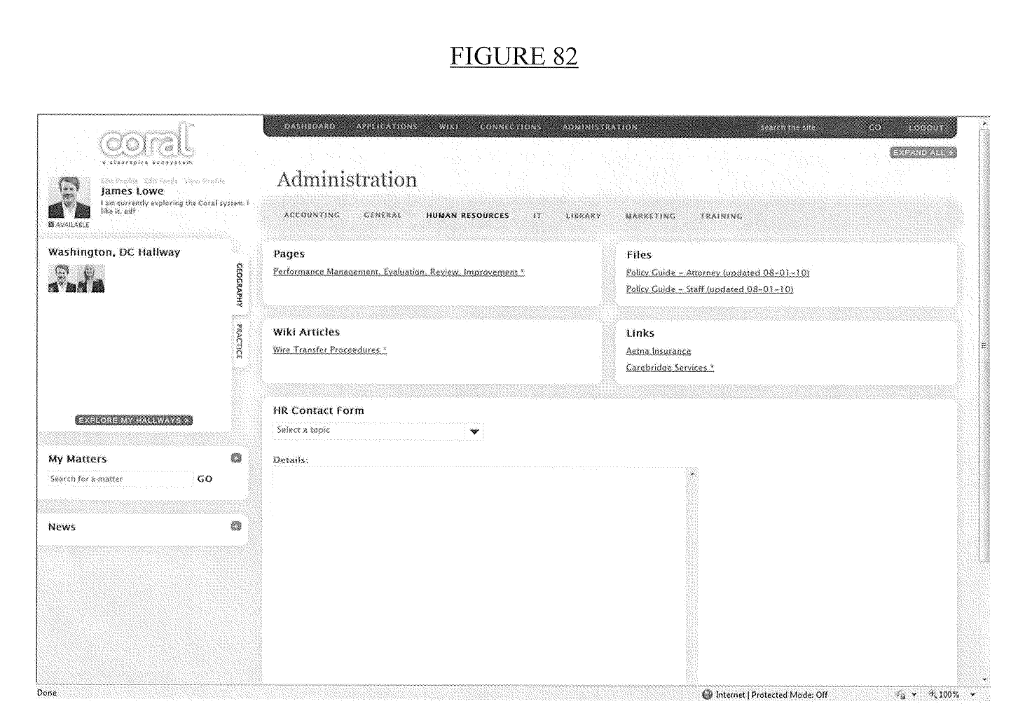

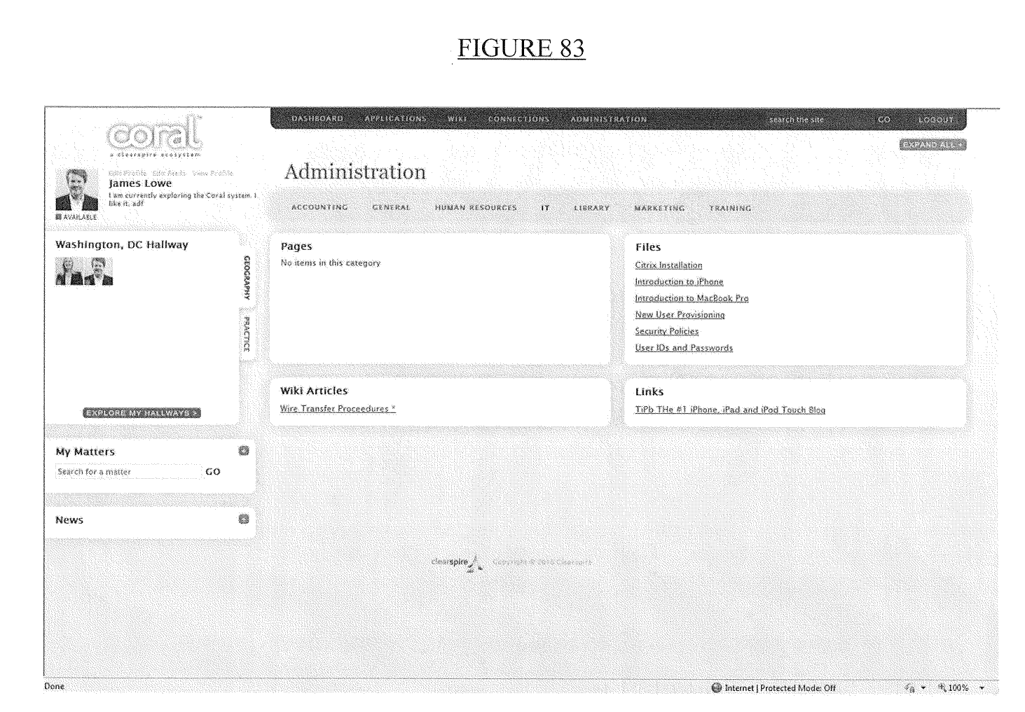

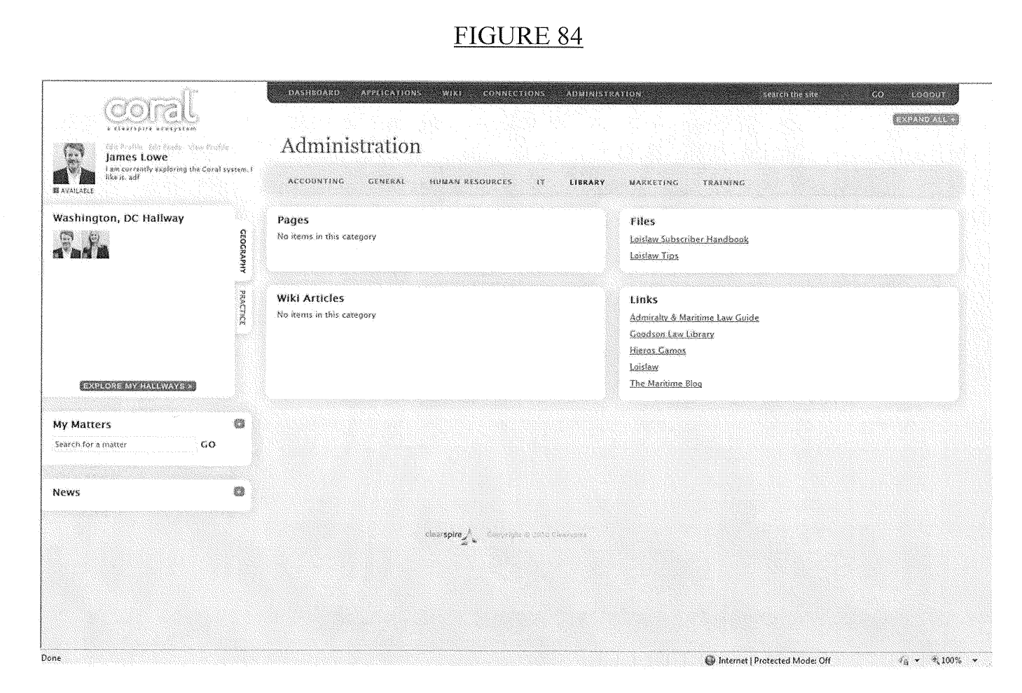

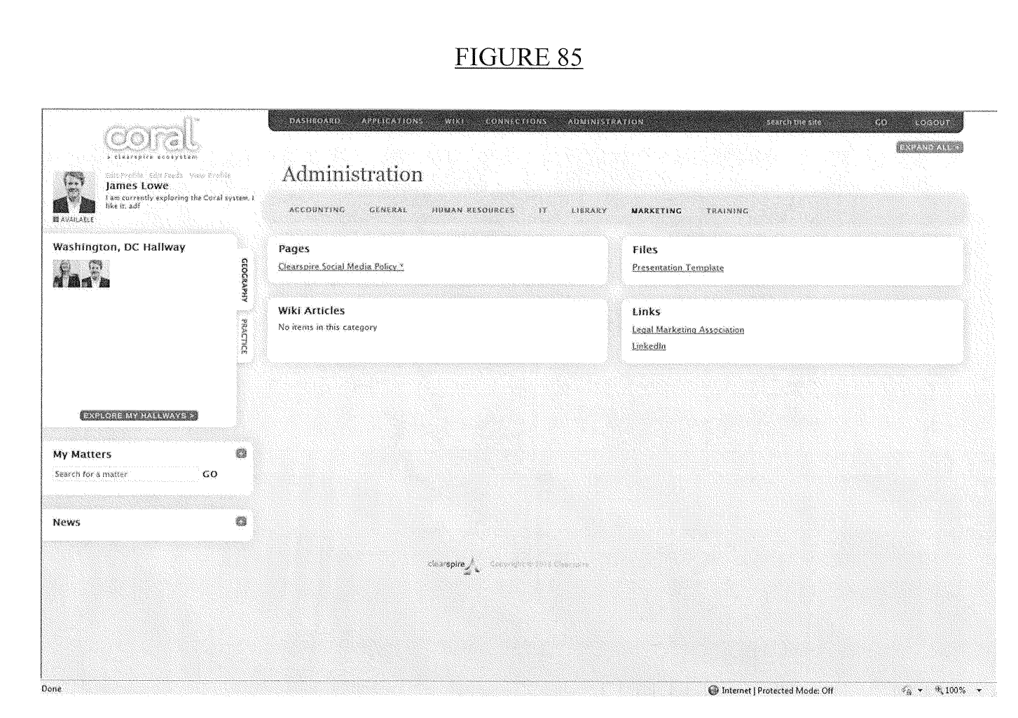

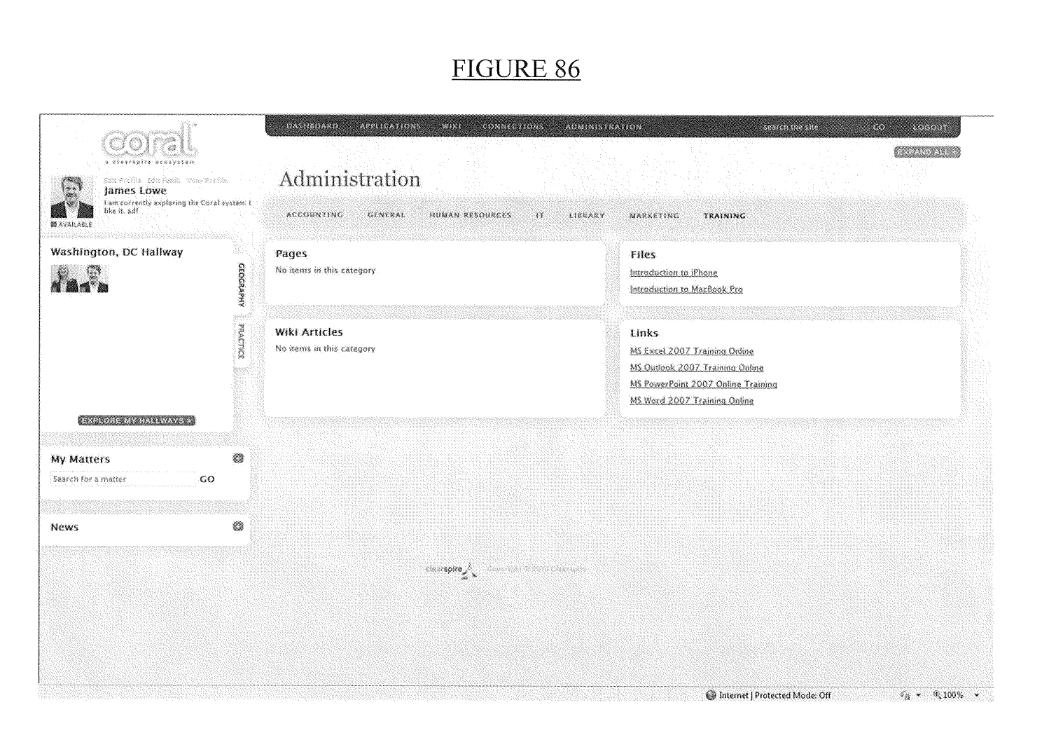

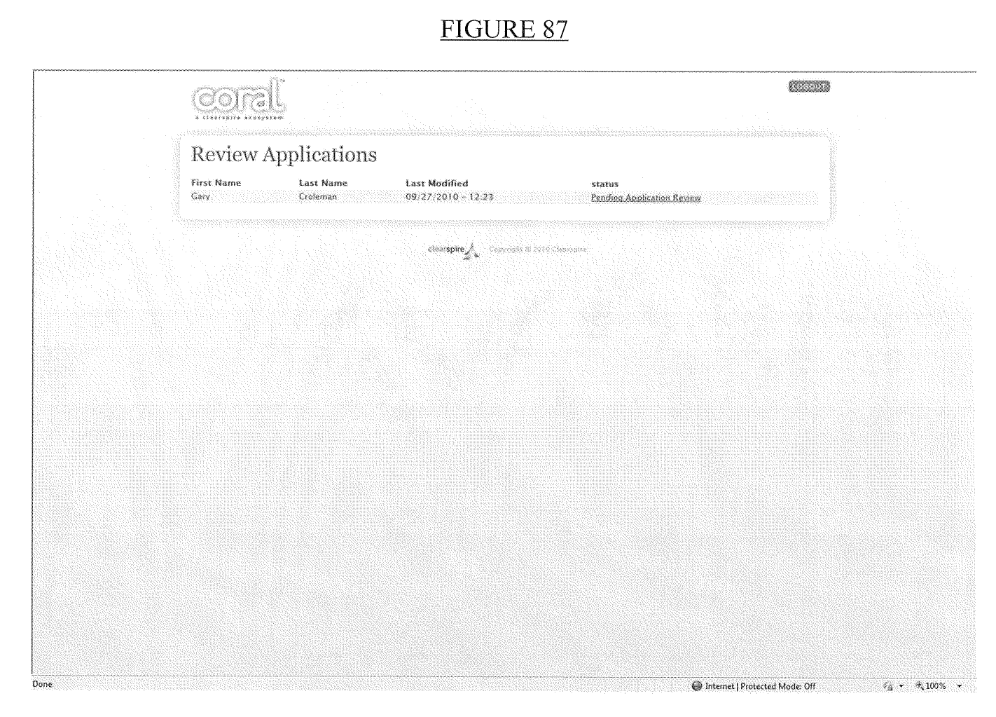

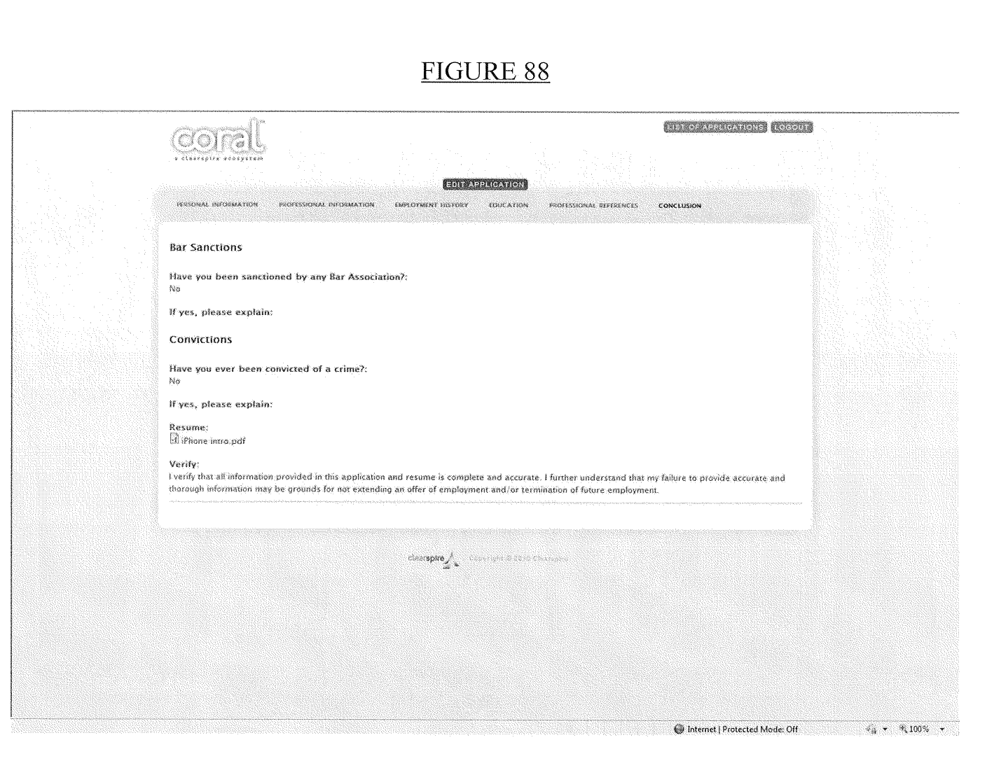

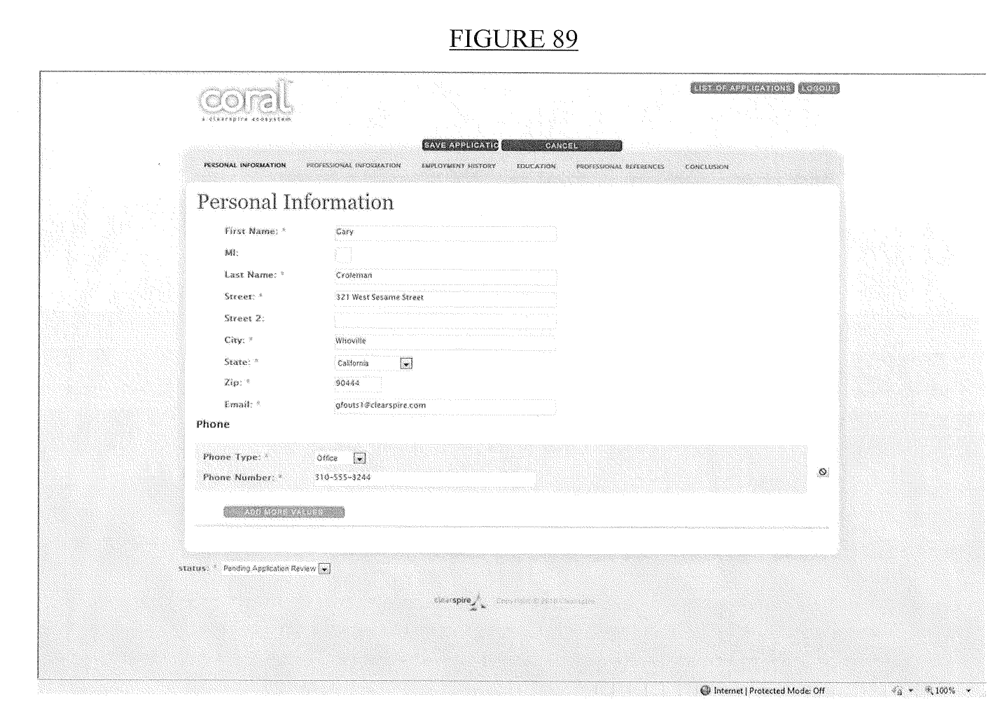

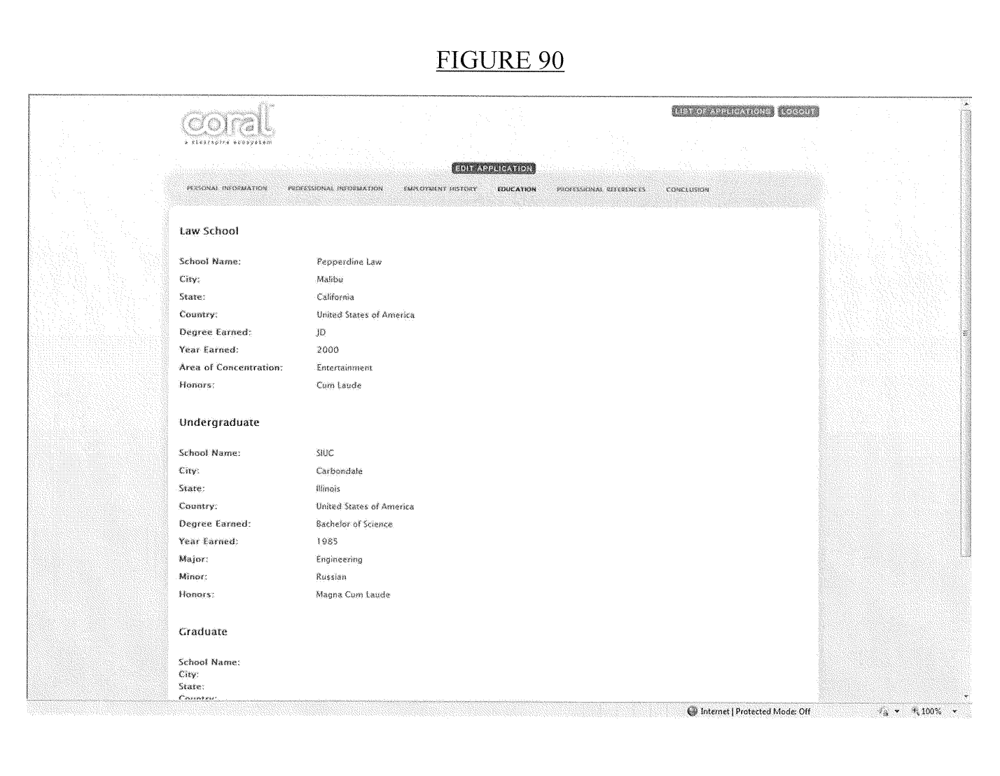

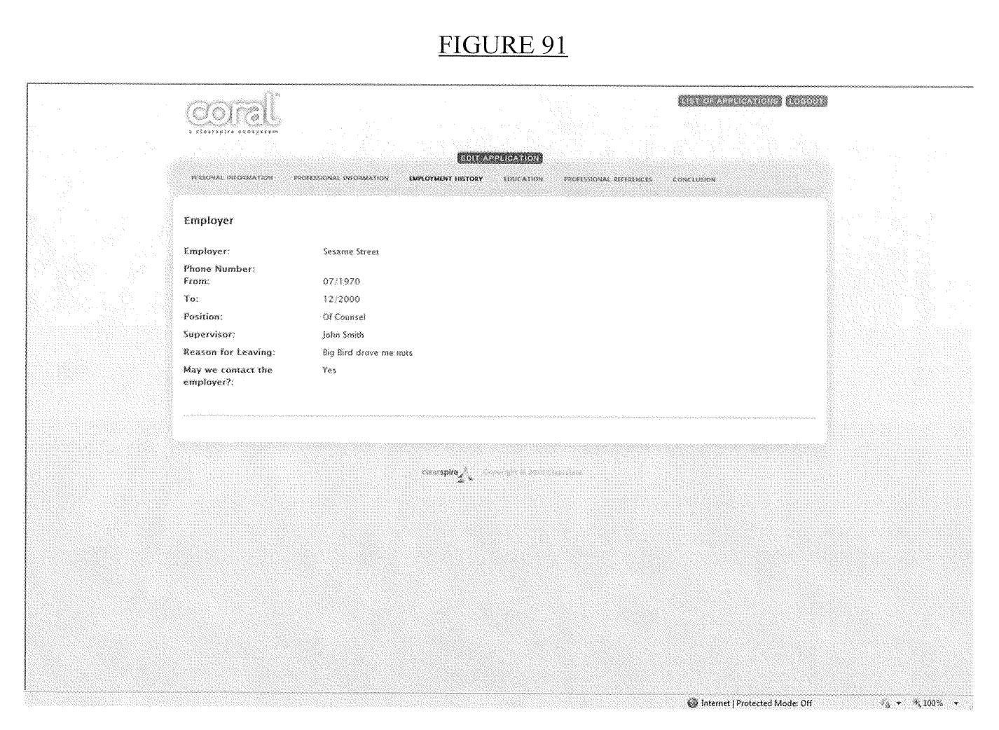

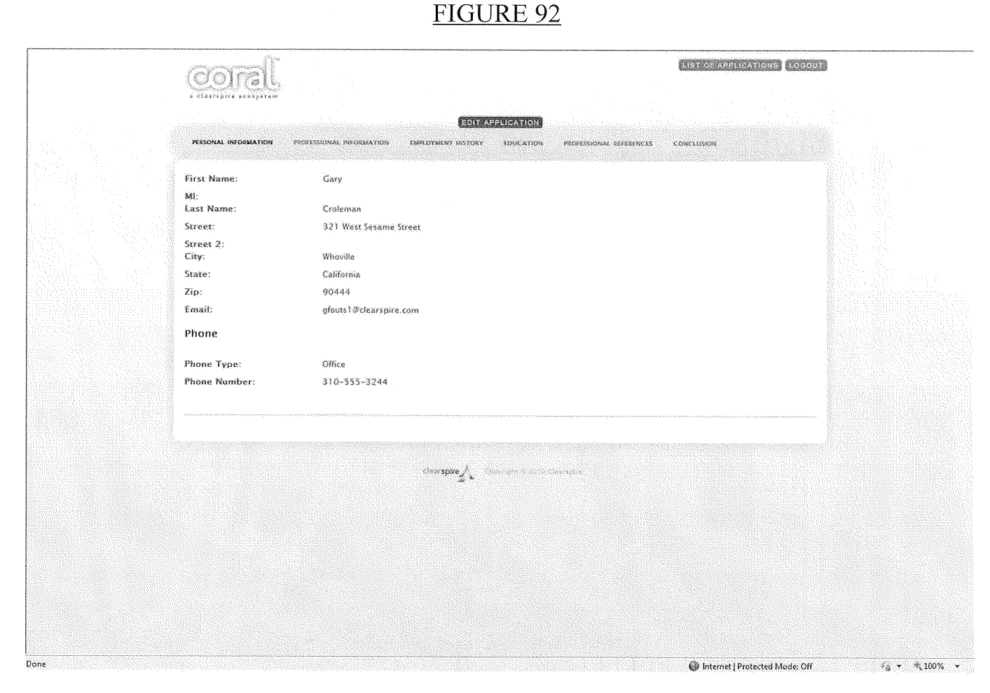

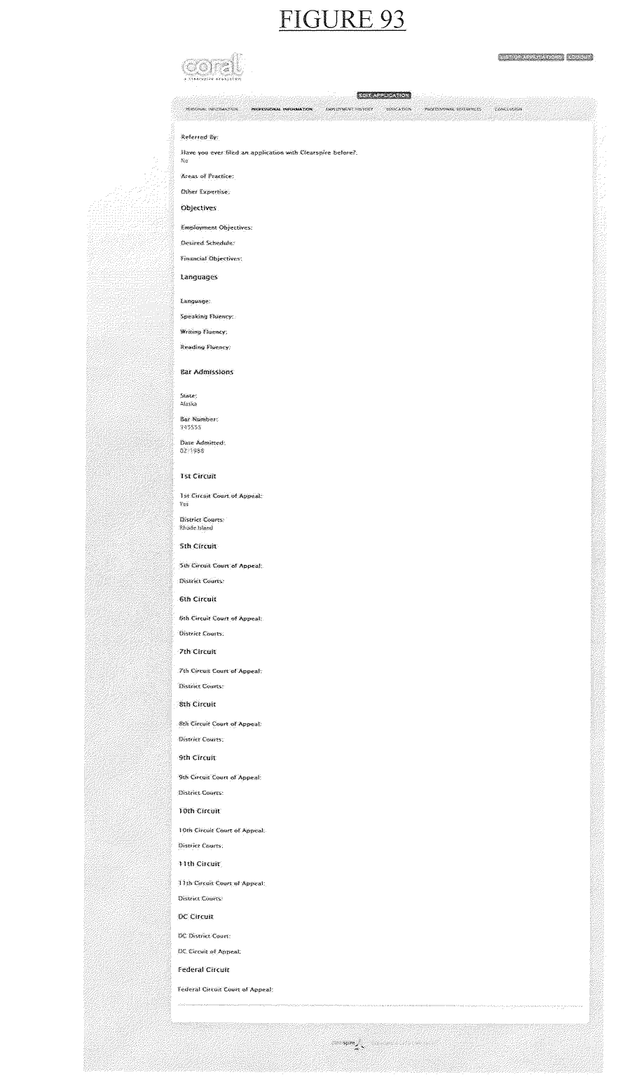

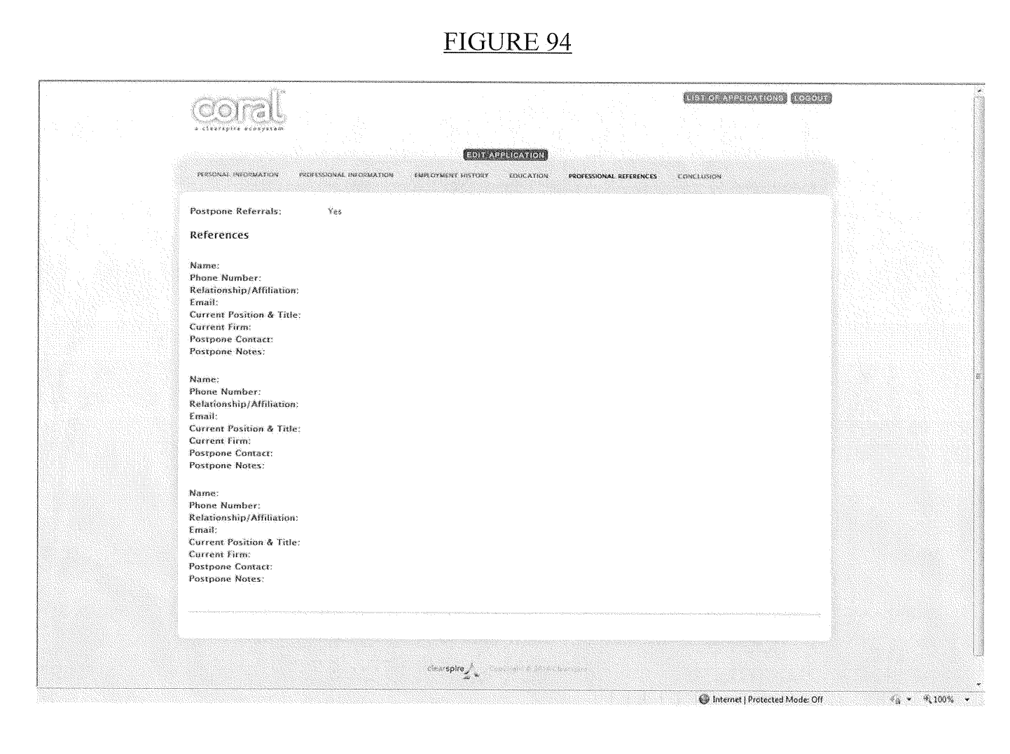

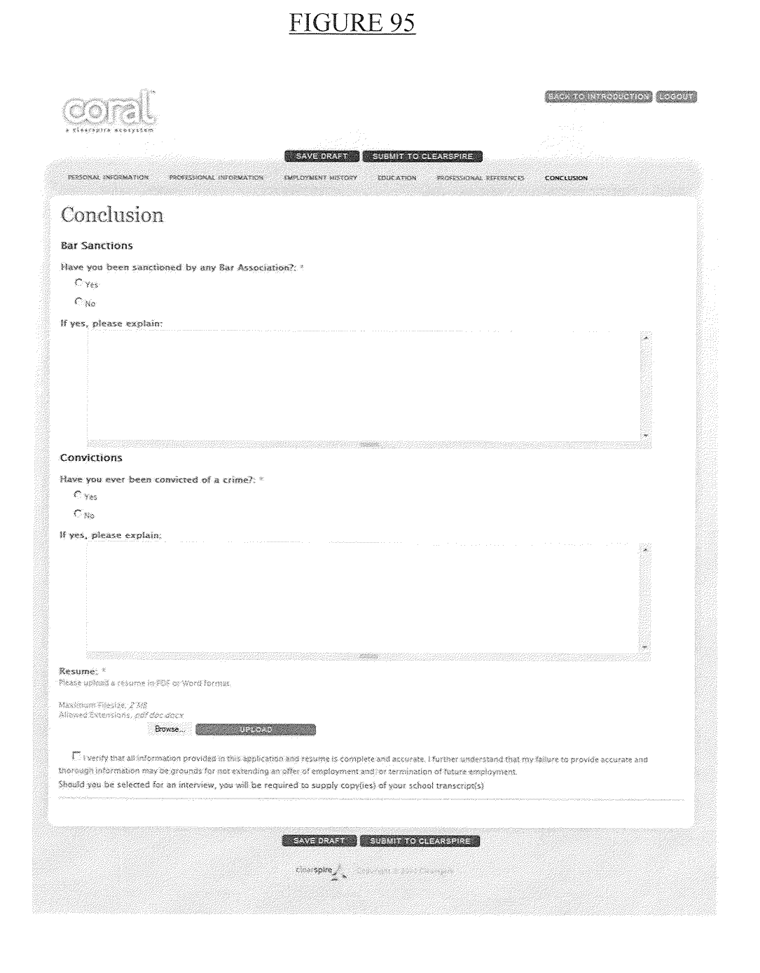

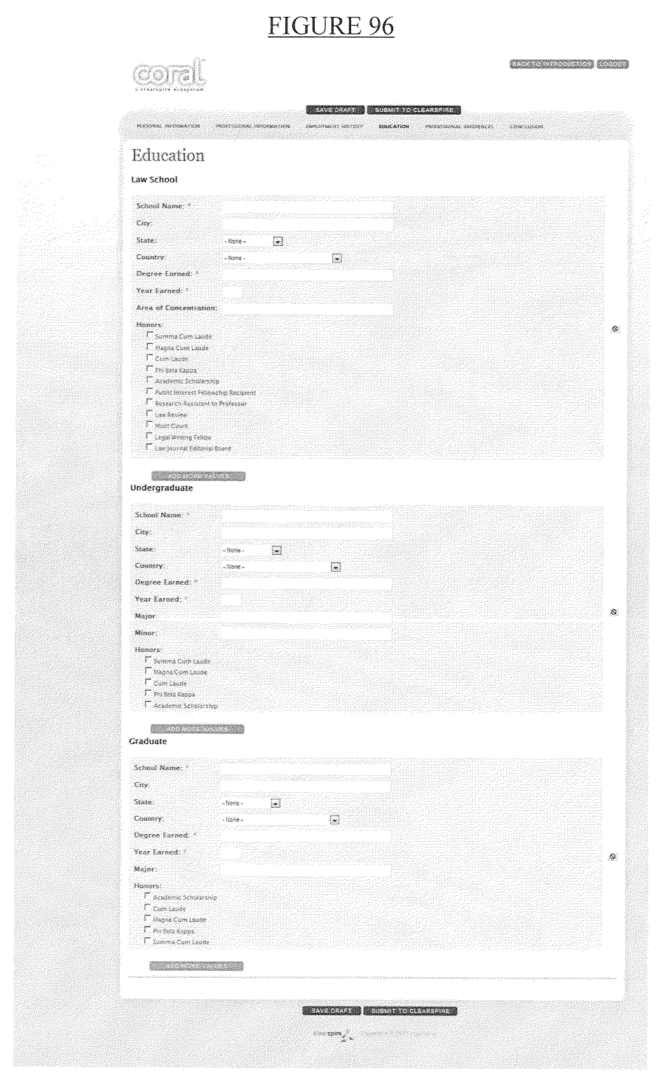

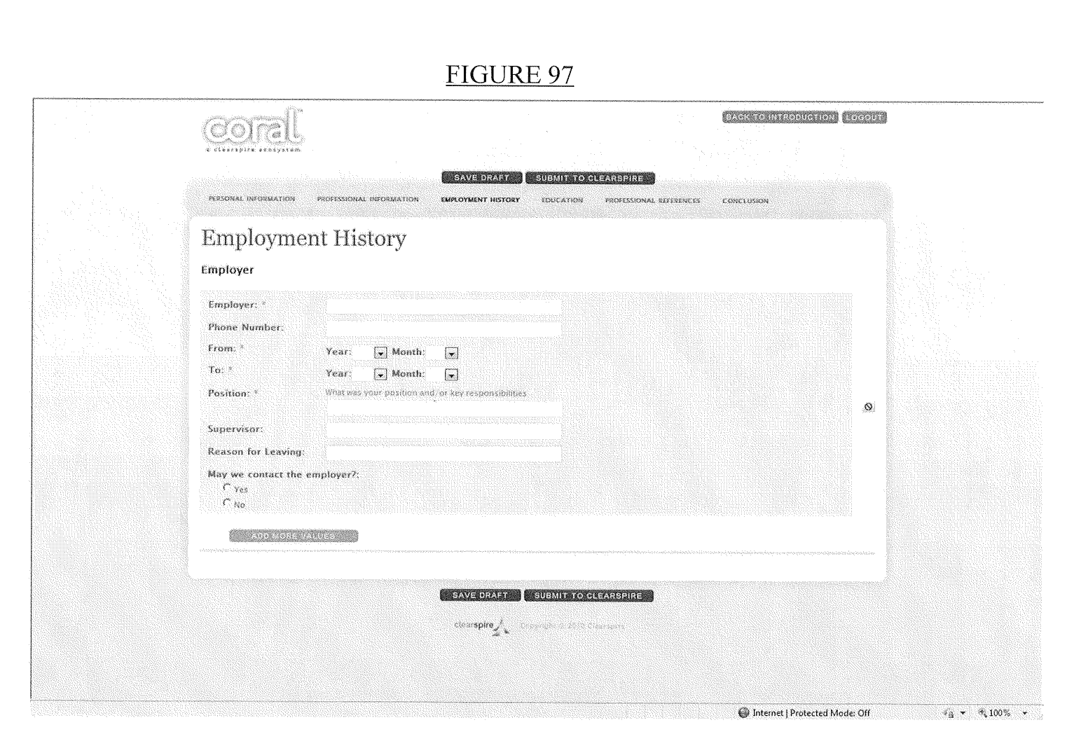

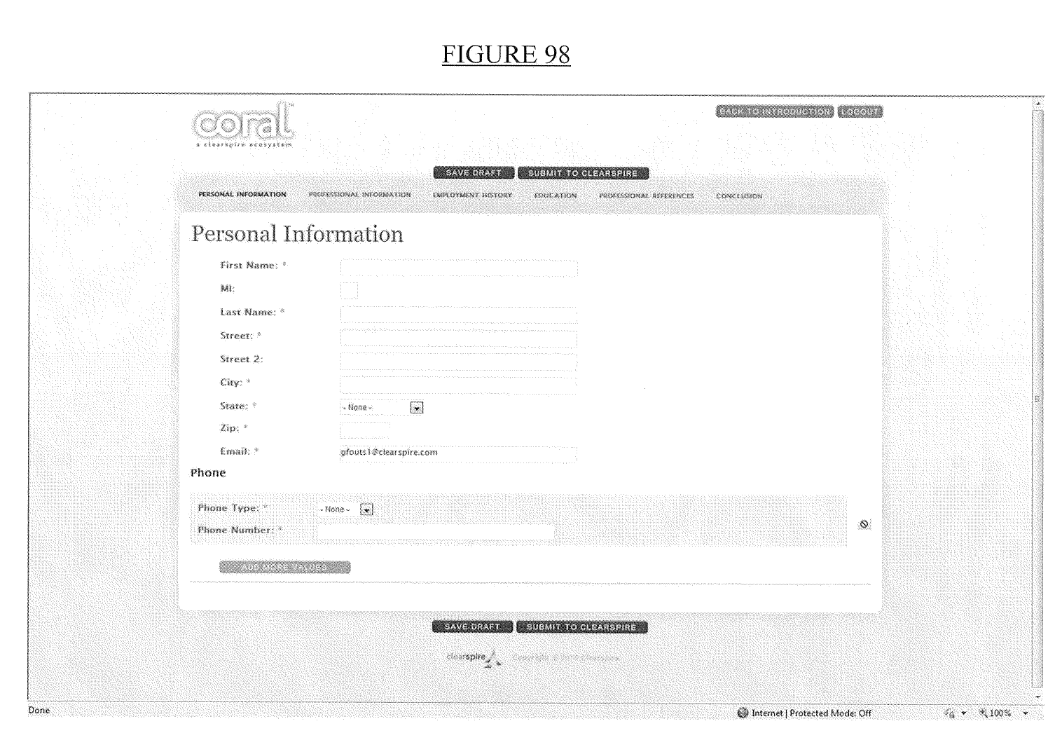

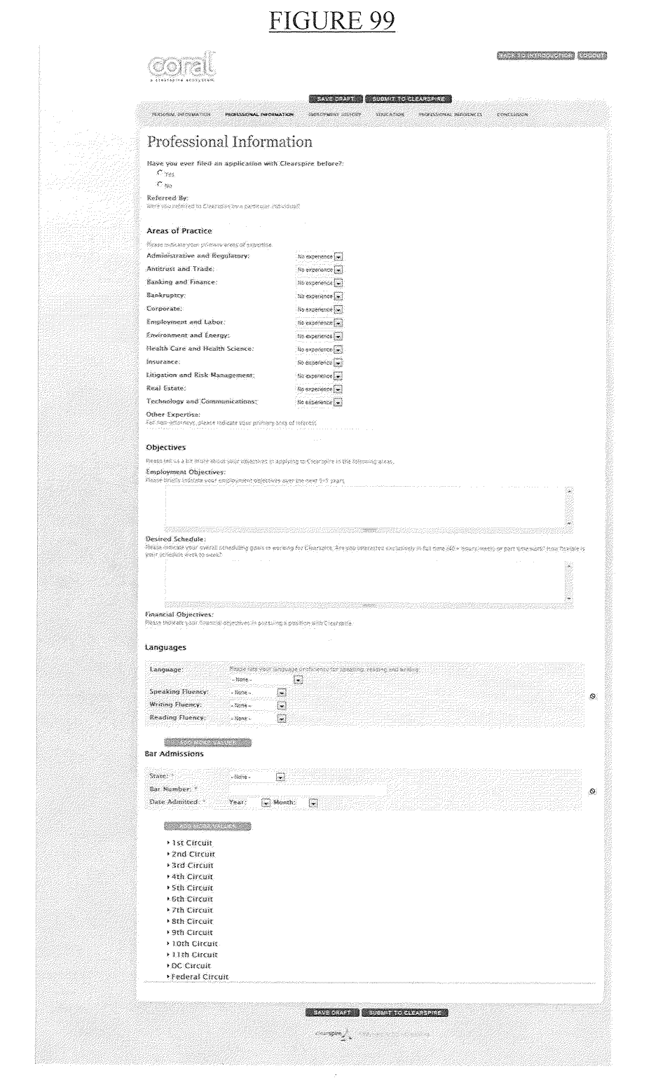

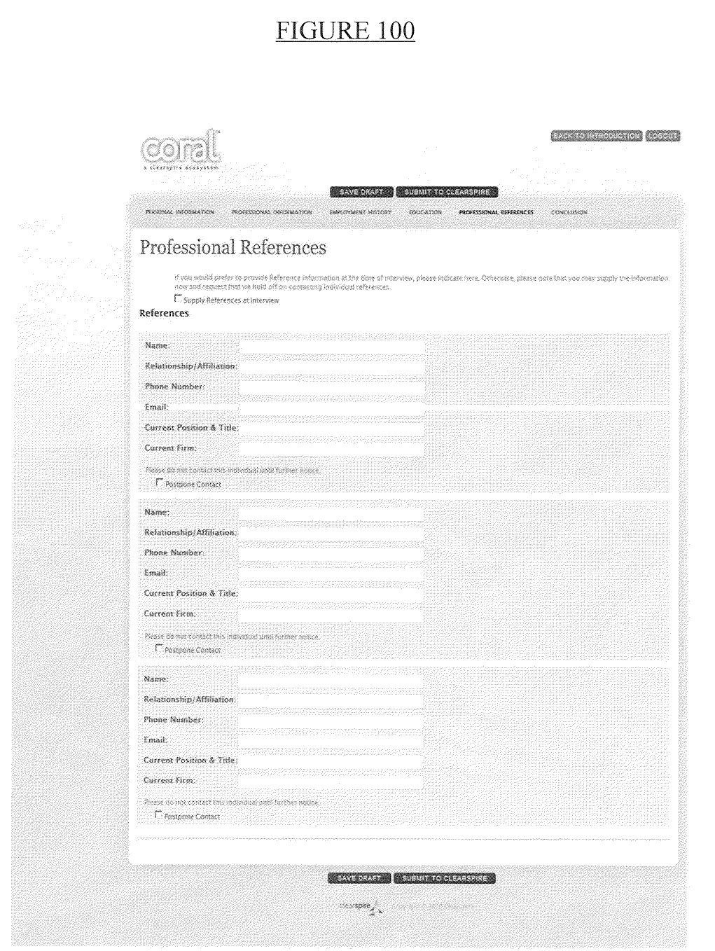

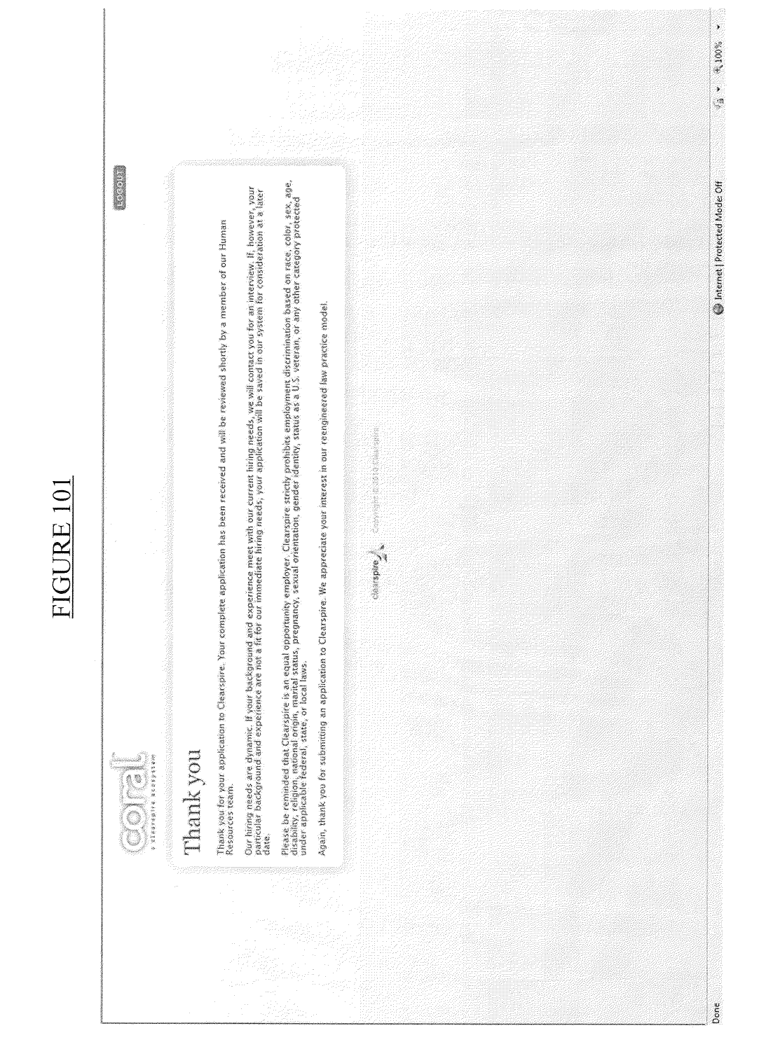

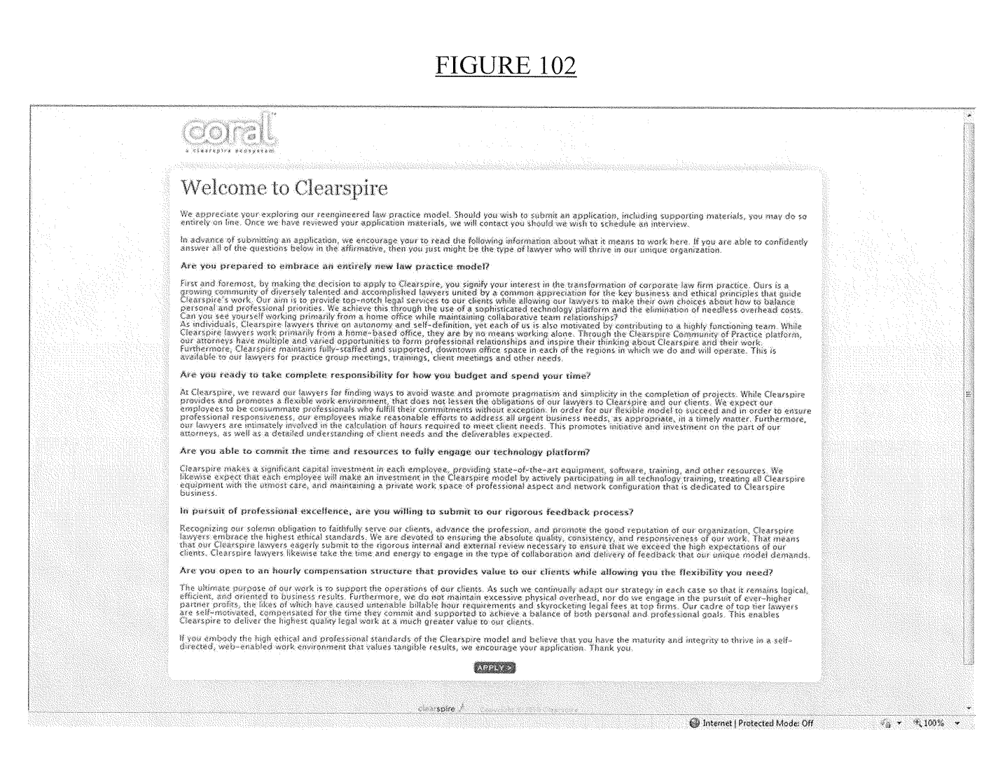

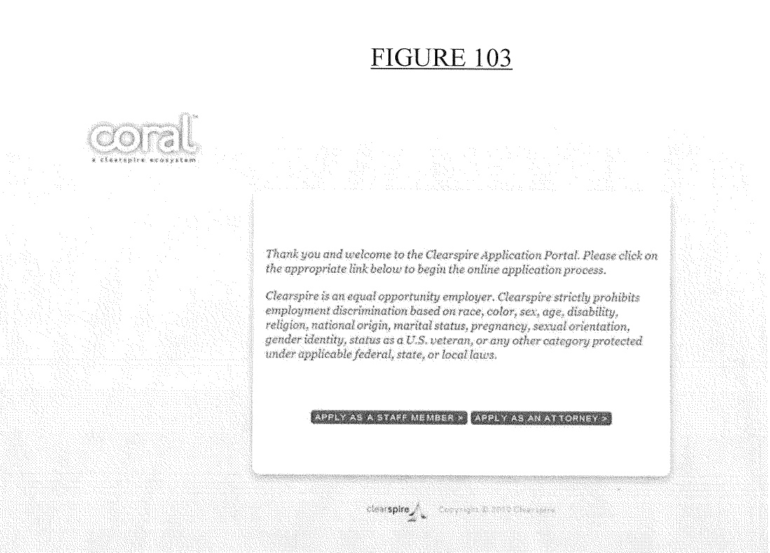

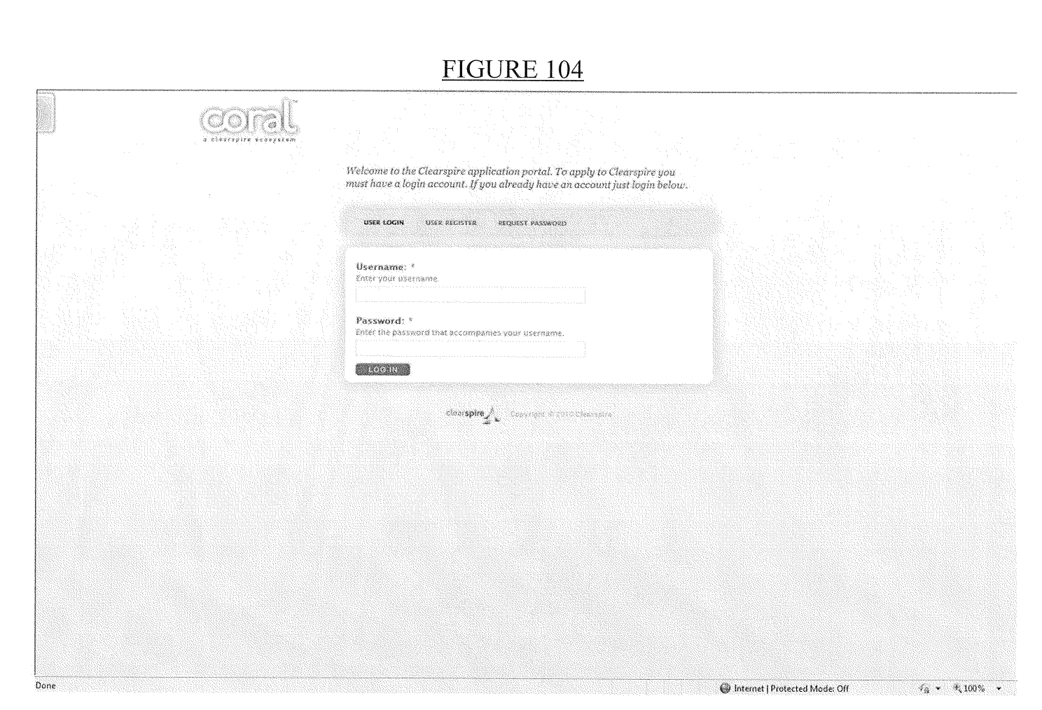

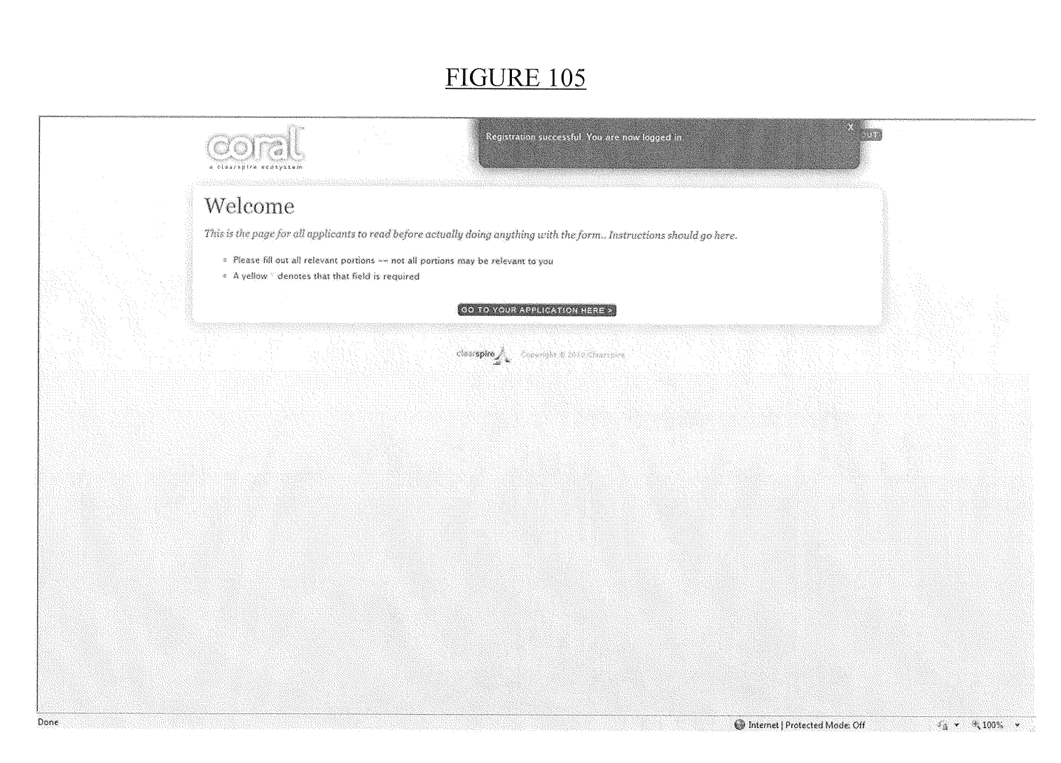

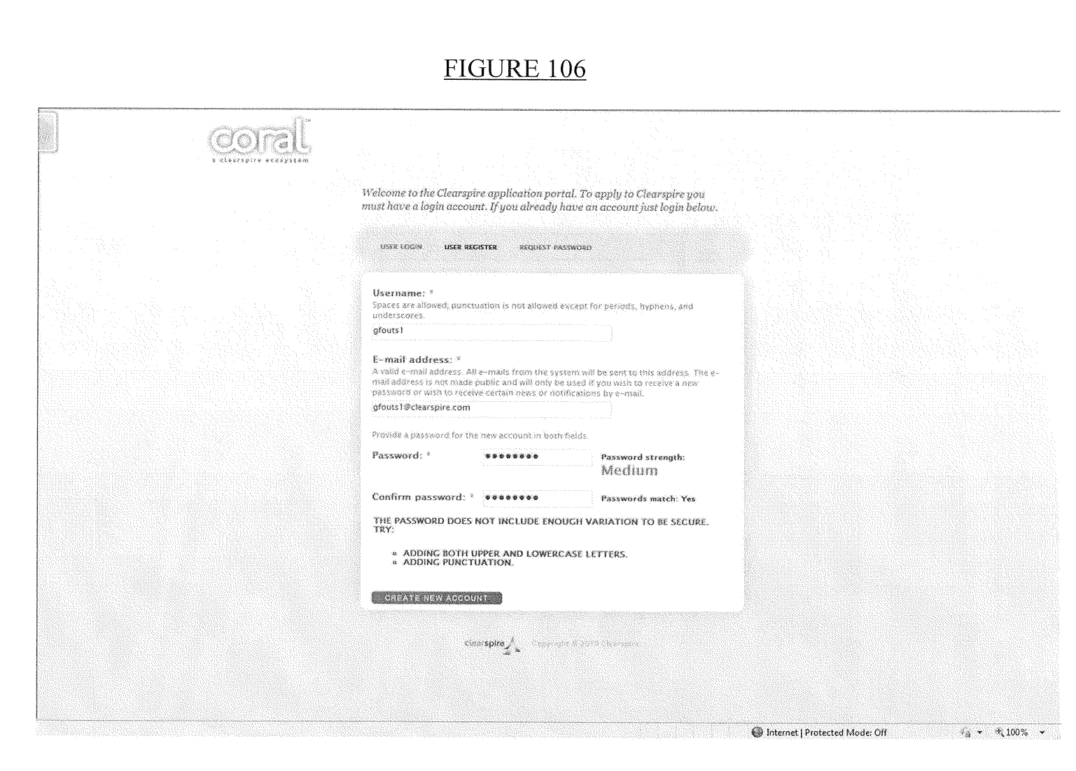

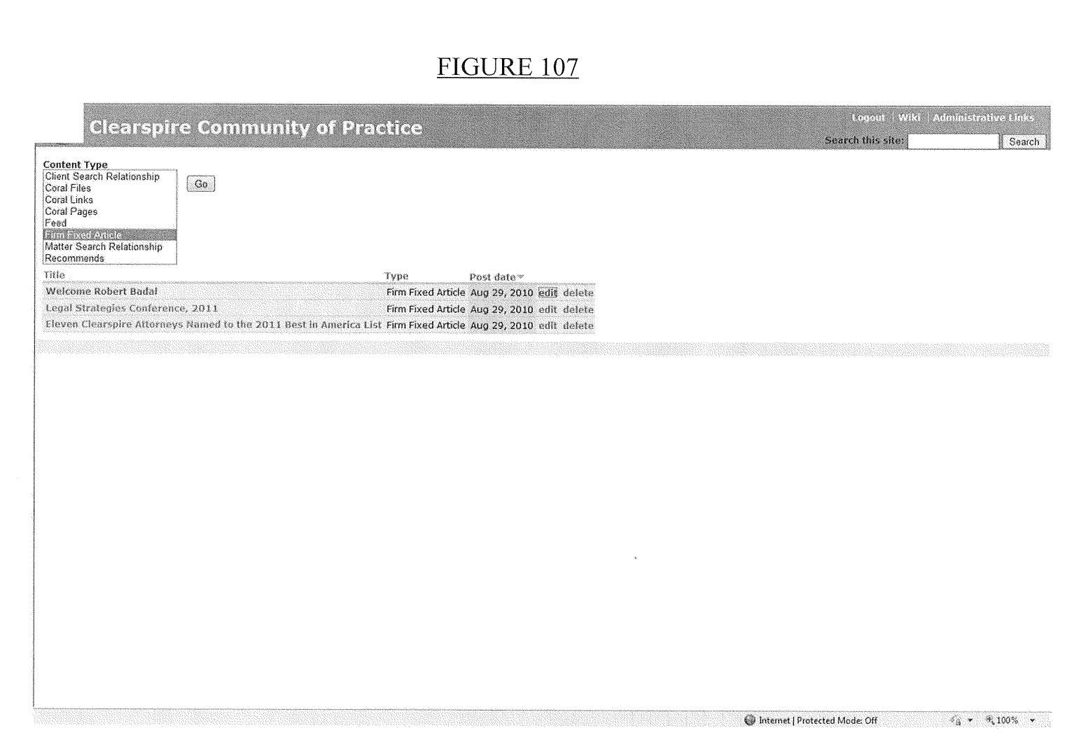

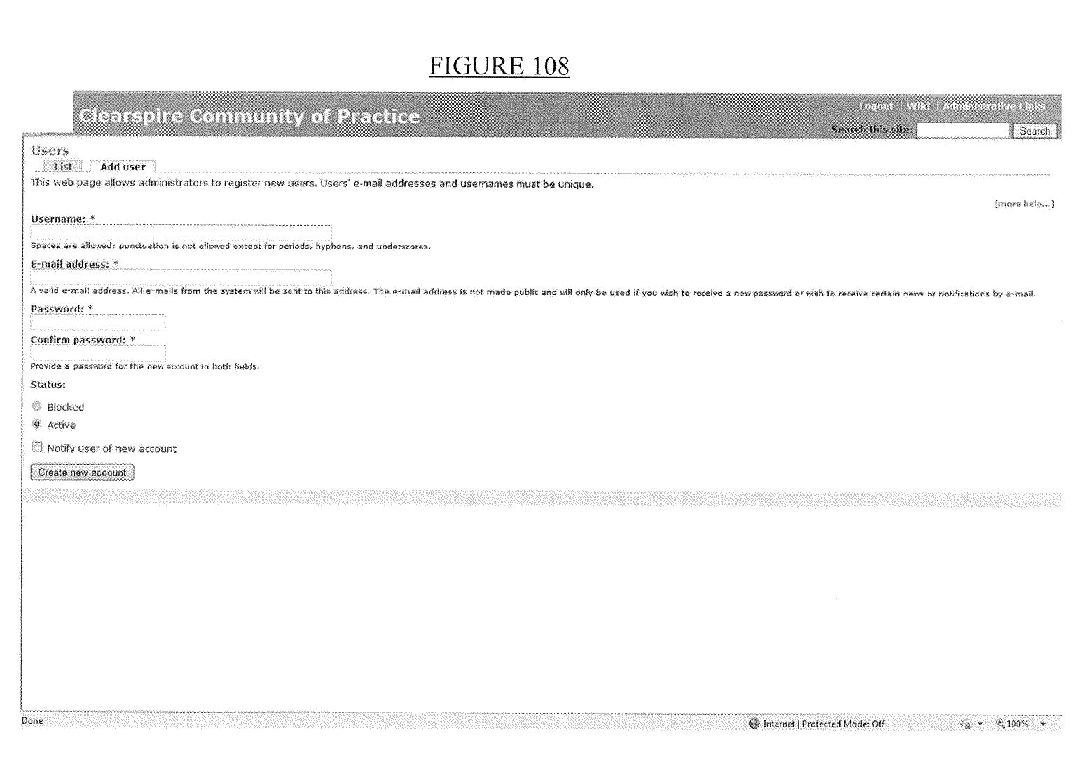

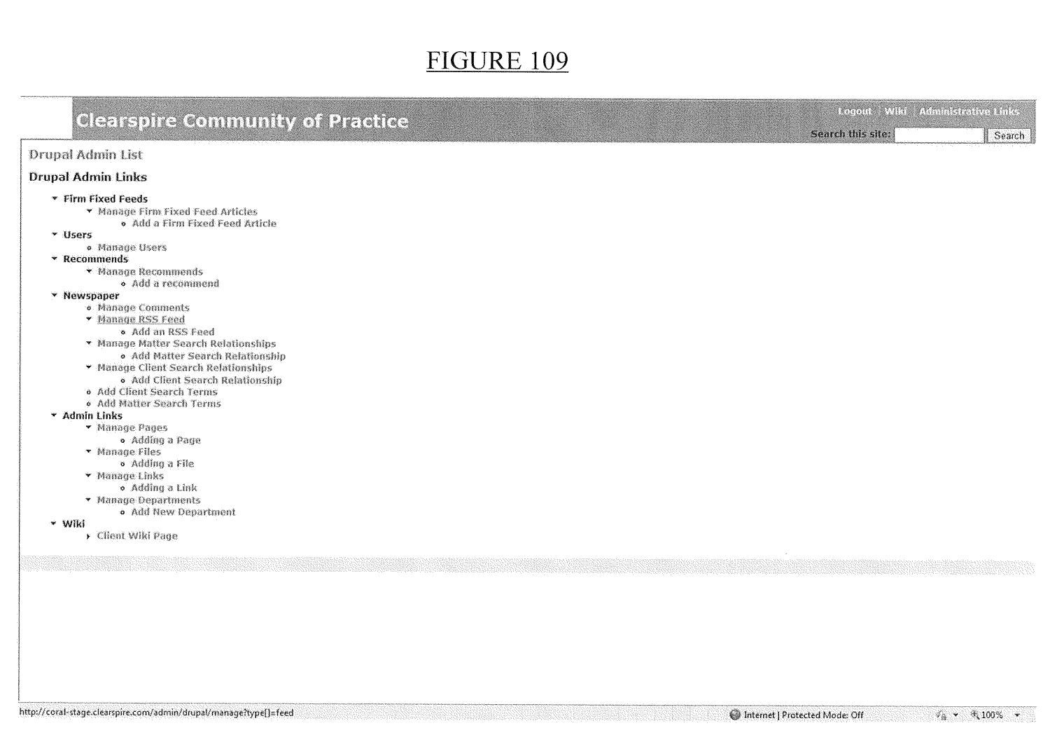

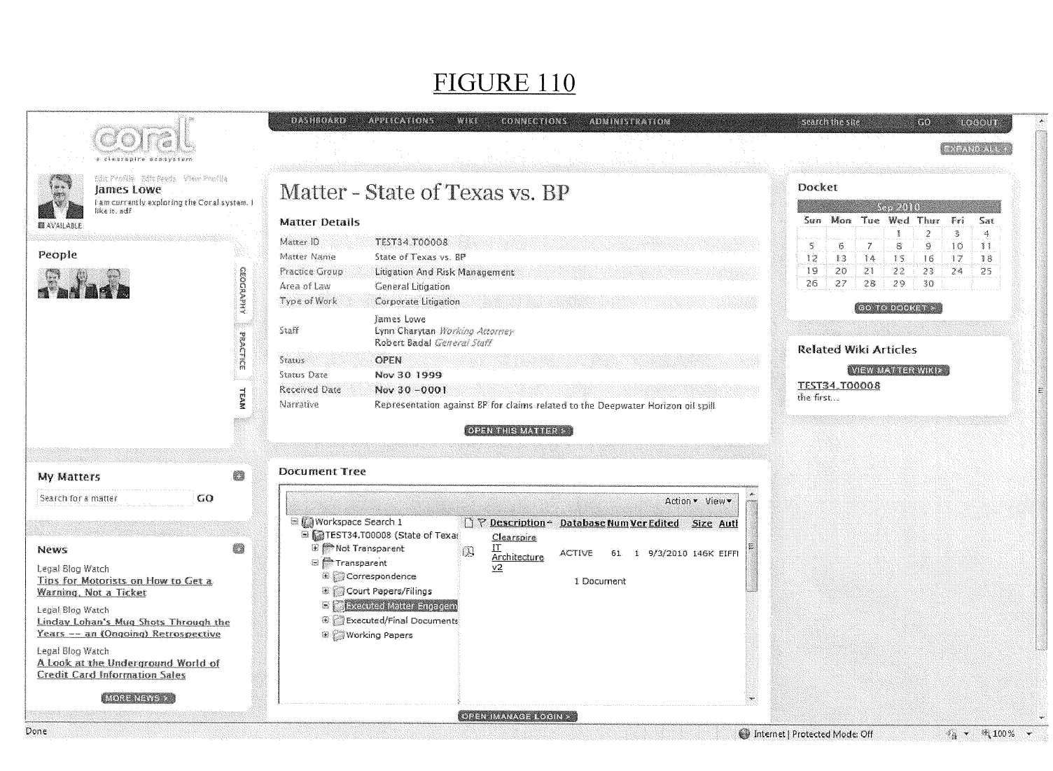

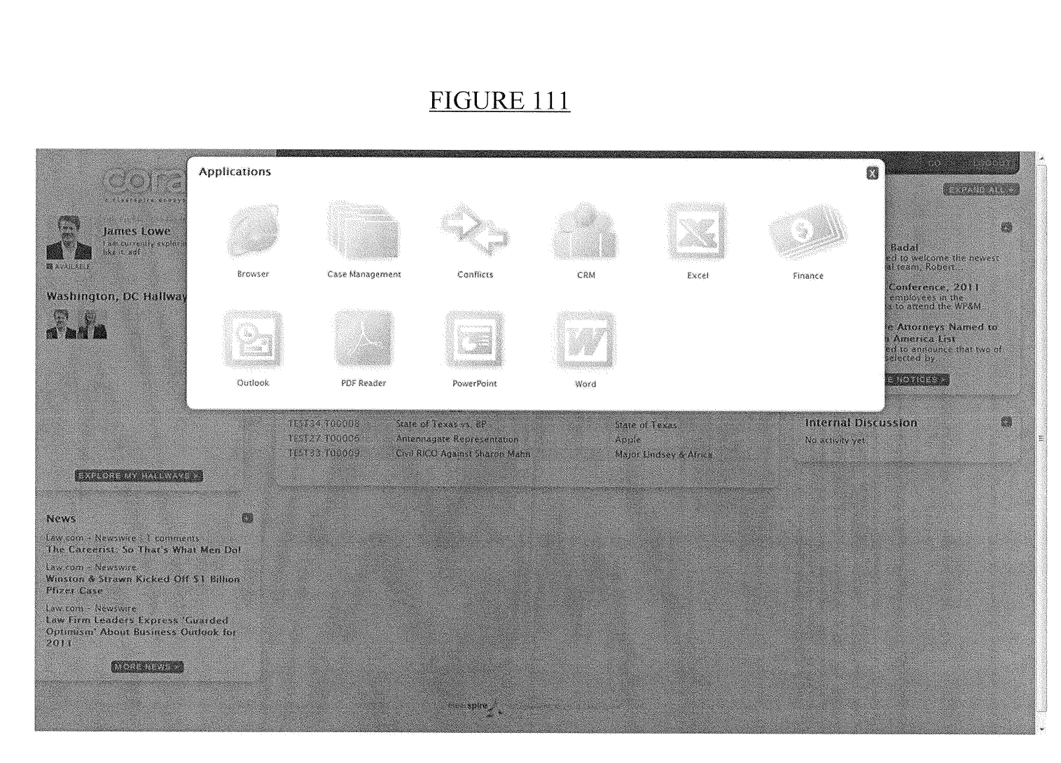

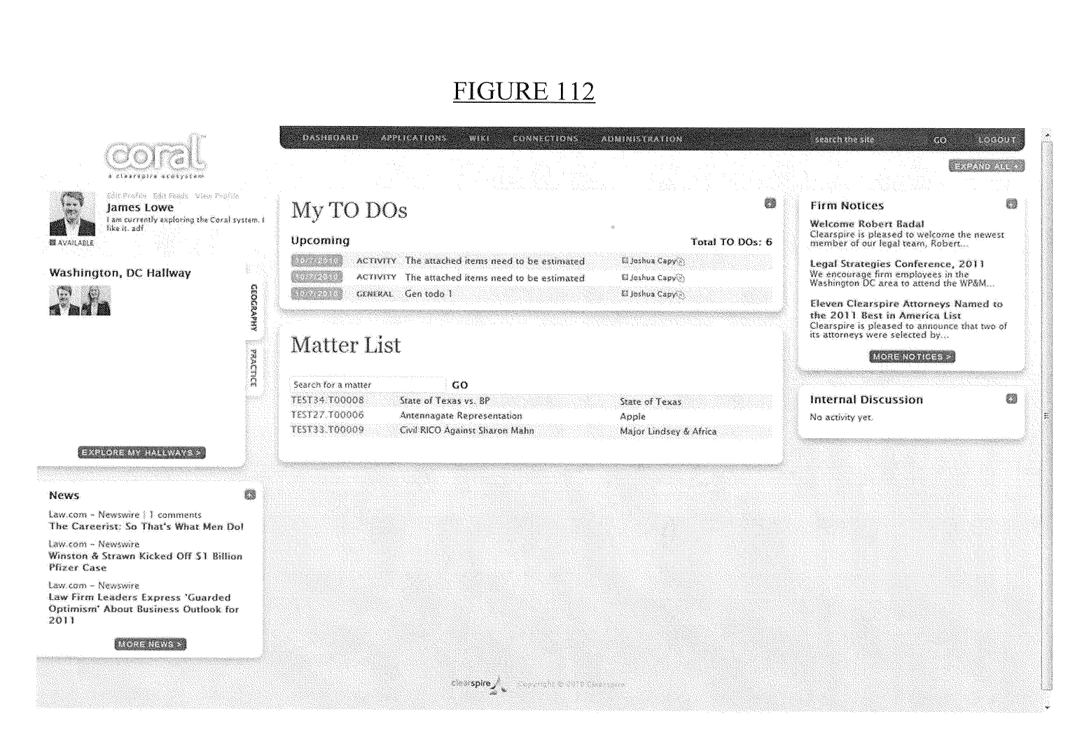

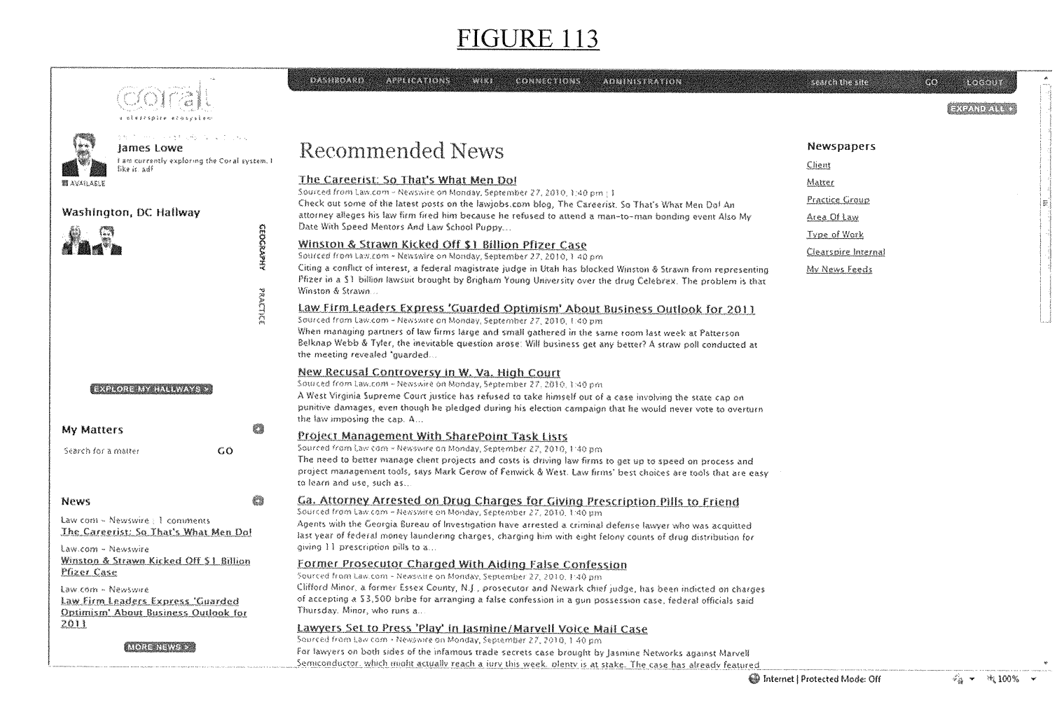

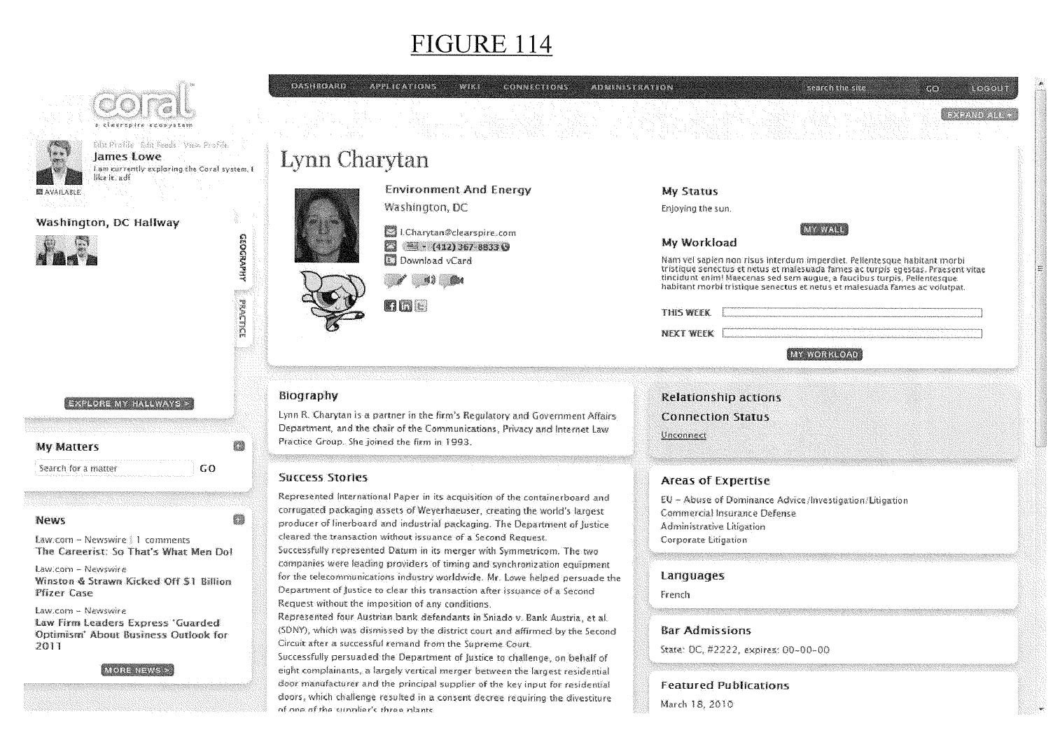

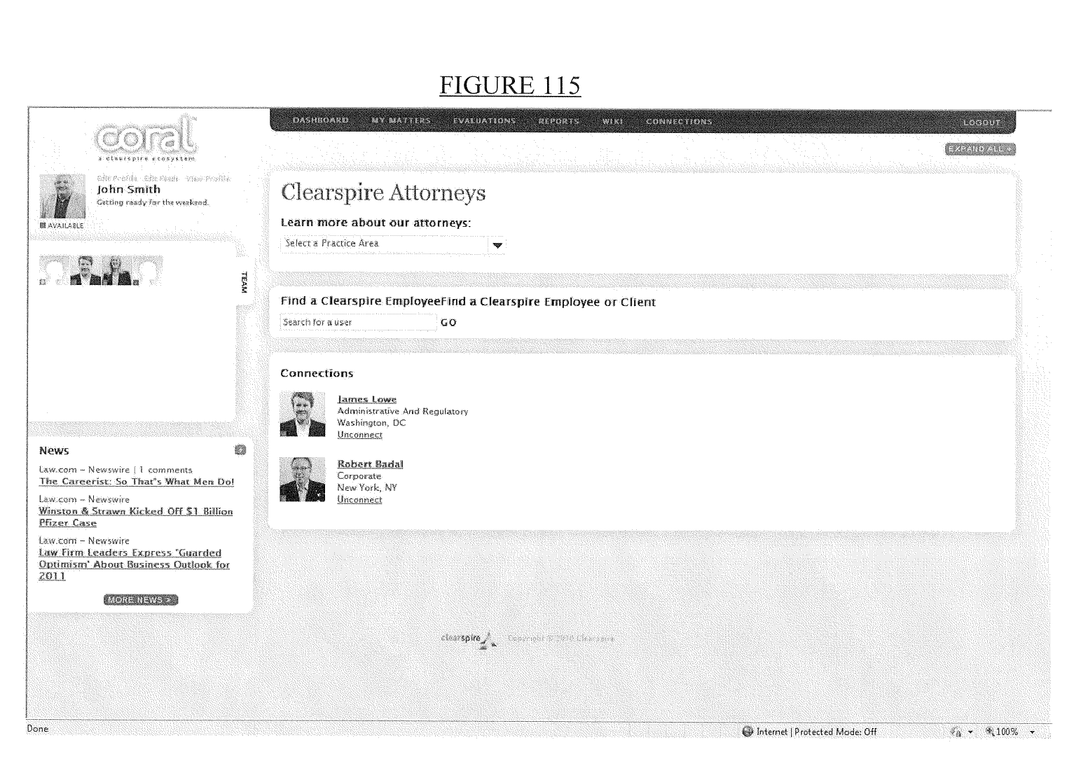

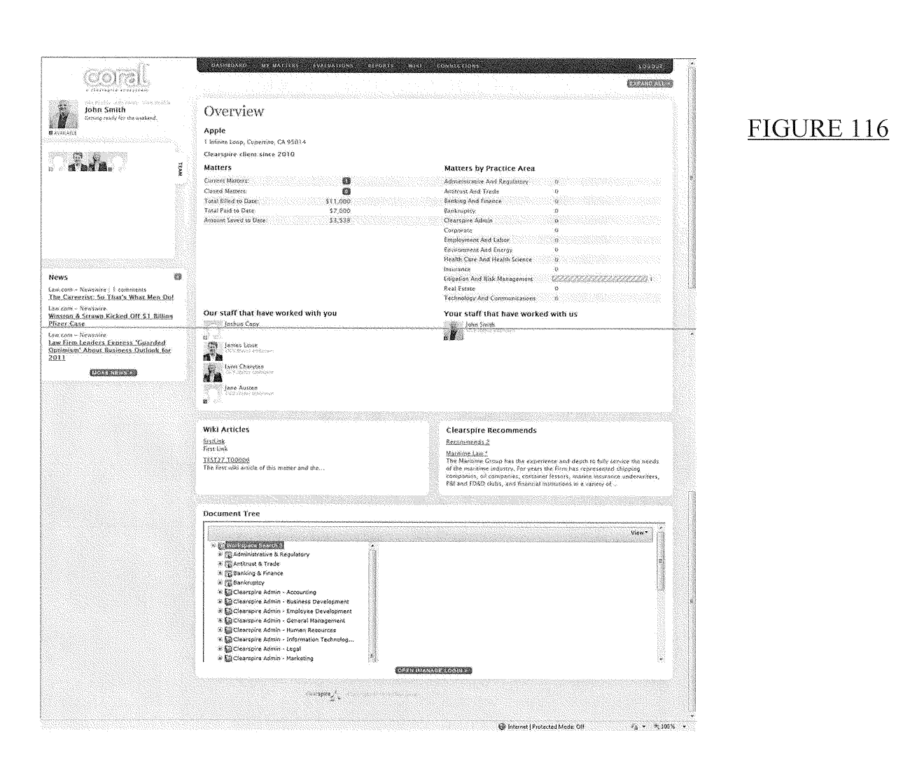

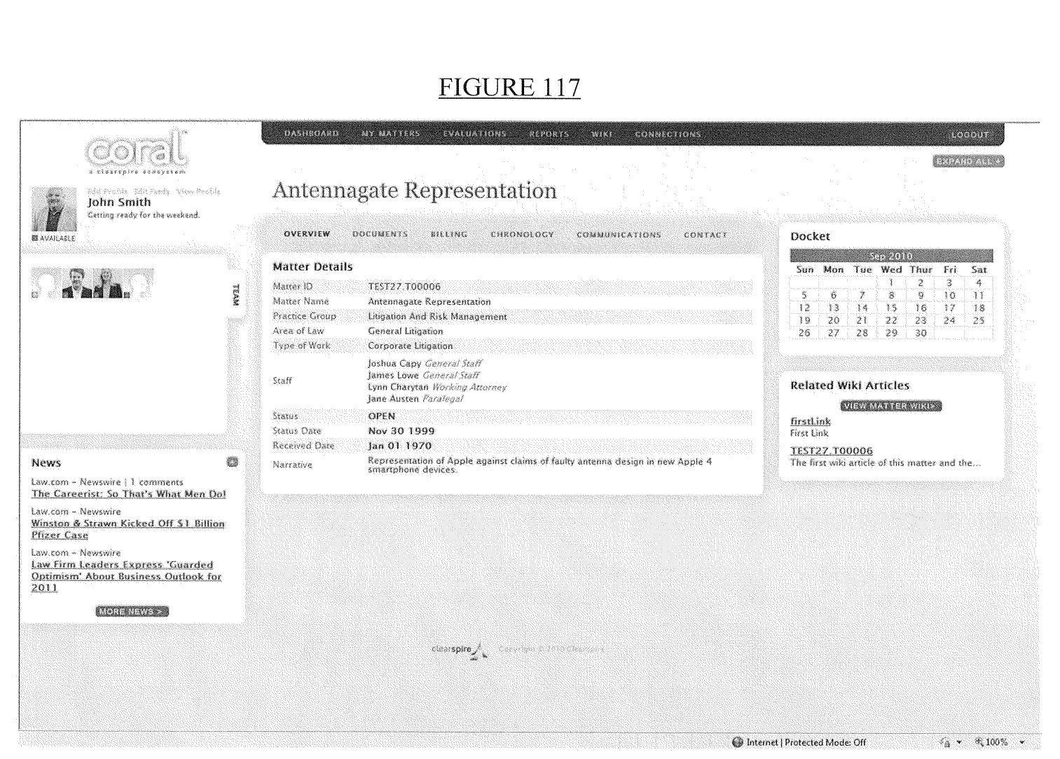

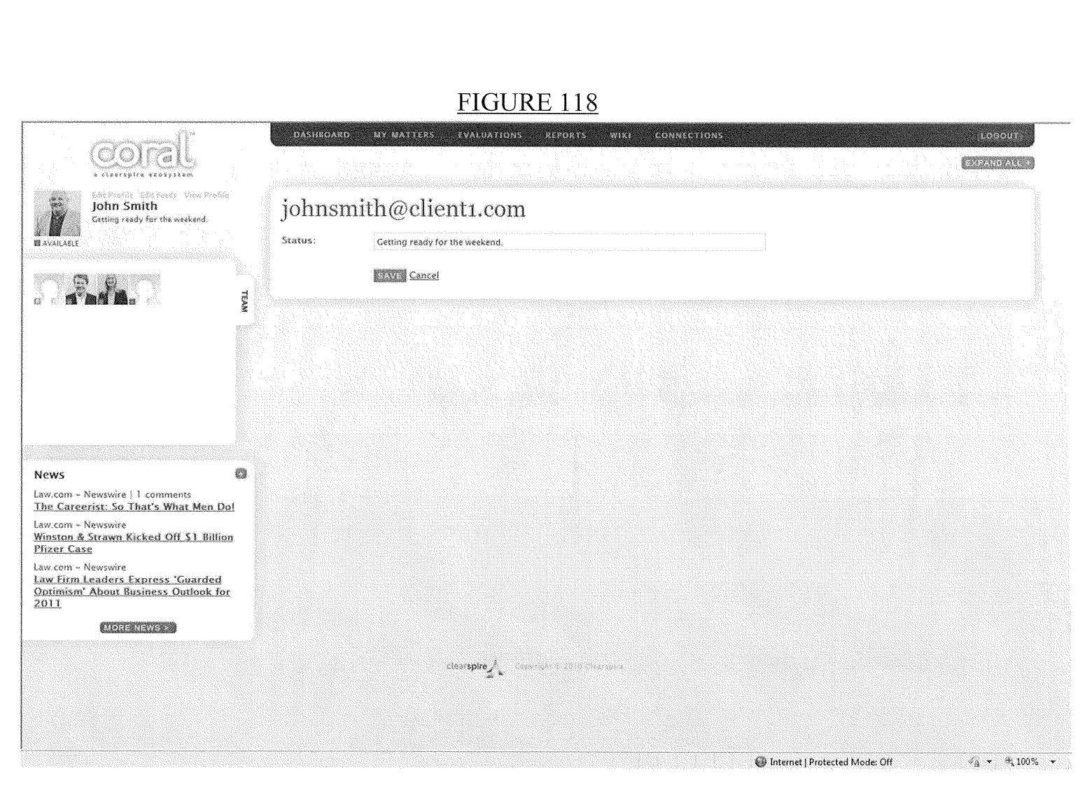

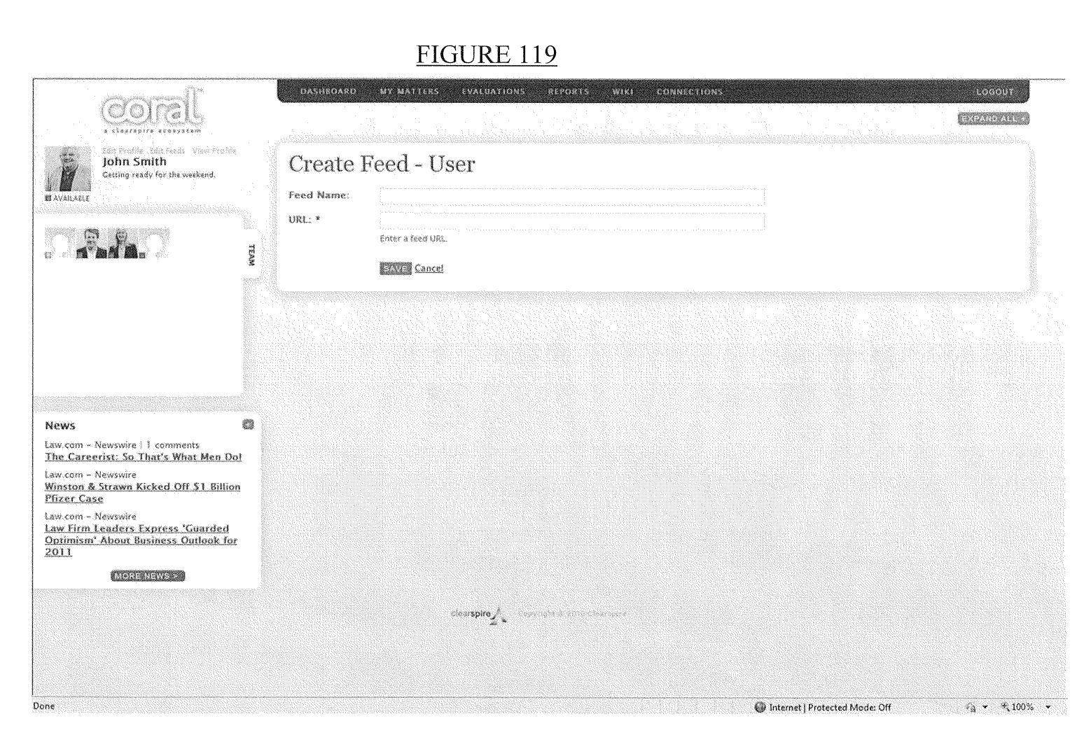

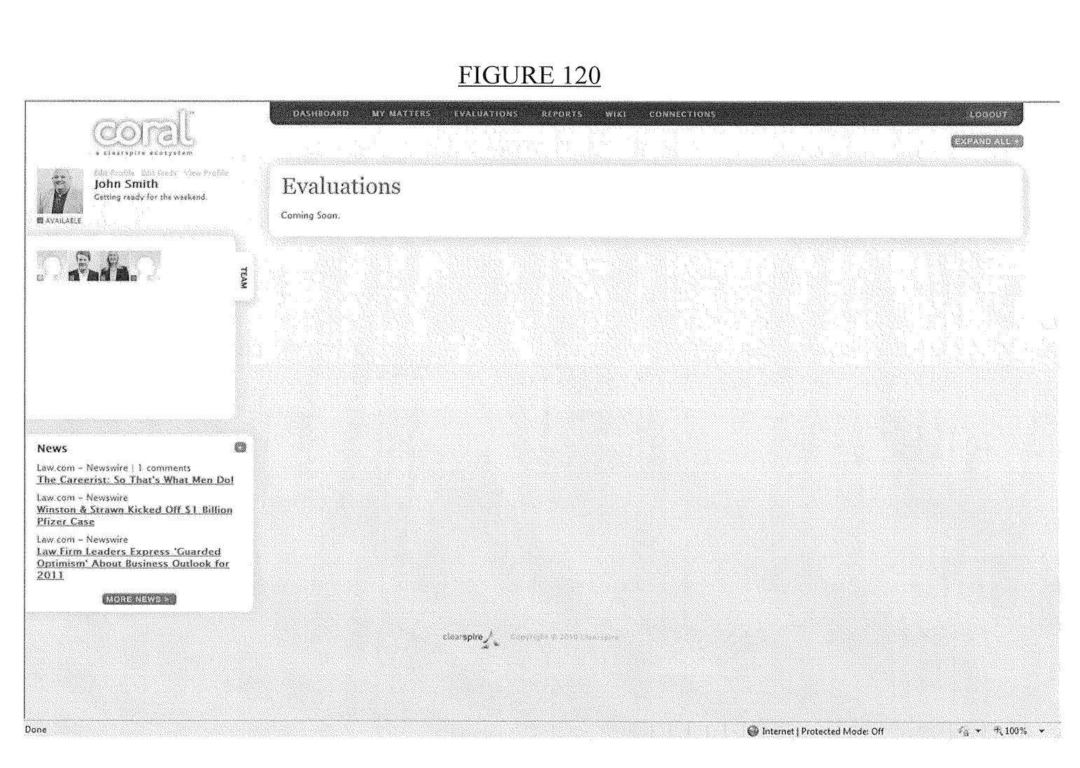

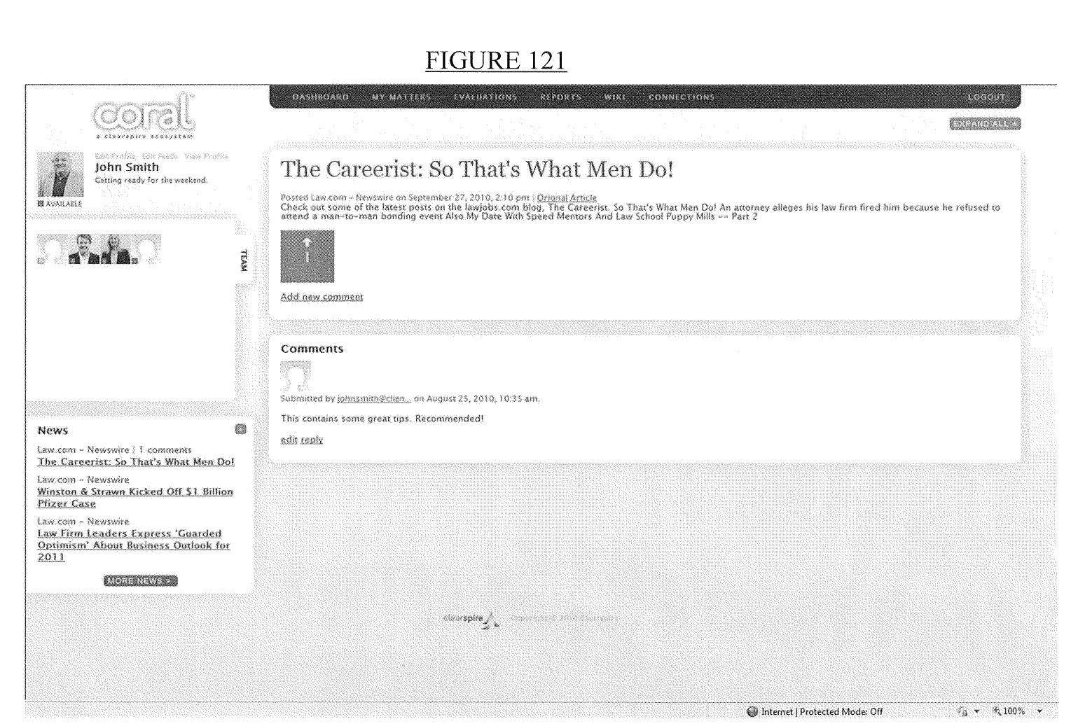

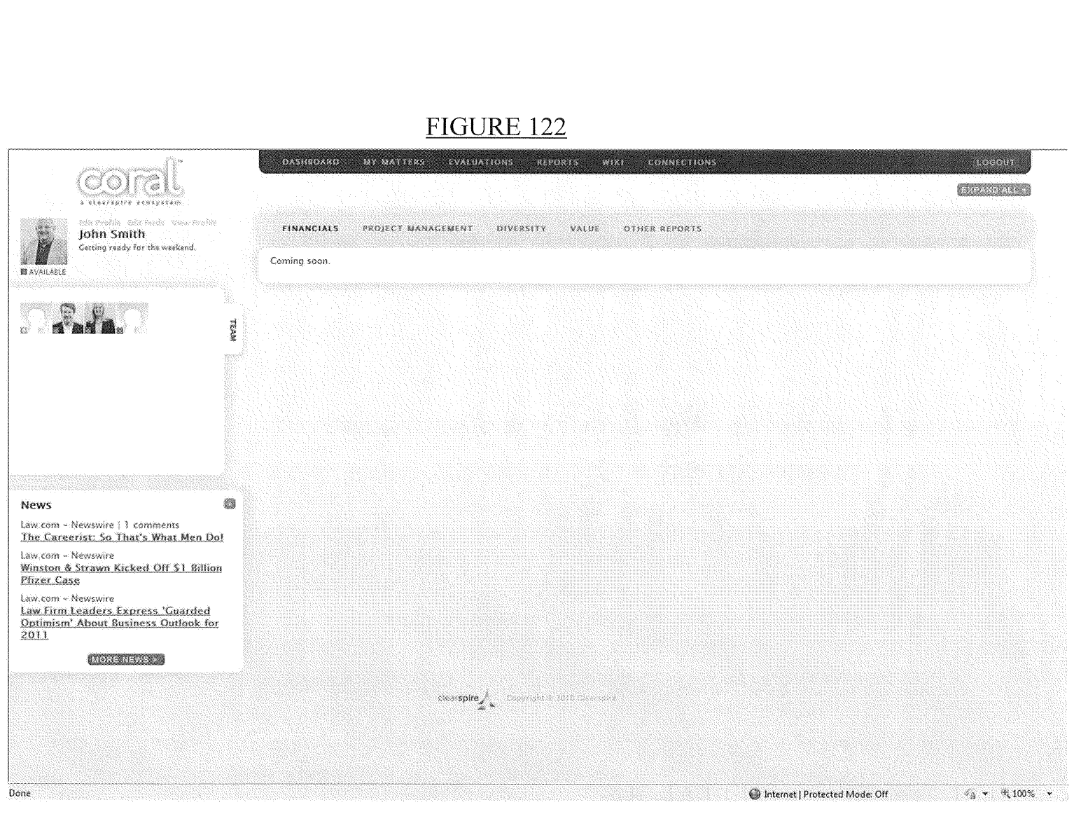

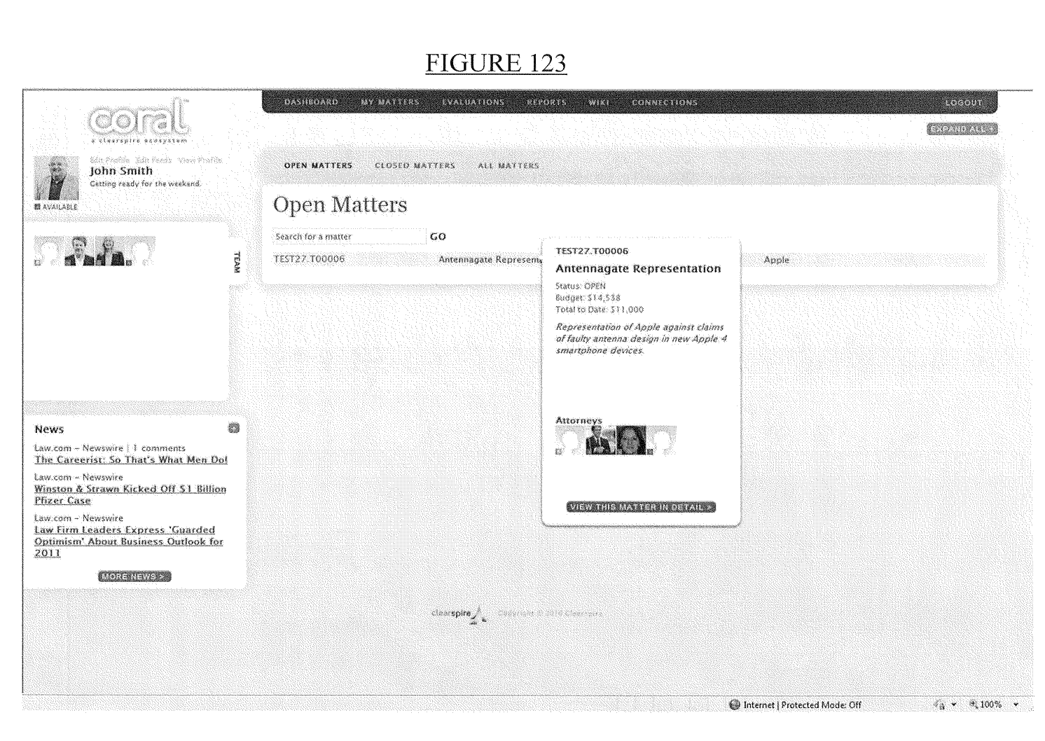

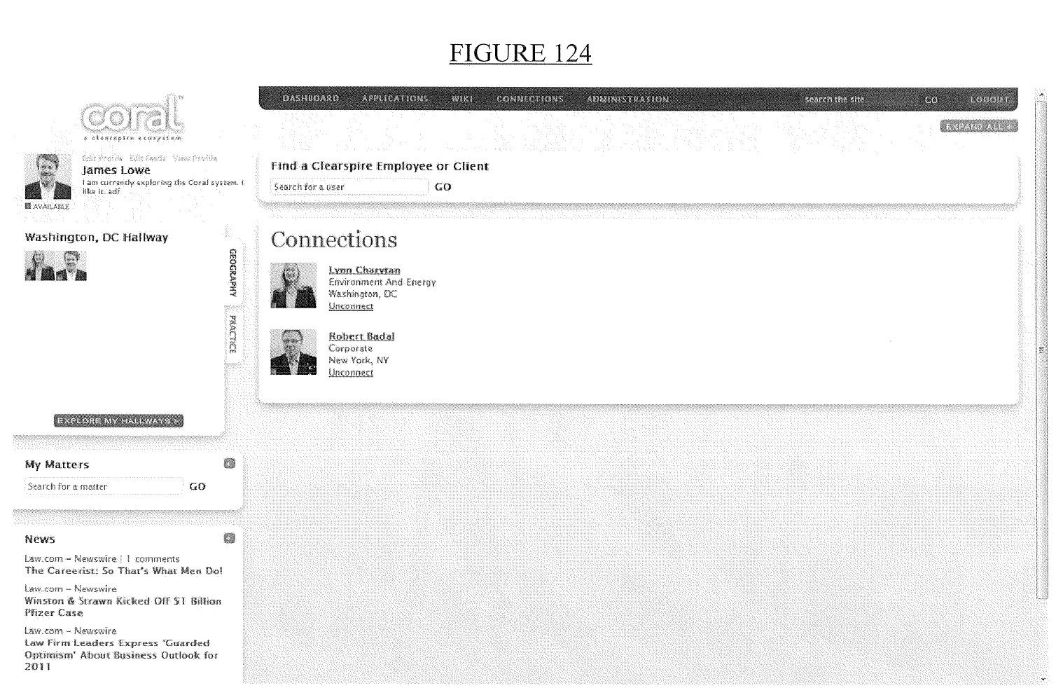

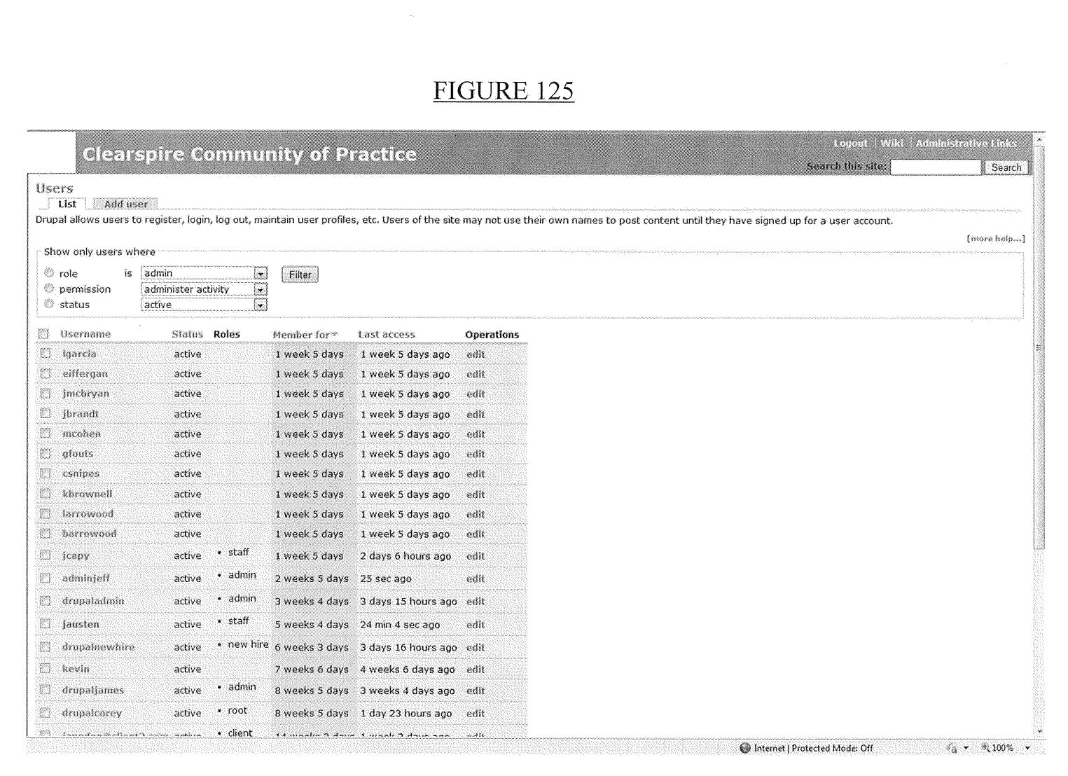

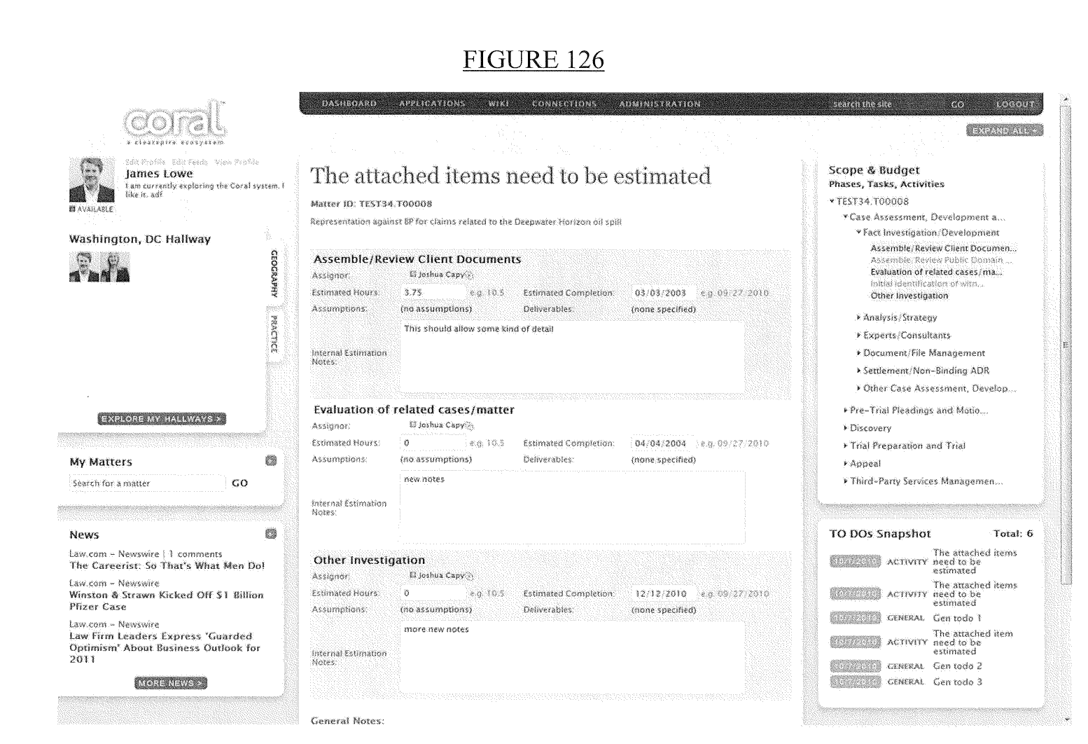

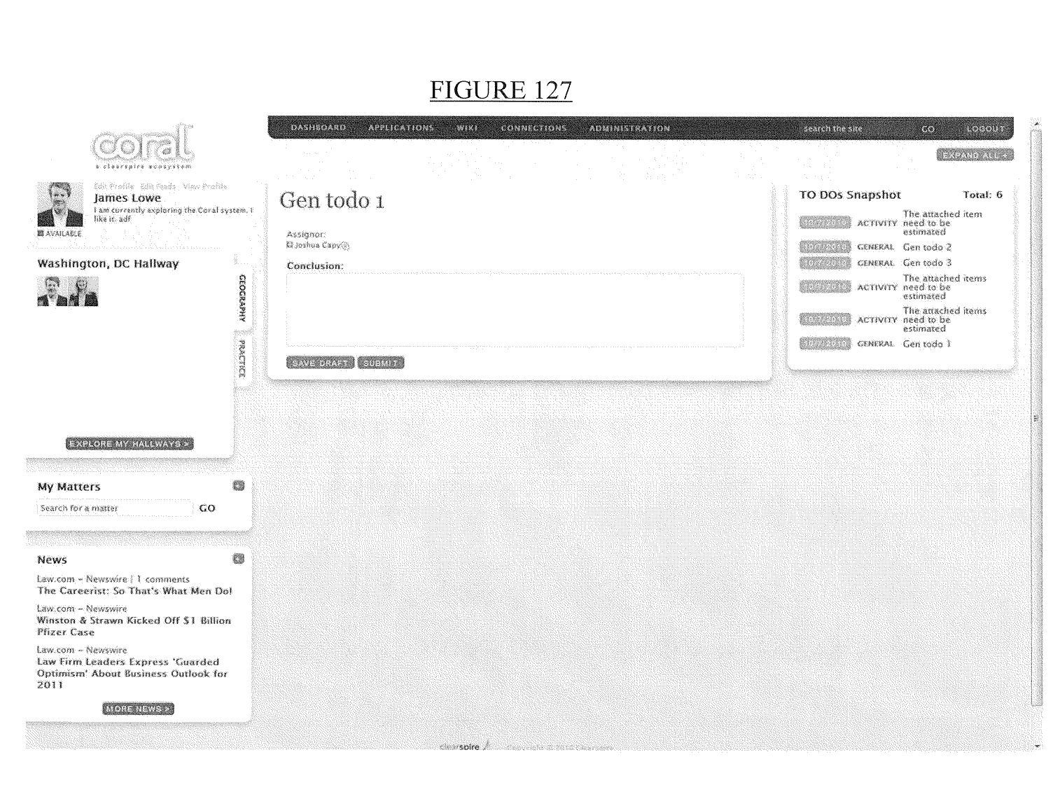

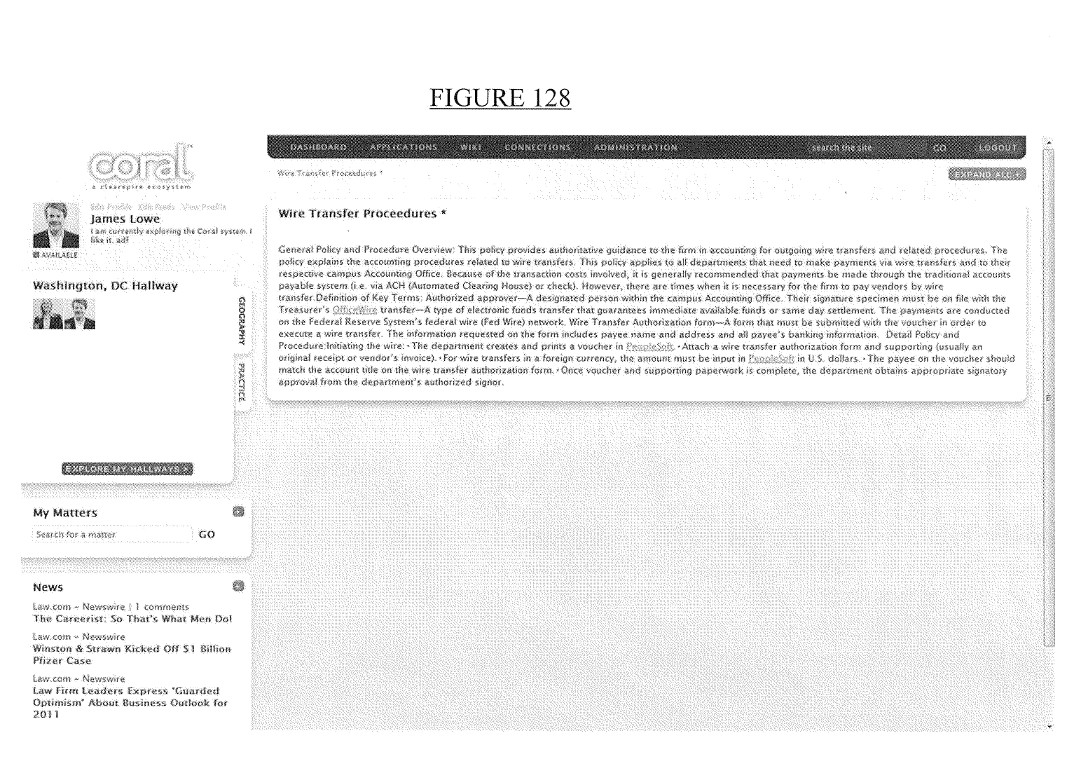

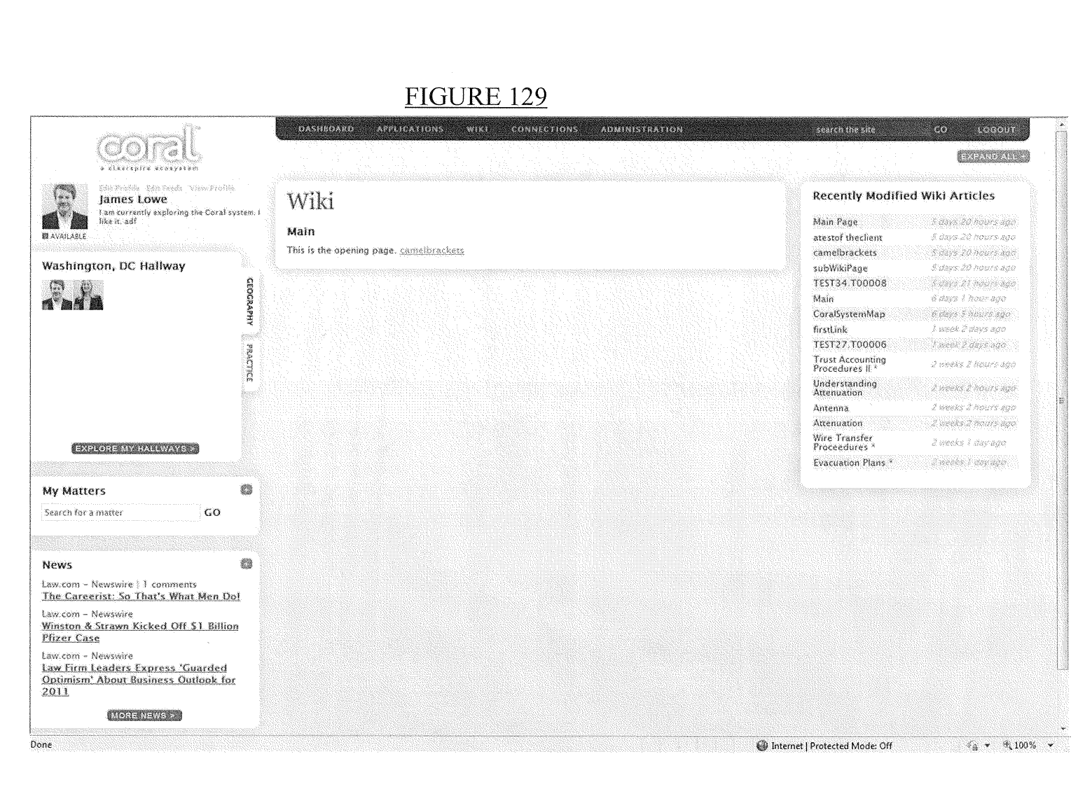

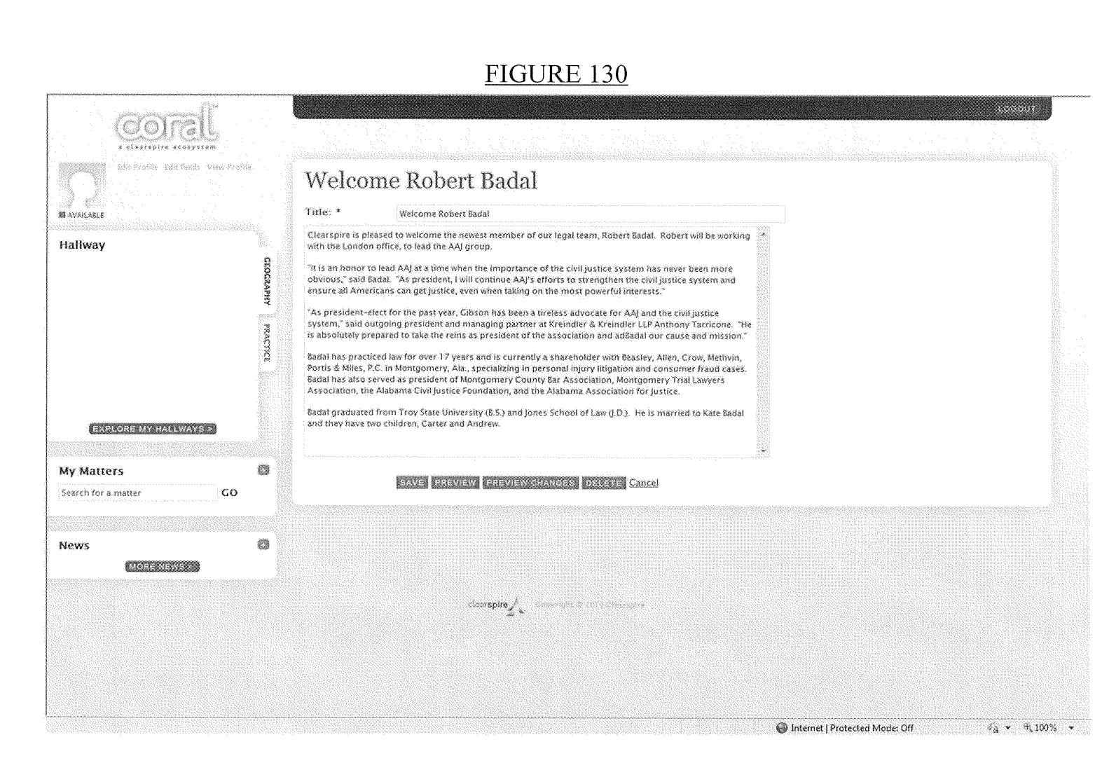

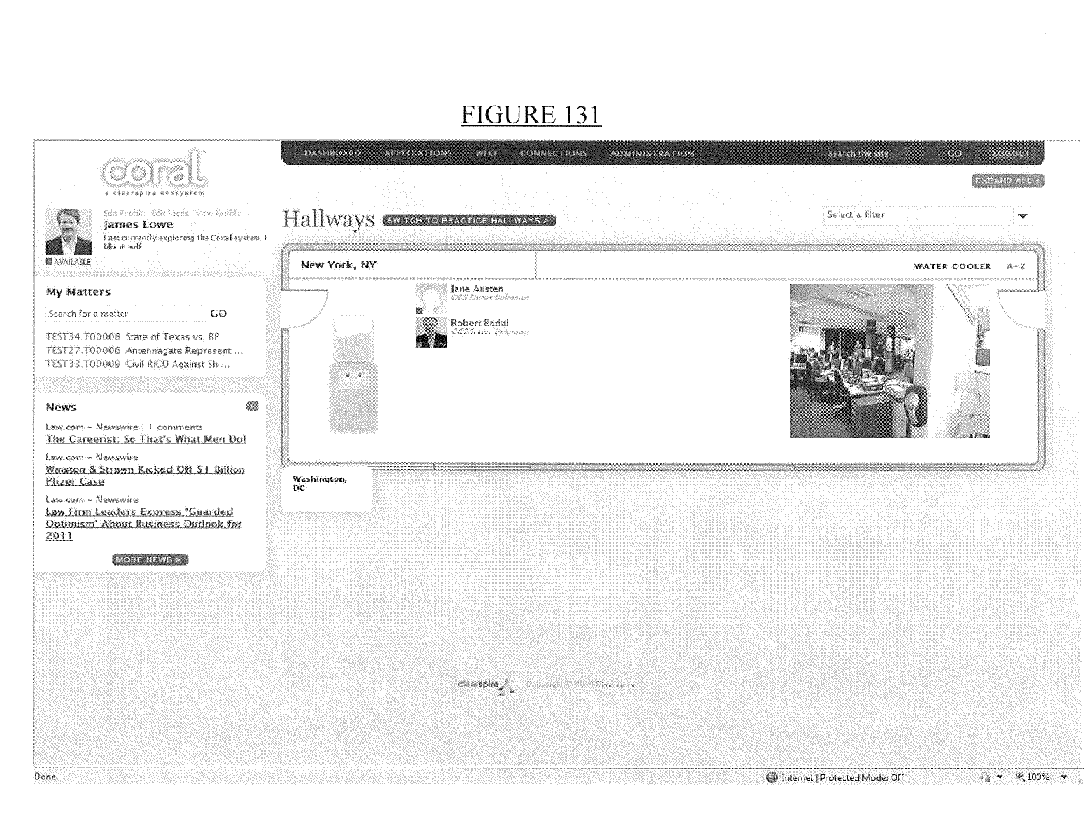

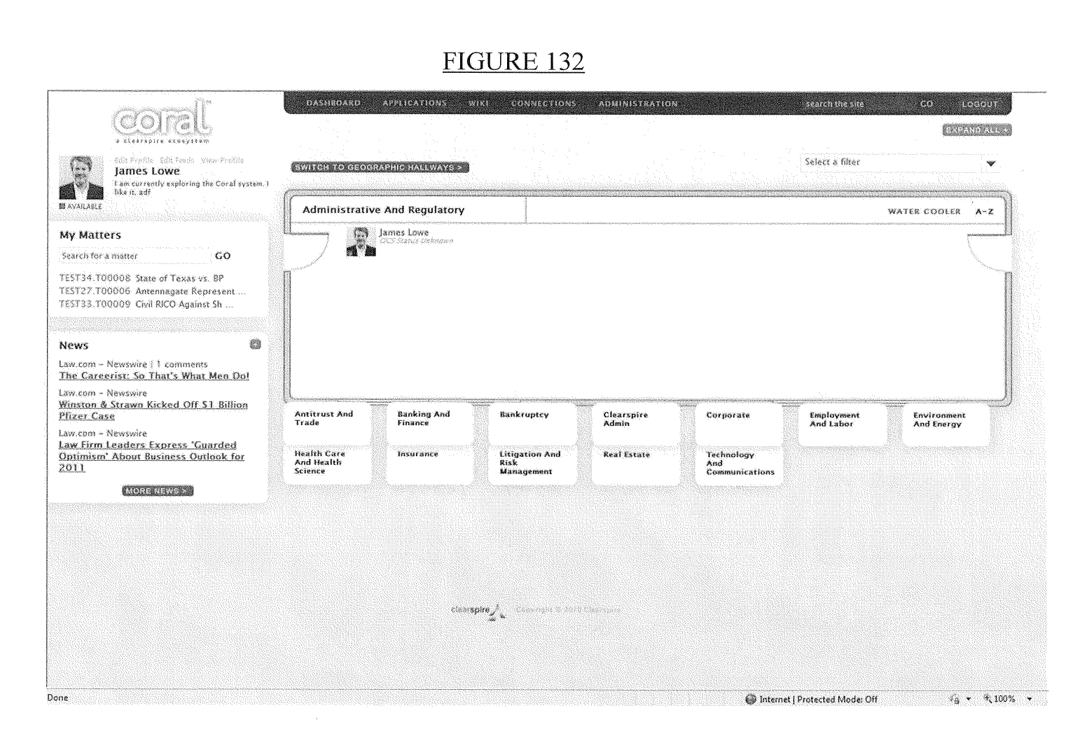

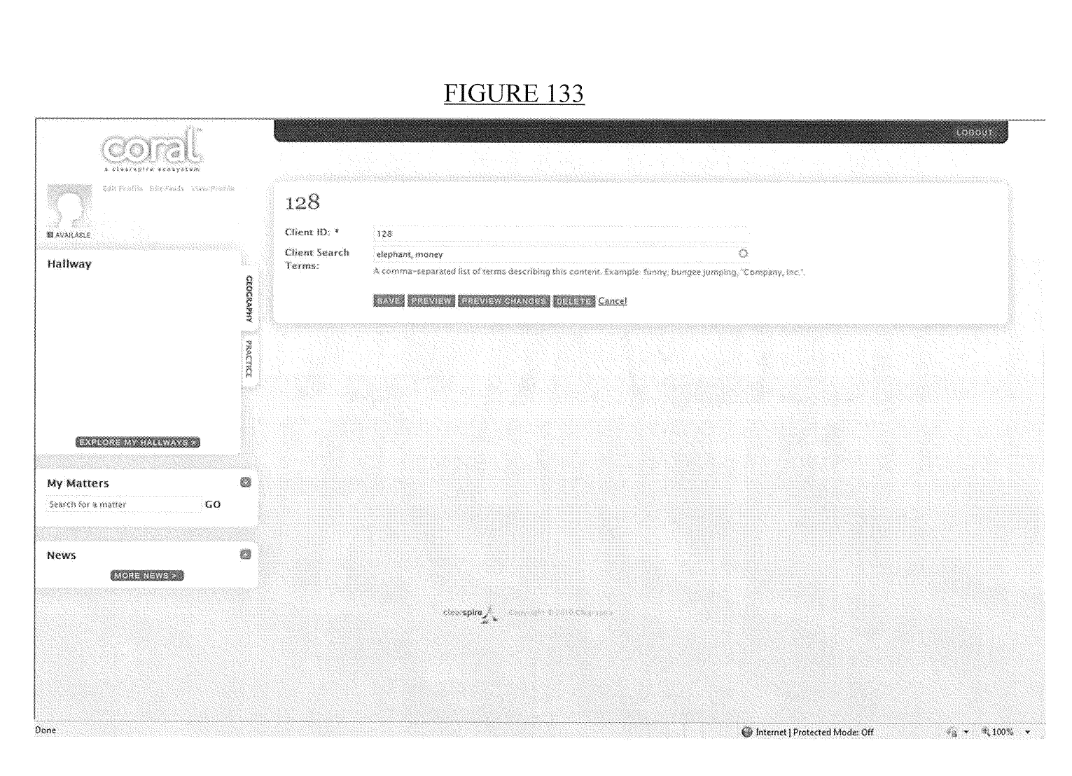

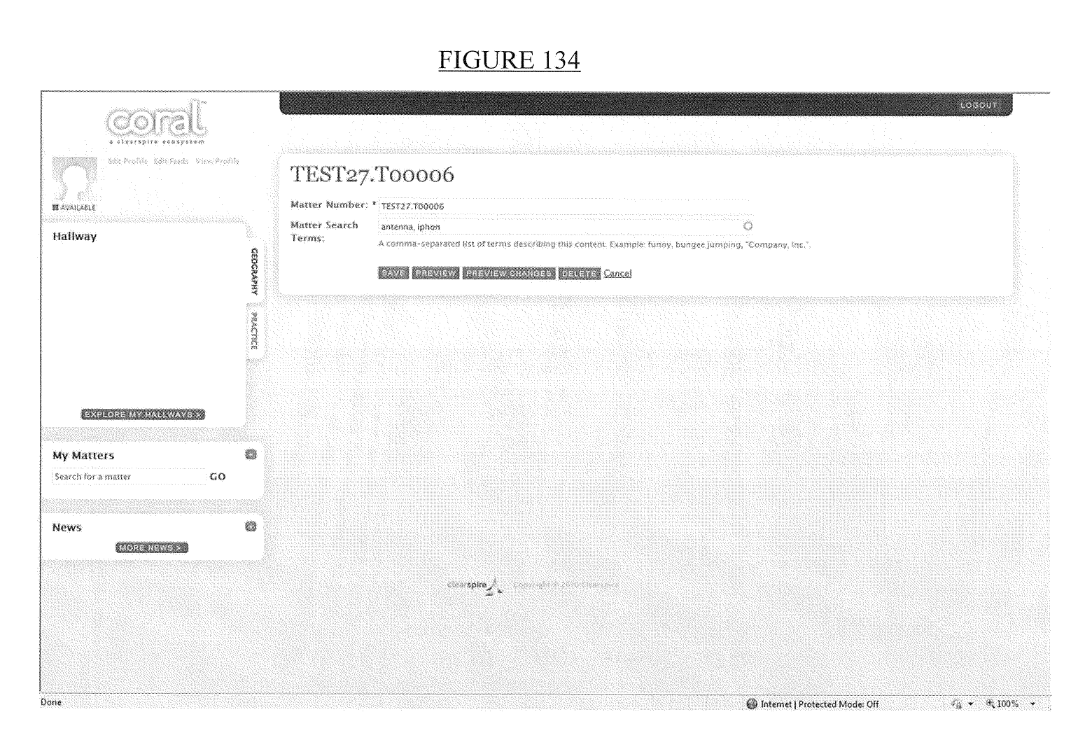

FIGS. 5-6 are flowcharts illustrating how a matter can be analyzed, according to one embodiment. Referring to FIG. 5, in 505, a situational analysis can occur. In 510, a budget analysis can occur. In 515, change orders can be done. In 520, the team can be managed. In 525, the support can be managed. In 530, the client and/or vendors can be managed. In FIG. 6, in 605, information can be gathered (e.g., organizational knowledge about the client and the team). In 610, the team can be analyzed (e.g., profitability, performance, best practice assessments). In 615, the professionals can be analyzed (e.g., professionalism, collaborative skills, skill sets). In 620, the client can be analyzed (e.g., satisfaction, break down of time). In one embodiment, a break down of the time spent in each area of the matter can be broken out by which client representative it was associated with, and how the professional involved rated that transaction and any issues of note. In one embodiment, as the data set grows, the practice heads can have an increasing depth of information at their disposal they can use for future job estimation phases of project staging. Models can also be developed for fixed pricing components of new matters and efficiencies which can allow further reduction of the cost of delivering a service. When the matter is closed, all activities and time against it can be frozen, and conclusive analysis of the success of the project can be conducted.

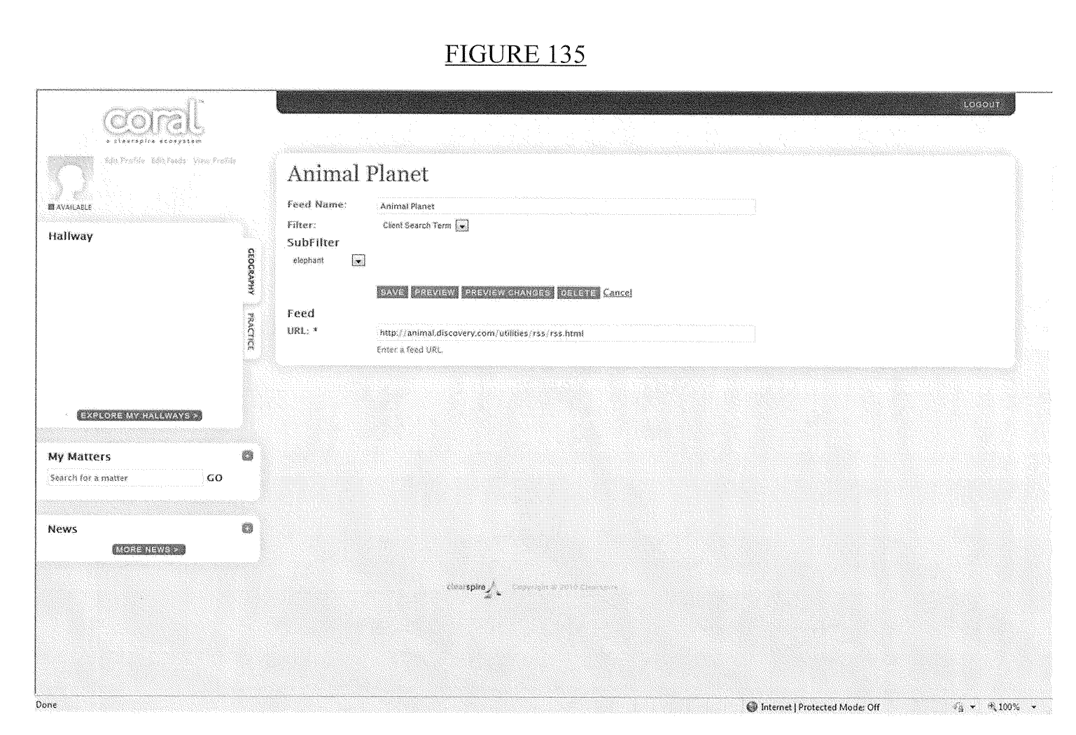

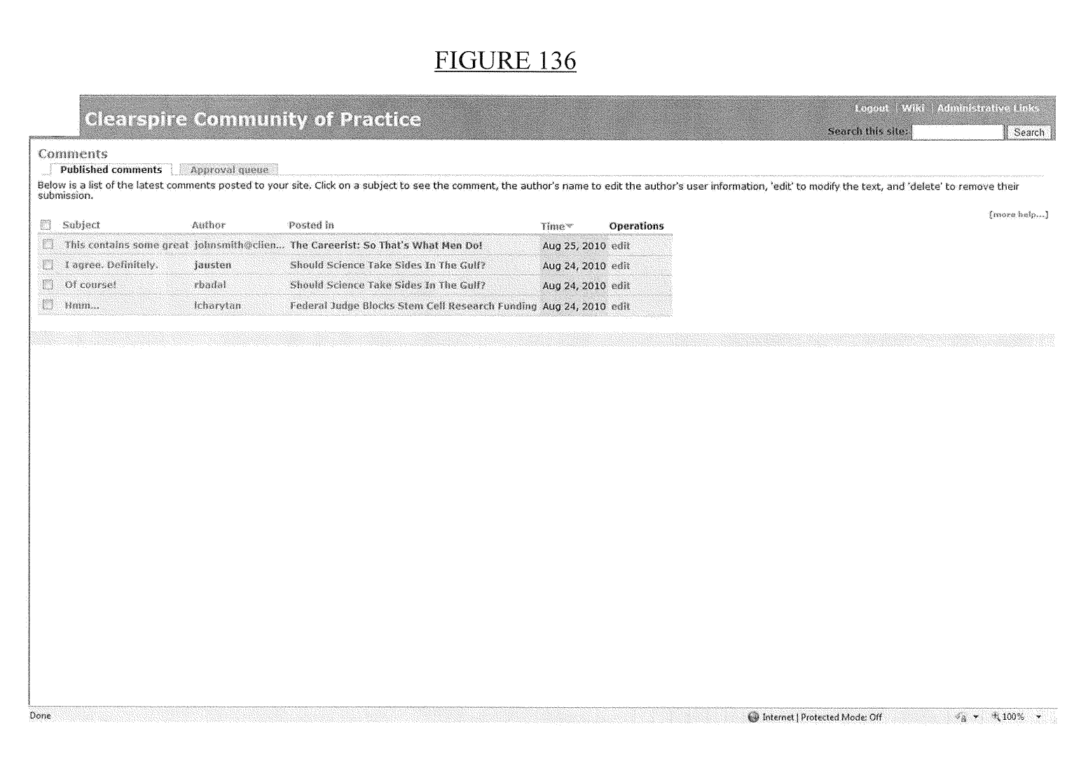

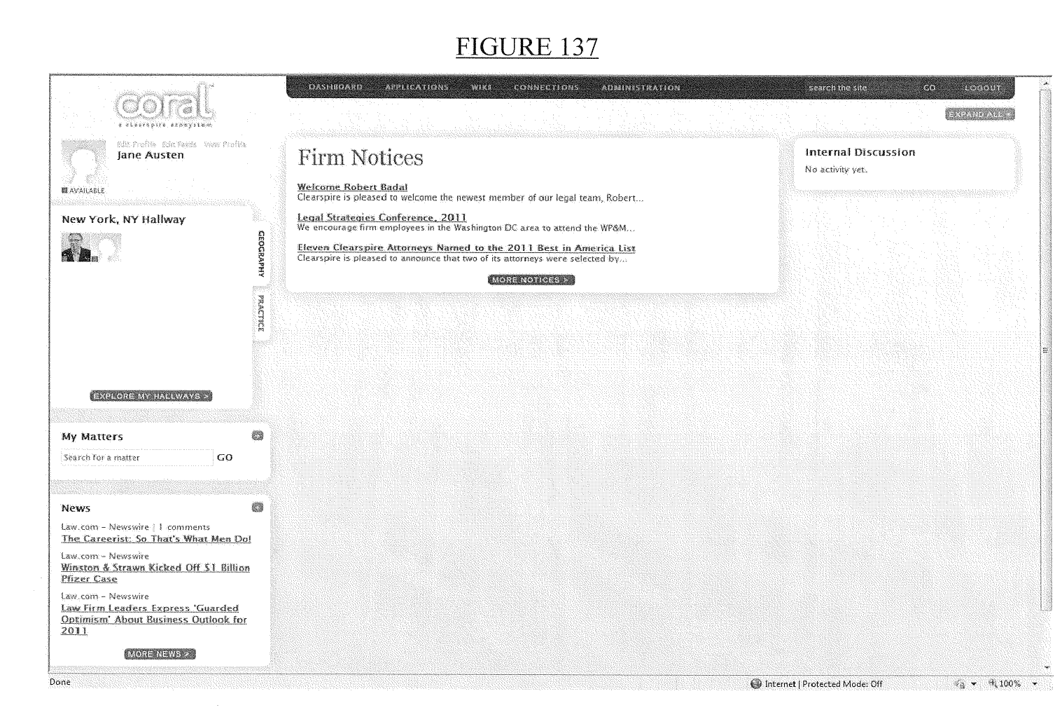

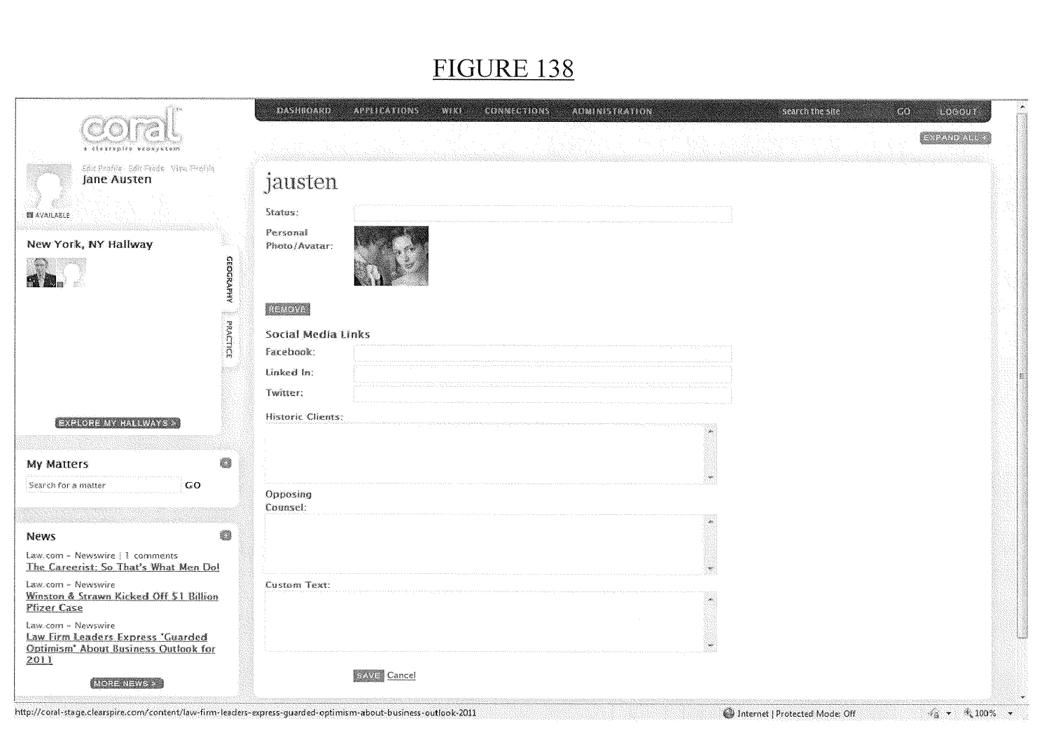

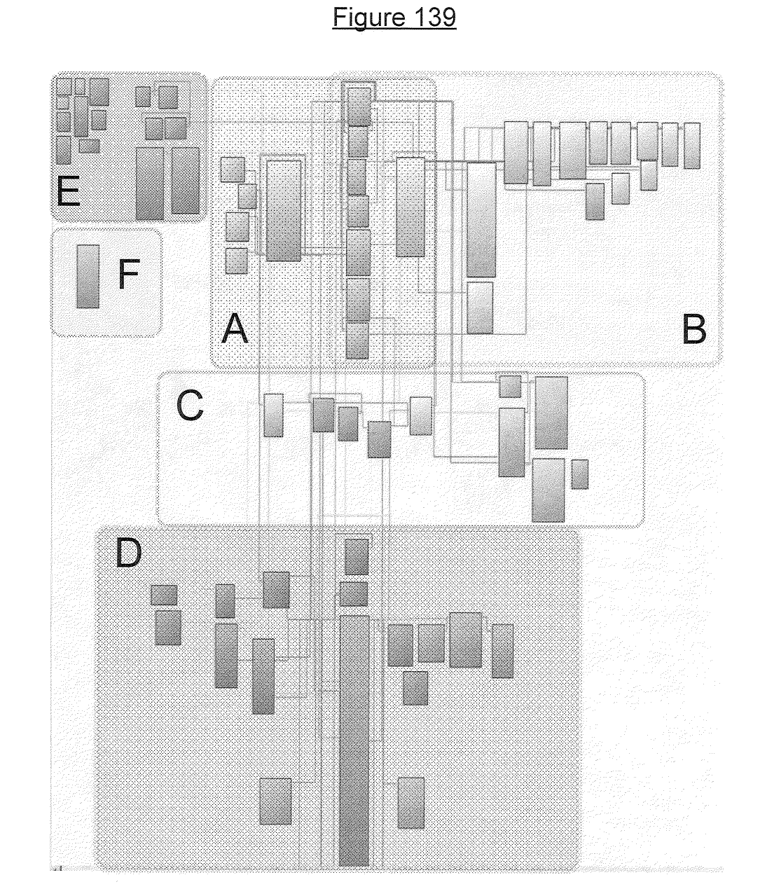

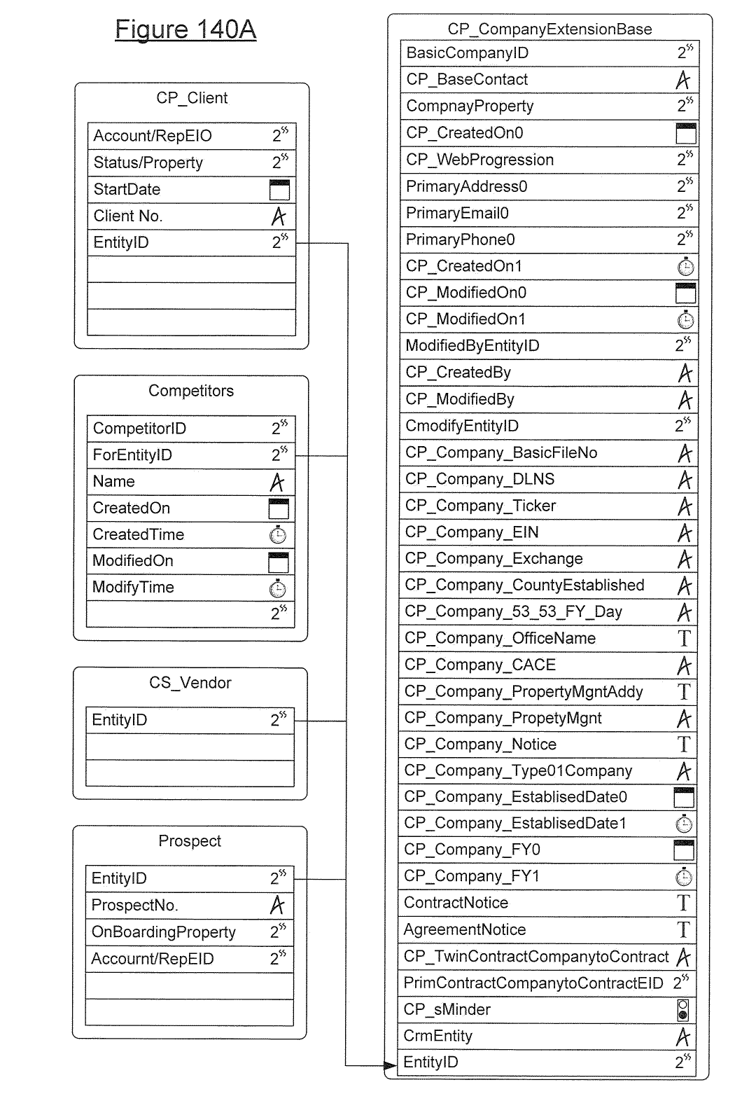

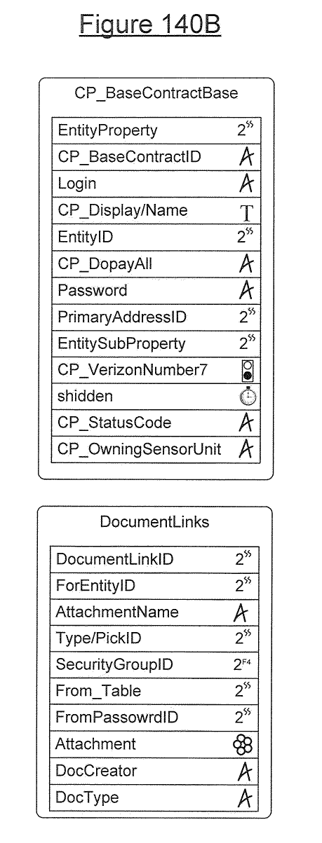

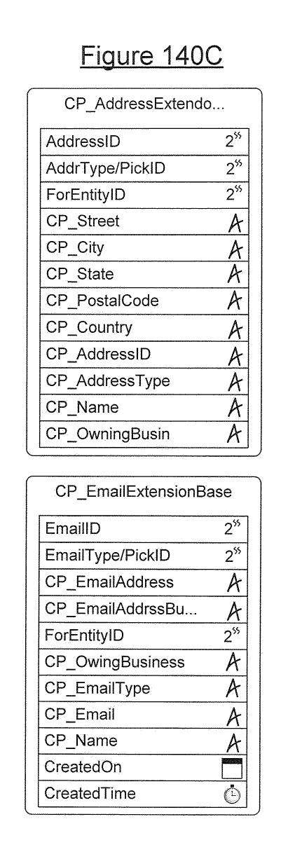

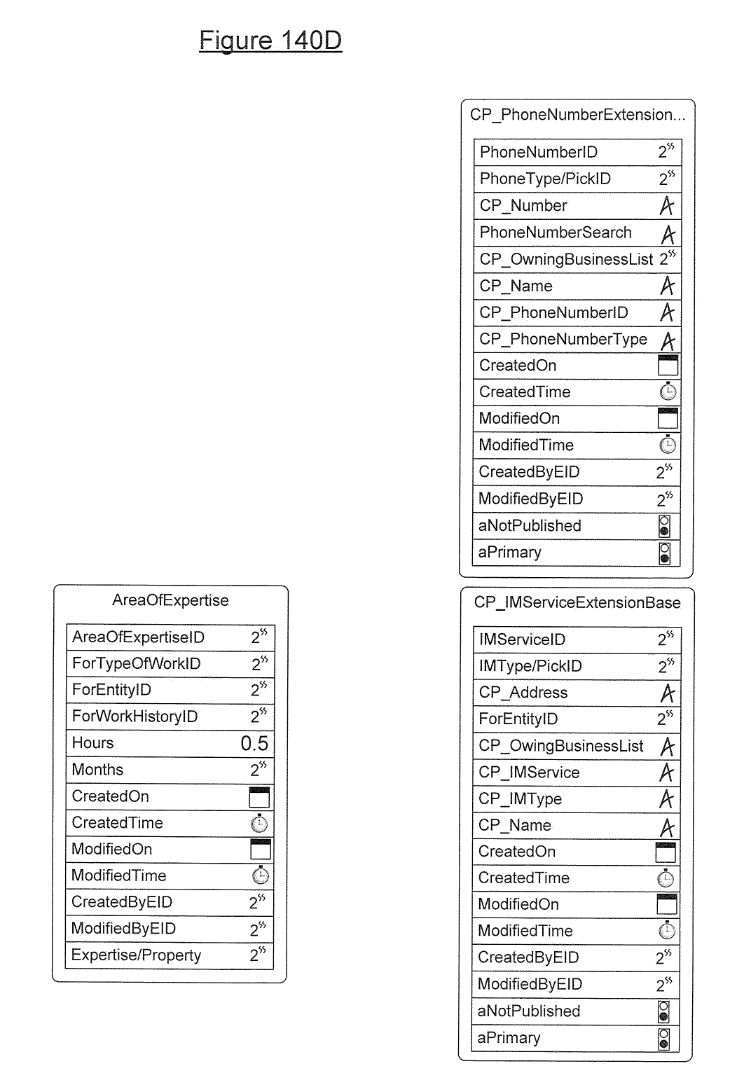

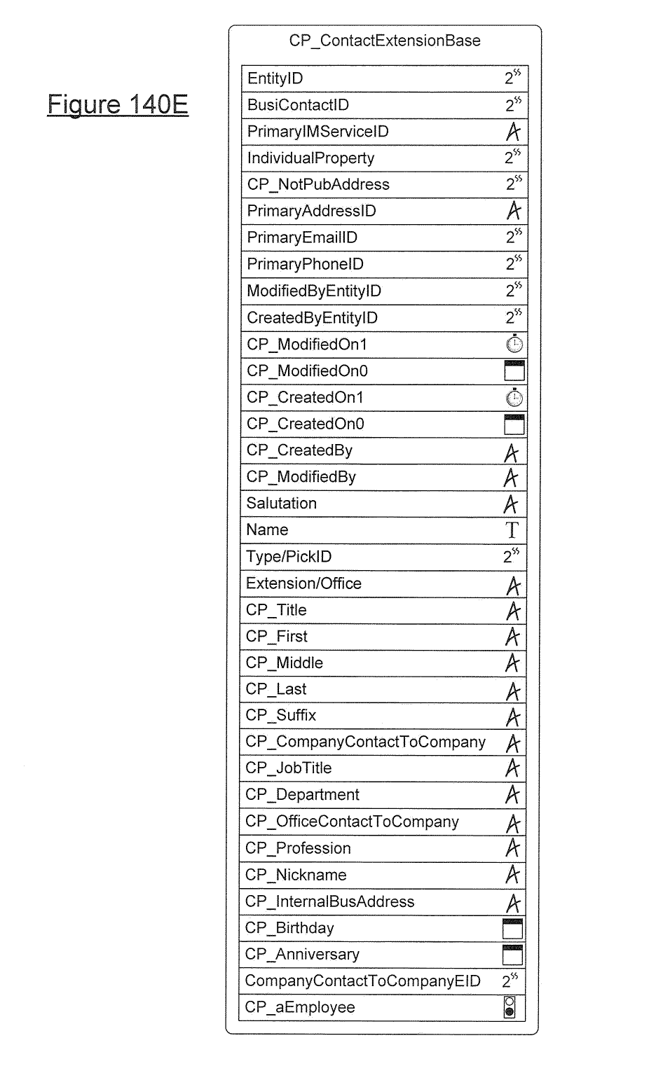

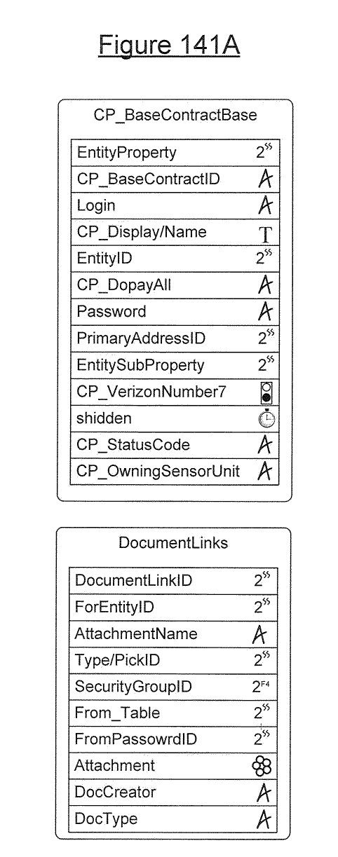

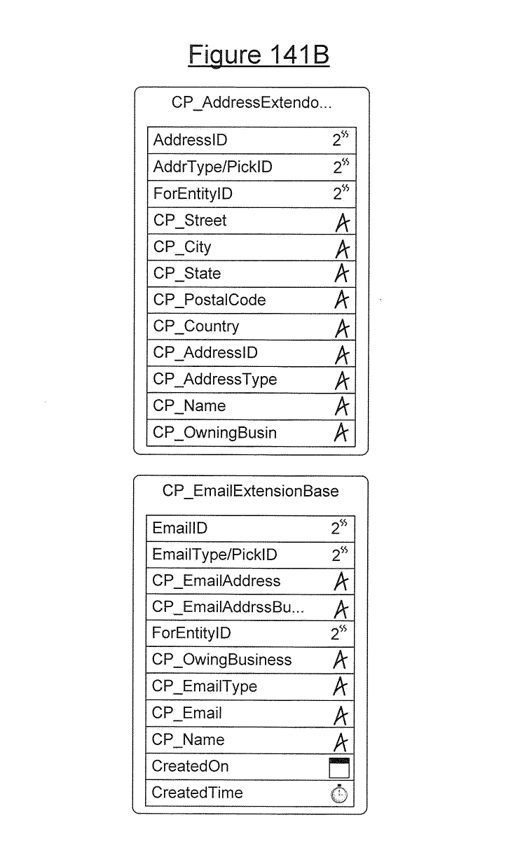

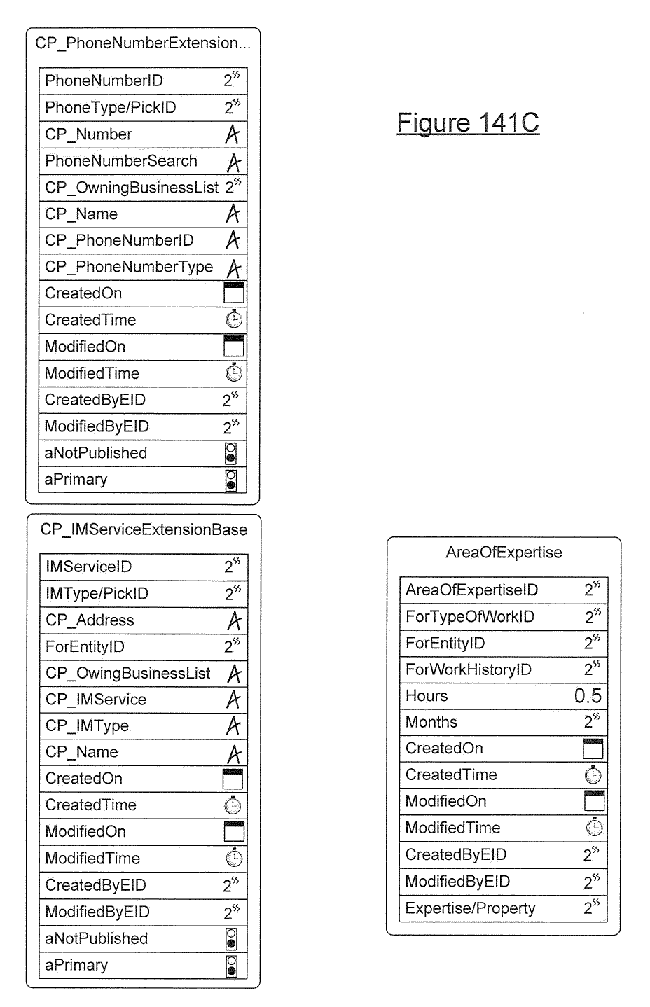

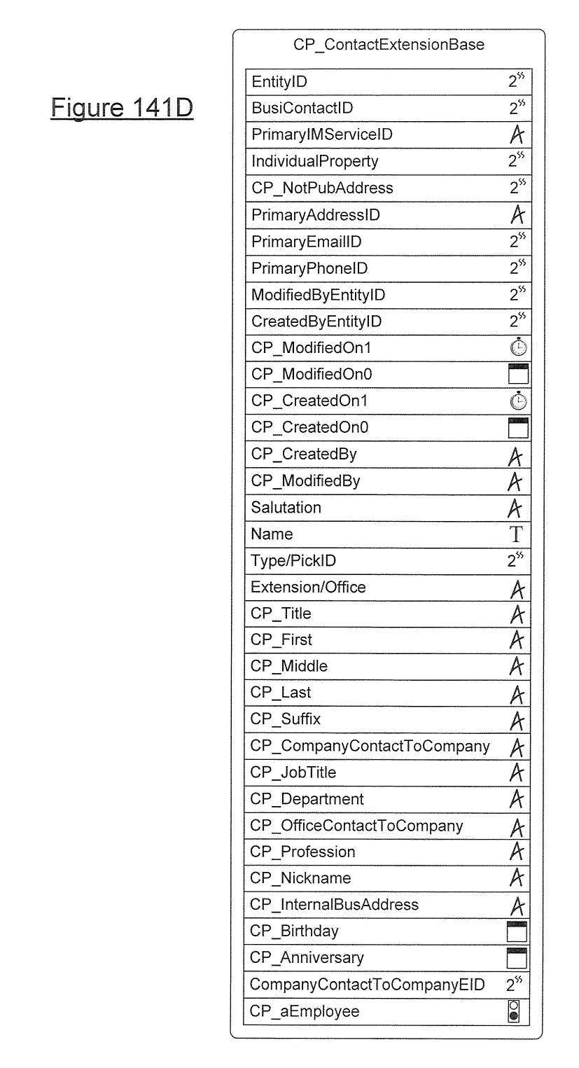

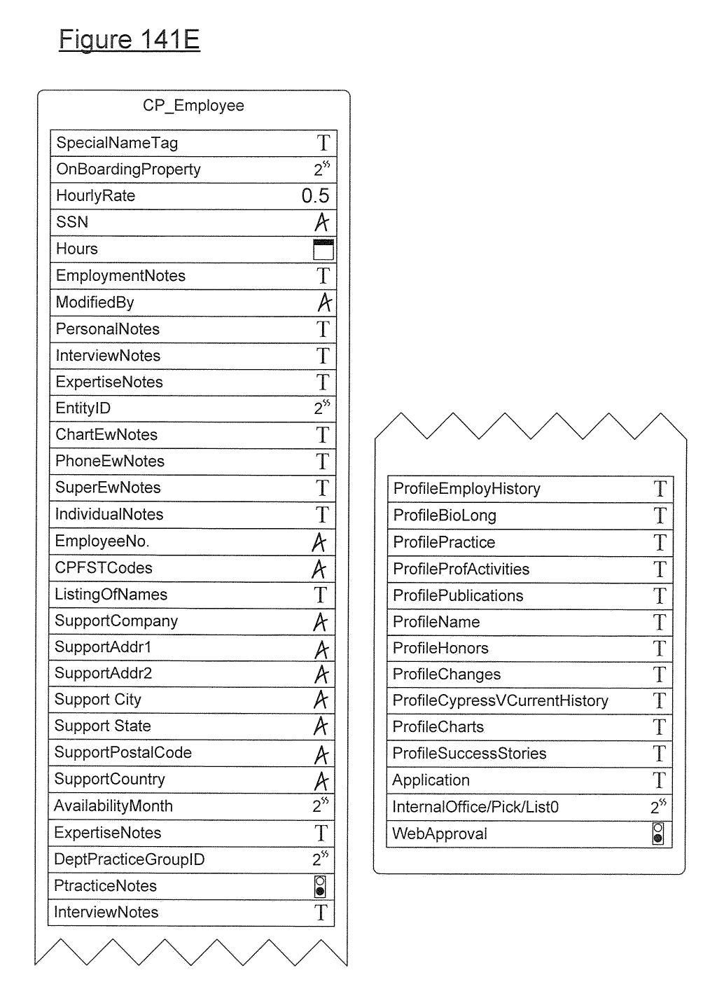

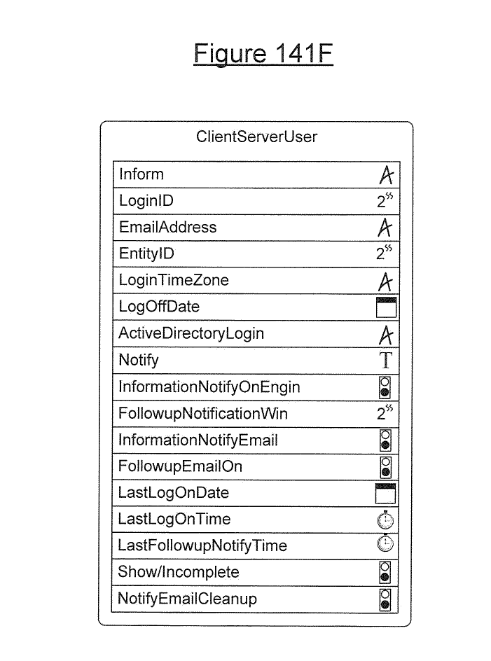

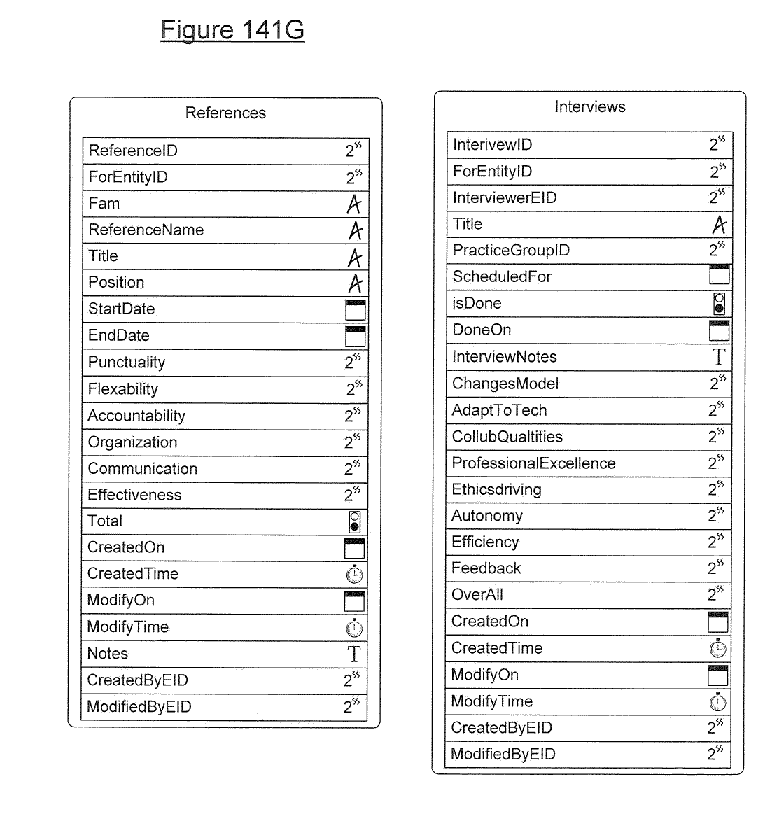

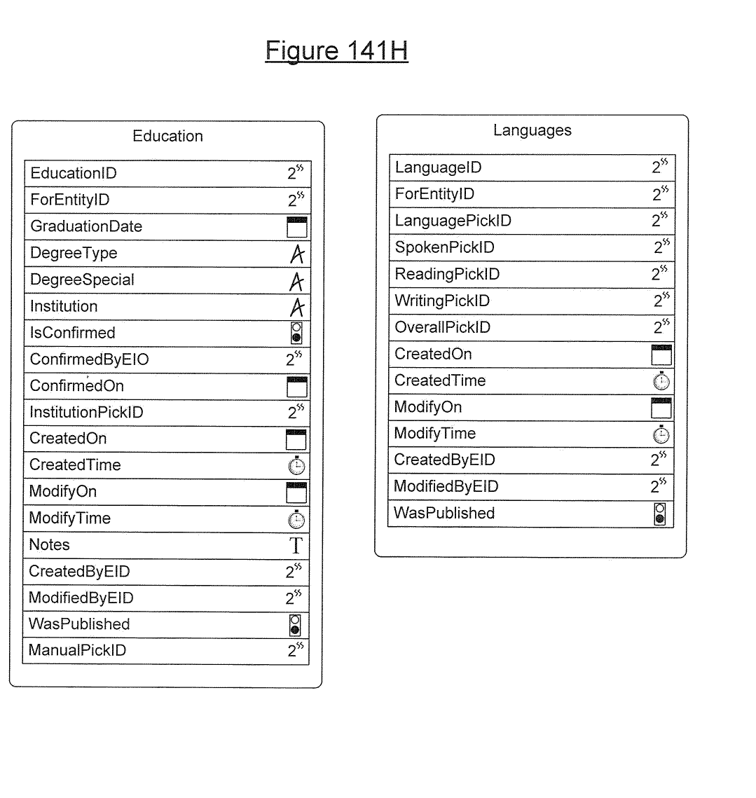

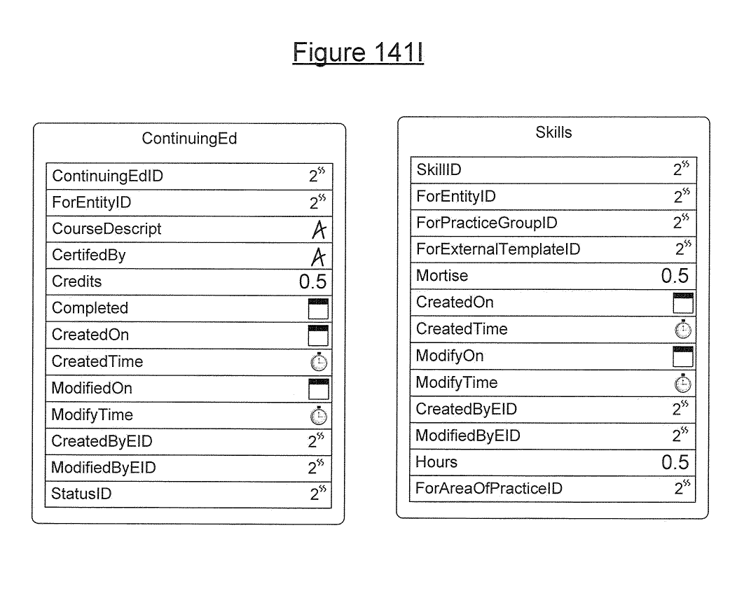

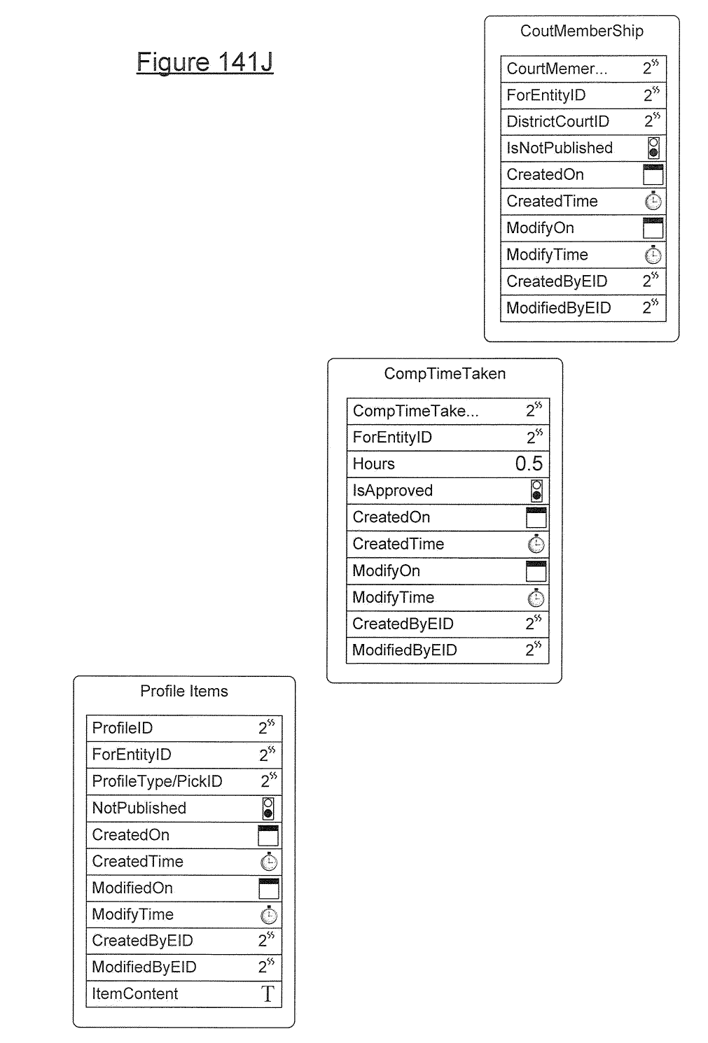

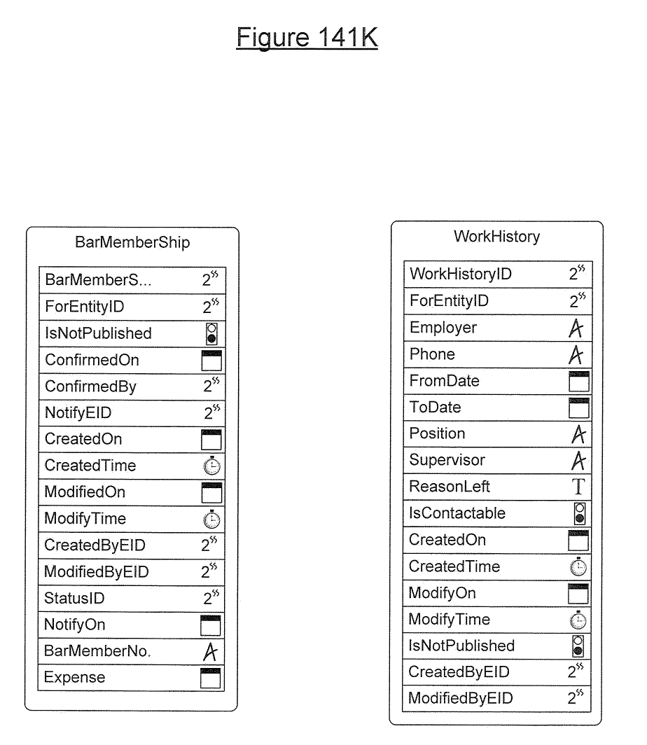

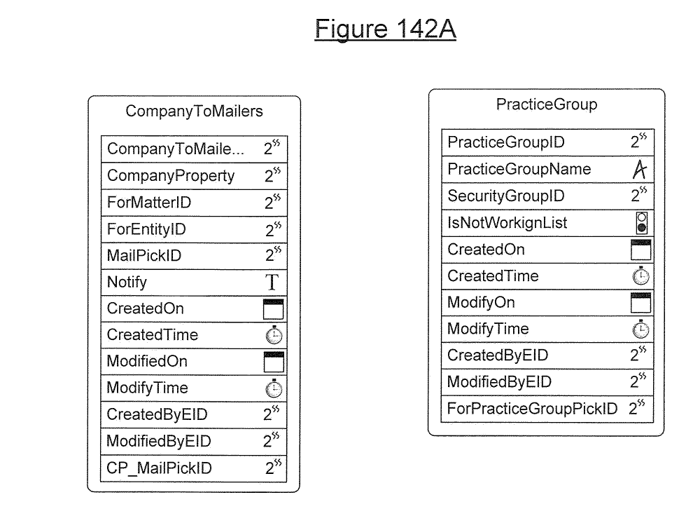

FIG. 7 is a flowchart illustrating details on matter closure, according to one embodiment. In 705, the matter closure is initiated. This could be centralized (e.g., via regular review of Matter activity) or initiated by an individual. In 710, a checklist can be reviewed before closing the matter. In 715, the matter status can be set to closed. All work product can be delivered to the client; all fees and expenses should have been received; all notes and work product can be purged; and practice head confirmation of closure activities can be done. In 720, the closure status can be pushed to all relevant applications. The closure process can help determine ultimate costs combined with performance of skills, and can thus help the budget projection and timely delivery of services.

It should be noted that the feel and presence of a brick and mortar environment of a large firm can be created in, for example, a web-enabled virtual space. A user experience can be provided that is simple and intuitive to professionals that are not familiar with virtual communities, while at the same time providing a rich set of powerful features for those that are. A layered interface can be provided where simple but useful features can sit on a top layer. Users seeking more advanced features can drill into deeper layers that offer more powerful features. Any combination of the following features could be provided: access to face book or linked in personal profile pages (including any combination of the following: portrait photos; video presentations; contact information; professional profile; articles published; personal list of links to resources; personal blog; participation rating); authoring tools (including some or all of the following: collaborative wiki pages; ability to post articles to home page where peers can enter into comment threads and dialog in chats and other media; personal/private group/public blogs); chat rooms by area of practice; logged in users displayed and grouped by current and past team members and areas of practice with the ability to invite to private and group chats, text audio and video, and email instant messages and tweets; new company members with synopsis of interest and expertise; employee of the month and featured employees; document repository (e.g., non wiki, to use for posting self authored, coauthored, and articles of interest; can be attached and viewable as a part of an individual's profile and site catalogues by topic, searchable by keyword); forums integrated with listservs by area of practice; micro sites (e.g., set up by community members for a specific area of interest); general event calendar for the company; virtual and physical meetings; a company wide group blog where all employees can post events, photos. In one embodiment, all areas of activity would be filtered by the user's login so that no tool or content that is proprietary or confidential would be exposed to the public or clients.

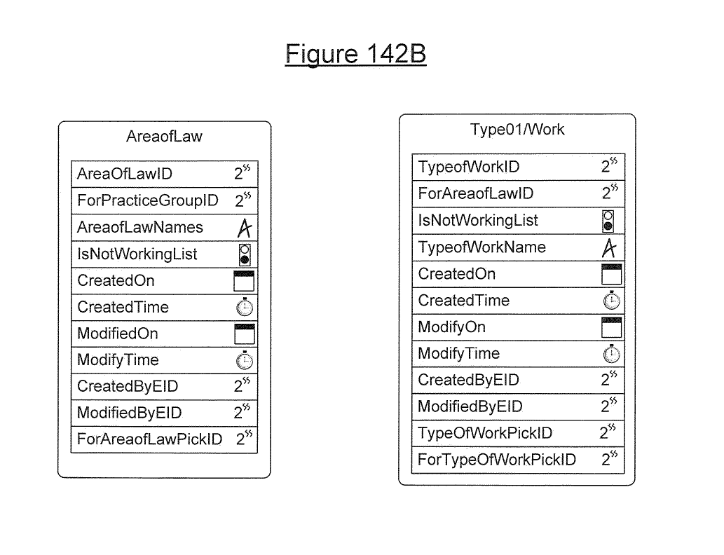

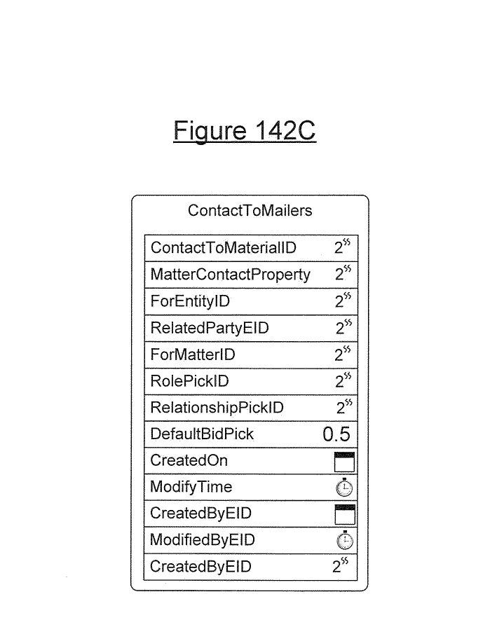

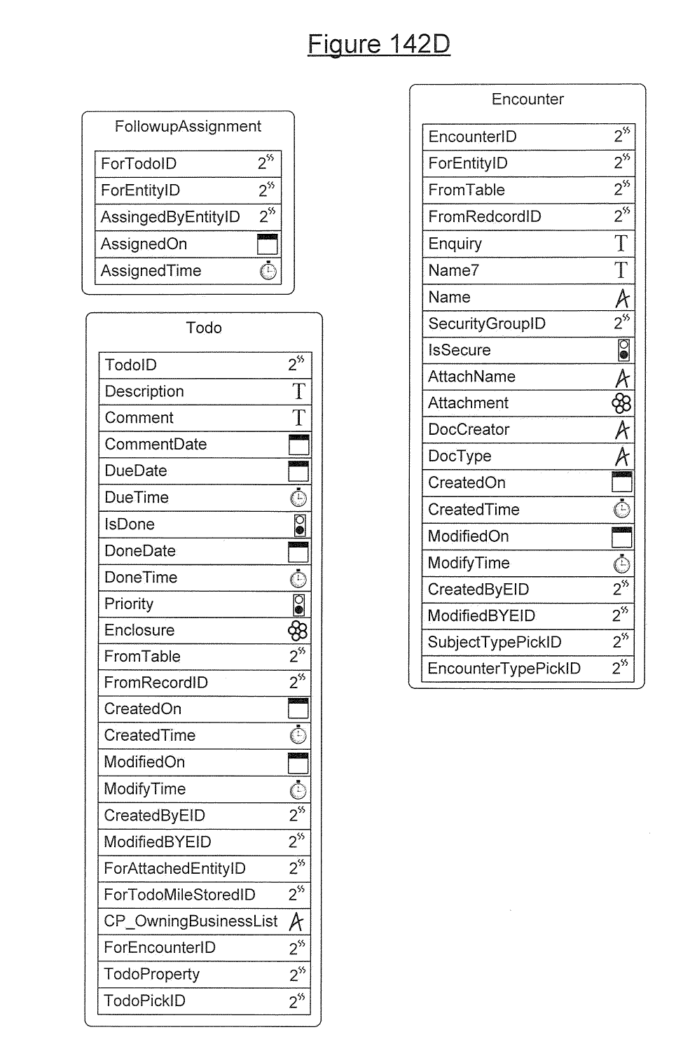

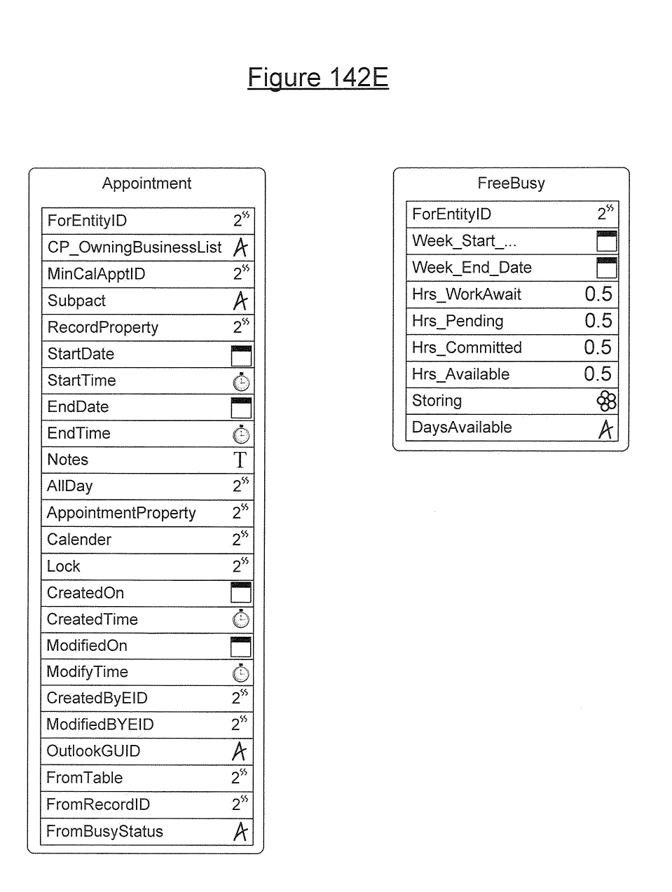

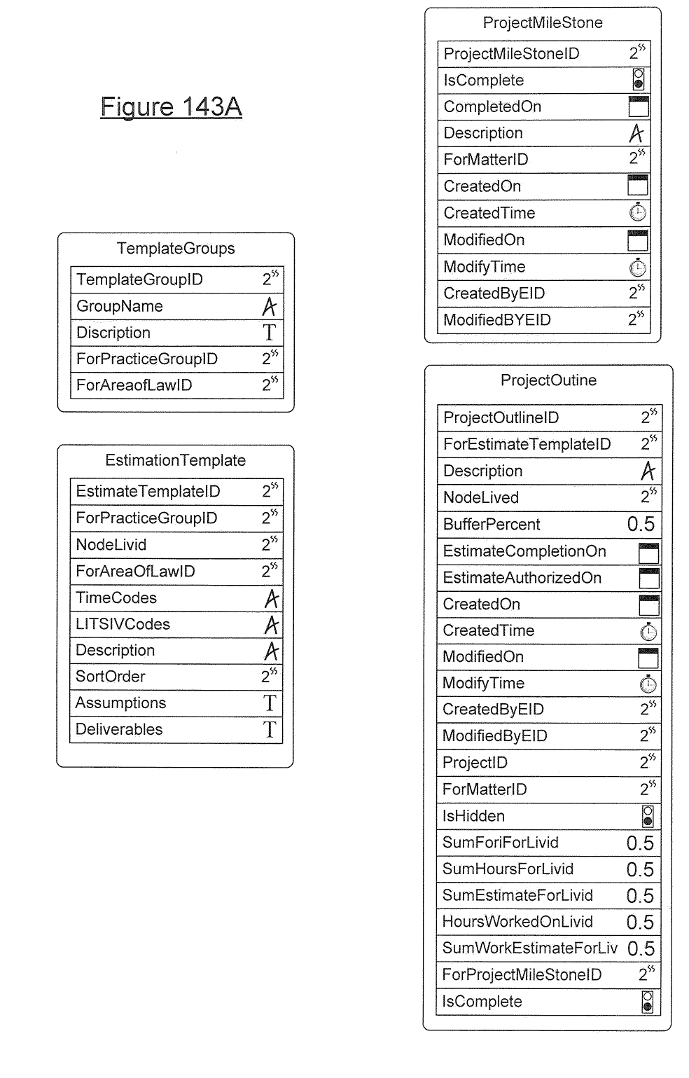

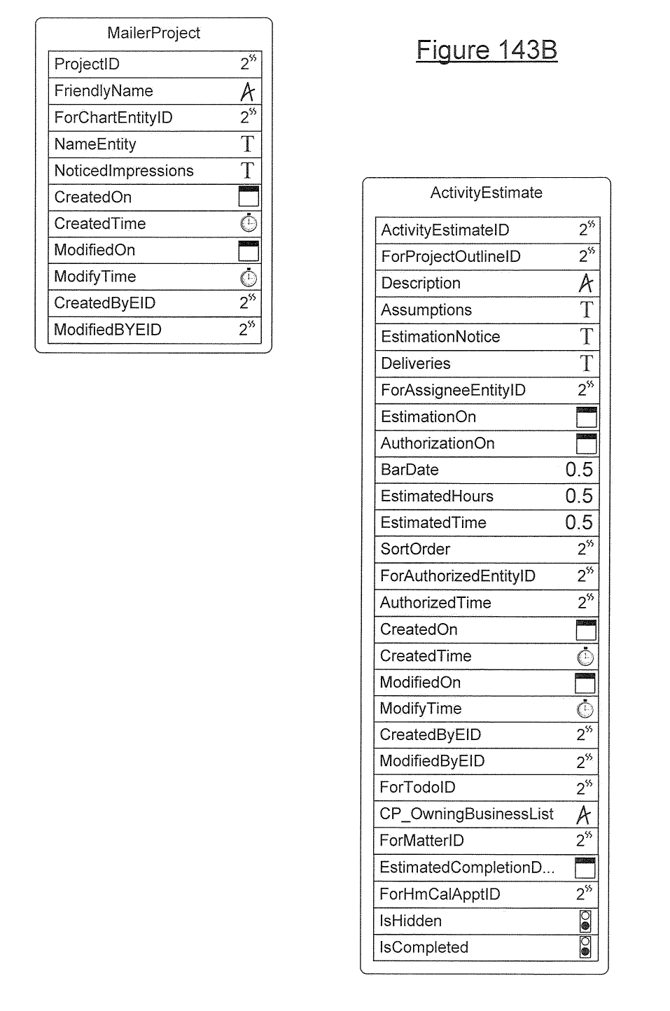

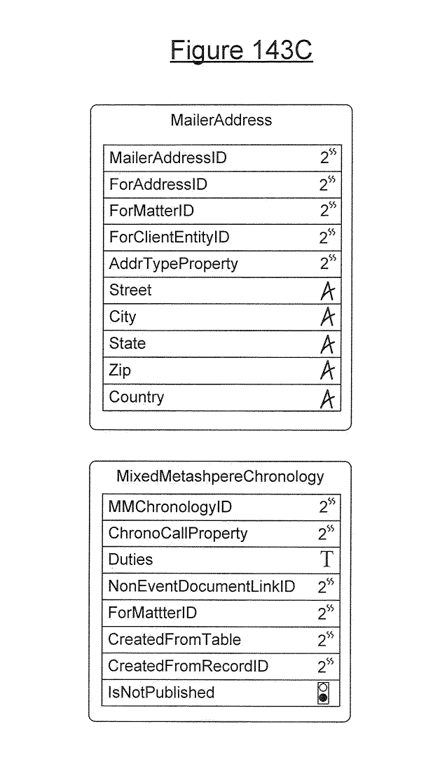

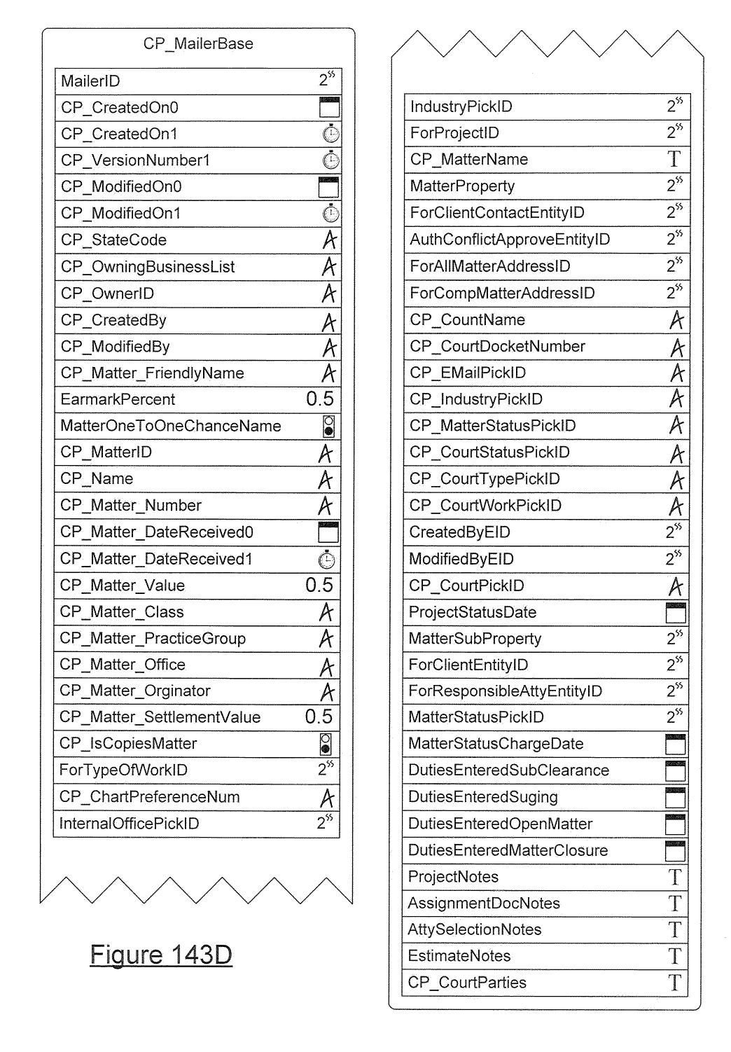

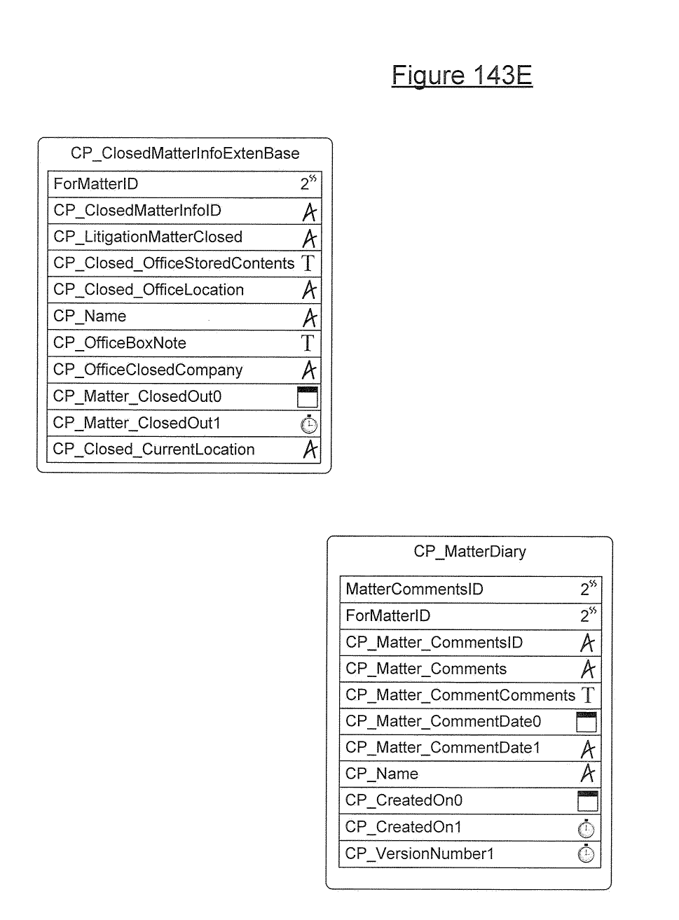

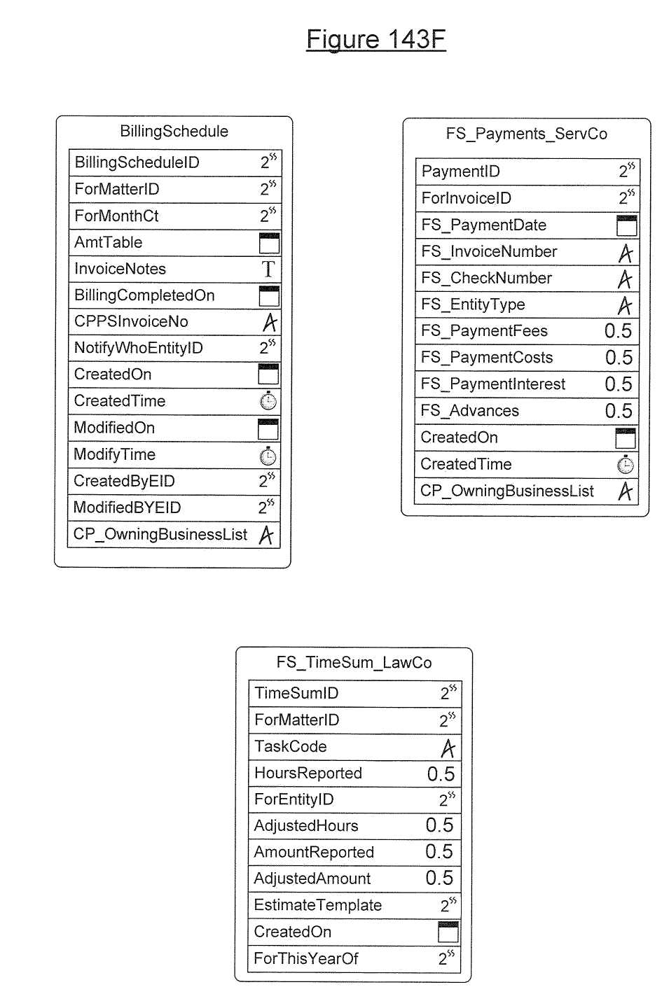

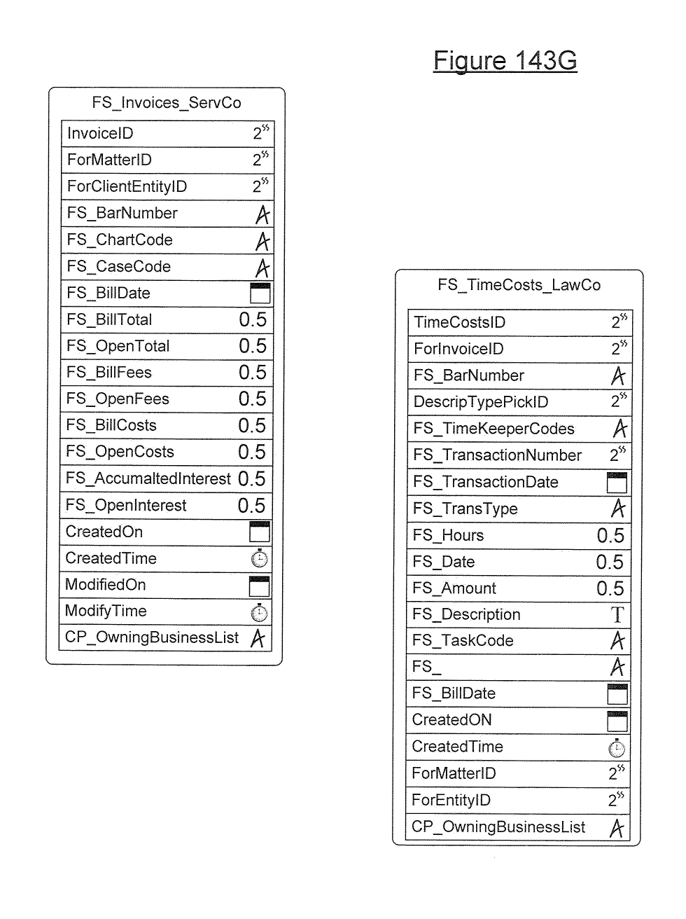

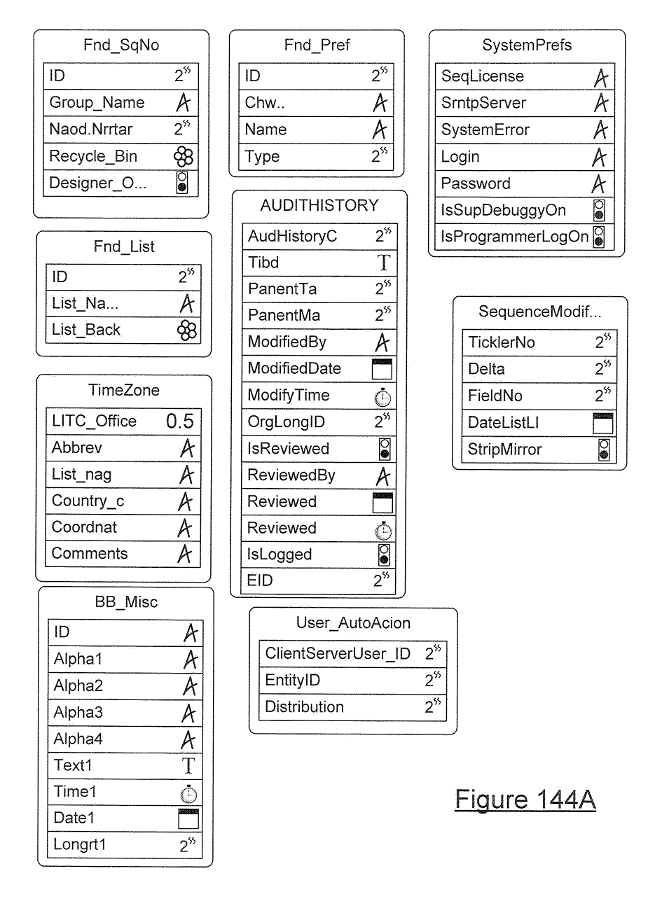

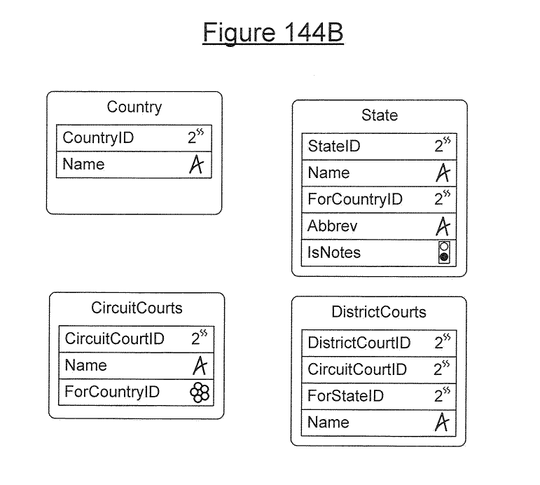

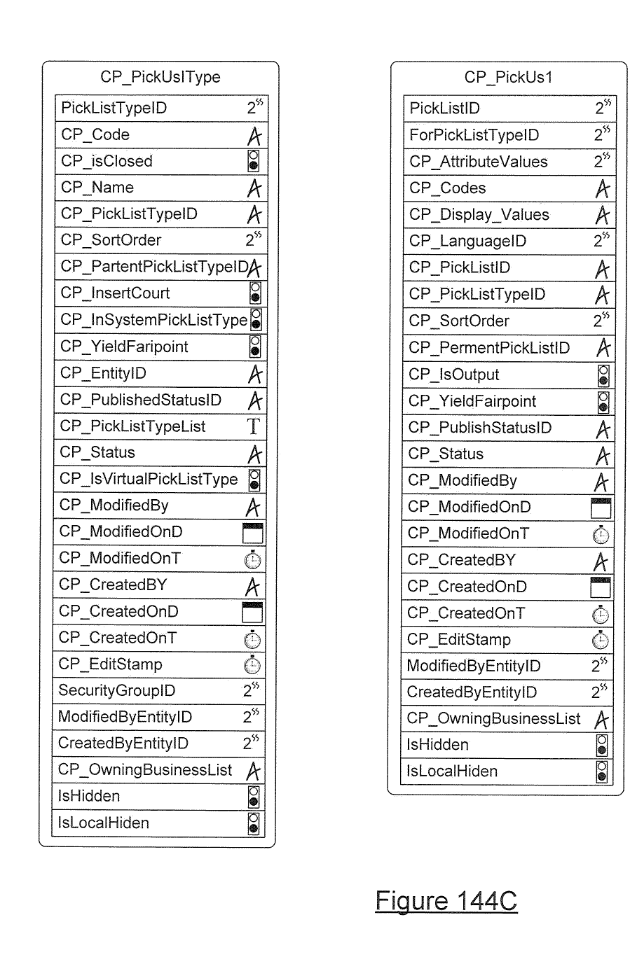

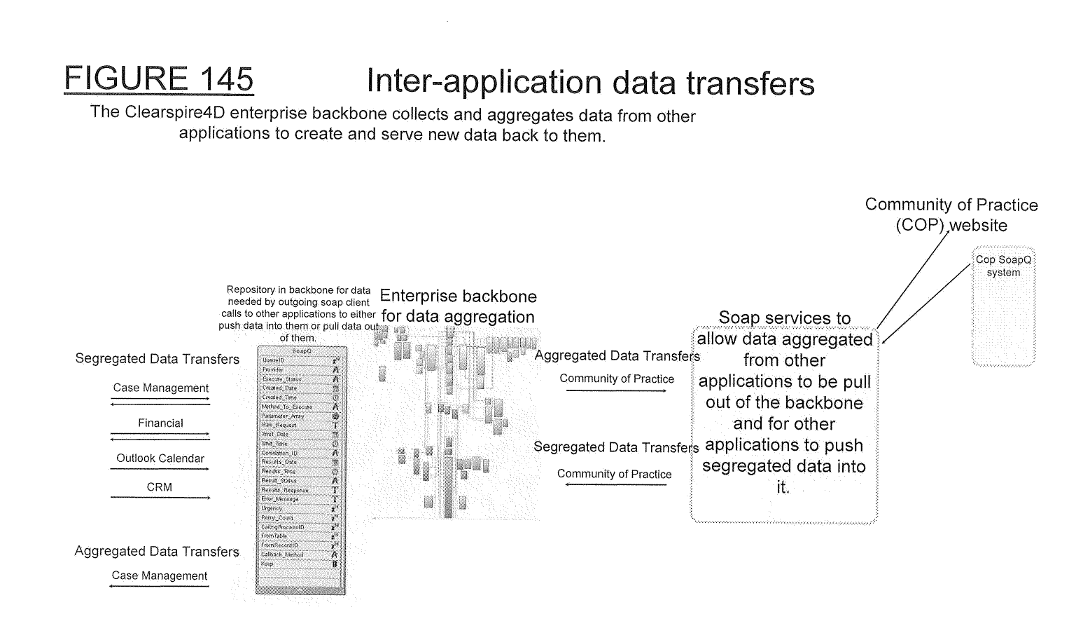

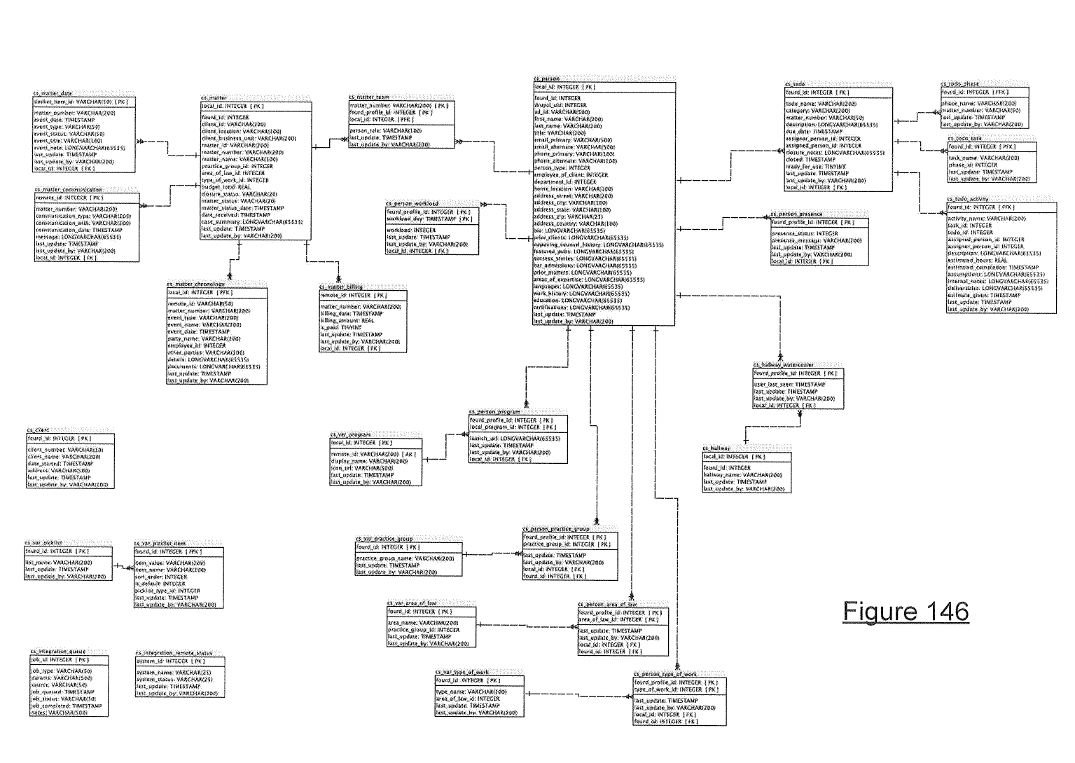

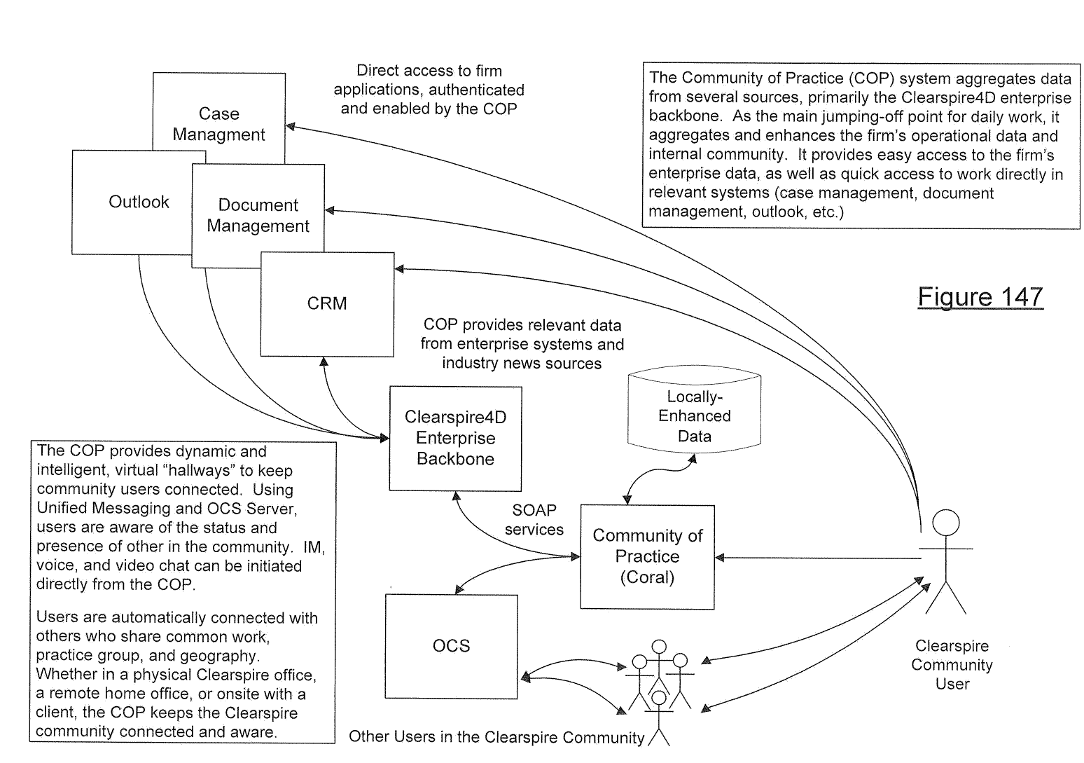

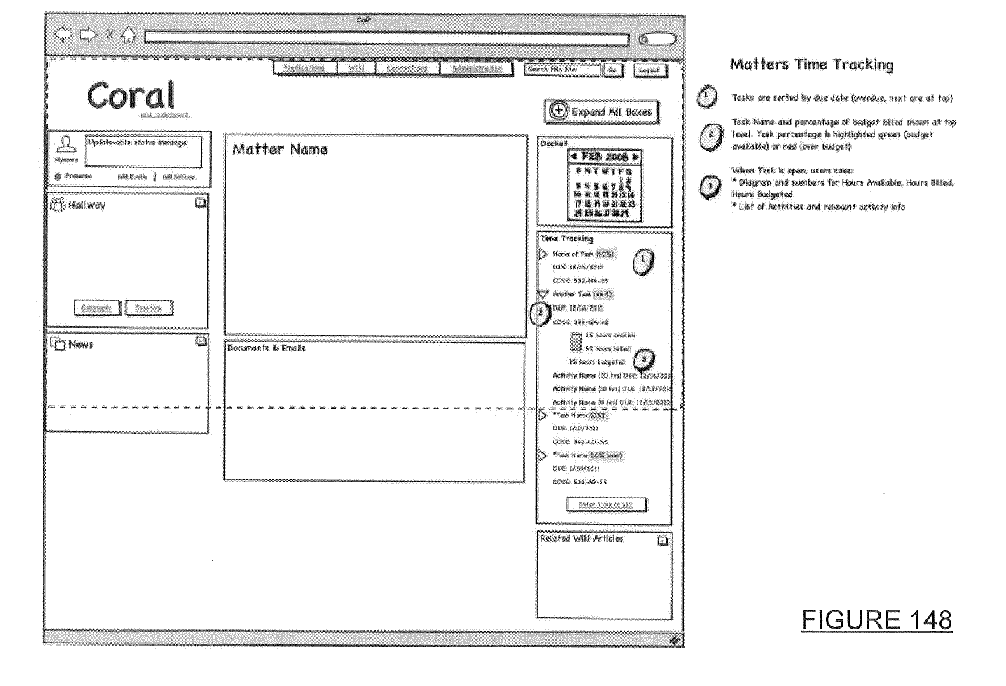

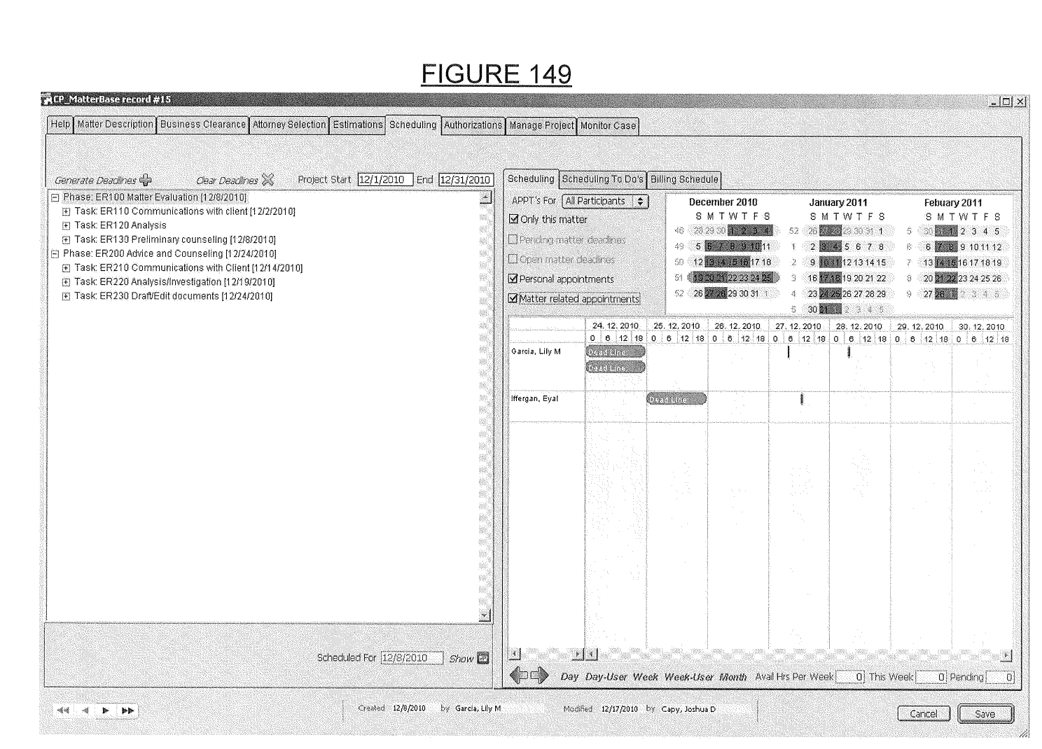

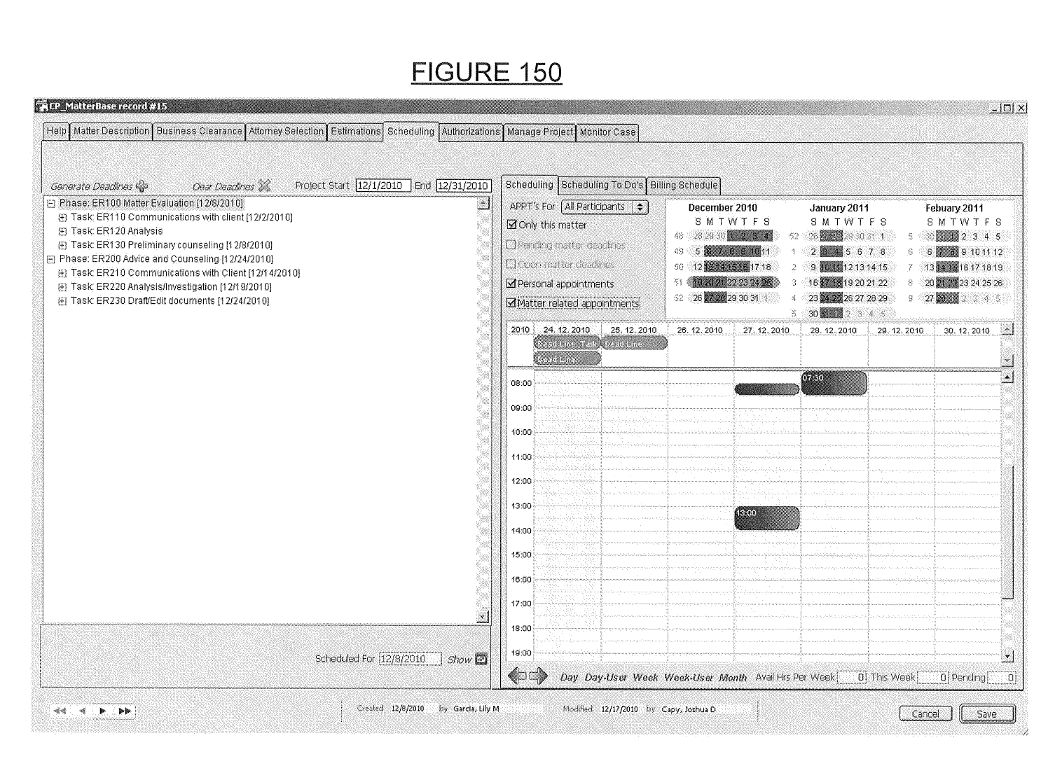

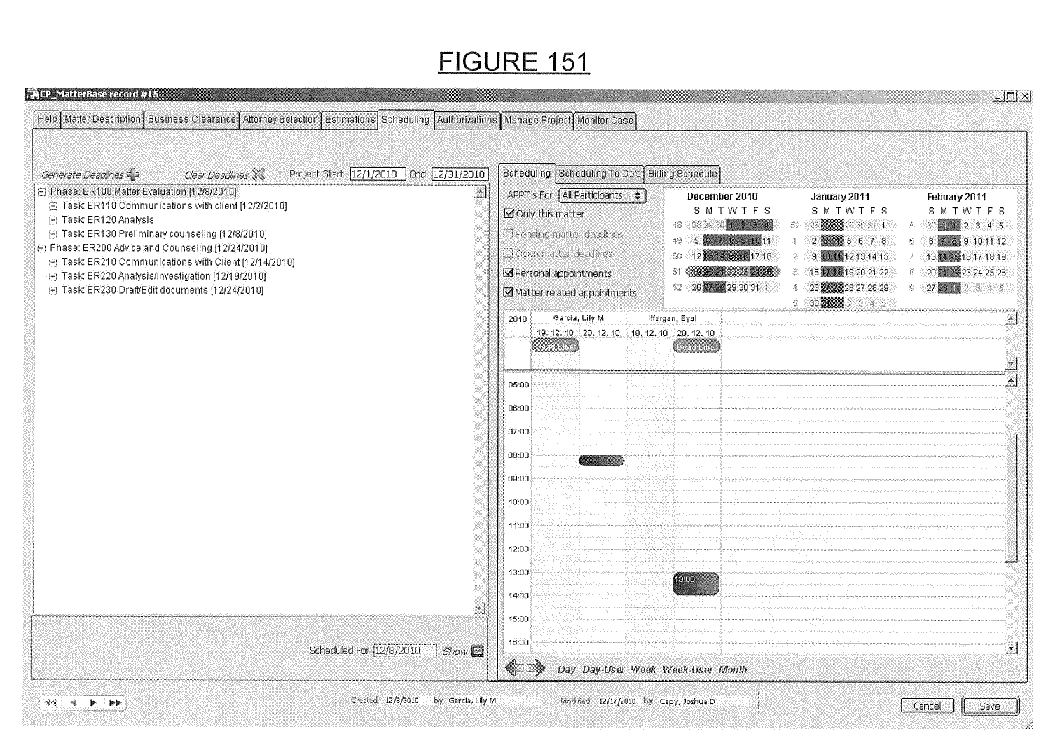

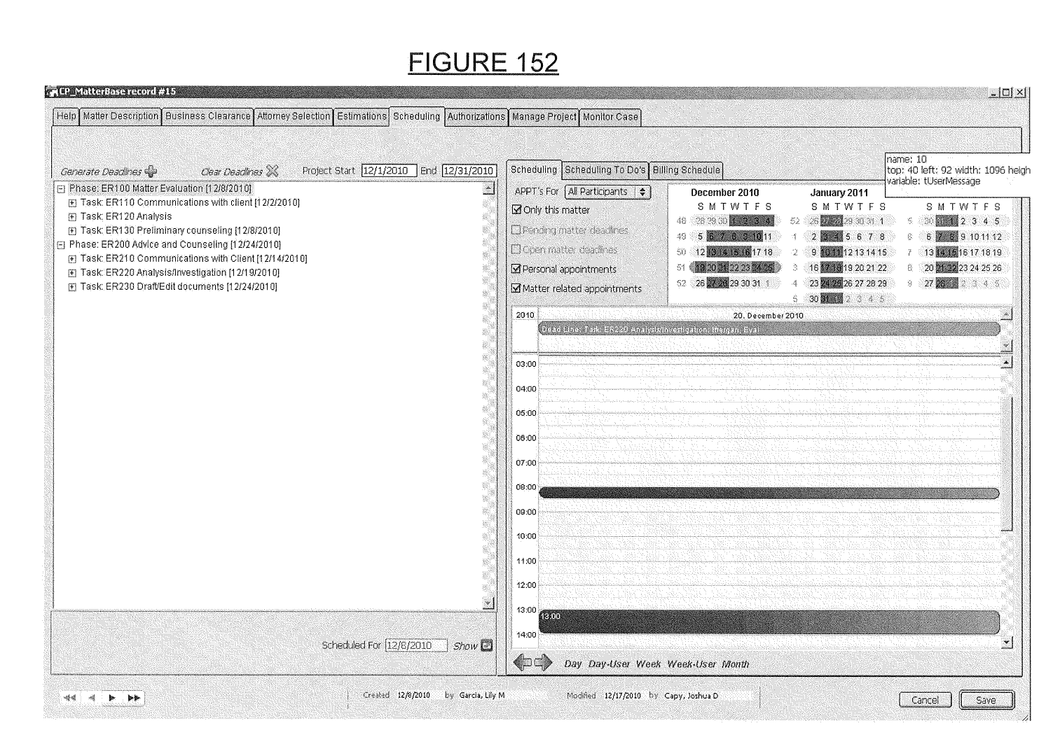

FIGS. 8-140 show screen shots illustrating the above features, as well as many others, according to multiple embodiments. FIGS. 8-9 illustrate an example of a landing page, according to one embodiment. The landing page can be the main operational window for professional individuals, and can provide an access point for: current/active matters; a virtual hallway which can provide an always present presence application; applications (e.g., MS Office, Outlook and other practice tools); searching (e.g., Enterprise Search); Newsstand with custom “newspapers” created from internal and external information feeds (e.g., blog RSS feeds, Twitter feeds, etc.); user defined screen space reserved for users to configure various widgets, weather, stocks, etc.; space for internal communications, such as firm fixed (e.g., internal) feeds (e.g., new employees, HR updates); internal discussion so users can monitor internal updates and conversations; or administrative links such as links to the accounting, human resource, or marketing and other administrative functions of the firm; or any combination thereof.

FIG. 10 illustrates an example of another landing page for administrative staff individuals, according to one embodiment. The staff landing page can be the main operational window for staff, and can provide an access point for: always present presence application on hallway; applications (MS Office, Outlook and other administrative and practice tools); Enterprise search; user defined screen real estate reserved for users able to configure various widgets, weather, stocks, etc.; reserved space for internal host communications from new employees to HR updates; administrative links to accounting, human resources, marketing and other administrative functions of the firm.

FIG. 11 illustrates an example of a client landing page, according to one embodiment. The client landing page can be the main operational window for clients, and can provide an access point for: matters relating their company; restricted access to internal presence tools using a virtual hallway; host/client team/co-entity information (e.g., rolodex type information on individuals key the client engagement); selective newspapers (e.g., news feeds will be restricted); work product access; marketing area (e.g., can show where host personnel or practices the client may not yet be using are highlighted and recommended (e.g., such as by Amazon) based on various criteria); or Wiki content so that the client can follow various Wiki conversations on topics of interest to them; or any combination thereof. In some embodiments, email alerts can provide new items/changes to clients until they get accustomed to visiting the Client landing page on their own.

FIG. 12 illustrates an example of a my matters page, according to one embodiment. The my matters page can include all related matter information a person might need. In one embodiment, only matters related to a particular authenticated user can be displayed. With the case management database driving the page formation, all related information can be filtered to pertain to just the matter being viewed. Examples include work product (e.g., documents, emails, etc. in the document management system), docket information, the new feeds, internal and external rolodex information and employee (and perhaps client) presence.

FIG. 13 illustrates an example of search results, according to one embodiment. A search term can be entered and any client/matter document with the search terms in it, or otherwise related as defined by a search term administrator, can be found.

FIG. 14 illustrates an example of user profile page search results, according to one embodiment. The hallway illustrates geographic context on the page. A professional marketing photo(s) can be shown. A user's personal photo (e.g., Avatar) can be shown. A contact card including a user professional marketing photo can be shown. Social networking icons (e.g., if the user has a profile at the various networking sites) can be shown to link the user to the various social networking sites. It should be noted that content from the social networking sites can be pulled in from the public site(s) and/or from links to the public site(s).

FIG. 15 illustrates an example of a user workload page, according to one embodiment. Information about an individual's availability and suitability to do work can be located here. A first and last name and specialty (e.g., practice group, area of practice) and location can be listed. Work availability restrictions (e.g., time zone, part-time status, lifestyle departures) can be available to the internal use. A weekly fuel or gas gauge can indicate how full a person's workload is/was. The option of including an extended forecast tool may also assist with planning. A hallway, my matters information, and news can also be shown.

FIG. 16 illustrates an example of a user wall page, according to one embodiment. The user wall can illustrate activity of the user. For example, the user name or real name of a person and what they did (e.g., commented on an article, changed their status, updated their workload) can be listed along with the time they did it.

FIG. 17 illustrates an example of a hallway page, according to one embodiment. Users may view one hallway type (e.g., global, geography, practice) at a time in one embodiment. A hallway can always be present and easy to get to. A hallway can reinforce the individuals that are working together, enhancing bonds and building the community. The hallway can track employees (and clients, to some extent). Availability can be set manually by the individual, or a unified messaging and presence system can automatically read their status via calendar appointments or when the phone is used.

In one embodiment, headshots can be utilized in the hallway, and different icons can be used to indicate various ways a person can be contacted (e.g., email, phone, video phone). The “presence” of a person can be indicated by: whether the person is on the phone, whether the person is on the computer; whether the person is in a meeting by calendars, or any combination thereof. In calendaring, detailed electronic calendaring can be required of users. Reoccurring lifestyle events (e.g., marked private in some embodiments) can be used to indicate unavailability. Additional presence states can be included. In some embodiments, the ability to manually set an individual's status can be allowed.

In one embodiment, email messages, voice mail messages, or facsimiles, or any combination thereof can be pushed to an inbox. Those of ordinary skill will see that many other types of technology can be included.

A hallway can illustrate a physical office, meeting in the hallway and/or around the office water cooler. The hallway can be present and easy to get to.

A global hallway can be a presence indicator. Floor plans can be used for each physical location the host opens. Each practice area can be represented. Employee presence information does not need to be present at this level. A nexus and/or headquarters hallway can represent a certain office (e.g., Washington D.C.) as both a location for professionals, administration and a nexus of commonality for the potentially far flung virtual workers. Availability of individuals, administrative functions, etc., would be shown via the floor plan model. Virtual windows, powered by web cams, could show both internal and external views. Internal web cams would be restricted to clearly public areas, such as the reception area. A common connector (e.g., host logo, coffee mug, water cooler) can be used as a reference point for all employees. This common connector, much like google logo or the igoogle themes, might change periodically based on the seasons, holidays, weather, special events, etc. Ideally this will drive people back to the nexus to what's new. External windows could be provided by host web cams or be powered by many cloud-powered web cams. They might show actual weather or traffic conditions or special sites of the city.

A practice area floor-plan hallway can show members of a certain practice group (e.g., maritime). Potential windows in this view could be to any number of practice themed shots.

In other embodiments, users can view multiple hallway types. Hallways can be listed in alphabetical order, or can be listed according to importance or priority. In some embodiments, the Nexus location can be listed below. Active or zoomed in hallways can have multiple pages and/or screens, such as, but not limited to: water cooler which illustrates users who enter the water cooler and indicate an availability to “chat”; a themed and/or branded image; web cam snapshot and/or link; or any combination thereof. An alphabetical screen can show users with last names in the letter range. Users can filter the active hallways by practice or geography. For example, if the user is viewing a geographic hallway, the user may filter all geographic hallways by practice area. The default filter can be in the user's practice area or geographic area, depending on which hallways are being viewed.

FIG. 18 illustrates another example of a search result page, according to one embodiment. From this search result page, a user can research and limit their search results to a specific type of content (e.g., view only searches within a certain application). Results can be sorted by relevance.

FIG. 19 is an example of a connections page, according to one embodiment. A geographic hallway can be shown. Connections can indicate the connections of a certain person to other people. A user can follow or unfollow any host employee here.

FIG. 20 is an example of a wiki page, according to one embodiment. A wiki article can be associated to a matter via a matter ID. A wiki page can include any content/links to other wiki articles. Recently updated wiki articles in reverse chronological order by updated data. FIG. 21 illustrates a wiki editor. Users can enter a matter ID to have wiki articles show up in the context of a given matter.

FIG. 22 illustrates a news page, according to one embodiment. A user can favorite an article from here. Users can filter which articles they're viewing using the checkbox fields and update button. Actual checkboxes are not required, and could be highlightable in another way. In one embodiment, news pages can be dynamic and intelligent and can promote news to a particular user according to the user's background, current client list, current matter lists, etc. FIG. 23 illustrates a quick link to jump to a comment entry box. Comments can be threaded in some embodiments.

FIG. 24 illustrates an administrative page, according to one embodiment. The administrative page, which can represent the various administrative groups of an organization, can include a library page, an accounting page, a marketing page, an IT page, a training page, a project management page, or a human resources page, or any combination thereof. A user can switch to other pages of the administration page, using a subnavigation bar. The library page can include a link to other pages, tiles, wiki articles, or links, or any combination thereof.

FIG. 26 illustrates firm fixed feeds firm notices), which can be sorted (e.g., in reverse chronological order). Firm fixed feeds can be archived and paginated. For example, corporate news can be reported and distributed to the entire community. Users can also receive email alerts as new information is published.

FIG. 27 illustrates an applications list page which can open when a user clicks on the applications navigation button at the top. All of the applications supported by system 100 can be shown on the applications page.

FIGS. 28-29 illustrate a to-do page, according to one embodiment. A view for an activity tree (which should automatically set to the associated matter being worked on) and a full list of to dos with due dates/overdue dates for all to do items can be shown. An icon label for the to do item (e.g., estimate category) can go here. Clicking on the name of the activity will highlight it in the right side activity tree to show the full content. Hovering over an icon (e.g., email, phone) can show relevant date/link in standard style paper. An estimated completion date is optional. The assumption notes, estimate nodes, or a deliverable text field, or any combination thereof can expand when clicked. A conclusion text area can be editable.

FIGS. 149-154 illustrate matter management pages, according to several embodiments. FIG. 149 shows a scheduling page, where appointments for all participants for a particular matter are shown. In particular, the schedules for particular individuals for a week are shown on FIG. 149. FIG. 150 shows another scheduling page, where deadlines and appointments are shown without listing actual names. FIG. 151 shows another scheduling page, where the schedule for two days is shown. FIG. 152 is another scheduling page, where the schedule for one day is shown. FIG. 154 illustrates a billing schedule, where the billed amount for a particular time for a particular matter can be shown. FIG. 153 is a scope of work page, where an activity scope narrative for an activity or matter can be entered.

FIGS. 30-33 illustrate matter description pages, according to one embodiment. Tabs for this page can include client communications, client addresses, related parties, and documents. For a client communications page, a matter name, client name, client contact (with phone contact and email contact), a matter number, a client number, a client reference ID, or any combination thereof, can be included. The responsible individual and his or her office location can be included. The case status, when it was opened and closed can be included. The project name of the project, the project phase and the project status can be included. The practice group, area of practice, type of work, and industry can be included. A narrative can be included. An inter-office memo can be included, which can include an encounter (e.g., communications, meetings) note, a type of inquiry, a subject, an attached document, a created by name, and a date. Tasks can be indicated, with a start date, due date, time, priority, whether or not it is done, the done date, and a name of person the task was done by. A court, court docket, parties in caption, and project notes can be included.

FIG. 31 illustrates a client addresses page, which can include a billing address and a correspondence address. FIG. 32 illustrates a related parties page, which can include a firm name, a person name, a role, a relationship, an email address, and a phone number. FIG. 33 illustrates a document page, which can include a document name, a type of document, when it was filed, and by whom, and the time. Agreement notes can also be included.

FIG. 34 illustrates a business clearance page, according to one embodiment. The business clearance page can include financial review information, business considerations, and storage for financial reports. The financial review information can include information on whether the client is foreign-based, information on the client's credit worthiness, an estimate of fees for the matter, additional pricing and/or reporting requirements for the matter, an accounts receivable (AR) report, or a credit report, or any combination thereof. The business consideration information can include whether the client/matter may preclude the firm from other anticipated work, will the matter create any ethical walls, will the matter create exposure to the firm of additional risk, of if there are any special circumstances, or any combination thereof.

FIG. 35 illustrates an authorization page, according to one embodiment. The authorizations page can include conflict review information (e.g., assignee information, approval status, and notes); storage for attached waivers; conditions and engagement letters (e.g., document names, type, filed on and filed by); business clearance information (e.g., assignee information, authorization information); financial review information (e.g., assignee information, approval status information); budget and scope review information (e.g., assignee information, approval status); resource and staffing information (e.g., assignee information, approval status information); or final approval information (e.g., assignee information, authorization information), or any combination thereof.

FIGS. 36-37 illustrates individual selection pages, according to one embodiment. The individual selection pages can include selection notes and/or selection to do's. In addition, an appointment calendar and/or appointment list can be viewed.

FIGS. 38-39 are estimations pages, according to one embodiment. The estimations pages can include activity estimates and/or estimation to do's. An employee can use these pages to go into assigned milestones, phases, tasks, and activities and fill in the estimate information. A manager (e.g., practice head) can then review the estimate information and make necessary changes. FIG. 38 illustrates an activity estimates page, which can include an estimates outline, a summary of estimates for phases and tasks, an activity estimates and assignments section, a general estimation notes section, an estimation assumptions section, an internal estimation notes section, a deliverables section, or information to enter an assigned individual's contact information (e.g., phone, email) and summary estimation information (e.g., average hourly rate, total hours estimated, sub total, buffer, total estimate), or any combination thereof. The estimates'outline can include a list of all milestones, phases, and tasks within those phases, and activities within those tasks. The highlighted section of the estimates outline can correspond to the highlighted information in the summary of estimates for phases and tasks and the activity estimates and assignments section. The summary of estimates for phases and tasks can include information on the level (e.g., phase, task, activity), description, buffer percentage, estimated on date, authorized on date, average rate, hours, or estimated dollar amount, or any combination thereof. The activity estimates and assignments section can include information related to a description of the assignment, assigned individual, estimated on date, authorized on date, bill rate, hours, estimated dollar amount, or any combination thereof. FIG. 39 illustrates an estimation to do's page, which can include information on the task, the type, who it is assigned to, the start date, the end date, the due time, the priority, or whether or not it is done, or any combination thereof.

FIGS. 40-41 illustrate scheduling pages, according to one embodiment. Scheduling pages can be used after the estimating is done to schedule the timelines needed to complete the phases, tasks, and activities. The scheduling pages can include a scheduling page, a list view page, a scheduling to do page, or a billing schedule, or any combination thereof. All of the scheduling pages can include a scheduling outline section. FIG. 40 illustrates a scheduling page, which can include a calendar section showing appointments (e.g., for a matter, a person(s), matter related, committed appointments, or pending appointments, or any combination thereof) on a calendar as well as a view of several months of a calendar at a time. In the milestone area, we create a milestone, then a phase. Then tasks and activities. We can see what employees are working on and can get an overview of their availability. This takes place prior to the project monitoring. This is where we monitor what is happening with time and resources. FIG. 41 illustrates a to do page, which can include information on a task to be done, the type, who it is assigned to, the start date, the end date, the due time, and the price. A section for task notes and/or a section for conclusion notes can be included.

FIGS. 42-43 illustrate manage project pages, according to one embodiment. The manage project pages can include a timeline page and/or a management to do page. FIG. 42 illustrates a timeline page, which can include a project outline section, summary sections (e.g., total estimated hours, total estimated dollars, used hours, used dollars, balance of hours, balance of dollars, bill, % complete, estimated hours, hours used, balance of hours, average rate per hour, estimated dollars, used dollars, or balance of dollars, or any combination thereof). A calendar section can also be shown with various information on what projects, tasks, phases, etc. are to be done when. FIG. 43 illustrates a management to do page, which can include information on tasks to be done, the type, who a task is assigned to, a start date, an end date, a due time, or a price, or any combination thereof.

FIG. 44 illustrates a monitor case page, according to one embodiment. The monitor case page can include information relating to a diary, a docket, demands, file storage, real estate, or bankruptcy, or any combination thereof.

FIG. 45 illustrates a matter closure page, according to one embodiment, which can include various information for closing a matter.

FIGS. 46-51 and 156 illustrate various client information pages, according to one embodiment. FIG. 46 illustrates a communications page, where information on client encounters (e.g., enquiry note, type of inquiry, subject, attached document(s), or created by, or date, or any combination thereof) and follow ups (e.g., follow up task, start date, due date, time, priority, done, done date, or done by, or any combination thereof) can be tracked. FIGS. 47 and 154 illustrates client information pages, which can include information on the client's main contact(s), main office, phone/fax, address information, areas of practice, or third party firm competition, or any combination thereof. FIG. 48 illustrates a contacts page, which can include information on client contact information, including name, title, office, email, phone/fax, or address information, or any combination thereof. FIG. 49 illustrates an agreements page, which can include information on contractual documents and/or agreement notes. FIG. 50 illustrates a matter analysis page, which can include information on matters, team members, costs and graphs. FIG. 51 illustrates an evaluations page, which can include information related to client evaluations of host (e.g., Clearspire) employees. It should be noted that, in one embodiment, clients can evaluate employees, employees can evaluate clients, and employees can evaluate each other.

FIGS. 52-64 and 157-164 illustrate various employee information pages, according to one embodiment. FIG. 52 illustrates a communications page, with information on employee encounters and/or encounter follow ups. FIG. 53 illustrates a locations page, with information on the location of the employees and/or how to contact them. FIG. 54 illustrates a current assignments page, which includes information on open matters, expenses, or team members, or any combination thereof. FIG. 55 illustrates a compensation page, which can include information on matters worked on year to date, time against selected matter, earned hours, total hours worked, or total compensation or any combination thereof. FIG. 56 illustrates a personnel file page, which can include documents and/or other notes. FIG. 57 illustrates a skill sets page, which can include information on areas of expertise, skills, or general comments, or any combination thereof. FIG. 58 illustrates an employee information page, which can include information on employment history, biography, practice, professional activities, publications, recent highlights, honors and awards, or clerkships, or any combination thereof. FIG. 59 illustrates a development page, which can include information on training schedules. FIG. 60 illustrates a client page, which can include client evaluations, summarizing comments, or score totals, or any combination thereof. FIG. 61 illustrates a supervising individual page, which can include information on supervising individual evaluations, skill excellence, score totals, comments, or summarizing comments, or any combination thereof. FIG. 62 illustrates a matter debriefing page, which can include an individual debrief of client, issue reports, or opportunity reports, or any combination thereof FIG. 63 illustrates a technical support page, which can include information on issued equipment, installation notes, credentials, or local home office support, or any combination thereof. FIG. 64 illustrates a cost summaries page, which can include a summary of cost versus revenue for employees. FIGS. 157-159 illustrate employee availability pages, which can show the schedule of an employee according to month, week, or day. FIG. 160 illustrates an interview page, where information about interviews with the employee can be entered and/or shown. FIG. 161 illustrates a reference page, where references, resumes and letters of recommendation can be entered and/or shown. FIG. 162 illustrates an education page, where education information can be entered and/or shown. FIG. 163 illustrates an applicant information page, where information about an applicant can be entered and/or shown. FIG. 164 illustrates a supervisor page, where information about evaluations can be entered and/or shown.

FIGS. 65-68 illustrate various prospect pages, according to one embodiment. FIG. 65 illustrates a communications page, which can include information on prospect encounters and/or encounter follow-ups. FIGS. 66 and 155 illustrate prospect information pages, which can include various ways to contact the prospect as well as third party firm competition. FIG. 67 illustrates a contacts page, which can include additional contact information. FIG. 68 illustrates an agreements page, which can include contractual documents and/or agreement notes.

FIGS. 69-138 and 148-169 illustrate additional user interface pages that can be used by various users (e.g., professionals, staff, clients, applicants, prospects, etc.), according to several embodiments. FIG. 69 illustrates a customized welcome page that can include information on firm notices, matters for a particular user, or news tailored to a user, or any combination thereof. FIG. 70 illustrates a customized page where wall information can be added. FIG. 71 illustrates a create client search relationship page where a client ID and/or client search terms can be entered. FIG. 72 illustrates a create matter search relationship page where a matter number and/or matter search terms can be entered. FIGS. 73-74 illustrate file pages. FIG. 73 is a page listing files available on the system and FIG. 74 is a page showing information about the first file on FIG. 73. FIGS. 75-76 illustrate link pages. FIG. 75 is a page listing links available on the system and FIG. 76 is a page showing information about the first link. With the tiles and links illustrated on FIGS. 73-76, each file and link can be assigned a category so that it can be searched and accessed later. FIG. 77 lists the category names and FIG. 78 is a page allowing the user to create his own customized category. FIG. 79 is a page illustrating a summary of the file or link that can be categorized.

FIG. 80-86 are pages illustrating various administration pages, and can include accounting information, general information, human resources information, IT information, library information, marketing information, training information. Pages, files, wiki articles, or links, or any combination thereof can be included on the administration pages.

FIGS. 87-106 are pages illustrating various information compiled and stored for applicants, and can include personal information, professional information, employment history, education information, professional references, or conclusion information (e.g., bar sanctions, convictions, resume, confirmation statement), or any combination thereof.

FIGS. 107-138 are pages illustrating various other content available, some of which has been discussed previously. As illustrated in FIGS. 107-138, multiple ways of presenting and acquiring various information can be utilized. FIG. 107 illustrates a screen shot showing firm fixed articles, including several titles and post dates. FIG. 108 illustrates a screen shot showing how a user can be added/registered. FIG. 109 illustrates administrative links, including firms fixed feeds, users, recommends, newspaper, admin links, and wiki. FIG. 110 illustrates a matter page, with matter details, a document tree, a docket, related wiki articles, a hallway (e.g., people by team, geography, and practice), and news. FIG. 111 illustrates various applications that can be utilized by users. FIG. 112 illustrates a to do list, with a matter list, firm notices, internal discussions, news, and a hallway. FIG. 113 illustrates recommended news. FIG. 114 illustrates information on a particular person, including biography information, success stories, areas of expertise, languages, bar admissions; featured publications, workload, and status. FIG. 115 illustrates information on searching for particular persons. FIG. 116 illustrates overview information, including matter information, persons worked with, wiki articles, recommends, and a document tree.

FIG. 117 is an overview page of a matter, illustrating matter details, including ID, name practice group, area of practice, type of work, staff, status, status date, received date, and narrative. FIG. 165 is a documents page, which can list documents associated with a particular matter. FIG. 166 illustrates a billing page, which can include bills sent for a particular matter. FIG. 167 is a chronology page, which can list various dates of importance, such as meetings, etc. FIG. 168 is a communications page, which can list communications for a matter, such as emails, phone calls, etc. FIG. 169 is a contact page, where comments or questions regarding a matter can be submitted.

FIG. 118 illustrates how a status can be entered for a particular person. FIG. 119 illustrates how a user feed can be created. FIG. 120 illustrates how evaluations can be entered. FIG. 121 illustrates a posted article with comments. FIG. 122 illustrates financial information. FIG. 123 illustrates open matter information. FIG. 124 illustrates a screen for searching for persons. FIG. 125 illustrates a list of users where users can register, login, log out, maintain user profiles, etc. FIG. 126 illustrates estimation information. FIG. 127 illustrates to do information, including to do snapshot information. FIG. 128 is a screen shot setting forth wire transfer procedures. FIG. 129 lists recently modified wiki articles. FIG. 130 illustrates an article. FIG. 131-132 illustrates various hallways. FIG. 133 illustrates client ID information. FIG. 134 illustrates a search page for matter information. FIG. 135 illustrates a search page for feed information. FIG. 136 illustrates an approval queue. FIG. 137 illustrates firm notice information. FIG. 138 illustrates social media information.

FIG. 139-147 illustrate various data tables related to the enterprise backbone 125 and community of practice (COP) 105, which are set forth in FIG. 1. The COP 105 can be related to receiving information and displaying information and the enterprise backbone 125 can be related to pulling in information from the practice management applications 150. Together, the COP 105 and the enterprise backbone 125 can enable a user to interact with custom or off the shelf practice management applications 150. The enterprise backbone 125 can receive and aggregate data from the COP 105 and the practice management applications 150.

When the COP 105 receives information, it can store that information in tables and then send that information to the enterprise backbone 125 utilizing a queue. Similarly, when the enterprise backbone 125 has aggregated the various data when it needs to send it to the COP 105 for display, the data can be stored in tables in the enterprise backbone 125 and sent to the COP 105 utilizing a queue.

With respect to the enterprise backbone 125, FIG. 139 sets forth various data tables that can be utilized. FIGS. 140A-E set forth tables related to clients, prospects, vendors, and their contacts, as shown in FIG. 139. FIGS. 141A-G set forth tables related to employee human resource information, as shown in FIG. 139. FIGS. 142A-E set forth tables related to connections between clients and employee human resources, and matters, project estimation, scheduling, and budget to actual information, as shown in FIG. 139. FIGS. 143A-G set forth tables related to matters, project estimation, scheduling, budget to action information, as shown in FIG. 139. FIGS. 144A-C set forth tables related to system control data for a user interface and pick list data for standardized data entry, as shown in FIG. 139. FIG. 144D sets forth tables related to inter-application data transfers, as shown in FIG. 139. In one embodiment, as shown by the interconnections in FIG. 139, various tables from one group (e.g., FIG. 141) can be utilized in other groups (e.g., FIG. 140). It should be noted that the tables include field names and field types. The field types are shown in the legend on FIG. 140B. Those of ordinary skill in the art will see that many other field names and types can be utilized.

FIG. 145 illustrates how the custom enterprise backbone 125 can collect and aggregate data from other applications to create and serve new data back to them. FIG. 146 sets forth tables related to the COP 105. FIG. 147 shows how a community user can access the COP 105, which can include a user interface accessed by the user. The COP 105 can aggregate data from several sources, such as the enterprise backbone 125. As a jumping off point for work, the COP 105 can aggregate and enhance an entity's operational data and internal community. The COP 105 can provide easy access to the firm's enterprise data, as well as quick access to work directly with relevant systems. The relevant systems can include practice management applications (e.g., case management 165, document management 160, records management 170 (CRM), unified messaging (e.g., outlook)).

The COP 105 can also display dynamic and intelligent, virtual hallways to keep community users connected. Users can be made aware of the status and presence of others in the community. For example, instant messaging (IM), voice, and video chat can be initiated directly from the COP 105. In addition, users can be automatically connected with others who share common work, practice group, and geography. Whether in a physical office, in a remote home office, or onsite with a client, the COP 105 can keep the community of users connected and aware.

FIG. 148 is a screen shot illustrating how matter time tracking can be captured, according to one embodiment. Tasks can be sorted on a list by due date (e.g., overdue, with the next due date at the top of the list). The task name and percentage of budget billed can be shown at a top level. A task percentage can be highlighted (e.g., over budget can be in red and available budget can be in green). A user can open a particular task and see a diagram and numbers for hours available, hours billed, or hours budgeted, or any combination thereof. In addition, a list of activities and relevant activity information can be shown. The time tracking for each matter can be integrated with case management and financial information. In addition, an individual can project how many calendar days it will take to complete a task, and whether there are conflicting dates with other tasks assigned to that person that are pending. In this way, estimate information for how long it will take to complete a new task can be integrated with estimate information provided for other tasks.

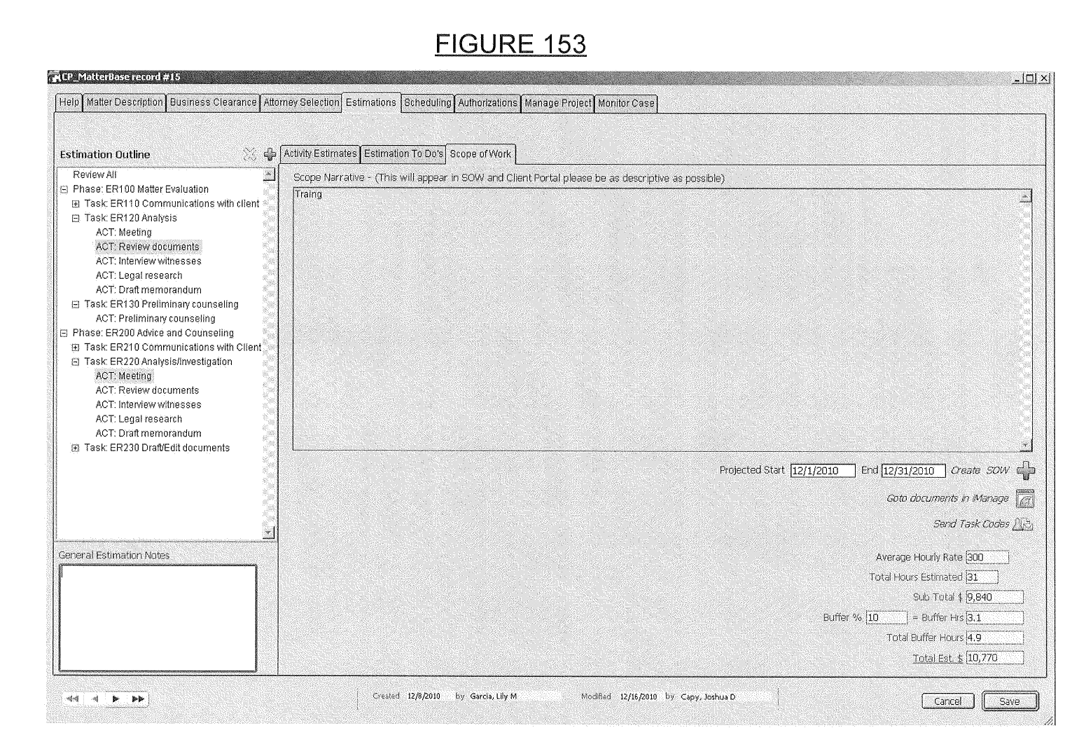

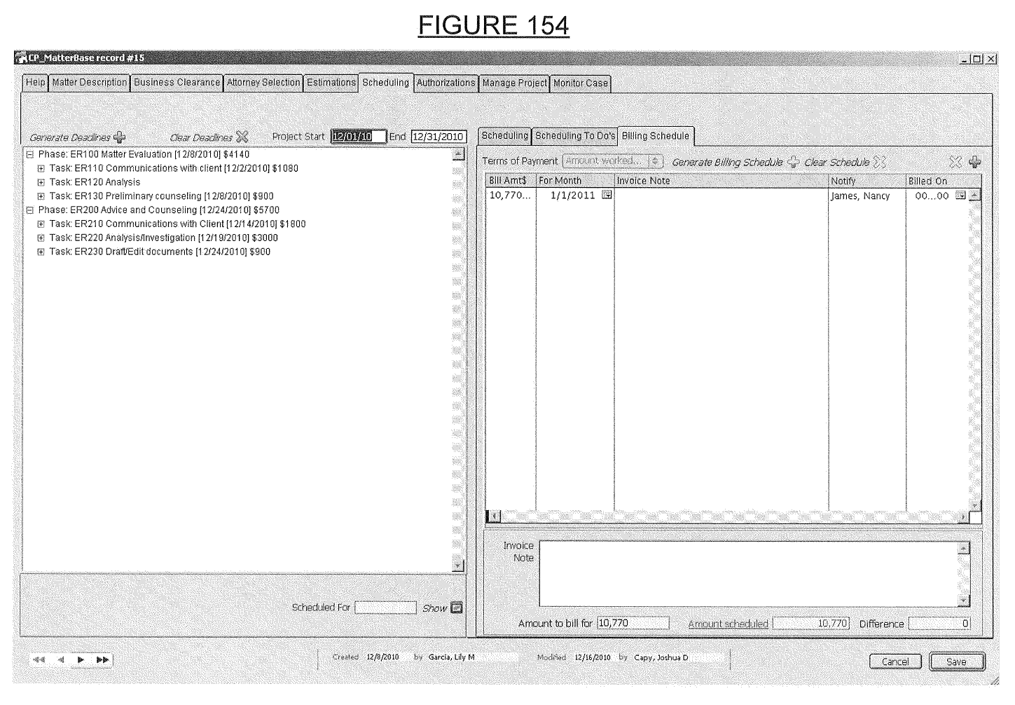

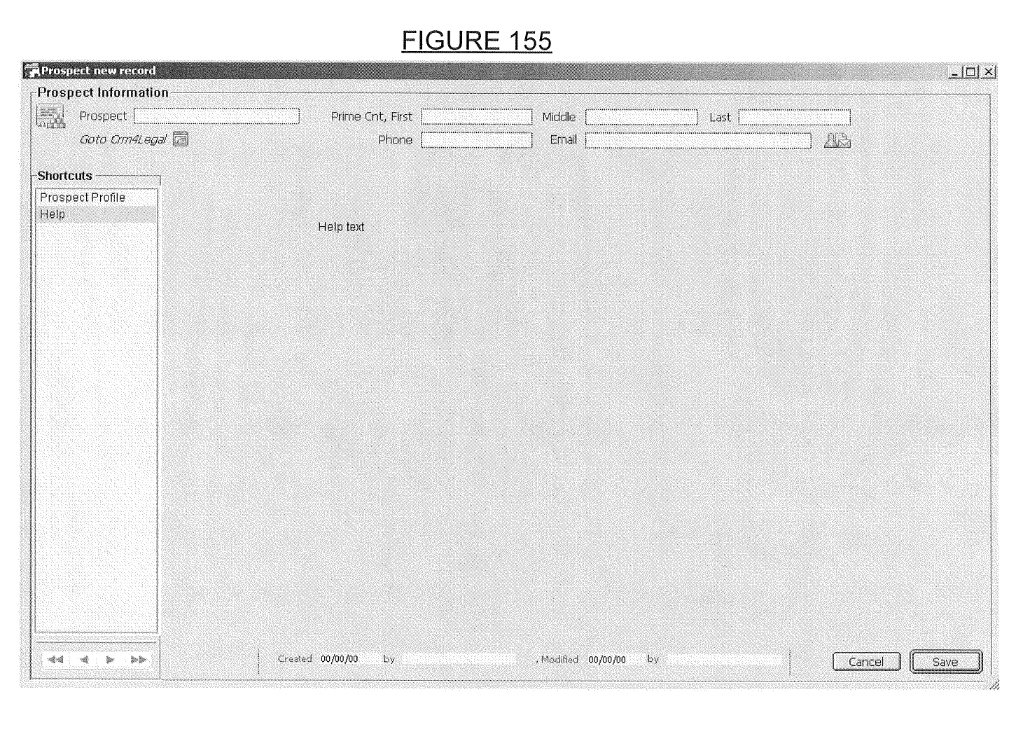

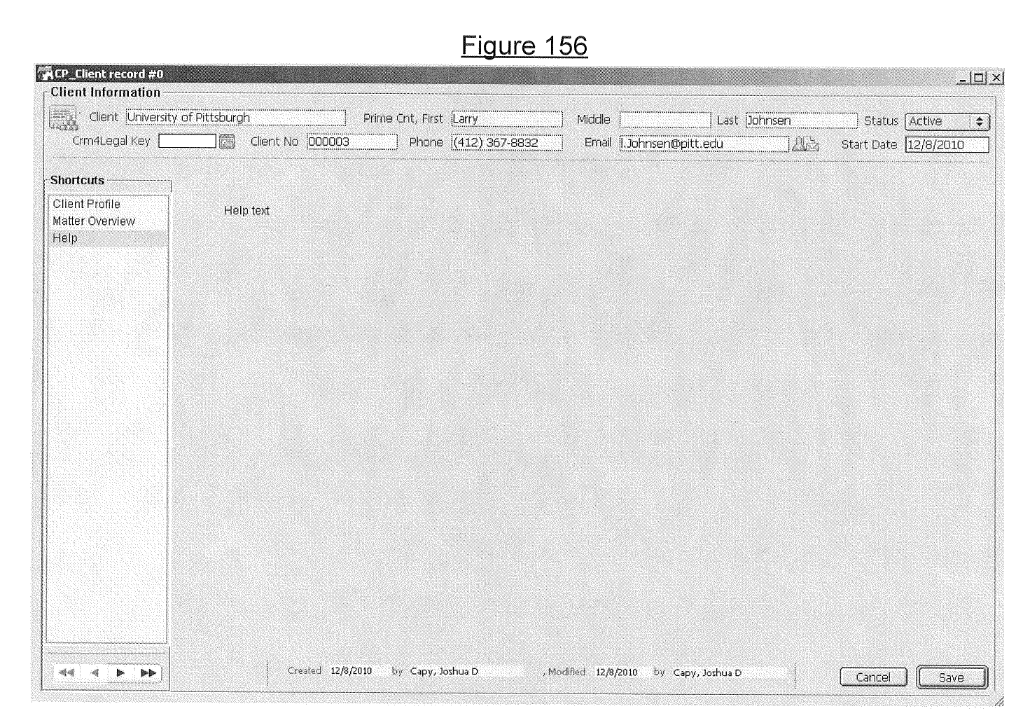

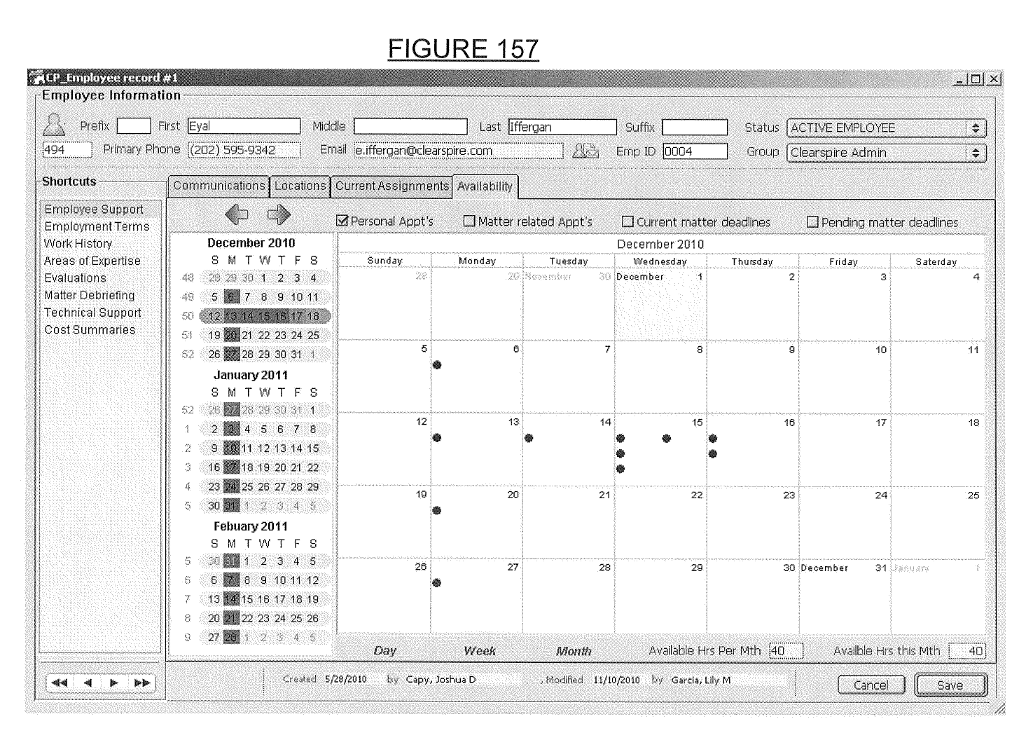

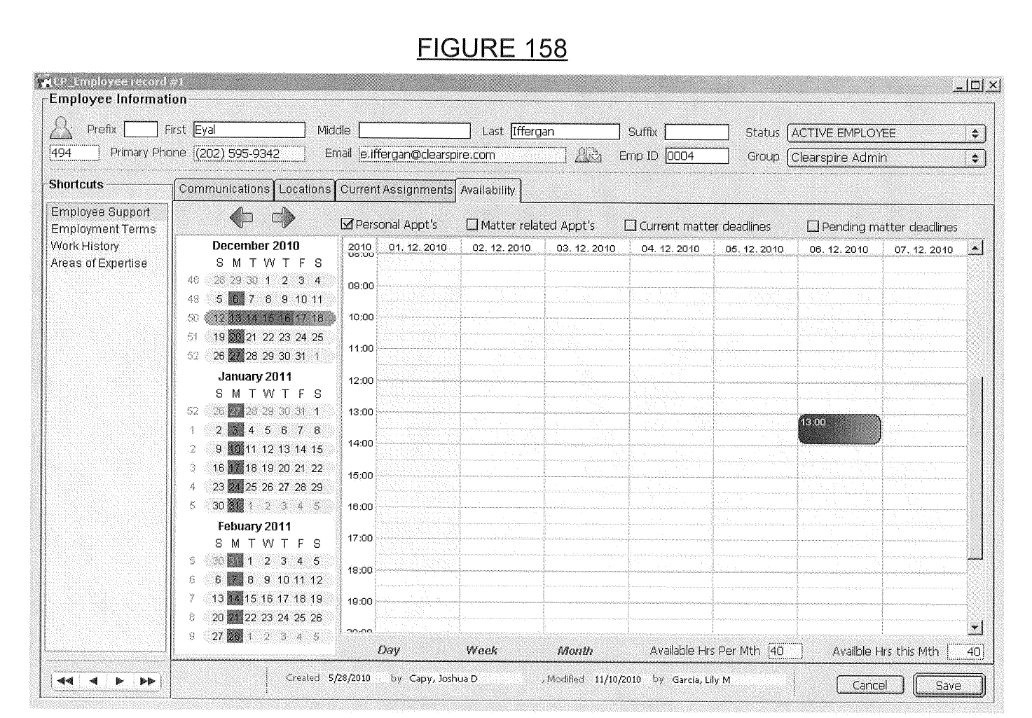

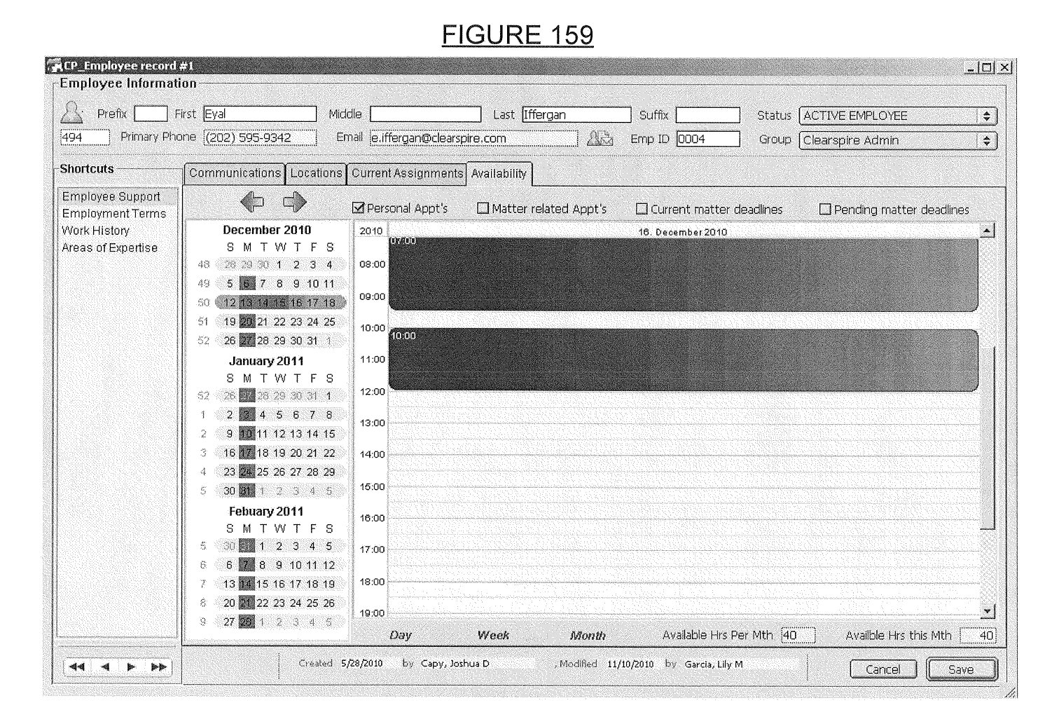

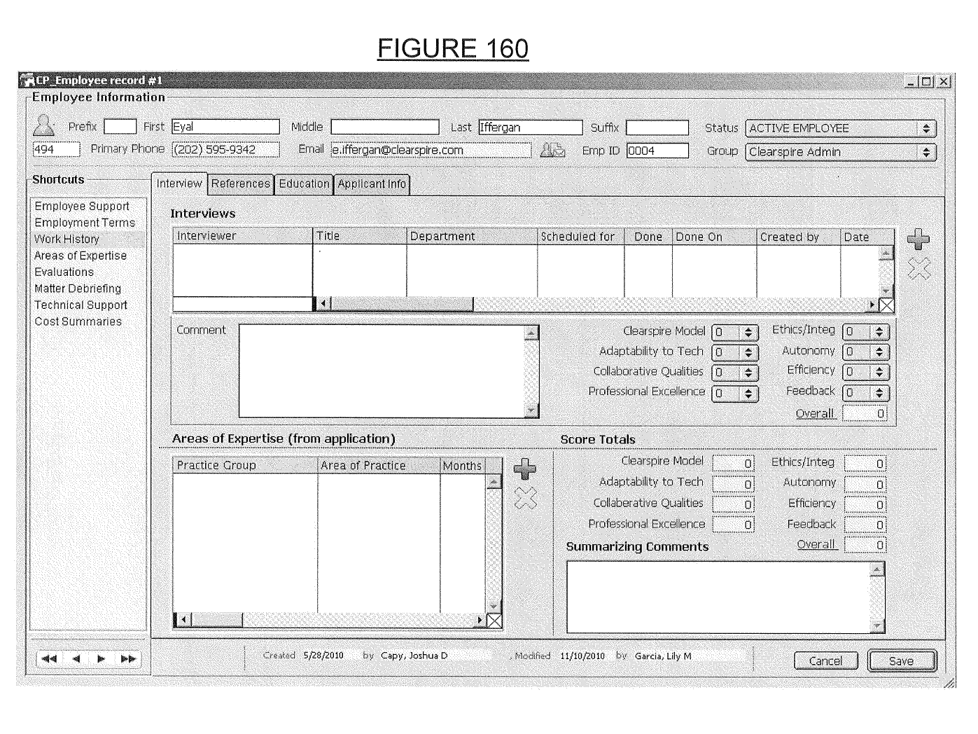

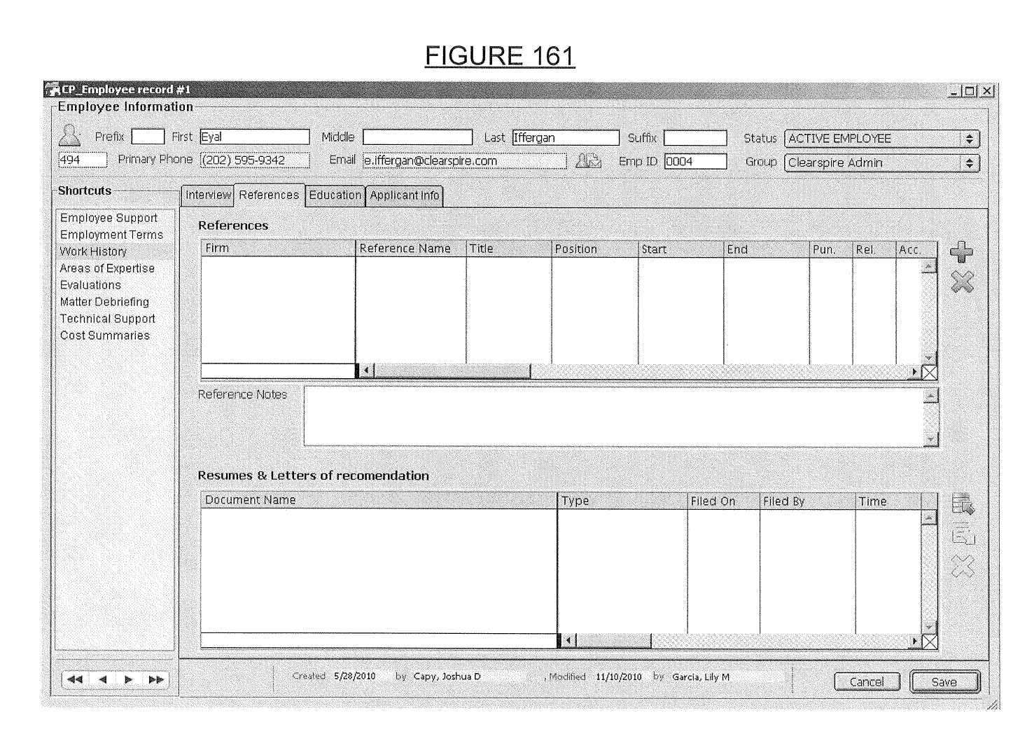

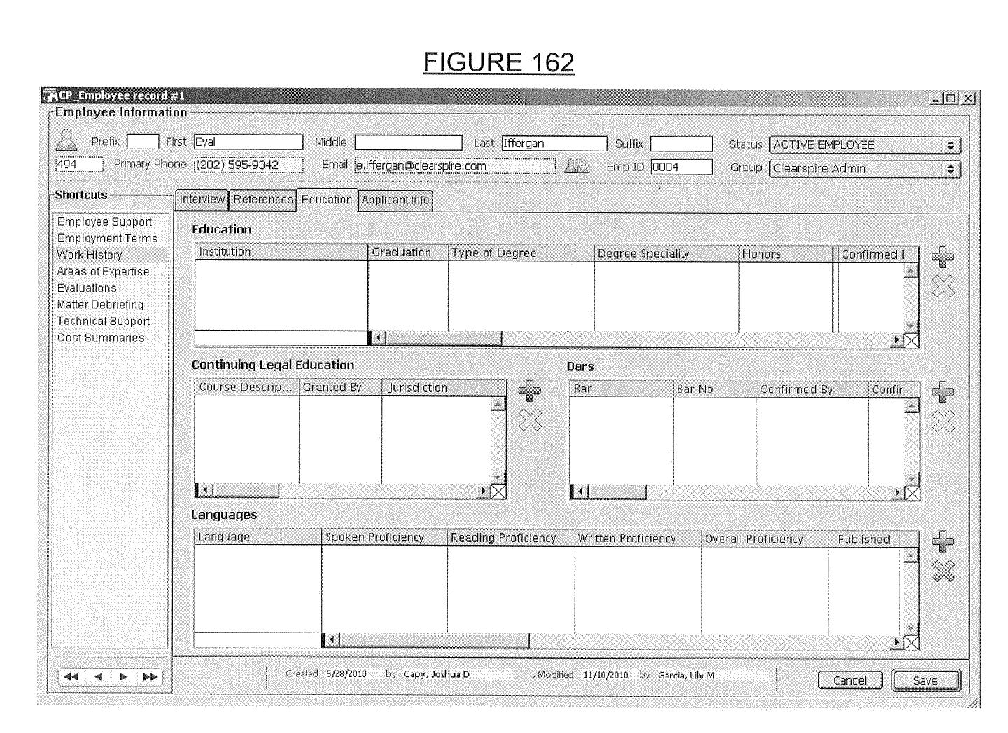

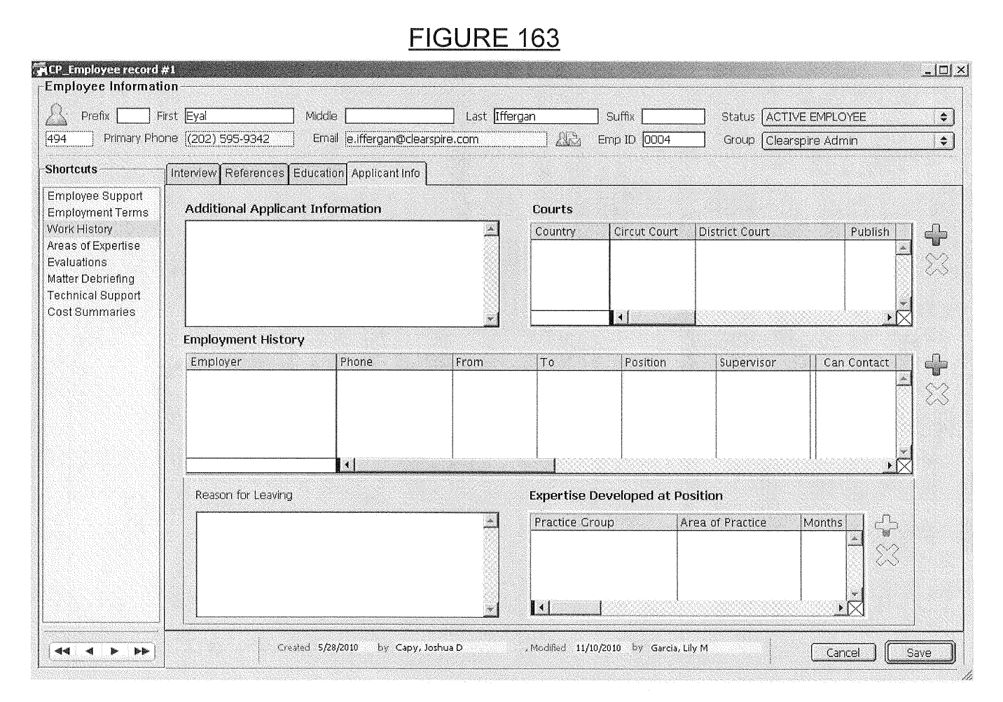

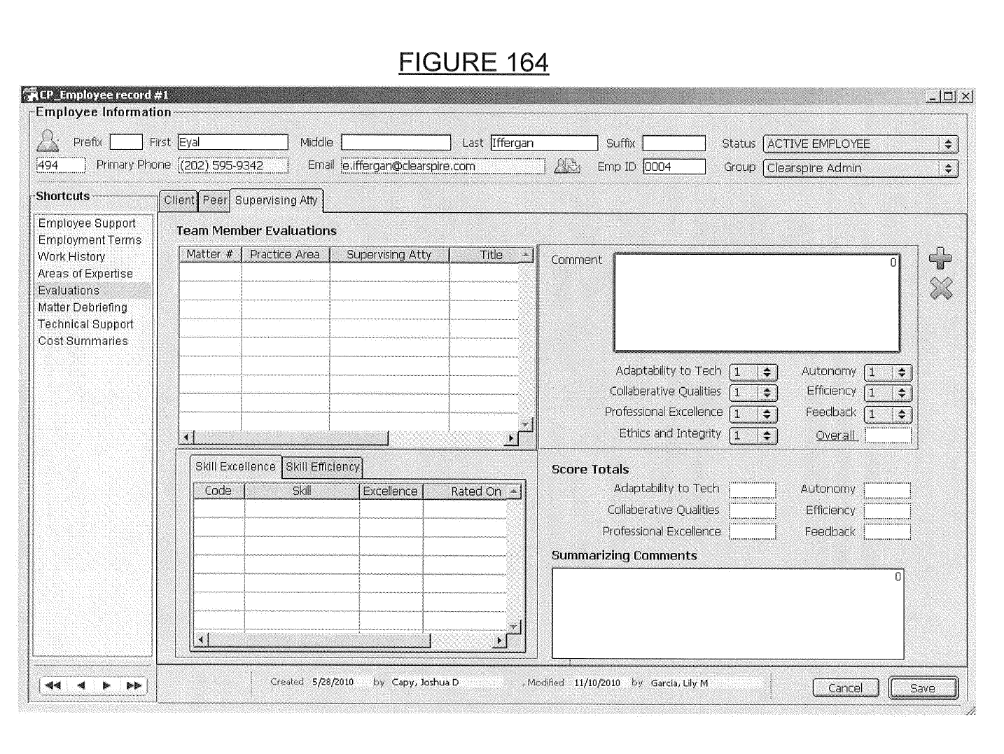

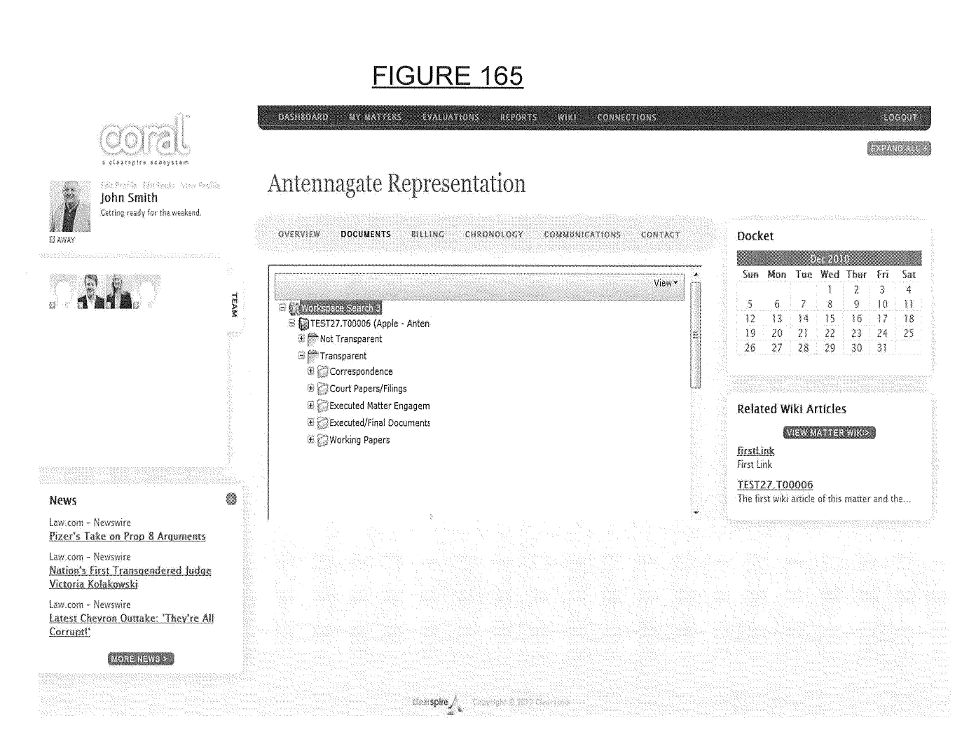

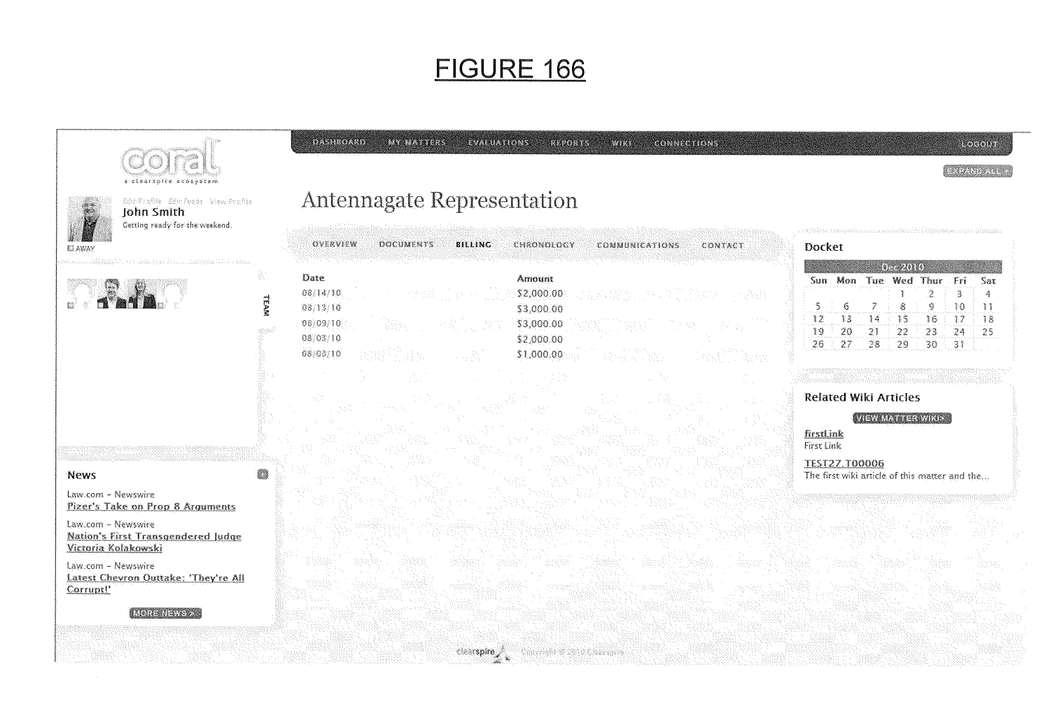

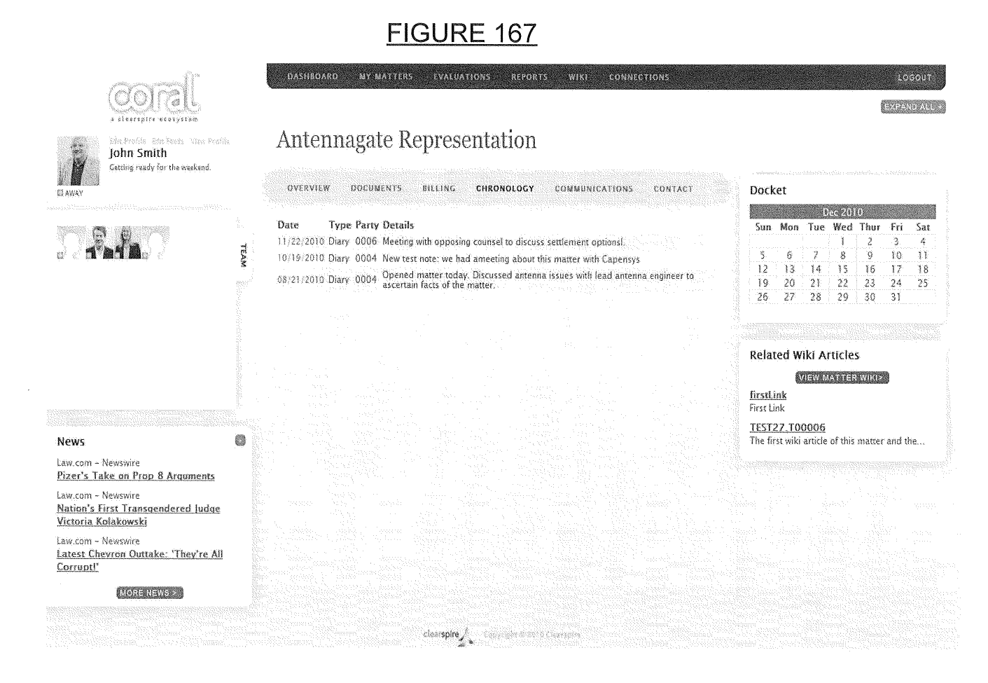

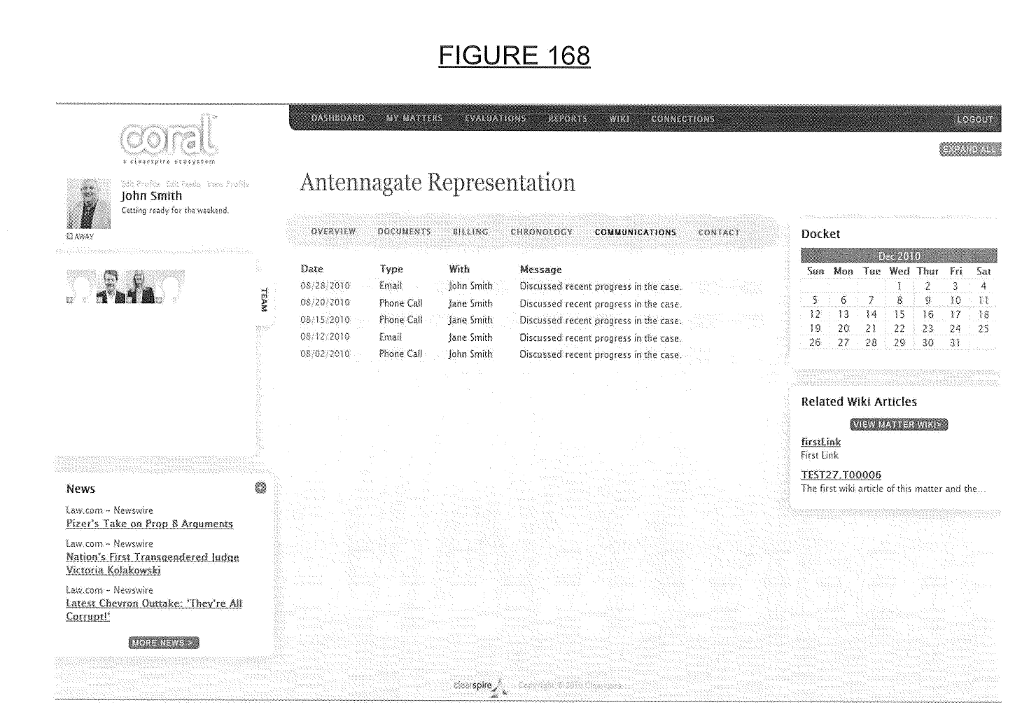

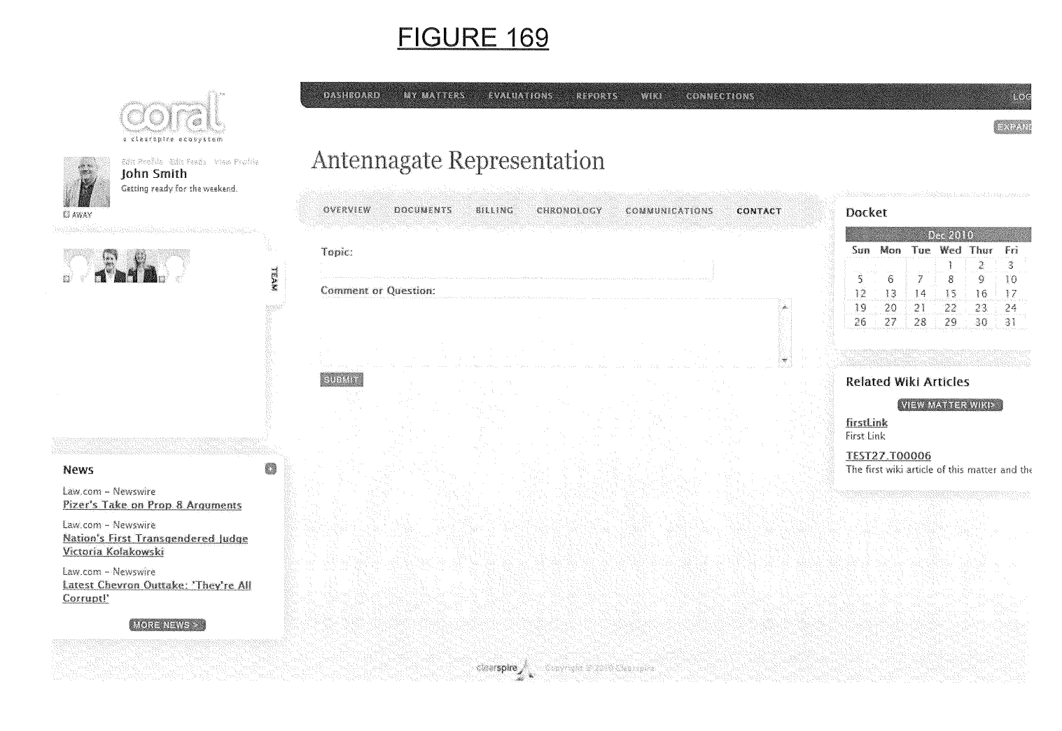

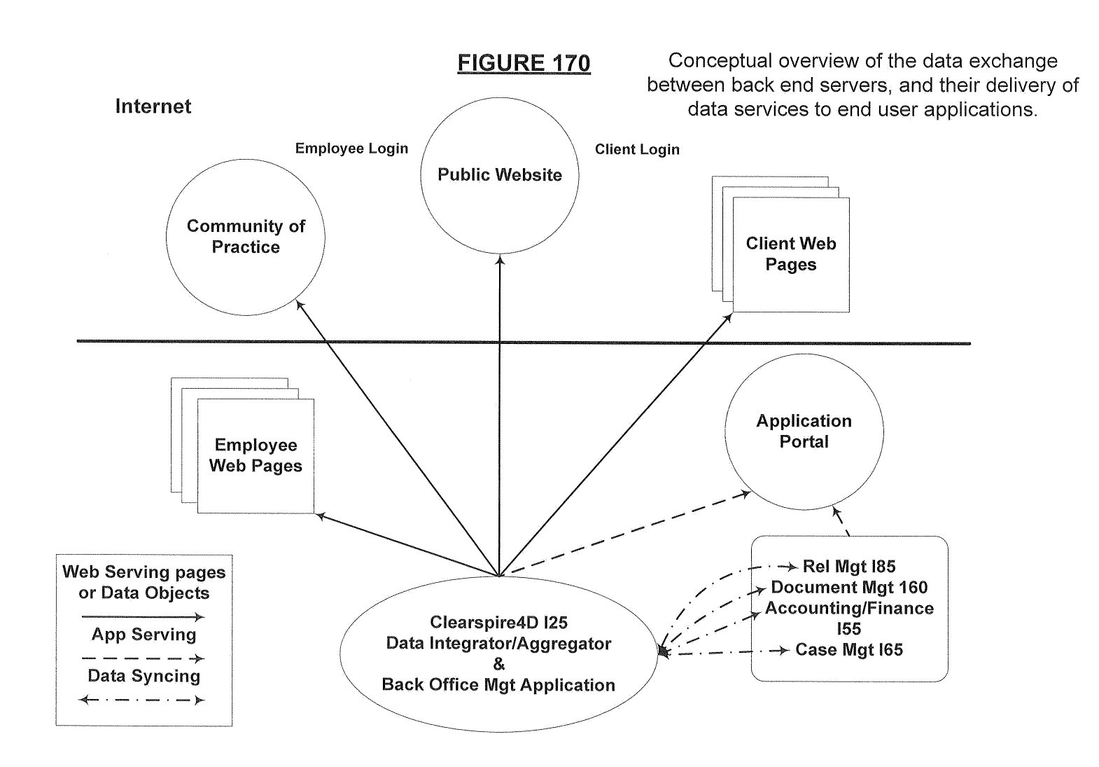

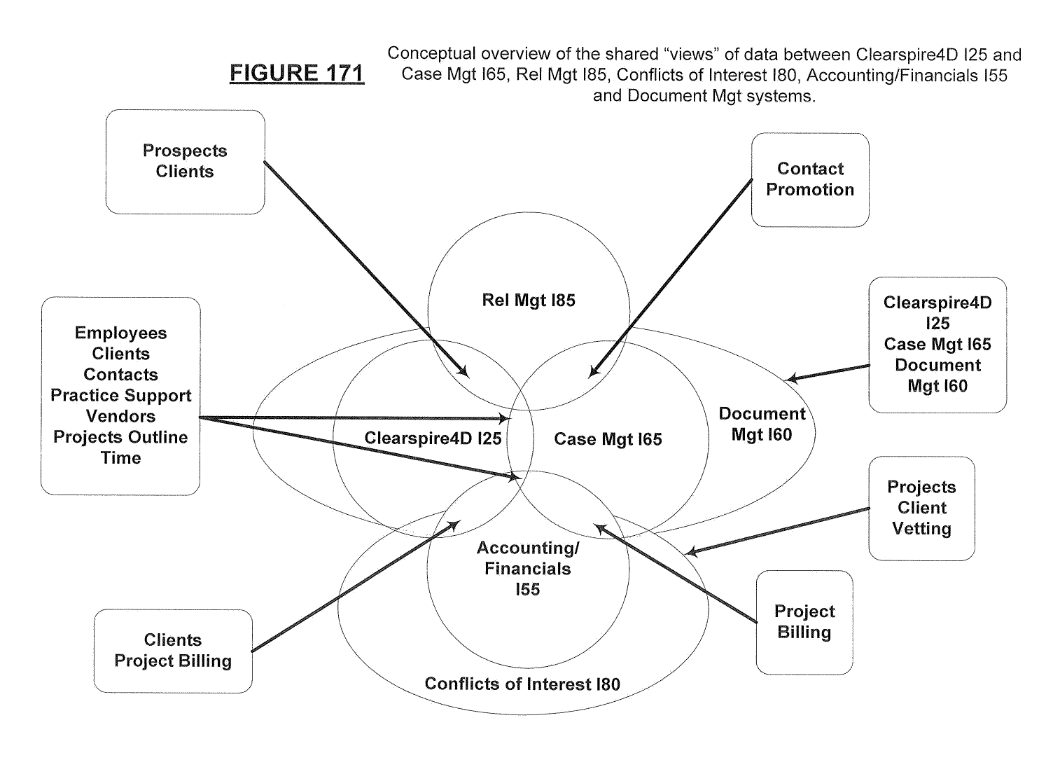

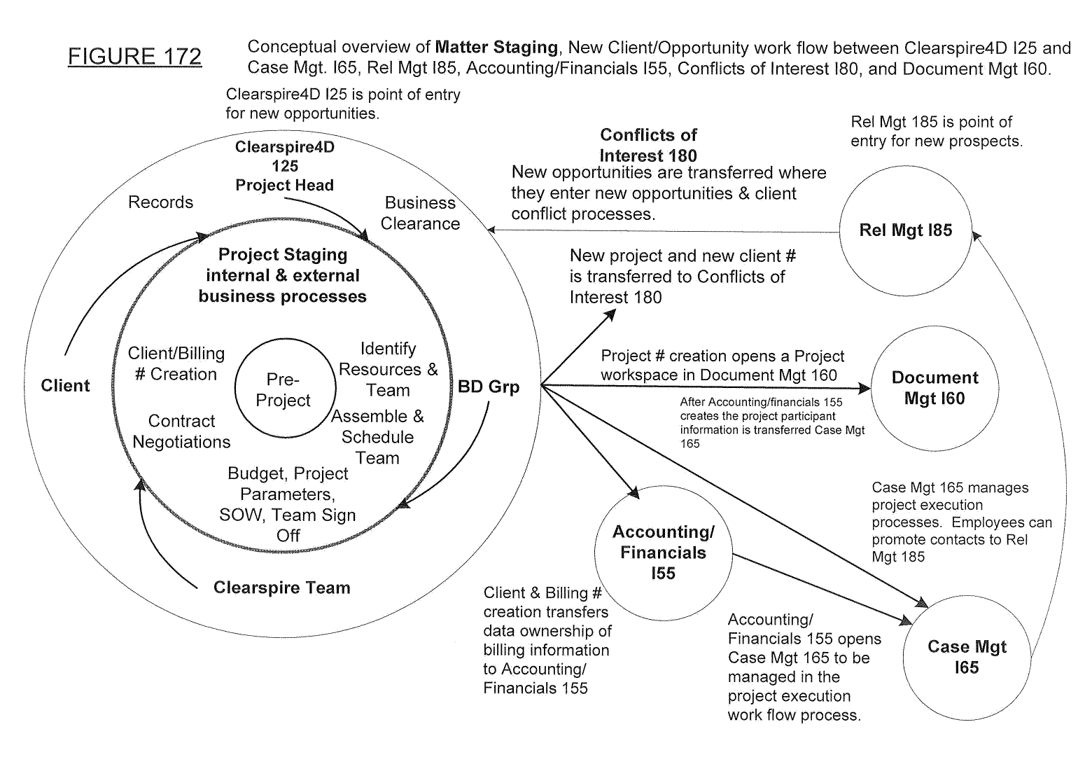

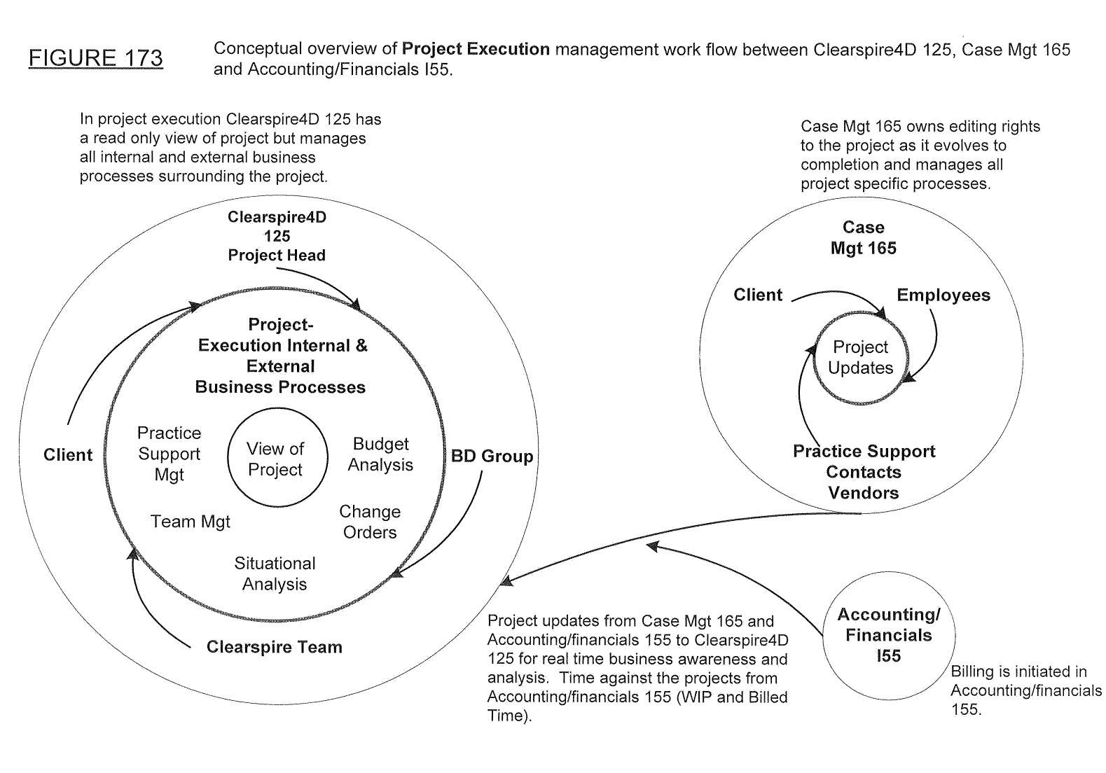

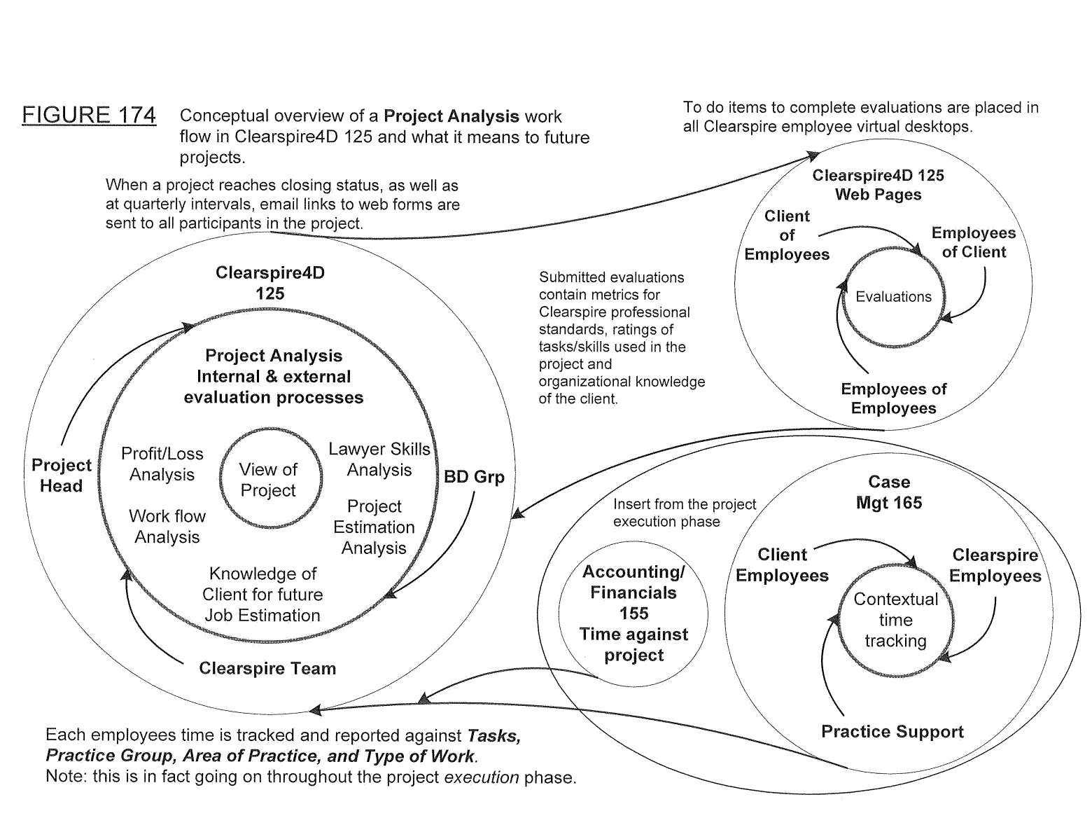

FIGS. 170-174 and FIG. 25 illustrate conception overviews of data exchanges and processes in system 100, according to one embodiment. In FIG. 170, a conceptual overview of the data exchange between back end servers, and their delivery of data services to end user applications is shown. The straight lines represent data that can be synchronized. FIG. 171 illustrates a conceptual overview of various shared “views” of data between the custom enterprise backbone 125 (e.g., Clearspire 4D), case management 165, relationship management 185, conflicts of interest 180, accounting finance 155, and document management 160. This can represent the kind of data that can be shared between different types of applications. It should be noted that many other kinds of data can be shared in system 100. FIGS. 172-174 and FIG. 25 illustrate various process stages and the transfer of data in relationship to the process stages. The process stages can include, but is not limited to, matter staging, matter execution, analysis of the process, and the closure process. FIG. 172 illustrates a conceptual overview of matter staging, with a new client/opportunity work flow between the custom enterprise backbone 125, case management 165, relationship management 185, accounting/finance 155, conflicts of interest 180, and document management 160. The curved arrows can indicate an iterative process. The straight lines can represent movement of data. FIG. 173 illustrates a conceptual overview of the project execution management work flow between the custom enterprise backbone 125, case management 165, and accounting/finance. FIG. 174 illustrates a conceptual overview of a project analysis work flow in the custom enterprise backbone 125. FIG. 174 also illustrates, for example, the knowledge building feed back loop between project management and HR. In another embodiment, the inclusion of the community of practice 105 (e.g., as an engine base on the principles of associative economics) could also be included. This could help provide a knowledge based community that is the economic engine of an organization because it builds professional identity, institutional knowledge, and presents it to clients, prospective clients, etc. For example, in project management and HR, metrics of efficiency and quality of work can be developed. In the community of practice 105, qualities of relationships between teams, and teams and clients, etc., through joint activity of knowledge building can be developed. It should also be noted that the data from the community of practice 105, the custom enterprise backbone 125, and the various applications can all be integrated and combined (e.g., in a total feed back loop) and utilized by users so that the users can take advantage of all of the known information about a subject and about the individuals that created particular content.

FIG. 25 illustrates a conceptual overview of a project closure, and the workflow between the custom enterprise backbone 125 and the case management 165, relationship management 185, accounting/finance 155, conflicts of interest 180, and document management 160. It should be noted that FIGS. 170-174 and FIG. 25 illustrate workflow according to several embodiments, but that many other workflows can be utilized.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments

In addition, it should be understood that any figures which highlight the functionality and advantages, are presented for example purposes only. The disclosed methodology and system are each sufficiently flexible and configurable, such that it may be utilized in ways other than that shown. For example, the steps listed in any flowchart may be re-ordered or only optionally used (even when not explicitly indicated) in some embodiments. Thus, those skilled in the art will realize that the ordering of the steps in the FIGURES can be altered in other embodiments and that various steps can be removed in some embodiments.

It should also be noted that the terms “a”, “an”, “the”, “said”, etc. signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A method for total resource management of at least one project for at least one knowledge-based practice, comprising:
receiving, in at least two practice management applications, employee data for at least one employee and/or client data for at least one client;
integrating data from the at least two practice management applications utilizing at least one enterprise application; and
creating, at least one project management model utilizing the integrated data, the at least one project management model enabling clients and employees to interact and/or manage metrics of the knowledge-based practice.

2. The method of claim 1, further comprising:
providing a single integrated real-time view of the activities taking place across the at least two practice management application.

3. The method of claim 1, further comprising:
managing communications between clients and/or employees.

4. The method of claim 1, further comprising:
utilizing the metrics for the purpose of evaluating project processes.

5. The method of claim 1, further comprising:
combining budget and actual costs with evaluation metrics from project participants into a project management outline illustrating real-time situational analysis.

6. The method of claim 1, wherein the at least two practice management applications comprise: at least one accounting application; at least one finance application; at least one document management application; at least one case management application; at least one records management application; at least one library application; at least one research application; at least one conflict of interest application; at least one relationship management application; at least one unified messaging application; at least one law application; at least one project management application; at least one technology application; or at least one desktop productivity application; or any combination thereof.

7. The method of claim 1, wherein the at least one enterprise application comprises:
at least one employee management application; at least one project management application;
at least one matter staging application; at least one reporting application.

8. The method of claim 1, wherein a single integrated real-time view of activities taking place across various communities is provided.

9. The method of claim 8, wherein the various communities utilize: at least one website; at least one intranet; at least one extranet.

10. The method of claim 1, wherein project oversight is provided to at least one client.

11. The method of claim 1, wherein employee HR needs are managed.

12. The method of claim 1, wherein the fixed price units are fixed price budgets comprising: estimates of actual work product costs; estimates of reasonable administrative costs; estimates of reasonable research and support costs; estimates of reasonable buffer costs; or any combination thereof.

13. The method of claim 1, further comprising:
assessing resource needs for the at least one project utilizing the integrated and aggregated data;
assessing team member needs for the at least one project utilizing the integrated and aggregated data; and
defining budget parameters for the at least one project utilizing information obtained from at least one team member.

14. The method of claim 13, wherein all team members sign off on their respective responsibilities and budgets.

15. The method of claim 1, further comprising:
gathering the integrated data from the at least one project in the interim of the at least one project or at the end of the at least one project.

16. The method of claim 15, further comprising:
analyzing profitability; performance and best practices of the team;
analyzing professionalism; collaborative skills; and skill sets of the team members; or
analyzing client satisfaction; or any combination thereof.

17. The method of claim 1, further comprising:
closing the at least one project by closing the at least two practice management applications.

18. The method of claim 1, further comprising:
providing at least, one community for the at least one project, where the at least one community comprises: at least one team member; at least one provider; at least one administrator; at least one client; or any combination thereof.

19. The method of claim 1, wherein the at least one community is displayed utilizing at least one hallway.

20. The method of claim 1, wherein the at least one project management model comprises information related to at least one person, comprising:
availability and/or workload of at least one person;
at least one person in at least one geographic area and/or at least one practice area;
at least one person participating in at least one matter;
at least one email address and/or phone number that can be utilized to contact that at least one person; or
any combination thereof.

21. The method of claim 1, wherein the at least one person is accessed by various communication options, comprising: telephone communication and/or video communication.

22. The method of claim 1, wherein the at least one project management model comprises at least one dashboard for at least one employee, comprising:
information related to at least one matter;
information related to at least one assignment to be accomplished;
knowledge-based practice notice information;
internal wiki and/or discussion information;
relevant news information; or
any combination thereof.

23. The method of claim 1, wherein the integrating data further comprises:
storing information related to at least one matter in at least one database as at least one phase, task, or activity, or any combination thereof; and
searching the at least one database for information related to the at least one matter, phase, task, or activity, or any combination thereof.

24. The method of claim 23, wherein information related to the at least one matter, phase, task, or activity, or any combination thereof, comprises: estimate information;
responsibility information; review information; or any combination thereof.

25. The method of claim 1, further comprising:
storing encounter information related to at least one person in at least one database.

26. The method of Clam 1, wherein the knowledge-baed practice comprises: at least one law practice; at least one consulting practice; at least one technology practice; at least one financial practice; at least one document management practice; at least one case management practice; at least one records management practice; at least one library management practice; at least one research management practice; at least one conflict of interest management practice; at least one relationship management practice; at least one unified messaging management practice; at least one desktop productivity management practice; or at least one accounting practice; or any combination thereof.

27. The method of claim 1, wherein the metrics comprise: qualitative metrics;
efficiency metrics; or budgetary metrics; or any combination thereof.

28. The method of claim 1, wherein the integrating data further comprises:
storing relevant experience gained while working and/or while not working for the at least one knowledge-based practice as at least one category of experience in at least one database; and
searching the at least one database for experience related to at least one new project.

29. The method of claim 4, wherein the relevant experience is categorized by:
practice group; area of practice; type of work; amount of time working; or any combination thereof.

30. A system for total resource management of at least one project for at least one knowledge-based practice, comprising:
at least one processor configured for:
receiving, in at least two practice management applications, employee data for at least one employee and/or client data for at least one client;
integrating data from the at least two practice management applications utilizing at least one enterprise application; and
creating, at least one project management model utilizing the integrated data, the at least one project management model enabling clients and employees to interact and/or manage metrics of the knowledge-based practice.
